(19) United States
(12) Patent Application Publication
(10) Pub. No.: US 2025/0085255 A1
(43) Pub. Date: Mar. 13, 2025

(54) METHODS AND SYSTEMS FOR DROPLET OPERATIONS

(71) Applicant: Volta Labs, Inc., Boston, MA (US)

(72) Inventors: William Kai LANGFORD, Cambridge, MA (US); Cedric Nicolas Marie VIRY, Cambridge, MA (US); Udayan UMAPATHI, Cambridge, MA (US); Richard Poulos KAUFMAN, Cambridge, MA (US); Akim LENNHOFF, Cambridge, MA (US); Liam MASTERS, Biddeford, ME (US); William Russell JACKSON, Cambridge, MA (US)

(21) Appl. No.: 18/628,148

(22) Filed: Apr. 5, 2024

Related U.S. Application Data
(63) Continuation of application No. PCT/US2022/046102, filed on Oct. 7, 2022.
(60) Provisional application No. 63/353,449, filed on Jun. 17, 2022.
(60) Provisional application No. 63/253,434, filed on Oct. 7, 2021.

(51) Int. Cl. G01N 27/447; B03C 1/28; B03C 5/00

(52) U.S. Cl. CPC G01N 27/44786; B03C 1/28; B03C 5/005; B03C 2201/18; B03C 2201/26

(57) ABSTRACT

Described herein are systems and methods for dispensing a liquid or for manipulating a droplet. In some examples, a method is provided for droplet operation. The method may comprise providing a substrate comprising a discrete location. The method may further comprise providing one or more electrodes disposed adjacent to the discrete location of the substrate and providing a droplet dispenser disposed over the substrate. Next, an electrode of the one or more electrodes may be activated or deactivated. Such activating or deactivating may be synchronized with dispensing the droplet to the discrete location or removal of at least the portion of the droplet from the discrete location.

### CROSS-REFERENCE

This application is a continuation of International Application No. PCT/US2022/046102, filed Oct. 7, 2022, which claims benefit of U.S. Provisional Application No. 63/253,434 filed Oct. 7, 2021, and U.S. Provisional Application No. 63/353,449 filed Jun. 17, 2022, all of which are herein incorporated by reference in their entirety.

### BACKGROUND

Liquid dispensers may be used in biotechnology applications, and may be used to carry and dispense one or more reagents. These reagents may be further used to process biological samples.

### SUMMARY

Recognized herein is an industry need for flexibility of storage conditions, dynamic range of volumes for storage and dispensing, accuracy and repeatability of dispensing, and scalability of parallel processing of multiple samples, for example, on electrowetting arrays. Recognized herein is a solution entailing separating the reagent storage and dispensing functions from the electrode array and offloading them to external modules. Recognized herein are also methods and systems for reducing the error margin of a droplet dispenser manipulating a droplet.

Aspects of the present disclosure provide a method for droplet processing, the method comprising: (a) providing (i) a substrate comprising a discrete location, (ii) one or more electrodes disposed adjacent to said discrete location of said substrate, and (iii) a droplet dispenser disposed over said substrate; and (b) activating or deactivating an electrode of said one or more electrodes, which activating or deactivating is synchronized with dispensing said droplet to said discrete location or removal of said at least said portion of said droplet from said discrete location. In some embodiments, said one or more electrodes is a plurality of electrodes. In some embodiments, said droplet dispenser comprises a droplet handling arm that moves towards or away from said substrate. In some embodiments, said droplet dispenser is used to dispense said droplet to said discrete location. In some embodiments, said droplet dispenser is used to remove at least a portion of said droplet from said discrete location. In some embodiments, said droplet is dispensed at said discrete location at an error margin of no more than 20 millimeters (mm), which error margin is calculated based at least in part on a difference between an intended dispensing location and an actual dispensing location of said droplet. In some embodiments, said droplet is dispensed at said discrete location comprising said error margin of no more than 1 mm. In some embodiments, said droplet is dispensed at said discrete location comprising an error margin of no more than. 1 mm. In some embodiments, said droplet dispenser is programmed to displace itself in an oscillating motion at an amplitude from about 0.1 mm to about 20 mm during dispensation. In some embodiments, said droplet is dispensed at said discrete location comprising said error margin of no more than 5 mm. In some embodiments, said droplet dispenser is programmed to displace itself in an oscillating motion at an amplitude from about 0.1 mm to about 5 mm during dispensation. In some embodiments, said droplet dispenser is programmed to displace itself in an oscillating motion at an amplitude from about 0.1 mm to about 1 mm during dispensation. In some embodiments, said droplet dispenser is programmed to displace itself in an oscillating motion at a frequency of at least 1 Hertz (Hz) during dispensation. In some embodiments, said droplet dispenser is programmed to displace itself in an oscillating motion at a frequency of from about 1 Hz to about 20 megahertz (MHz) during dispensation. In some embodiments, said droplet dispenser is programmed to displace itself in an oscillating motion at a frequency of from about 1 Hz to about 20 kilohertz (kHz) during dispensation. In some embodiments, said droplet dispenser is programmed to displace itself in an oscillating motion at a frequency of from about 1 Hz to about 500 Hz during dispensation. In some embodiments, said droplet dispenser is programmed to displace itself in an oscillating motion at a frequency of from about 1 Hz to 20 Hz during dispensation. In some embodiments, said dispensing of said droplet occurs less than 20 centimeters (cm) above the surface of said substrate. In some embodiments, said droplet dispenser is in an open configuration. In some embodiments, said droplet comprises at least one biological sample. In some embodiments, said dispensing a droplet to said discrete location or removal of at least a portion of said droplet is a dispensation of said droplet from said liquid handling arm. In some embodiments, said dispensing a droplet to said discrete location or removal of at least a portion of said droplet is an aspiration of said droplet from said liquid handling arm. In some embodiments, said substrate further comprises a top plate and a bottom plate. In some embodiments, said top plate has at least one hole. In some embodiments, said droplet dispenser is robotic. In some embodiments, said droplet dispenser is automated. In some embodiments, said droplet dispenser makes contact with the surface of said substrate. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said substrate further comprises a lubricant and/or a film. In some embodiments, said droplet dispenser does not make contact with said lubricant and/or film. In some embodiments, wherein the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet comprises at least one biological sample, and wherein said droplet dispenser does not make contact with said biological sample. In some embodiments, the method further comprises: providing a sample droplet on an electrowetting substrate; suspending and mixing a bead in said sample droplet; introducing a magnet into said sample droplet, and moving said magnet in one or more axes while said sample droplet is held in place by said electrowetting substrate; and separating said bead from said sample droplet. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system. In some embodiments, said droplet dispenser comprising said droplet shakes with respect to a Z-axis or an X-axis with respect to a plane parallel to a surface of said substrate during said dispensing said droplet to said location. In some embodiments, said droplet dispenser shakes in a “Figure Eight” pattern. In some embodiments, prior to said dispensing or said removal, said droplet dispenser is moved with respect to a Z axis.

Another aspect of the present disclosure provides a method for droplet processing, the method comprising: (a) providing (i) a substrate comprising a discrete location, (ii) one or more electrodes disposed adjacent to said discrete location of said substrate, and (iii) a droplet dispenser disposed over said substrate; and (b) activating or deactivating an electrode of said one or more electrodes, which activating or deactivating is synchronized with dispensing said droplet to said discrete location. In some embodiments, said one or more electrodes is a plurality of electrodes. In some embodiments, said droplet dispenser comprises a droplet handling arm that moves towards or away from said substrate. In some embodiments, said droplet is dispensed at said discrete location at an error margin of no more than 20 millimeters (mm), which error margin is calculated based at least in part on a difference between an intended dispensing location and an actual dispensing location of said droplet. In some embodiments, said droplet is dispensed at said discrete location comprising said error margin of no more than 1 mm. In some embodiments, said droplet is dispensed at said discrete location comprising an error margin of no more than. 1 mm. In some embodiments, said droplet dispenser is programmed to displace itself in an oscillating motion at an amplitude from about 0.1 mm to about 20 mm during dispensation. In some embodiments, said droplet dispenser is programmed to displace itself in an oscillating motion at an amplitude from about 0.1 mm to about 5 mm during dispensation. In some embodiments, said droplet dispenser is programmed to displace itself in an oscillating motion at an amplitude from about 0.1 mm to about 1 mm during dispensation. In some embodiments, said droplet dispenser is programmed to displace itself in an oscillating motion at a frequency of at least 1 Hertz (Hz) during dispensation. In some embodiments, said droplet dispenser is programmed to displace itself in an oscillating motion at a frequency of from about 1 Hz to about 20 megahertz (MHz) during dispensation. In some embodiments, said droplet dispenser is programmed to displace itself in an oscillating motion at a frequency of from about 1 Hz to about 20 kilohertz (kHz) during dispensation. In some embodiments, said droplet dispenser is programmed to displace itself in an oscillating motion at a frequency of from about 1 Hz to about 500 Hz during dispensation. In some embodiments, said droplet dispenser is programmed to displace itself in an oscillating motion at a frequency of from about 1 Hz to 20 Hz during dispensation. In some embodiments, the dispensation of said droplet occurs less than 20 centimeters (cm) above the surface of said substrate. In some embodiments, said droplet dispenser is in an open configuration. In some embodiments, said droplet comprises at least one biological sample. In some embodiments, said substrate further comprises a top plate and a bottom plate. In some embodiments, said top plate has at least one hole. In some embodiments, said droplet dispenser is robotic. In some embodiments, said droplet dispenser is automated. In some embodiments, said droplet dispenser makes contact with the surface of said substrate. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said substrate further comprises a lubricant and/or a film. In some embodiments, said droplet dispenser does not make contact with said lubricant and/or film. In some embodiments, wherein the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet comprises at least one biological sample, and wherein said member does not make contact with said biological sample. In some embodiments, wherein the method further comprises: providing a sample droplet on an electrowetting substrate; suspending and mixing a bead in said sample droplet; introducing a magnet into said sample droplet, and moving said magnet in one or more axes while said sample droplet is held in place by said electrowetting substrate; and separating said bead from said sample droplet. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

Another aspect of the present disclosure provides a method for droplet processing, the method comprising: (a) providing (i) a substrate comprising a discrete location, (ii) one or more electrodes disposed adjacent to said discrete location of said substrate, and (iii) a droplet dispenser disposed over said substrate; and (b) activating or deactivating an electrode of said one or more electrodes, which activating or deactivating is synchronized with removal of said at least said portion of said droplet from said discrete location. In some embodiments, said one or more electrodes is a plurality of electrodes. In some embodiments, said droplet dispenser comprises a droplet handling arm that moves towards or away from said substrate. In some embodiments, said droplet dispenser removes at least a portion of said droplet from said discrete location. In some embodiments, the offload dead volume is calculated as the percentage of the original droplet remaining after aspiration. In some embodiments, the offload dead volume is less than about 99%, less than about 95%, less than about 90%, less than about 80%, less than about 70%, less than about 60%, less than about 50%, less than about 40%, less than about 30%, less than about 20%, less than about 15%, less than about 10%, less than about 5%, less than about 1%, less than about 0.1%, less than about 0.01%, less than about 0.001%, or less. In some embodiments, the offload dead volume is less than 20%. In some embodiments, said droplet dispenser is in an open configuration. In some embodiments, said droplet comprises at least one biological sample, and wherein said member does not make contact with said biological sample. In some embodiments, said droplet has a volume that is from about 1 pL to about 10 milliliters (mL). In some embodiments, said droplet has a volume that is between about 1 μL and about 1000 microliters (μL). In some embodiments, said droplet has a volume that is between about 1 μL and about 1000 microliters (μL). In some embodiments, the said one or more electrodes are activated during said manipulation. In some embodiments, the said one or more electrodes are activated before said manipulation. In some embodiments, the said one or more electrodes are activated after said manipulation. In some embodiments, said one or more electrodes are activated in a time dependent pattern by said controller. In some embodiments, said one or more electrodes are activated in an alternating checkerboard like pattern by said controller. In some embodiments, said one or more electrodes are activated in a square like pattern by said controller. In some embodiments, said substrate further comprises a top plate and a bottom plate. In some embodiments, said top plate has at least one hole. In some embodiments, said droplet dispenser is robotic. In some embodiments, said droplet dispenser is automated. In some embodiments, said droplet dispenser makes contact with the surface of said substrate. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said substrate further comprises a lubricant and/or a film. In some embodiments, said droplet dispenser does not make contact with said lubricant and/or film. In some embodiments, the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet comprises at least one biological sample, and wherein said droplet dispenser does not make contact with said biological sample. In some embodiments, the method further comprises: providing a sample droplet on an electrowetting substrate; suspending and mixing a bead in said sample droplet; introducing a magnet into said sample droplet, and moving said magnet in one or more axes while said sample droplet is held in place by said electrowetting substrate; and separating said bead from said sample droplet. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

Another aspect of the present disclosure provides a method for droplet processing, the method comprising: (a) providing (i) a substrate comprising a discrete location, (ii) one or more electrodes disposed adjacent to said discrete location of said substrate, and (iii) a droplet dispenser disposed over said substrate; and (b) activating or deactivating an electrode of said one or more electrodes, which activating or deactivating is synchronized with dispensing said droplet or removal of said at least said portion of said droplet from said discrete location, wherein an error margin comprising the difference between an intended location for said dispensing said droplet or said removal of said at least said portion of said droplet on said substrate and an actual location for said dispensing said droplet or said removal of said at least said portion of said droplet on said substrate is no more than 20 millimeters (mm). In some embodiments, said one or more electrodes is a plurality of electrodes. In some embodiments, said droplet dispenser comprises a droplet handling arm that moves towards or away from said substrate. In some embodiments, said droplet dispenser is used to dispense said droplet at said location. In some embodiments, said droplet dispenser is used to remove at least a portion of said droplet from said discrete location. In some embodiments, said droplet is dispensed at said discrete location at an error margin of no more than 20 millimeters (mm), which error margin is calculated based at least in part on a difference between an intended dispensing location and an actual dispensing location of said droplet. In some embodiments, said droplet is dispensed at said discrete location comprising said error margin of no more than 1 mm. In some embodiments, said droplet is dispensed at said discrete location comprising an error margin of no more than. 1 mm. In some embodiments, said droplet dispenser is programmed to displace itself in an oscillating motion at an amplitude from about 0.1 mm to about 20 mm during dispensation. In some embodiments, said droplet dispenser is programmed to displace itself in an oscillating motion at an amplitude from about 0.1 mm to about 5 mm during dispensation. In some embodiments, said droplet dispenser is programmed to displace itself in an oscillating motion at an amplitude from about 0.1 mm to about 1 mm during dispensation. In some embodiments, said droplet dispenser is programmed to displace itself in an oscillating motion at a frequency of at least 1 Hertz (Hz) during dispensation. In some embodiments, wherein said droplet dispenser is programmed to displace itself in an oscillating motion at a frequency of from about 1 Hz to about 20 megahertz (MHz) during dispensation. In some embodiments, wherein said droplet dispenser is programmed to displace itself in an oscillating motion at a frequency of from about 1 Hz to about 20 kilohertz (kHz) during dispensation. In some embodiments, wherein said droplet dispenser is programmed to displace itself in an oscillating motion at a frequency of from about 1 Hz to about 500 Hz during dispensation. In some embodiments, said droplet dispenser is programmed to displace itself in an oscillating motion at a frequency of from about 1 Hz to 20 Hz during dispensation. In some embodiments, wherein the dispensation of said droplet occurs less than 20 centimeters (cm) above the surface of said substrate. In some embodiments, wherein said droplet dispenser is in an open configuration. In some embodiments, wherein said droplet comprises at least one biological sample. In some embodiments, said dispensing a droplet to said discrete location or removal of at least a portion of said droplet is a dispensation of said droplet from said liquid handling arm. In some embodiments, said dispensing a droplet to said discrete location or removal of at least a portion of said droplet is an aspiration of said droplet from said liquid handling arm. In some embodiments, said substrate further comprises a top plate and a bottom plate. In some embodiments, said top plate has at least one hole. In some embodiments, said droplet dispenser is robotic. In some embodiments, said droplet dispenser is automated. In some embodiments, said droplet dispenser makes contact with the surface of said substrate. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said substrate further comprises a lubricant and/or a film. In some embodiments, said droplet dispenser does not make contact with said lubricant and/or film. In some embodiments, the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet comprises at least one biological sample, and wherein said droplet dispenser does not make contact with said biological sample. In some embodiments, the method further comprises: providing a sample droplet on an electrowetting substrate; suspending and mixing a bead in said sample droplet; introducing a magnet into said sample droplet, and moving said magnet in one or more axes while said sample droplet is held in place by said electrowetting substrate; and separating said bead from said sample droplet. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

Another aspect of the present disclosure provides a method for droplet processing, the method comprising: (a) providing (i) a substrate comprising a discrete location, (ii) one or more electrodes disposed adjacent to said discrete location of substrate, and (iii) a droplet dispenser disposed over said substrate; and (b) activating or deactivating an electrode of said one or more electrodes, which activating or deactivating is synchronized with dispensing said droplet, wherein an error margin comprising the difference between an intended dispensing location and an actual dispensing location of said droplet on said substrate is no more than 20 millimeters (mm). In some embodiments, said one or more electrodes is a plurality of electrodes. In some embodiments, said droplet dispenser comprises a droplet handling arm that moves towards or away from said substrate. In some embodiments, said droplet dispenser dispenses said droplet In some embodiments, said droplet is dispensed at said discrete location at an error margin of no more than 20 millimeters (mm), which error margin is calculated based at least in part on a difference between an intended dispensing location and an actual dispensing location of said droplet. In some embodiments, said droplet is dispensed at said discrete location comprising said error margin of no more than 1 mm. In some embodiments, said droplet is dispensed at said discrete location comprising an error margin of no more than. 1 mm. In some embodiments, said droplet dispenser is programmed to displace itself in an oscillating motion at an amplitude from about 0.1 mm to about 20 mm during dispensation. In some embodiments, said droplet dispenser is programmed to displace itself in an oscillating motion at an amplitude from about 0.1 mm to about 5 mm during dispensation. In some embodiments, said droplet dispenser is programmed to displace itself in an oscillating motion at an amplitude from about 0.1 mm to about 1 mm during dispensation. In some embodiments, said droplet dispenser is programmed to displace itself in an oscillating motion at a frequency of at least 1 Hertz (Hz) during dispensation. In some embodiments, wherein said droplet dispenser is programmed to displace itself in an oscillating motion at a frequency of from about 1 Hz to about 20 megahertz (MHz) during dispensation. In some embodiments, wherein said droplet dispenser is programmed to displace itself in an oscillating motion at a frequency of from about 1 Hz to about 20 kilohertz (kHz) during dispensation. In some embodiments, wherein said droplet dispenser is programmed to displace itself in an oscillating motion at a frequency of from about 1 Hz to about 500 Hz during dispensation. In some embodiments, said droplet dispenser is programmed to displace itself in an oscillating motion at a frequency of from about 1 Hz to 20 Hz during dispensation. In some embodiments, the dispensation of said droplet occurs less than 20 centimeters (cm) above the surface of said substrate. In some embodiments, said droplet dispenser is in an open configuration. In some embodiments, said droplet comprises at least one biological sample. In some embodiments, said substrate further comprises a top plate and a bottom plate. In some embodiments, said top plate has at least one hole. In some embodiments, said droplet dispenser is robotic. In some embodiments, said droplet dispenser is automated. In some embodiments, said droplet dispenser makes contact with the surface of said substrate. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said substrate further comprises a lubricant and/or a film. In some embodiments, said droplet dispenser does not make contact with said lubricant and/or film. In some embodiments, the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet comprises at least one biological sample, and wherein said droplet dispenser does not make contact with said biological sample. In some embodiments, the method further comprises: providing a sample droplet on an electrowetting substrate; suspending and mixing a bead in said sample droplet; introducing a magnet into said sample droplet, and moving said magnet in one or more axes while said sample droplet is held in place by said electrowetting substrate; and separating said bead from said sample droplet. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

Another aspect of the present disclosure provides a method for droplet processing, the method comprising: (a) providing (i) a substrate comprising a discrete location, (ii) one or more electrodes disposed adjacent to said discrete location of substrate, and (iii) a droplet dispenser disposed over said substrate; and (b) activating or deactivating an electrode of said one or more electrodes, which activating or deactivating is synchronized with removal of said at least said portion of said droplet from said discrete location, wherein an error margin comprising the difference between an intended location for said removal of said at least said portion of said droplet on said substrate and an actual location for said removal of said at least said portion of said droplet on said substrate is no more than 20 millimeters (mm). In some embodiments, said one or more electrodes is a plurality of electrodes. In some embodiments, said droplet dispenser comprises a droplet handling arm that moves towards or away from said substrate. In some embodiments, said droplet dispenser removes at least a portion of said droplet from said discrete location. In some embodiments, the offload dead volume is calculated as the percentage of the original droplet remaining after aspiration. In some embodiments, the offload dead volume is less than about 99%, less than about 95%, less than about 90%, less than about 80%, less than about 70%, less than about 60%, less than about 50%, less than about 40%, less than about 30%, less than about 20%, less than about 15%, less than about 10%, less than about 5%, less than about 1%, less than about 0.1%, less than about 0.01%, less than about 0.001%, or less. In some embodiments, the offload dead volume is less than 20%. In some embodiments, the rate of removal (e.g., aspiration, etc.) of the droplet on to the discrete location is no more than about 2,000 microliters per second (μL/s) to no more than about 0.1 μL/s. In some embodiments, the rate of removal (e.g., aspiration, etc.) of the droplet on to the discrete location is no more than about 2,000 μL/s, no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, or no more than about 50 μL/s, not more than at most no more than about 1,500 μL/s, no more than about 1,000 L/s, no more than about 750 μL/s, no more than about 500 μL/s, no more than about 250 μL/s, no more than about 200 μL/s, no more than about 150 μL/s, no more than about 100 μL/s, no more than about 75 μL/s, no more than about 50 μL/s, or no more than about 25 μL/s, no more than about 15 μL/s, no more than about 10 μL/s, no more than about 5 μL/s, no more than about 1 μL/s, no more than about 0.75 L/s, no more than about 0.5 μL/s, no more than about 0.25 μL/s, no more than about 0.1 μL/s, no more than about 0.05 L/s, or no more than about 0.01 μL/s. In some embodiments, the rate of removal (e.g., dispensation, aspiration, etc.) of the droplet on to the discrete location is no more than about 1000 μL/s. In some embodiments, the rate of removal (e.g., dispensation, aspiration, etc.) of the droplet on to the discrete location is no more than about 100 μL/s. In some embodiments, the rate of removal (e.g., dispensation, aspiration, etc.) of the droplet on to the discrete location is no more than about 0.5 μL/s. In some embodiments, the rate of removal (e.g., dispensation, aspiration, etc.) of the droplet on to the discrete location is no more than about 0.1 μL/s. In some embodiments, the said one or more electrodes are activated during said manipulation. In some embodiments, the said one or more electrodes are activated before said manipulation. In some embodiments, the said one or more electrodes are activated after said manipulation. In some embodiments, said one or more electrodes are activated in a time dependent pattern by said controller. In some embodiments, said one or more electrodes are activated in an alternating checkerboard like pattern by said controller. In some embodiments, said substrate further comprises a top plate and a bottom plate. In some embodiments, said top plate has at least one hole. In some embodiments, said droplet dispenser is robotic. In some embodiments, said droplet dispenser is automated. In some embodiments, said droplet dispenser makes contact with the surface of said substrate. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said substrate further comprises a lubricant and/or a film. In some embodiments, said droplet dispenser does not make contact with said lubricant and/or film. In some embodiments, the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet comprises at least one biological sample, and wherein said droplet dispenser does not make contact with said biological sample. In some embodiments, the method further comprises: providing a sample droplet on an electrowetting substrate; suspending and mixing a bead in said sample droplet; introducing a magnet into said sample droplet, and moving said magnet in one or more axes while said sample droplet is held in place by said electrowetting substrate; and separating said bead from said sample droplet. In some embodiments, said droplet dispenser comprises a pipette. In some embodiments, said droplet dispenser comprises a pipette tip In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

Another aspect of the present disclosure provides a method for droplet operations, the method comprising: providing (i) a substrate comprising a discrete location, (ii) one or more electrodes disposed adjacent to said discrete location of substrate, and (iii) a droplet dispenser disposed over said substrate; contacting said droplet with said discrete location without creating contact between said droplet dispenser and said discrete location. In some embodiments, said one or more electrodes is a plurality of electrodes. In some embodiments, said droplet dispenser comprises a droplet handling arm that moves towards or away from said substrate. In some embodiments, said discrete location is a second droplet on said substrate. In some embodiments, the method further comprises merging said droplet with said second droplet to form a merged droplet. In some embodiments, the method further comprises using vibration to mix said merged droplet. In some embodiments, said droplet or said second droplet comprise a plurality of artifacts. In some embodiments, said plurality of artifacts are responsive to a magnetic field. In some embodiments, a magnetic field adjacent to said substrate is applied to said merged droplet. In some embodiments, said magnetic field is supplied by a magnet. In some embodiments, said magnet is actuated to supply said magnetic field to said merged droplet. In some embodiments, said magnetic field is used to separate said plurality of artifacts from said merged droplet. In some embodiments, upon said contact between said droplet and said second droplet, a surface tension of said droplet and surface tension of said second droplet are disrupted. In some embodiments, said discrete location is a surface of said substrate. In some embodiments, said surface comprises a liquid layer. In some embodiments, said liquid layer comprises a lubricant or film. In some embodiments, upon said contact between said droplet and said surface, a surface tension of said droplet and surface tension on said surface are disrupted. In some embodiments, the method further comprises using gravitational forces to allow said droplet to overcome adhesion to said droplet dispenser. In some embodiments, said droplet comprises at least one biological sample, and wherein said droplet dispenser does not make contact with said biological sample. In some embodiments, the droplet dispenser is in an open configuration. In some embodiments, said substrate further comprises a top plate and a bottom plate. In some embodiments, said top plate has at least one hole. In some embodiments, said droplet dispenser is robotic. In some embodiments, said droplet dispenser is automated. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said droplet dispenser does not make contact with said lubricant and/or film. In some embodiments, the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system. In some embodiments, said droplet dispenser shakes with respect to a Z-axis or an X-axis with respect to a plane parallel to a surface of said substrate during said dispensing said droplet to said location. In some embodiments, said droplet dispenser shakes in a “Figure Eight” pattern. In some embodiments, prior to (b), said contacting said droplet with said discrete location, said droplet dispenser is moved with respect to a Z axis. In some embodiments, in (a), generating said droplet from said droplet dispenser, a first surface tension is formed between said droplet and said droplet dispenser. In some embodiments, said droplet dispenser moves with respect to a Z axis, prior to said droplet contacting said discrete location. In some embodiments, a second surface tension forms between said droplet and said discrete location. In some embodiments, said first surface tension between said droplet and said droplet dispenser is overcome said a second surface tension between said droplet and said discrete location. In some embodiments, F>mg+T, wherein F is said first surface tension of said droplet dispenser on said droplet, m is a mass of said droplet, g is a gravitational acceleration constant, and T is a force of said discrete location exerted on said droplet when in contact with said droplet. In some embodiments, prior to (b), said generating said droplet from said dispenser, said droplet is aspirated from a source. In some embodiments, prior to aspiration of said droplet from said source, a quantity of air is aspirated into said droplet dispenser. In some embodiments, in (b), said generating said droplet from said droplet dispenser, said quantity of air pushes said droplet. In some embodiments, said aspirating creates an air pressure to overcome said first surface tension.

Another aspect of the present disclosure provides a method of droplet operations, the method comprising: providing (i) a substrate comprising a second droplet, (ii) one or more electrodes disposed adjacent to said discrete location of substrate, and (iii) a droplet dispenser disposed over said substrate; generating a first droplet from said droplet dispenser; contacting said first droplet with said second droplet without creating contact between said droplet dispenser and said second droplet. In some embodiments, said one or more electrodes is a plurality of electrodes. In some embodiments, said droplet dispenser comprises a droplet handling arm that moves towards or away from said substrate. In some embodiments, the method further comprises merging said droplet with said second droplet to form a merged droplet. In some embodiments, the method further comprises using vibration to mix said merged droplet. In some embodiments, said droplet or said second droplet comprise a plurality of artifacts. In some embodiments, said plurality of artifacts are responsive to a magnetic field. In some embodiments, a magnetic field adjacent to said substrate is applied to said merged droplet. In some embodiments, said magnetic field is supplied by a magnet. In some embodiments, said magnet is actuated to supply said magnetic field to said merged droplet. In some embodiments, said magnetic field is used to separate said plurality of artifacts from said merged droplet. In some embodiments, upon said contact between said droplet and said second droplet, a surface tension of said droplet and surface tension of said second droplet are disrupted. In some embodiments, the method further comprises using gravitational forces to allow said droplet to overcome adhesion to said liquid handling arm. In some embodiments, said droplet comprises at least one biological sample, and wherein said liquid handling arm does not make contact with said biological sample. In some embodiments, the droplet dispenser is in an open configuration. In some embodiments, said substrate further comprises a top plate and a bottom plate. In some embodiments, said top plate has at least one hole. In some embodiments, said droplet dispenser is robotic. In some embodiments, said droplet dispenser is automated. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said droplet dispenser does not make contact with said lubricant and/or film. In some embodiments, the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

Another aspect of the present disclosure provides a system for droplet processing, comprising: a droplet dispenser configured to be disposed over a substrate comprising a discrete location, and further configured to generate said droplet; and a controller operatively coupled to said droplet dispenser, wherein said controller is programmed to manipulate said droplet dispenser to contact said droplet with said discrete location of said surface of said substrate without creating contact between said droplet dispenser and said discrete region of said surface of said substrate. In some embodiments, wherein said one or more electrodes is a plurality of electrodes. In some embodiments, said droplet dispenser comprises a droplet handling arm that is configured to move towards or away from said substrate. In some embodiments, wherein said discrete location is a second droplet. In some embodiments, the system further comprises merging said droplet with said second droplet to form a merged droplet. In some embodiments, the system further comprises using vibration to mix said merged droplet. In some embodiments, said droplet or said second droplet comprise a plurality of artifacts. In some embodiments, wherein said plurality of artifacts are responsive to a magnetic field. In some embodiments, wherein a magnetic field adjacent to said substrate is applied to said merged droplet. In some embodiments, wherein said magnetic field is supplied by a magnet. In some embodiments, wherein said magnet is actuated to supply said magnetic field to said merged droplet. In some embodiments, wherein said magnetic field is used to separate said plurality of artifacts from said merged droplet. In some embodiments, the system further comprises displacing said droplet to a tip of said droplet dispenser. In some embodiments, the system further comprises maintaining a first surface tension between said tip and said droplet. In some embodiments, said discrete location comprises a surface. In some embodiments, the system further comprises displacing said droplet dispenser in contact to said surface of said discrete location and said droplet. In some embodiments, the system further comprises generating a second surface tension between said droplet and said surface, wherein said first surface tension between said droplet and said tip is overcome by said second surface. In some embodiments, wherein said first surface tension and said second surface tension are calculated using equation: upon said contact between said droplet and said surface, said first surface tension is disrupted. In some embodiments, wherein said droplet dispenser aspirates air prior to said contact of said droplet and said surface. In some embodiments, wherein said aspiration creates an air pressure to overcome said first surface tension.

Another aspect of the present disclosure provides a method for droplet operations, the method comprising: providing (i) a substrate comprising a surface comprising a discrete region, (ii) one or more electrodes disposed adjacent to said discrete location of substrate, and (iii) a droplet dispenser disposed over said substrate; generating a first droplet from said droplet dispenser; contacting said first droplet with said discrete region of said surface of said substrate without creating contact between said droplet dispenser and said discrete region of said surface of said substrate. In some embodiments, said one or more electrodes is a plurality of electrodes. In some embodiments, said droplet dispenser comprises a droplet handling arm that moves towards or away from said substrate. In some embodiments, said surface comprises a liquid layer. In some embodiments, said liquid layer comprises a lubricant. In some embodiments, upon said contact between said droplet and said surface, a surface tension of said droplet and surface tension on said surface are disrupted. In some embodiments, the method further comprises using gravitational forces to allow said droplet to overcome adhesion to said liquid handling arm. In some embodiments, said droplet comprises at least one biological sample, and wherein said liquid handling arm does not make contact with said biological sample. In some embodiments, the droplet dispenser is in an open configuration. In some embodiments, said substrate further comprises a top plate and a bottom plate. In some embodiments, said top plate has at least one hole. In some embodiments, said droplet dispenser is robotic. In some embodiments, said droplet dispenser is automated. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said droplet dispenser does not make contact with said lubricant and/or film. In some embodiments, the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

Another aspect of the present disclosure provides a system for droplet processing, comprising: a droplet dispenser configured to be disposed over a substrate comprising a discrete location; and a controller operatively coupled to said droplet dispenser, wherein said controller is programmed to: use said droplet dispenser to dispense said droplet to said discrete location or to remove at least a portion of said droplet from said discrete location; and during (i), activate or deactivate an electrode of one or more electrodes, wherein said electrode is disposed adjacent to said discrete location, and wherein activation or deactivation of said electrode is synchronized with said droplet being dispensed to said discrete location or at least a portion of said droplet being removed from said discrete location. In some embodiments, said one or more electrodes is a plurality of electrodes. In some embodiments, said droplet dispenser comprises a droplet handling arm that moves towards or away from said substrate. In some embodiments, said droplet dispenser is used to dispense said droplet to said discrete location. In some embodiments, said droplet dispenser is used to remove at least a portion of said droplet from said discrete location. In some embodiments, said droplet is dispensed at said discrete location at an error margin of no more than 20 millimeters (mm), which error margin is calculated based at least in part on a difference between an intended dispensing location and an actual dispensing location of said droplet. In some embodiments, said droplet is dispensed at said discrete location comprising said error margin of no more than 1 mm. In some embodiments, said droplet is dispensed at said discrete location comprising an error margin of no more than. 1 mm. In some embodiments, said droplet dispenser is programmed to displace itself in an oscillating motion at an amplitude from about 0.1 mm to about 20 mm during dispensation. In some embodiments, said droplet dispenser is programmed to displace itself in an oscillating motion at an amplitude from about 0.1 mm to about 5 mm during dispensation. In some embodiments, said droplet dispenser is programmed to displace itself in an oscillating motion at an amplitude from about 0.1 mm to about 1 mm during dispensation. In some embodiments, said droplet dispenser is programmed to displace itself in an oscillating motion at a frequency of at least 1 Hertz (Hz) during dispensation. In some embodiments, wherein said droplet dispenser is programmed to displace itself in an oscillating motion at a frequency of from about 1 Hz to about 20 megahertz (MHz) during dispensation. In some embodiments, wherein said droplet dispenser is programmed to displace itself in an oscillating motion at a frequency of from about 1 Hz to about 20 kilohertz (kHz) during dispensation. In some embodiments, wherein said droplet dispenser is programmed to displace itself in an oscillating motion at a frequency of from about 1 Hz to about 500 Hz during dispensation. In some embodiments, said droplet dispenser is programmed to displace itself in an oscillating motion at a frequency of from about 1 Hz to 20 Hz during dispensation. In some embodiments, wherein said dispensing of said droplet occurs less than 20 centimeters (cm) above the surface of said substrate. In some embodiments, wherein said droplet dispenser is in an open configuration. In some embodiments, wherein said droplet comprises at least one biological sample. In some embodiments, said dispensing a droplet to said discrete location or removal of at least a portion of said droplet is a dispensation of said droplet from said liquid handling arm. In some embodiments, said dispensing a droplet to said discrete location or removal of at least a portion of said droplet is an aspiration of said droplet from said liquid handling arm. In some embodiments, said substrate further comprises a top plate and a bottom plate. In some embodiments, said top plate has at least one hole. In some embodiments, said droplet dispenser is robotic. In some embodiments, said droplet dispenser is automated. In some embodiments, said droplet dispenser makes contact with the surface of said substrate. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said substrate further comprises a lubricant and/or a film. In some embodiments, said droplet dispenser does not make contact with said lubricant and/or film. In some embodiments, the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet comprises at least one biological sample, and wherein said droplet dispenser does not make contact with said biological sample. In some embodiments, the method further comprises: providing a sample droplet on an electrowetting substrate; suspending and mixing a bead in said sample droplet; introducing a magnet into said sample droplet, and moving said magnet in one or more axes while said sample droplet is held in place by said electrowetting substrate; and separating said bead from said sample droplet. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

Another aspect of the present disclosure provides a system for droplet processing, comprising: a droplet dispenser configured to be disposed over a substrate comprising a discrete location; and a controller operatively coupled to said droplet dispenser, wherein said controller is programmed to: use said droplet dispenser to dispense said droplet to said discrete location or to remove at least a portion of said droplet from said discrete location; and during (i), activate or deactivate an electrode of one or more electrodes, wherein said electrode is disposed adjacent to said discrete location, and wherein activation or deactivation of said electrode is synchronized with said droplet being dispensed to said discrete location or at least a portion of said droplet being removed from said discrete location, wherein an error margin comprising the difference between an intended location for said dispensing said droplet or said removal of said at least said portion of said droplet on said substrate and an actual location for said dispensing said droplet or said removal of said at least said portion of said droplet on said substrate is no more than 20 millimeters (mm). In some embodiments, said one or more electrodes is a plurality of electrodes. In some embodiments, said droplet dispenser comprises a droplet handling arm that moves towards or away from said substrate. In some embodiments, said droplet dispenser is used to dispense said droplet to said discrete location. In some embodiments, said droplet dispenser is used to remove at least a portion of said droplet from said discrete location. In some embodiments, said droplet is dispensed at said discrete location comprising said error margin of no more than 1 mm. In some embodiments, said droplet is dispensed at said discrete location comprising an error margin of no more than. 1 mm. In some embodiments, said droplet dispenser is programmed to displace itself in an oscillating motion at an amplitude from about 0.1 mm to about 20 mm during dispensation. In some embodiments, said droplet dispenser is programmed to displace itself in an oscillating motion at an amplitude from about 0.1 mm to about 5 mm during dispensation. In some embodiments, said droplet dispenser is programmed to displace itself in an oscillating motion at an amplitude from about 0.1 mm to about 1 mm during dispensation. In some embodiments, said droplet dispenser is programmed to displace itself in an oscillating motion at a frequency of at least 1 Hertz (Hz) during dispensation. In some embodiments, wherein said droplet dispenser is programmed to displace itself in an oscillating motion at a frequency of from about 1 Hz to about 20 megahertz (MHz) during dispensation. In some embodiments, wherein said droplet dispenser is programmed to displace itself in an oscillating motion at a frequency of from about 1 Hz to about 20 kilohertz (kHz) during dispensation. In some embodiments, wherein said droplet dispenser is programmed to displace itself in an oscillating motion at a frequency of from about 1 Hz to about 500 Hz during dispensation. In some embodiments, said droplet dispenser is programmed to displace itself in an oscillating motion at a frequency of from about 1 Hz to 20 Hz during dispensation. In some embodiments, wherein said dispensing of said droplet occurs less than 20 centimeters (cm) above the surface of said substrate. In some embodiments, wherein said droplet dispenser is in an open configuration. In some embodiments, wherein said droplet comprises at least one biological sample. In some embodiments, said dispensing a droplet to said discrete location or removal of at least a portion of said droplet is a dispensation of said droplet from said liquid handling arm. In some embodiments, said dispensing a droplet to said discrete location or removal of at least a portion of said droplet is an aspiration of said droplet from said liquid handling arm. In some embodiments, said substrate further comprises a top plate and a bottom plate, wherein said top plate comprises one or more inlets configured to receive a droplet from said droplet dispenser. In some embodiments, said top plate has at least one hole. In some embodiments, said droplet dispenser is robotic. In some embodiments, said droplet dispenser is automated. In some embodiments, said droplet dispenser makes contact with the surface of said substrate. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said substrate further comprises a lubricant and/or a film. In some embodiments, said droplet dispenser does not make contact with said lubricant and/or film. In some embodiments, the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet comprises at least one biological sample, and wherein said droplet dispenser does not make contact with said biological sample. In some embodiments, the method further comprises: providing a sample droplet on an electrowetting substrate; suspending and mixing a bead in said sample droplet; introducing a magnet into said sample droplet, and moving said magnet in one or more axes while said sample droplet is held in place by said electrowetting substrate; and separating said bead from said sample droplet. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

Another aspect of the present disclosure provides a system for droplet processing, comprising: a droplet dispenser configured to be disposed over a substrate comprising a discrete location; and a controller operatively coupled to said droplet dispenser, wherein said controller is programmed to manipulate said droplet dispenser to contact said a droplet with said discrete location of said surface of said substrate without creating contact between said droplet dispenser and said discrete region of said surface of said substrate. In some embodiments, said one or more electrodes is a plurality of electrodes. In some embodiments, said droplet dispenser comprises a pipette tip. In some embodiments, said droplet dispenser comprises a droplet handling arm that moves towards or away from said substrate. In some embodiments, the method further comprises merging said droplet with said second droplet to form a merged droplet. In some embodiments, the method further comprises using vibration to mix said merged droplet. In some embodiments, said droplet or said second droplet comprise a plurality of artifacts. In some embodiments, said plurality of artifacts are responsive to a magnetic field. In some embodiments, a magnetic field adjacent to said substrate is applied to said merged droplet. In some embodiments, said magnetic field is supplied by a magnet. In some embodiments, said magnet is actuated to supply said magnetic field to said merged droplet. In some embodiments, said magnetic field is used to separate said plurality of artifacts from said merged droplet. In some embodiments, upon said contact between said droplet and said second droplet, a surface tension of said droplet and surface tension of said second droplet are disrupted. In some embodiments, the method further comprises using gravitational forces to allow said droplet to overcome adhesion to said liquid handling arm. In some embodiments, said droplet comprises at least one biological sample, and wherein said liquid handling arm does not make contact with said biological sample. In some embodiments, the droplet dispenser is in an open configuration. In some embodiments, said substrate further comprises a top plate and a bottom plate, wherein said top plate comprises one or more inlets configured to receive a droplet from said droplet dispenser. In some embodiments, said top plate has at least one hole. In some embodiments, said droplet dispenser is robotic. In some embodiments, said droplet dispenser is automated. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said droplet dispenser does not make contact with said lubricant and/or film. In some embodiments, the method further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

Another aspect of the present disclosure provides a system for droplet processing, comprising: a droplet dispenser configured to be disposed over a substrate comprising a discrete location; and a controller operatively coupled to said droplet dispenser, wherein said controller is programmed to: use said droplet dispenser to dispense said droplet to said discrete location or to remove at least a portion of said droplet from said discrete location; and during (i), activate or deactivate an electrode of one or more electrodes, wherein said electrode is disposed adjacent to said discrete location, and wherein activation or deactivation of said electrode is synchronized with said droplet being dispensed to said discrete location or at least a portion of said droplet being removed from said discrete location. In some embodiments, said one or more electrodes is a plurality of electrodes. In some embodiments, said droplet dispenser comprises a droplet handling arm that moves towards or away from said substrate. In some embodiments, said droplet dispenser is configured to dispense said droplet to said discrete location. In some embodiments, said droplet dispenser is configured to remove at least a portion of said droplet from said discrete location. In some embodiments, said droplet is dispensed at said discrete location at an error margin of no more than 20 millimeters (mm), which error margin is calculated based at least in part on a difference between an intended dispensing location and an actual dispensing location of said droplet. In some embodiments, said droplet is dispensed at said discrete location comprising said error margin of no more than 1 mm. In some embodiments, said droplet is dispensed at said discrete location comprising an error margin of no more than. 1 mm. In some embodiments, said droplet dispenser is programmed to displace itself in an oscillating motion at an amplitude from about 0.1 mm to about 20 mm during dispensation. In some embodiments, said droplet dispenser is programmed to displace itself in an oscillating motion at an amplitude from about 0.1 mm to about 5 mm during dispensation. In some embodiments, said droplet dispenser is programmed to displace itself in an oscillating motion at an amplitude from about 0.1 mm to about 1 mm during dispensation. In some embodiments, said droplet dispenser is programmed to displace itself in an oscillating motion at a frequency of at least 1 Hertz (Hz) during dispensation. In some embodiments, said droplet dispenser is programmed to displace itself in an oscillating motion at a frequency of from about 1 Hz to about 20 megahertz (MHz) during dispensation. In some embodiments, said droplet dispenser is programmed to displace itself in an oscillating motion at a frequency of from about 1 Hz to about 20 kilohertz (kHz) during dispensation. In some embodiments, said droplet dispenser is programmed to displace itself in an oscillating motion at a frequency of from about 1 Hz to about 500 Hz during dispensation. In some embodiments, said droplet dispenser is programmed to displace itself in an oscillating motion at a frequency of from about 1 Hz to 20 Hz during dispensation. In some embodiments, said dispensing of said droplet occurs less than 20 centimeters (cm) above the surface of said substrate. In some embodiments, said droplet dispenser is in an open configuration. In some embodiments, said droplet comprises at least one biological sample. In some embodiments, said manipulation is a dispensation of said droplet from said liquid handling arm. In some embodiments, said manipulation is an aspiration of said droplet from said liquid handling arm. In some embodiments, said substrate further comprises a top plate and a bottom plate, wherein said top plate comprises one or more inlets configured to receive a droplet from said droplet dispenser. In some embodiments, said top plate has at least one hole. In some embodiments, said droplet dispenser is robotic. In some embodiments, said droplet dispenser is automated. In some embodiments, said droplet dispenser makes contact with the surface of said substrate. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, said substrate further comprises a lubricant and/or a film. In some embodiments, said droplet dispenser does not make contact with said lubricant and/or film. In some embodiments, the system further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet comprises at least one biological sample, and wherein said droplet dispenser does not make contact with said biological sample. In some embodiments, the system further comprises: providing a sample droplet on an electrowetting substrate; suspending and mixing a bead in said sample droplet; introducing a magnet into said sample droplet, and moving said magnet in one or more axes while said sample droplet is held in place by said electrowetting substrate; and separating said bead from said sample droplet. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

Another aspect of the present disclosure provides a system for droplet processing, comprising: a droplet dispenser configured to be disposed over a substrate comprising a discrete location, and further configured to generate said droplet; and a controller operatively coupled to said droplet dispenser, wherein said controller is programmed to manipulate said droplet dispenser to contact said droplet with said discrete location of said surface of said substrate without creating contact between said droplet dispenser and said discrete region of said surface of said substrate. In some embodiments, said one or more electrodes is a plurality of electrodes. In some embodiments, said droplet dispenser comprises a droplet handling arm that moves towards or away from said substrate. In some embodiments, said discrete location is a second droplet. In some embodiments, the system further comprises merging said droplet with said second droplet to form a merged droplet. In some embodiments, the system further comprises using vibration to mix said merged droplet. In some embodiments, said droplet or said second droplet comprise a plurality of artifacts. In some embodiments, said plurality of artifacts are responsive to a magnetic field. In some embodiments, a magnetic field adjacent to said substrate is applied to said merged droplet. In some embodiments, said magnetic field is supplied by a magnet. In some embodiments, said magnet is actuated to supply said magnetic field to said merged droplet. In some embodiments, said magnetic field is used to separate said plurality of artifacts from said merged droplet. In some embodiments, said droplet comprises at least one biological sample, and wherein said liquid handling arm does not make contact with said biological sample. In some embodiments, said substrate is in an open configuration. In some embodiments, said substrate further comprises a top plate and a bottom plate, wherein said top plate comprises one or more inlets configured to receive a droplet from said droplet dispenser. In some embodiments, said top plate has at least one hole. In some embodiments, said droplet dispenser is robotic. In some embodiments, said droplet dispenser is automated. In some embodiments, said droplet dispenser does not make contact with the surface of said substrate. In some embodiments, said droplet dispenser is configured to motion with respect to at least three axes. In some embodiments, said droplet dispenser is configured to motion with respect to at least four axes. In some embodiments, said droplet dispenser dispenses in non-continuous volumes. In some embodiments, said droplet dispenser dispenses in continuous volumes. In some embodiments, the system further comprises providing a reagent reservoir adjacent to said substrate, wherein said reagent reservoir comprises one or more reagents configured to be received by said droplet dispenser. In some embodiments, said reagent reservoir and/or said droplet dispenser are integrated into a single unit. In some embodiments, said reservoir and/or said droplet dispenser are configured to regulate temperature. In some embodiments, said reservoir or said droplet dispenser are configured to stir fluids. In some embodiments, said reservoir or said droplet dispenser are configured to agitate fluids. In some embodiments, said droplet dispenser comprises a pipette. In some embodiments, said droplet dispenser comprises a pipette tip. In some embodiments, said droplet dispenser comprises a plurality of pipettes. In some embodiments, said droplet dispenser is connected with a tool changer. In some embodiments, said droplet dispenser is operatively connected to a motion gantry system. In some embodiments, said motion gantry system is a linear gantry. In some embodiments, said motion gantry system is a multi-axis dispensing system.

In some aspects, the present disclosure provides a method for controlling motion of liquid droplets, the method comprising: (a) providing an array, wherein said array comprises a surface configured to support a droplet, wherein the volume of the droplet is about 1 picoliter (pl) to about 1 milliliter (mL); (b) providing a tray adjacent to said array, wherein said tray contains at least one reservoir, and wherein at least said one reservoir comprises at least one reagent; (c) providing a member that is configured to motion with respect to at least two axes from a position adjacent to said array, a position adjacent to said reservoir, or both; (d) providing one or more cartridges comprising a volume of about 1 nanoliter (nL) to about 100 mL; (e) contacting a cartridge of said one or more cartridges with said member and contacting said cartridge with said at least one reagent; and (f) displacing said cartridge adjacent to said array and disposing said reagent onto said array. In some embodiments, (e) occurs before (a), (b), (c), or (d). In some embodiments, said array is in an open configuration. In some embodiments, said array further comprises a top plate and a bottom plate, wherein said top plate comprises one or more inlets configured to receive a droplet from said droplet dispenser. In some embodiments, said top plate has at least one hole. In some embodiments, said member is robotic. In some embodiments, said member is automated. In some embodiments, said member makes contact with the surface of said array. In some embodiments, said member does not make contact with the surface of said array. In some embodiments, said member is configured to motion with respect to at least three axes. In some embodiments, said member is configured to motion with respect to at least four axes. In some embodiments, said member dispenses in non-continuous volumes. In some embodiments, said member dispenses in continuous volumes. In some embodiments, said array further comprises a lubricant and/or a film. In some embodiments, said member does not make contact with said lubricant and/or film. In some embodiments, said reservoir and said member are integrated into a single unit. In some embodiments, said reservoir and said member are configured to regulate temperature. In some embodiments, said reservoir or said member are configured to stir fluids. In some embodiments, said reservoir or said member are configured to agitate fluids. In some embodiments, said droplet comprises at least one biological sample, and wherein said member does not make contact with said biological sample. In some embodiments, the method further comprises providing a metal pin with a hydrophobic coating. In some embodiments, said metal pin is a Precision Pin. In some embodiments, said Precision Pin can hold about 1 microliter (μL) to about 10 μL of said volume of fluid. In some embodiments, the method further comprises providing at least one pressure valve. In some embodiments, the method further comprises providing at least one vacuum valve. In some embodiments, the method further comprises: providing a sample droplet on an electrowetting array; suspending and mixing a bead in said sample droplet; introducing a magnet into said sample droplet, and moving said magnet in one or more axes while said sample droplet is held in place by said electrowetting array; and separating said bead from said sample droplet.

In some aspects, the present disclosure provides a method for controlling motion of liquid droplets, the method comprising: (a) providing an array, wherein said array comprises a surface configured to support a droplet, wherein the volume of the droplet is about 1 picoliter (pL) to about 1 milliliter (mL); (b) providing a tray adjacent to said array, wherein said tray contains at least one reservoir, and wherein at least said one reservoir comprises at least one reagent; (c) providing a member that is configured to motion with respect to at least two planes from a position adjacent to said array, a position adjacent to said reservoir, or both; (d) contacting said member with said at least one reagent; and (e) dispensing said at least one reagent onto said array in non-continuous volumes. In some embodiments, (e) occurs before (a), (b), (c), or (d). In some embodiments, said array is in an open configuration. In some embodiments, said array further comprises a top plate and a bottom plate, wherein said top plate comprises one or more inlets configured to receive a droplet from said droplet dispenser. In some embodiments, said top plate has at least one hole. In some embodiments, said member is robotic. In some embodiments, said member is automated. In some embodiments, said member makes contact with the surface of said array. In some embodiments, said member does not make contact with the surface of said array. In some embodiments, said member is configured to motion with respect to at least three axes. In some embodiments, said member is configured to motion with respect to at least four axes. In some embodiments, said array further comprises a lubricant and/or a film. In some embodiments, said member does not make contact with said lubricant and/or film. In some embodiments, said reservoir and said member are integrated into a single unit. In some embodiments, said reservoir and said member are configured to regulate temperature. In some embodiments, said reservoir or said member are configured to stir fluids. In some embodiments, said reservoir or said member are configured to agitate fluids. In some embodiments, said droplet comprises at least one biological sample, and wherein said member does not make contact with said biological sample. In some embodiments, the method further comprises providing a metal pin with a hydrophobic coating. In some embodiments, said metal pin is a Precision Pin. In some embodiments, said Precision Pin can hold about 1 μL to about 10 μL of said volume of fluid. In some embodiments, the method further comprises providing at least one pressure valve. In some embodiments, the method further comprises providing a vacuum valve. In some embodiments, the method further comprises: providing a sample droplet on an electrowetting array; suspending and mixing a bead in said sample droplet; introducing a magnet into said sample droplet, and moving said magnet in one or more axes while said sample droplet is held in place by said electrowetting array; and separating said bead from said sample droplet.

In some aspects, the present disclosure provides a method for controlling motion of liquid droplets, the method comprising: (a) providing an array, wherein said array comprises a surface configured to support a droplet, wherein the volume of the droplet is about 1 picoliter (pL) to about 1 milliliter (mL); (b) providing a tray adjacent to said array, wherein said tray contains at least one reservoir, and wherein at least said one reservoir comprises at least one reagent; (c) providing a member that is configured to motion with respect to at least two planes from a position adjacent to said array, a position adjacent to said reservoir, or both; (d) contacting said member with said at least one reagent; and (e) dispensing said at least one reagent such that member does not make contact with the surface of the electrowetting array. In some aspects, the present disclosure provides a method for controlling motion of liquid droplets, the method comprising: (a) providing an array, wherein said array comprises a surface configured to support a droplet, wherein the droplet comprises a biological sample; (b) providing a tray adjacent to said array, wherein said tray contains at least one reservoir, and wherein at least said one reservoir comprises at least one reagent; (c) providing a member that is configured to motion with respect to at least two planes from a position adjacent to said array, a position adjacent to said reservoir, or both; (d) contacting said member with said at least one reagent; and (e) dispensing said at least one reagent such that member does not make contact with said biological sample. In some embodiments, (e) occurs before (a), (b), (c), or (d). In some embodiments, said array is in an open configuration. In some embodiments, said array further comprises a top plate and a bottom plate, wherein said top plate comprises one or more inlets configured to receive a droplet from said droplet dispenser. In some embodiments, said top plate has at least one hole. In some embodiments, said member is robotic. In some embodiments, said member is automated. In some embodiments, said member is configured to motion with respect to at least three axes. In some embodiments, said member is configured to motion with respect to at least four axes. In some embodiments, said member dispenses in non-continuous volumes. In some embodiments, said member dispenses in continuous volumes. In some embodiments, said array further comprises a lubricant and/or a film. In some embodiments, said reservoir and said member are integrated into a single unit. In some embodiments, said reservoir and said member are configured to regulate temperature. In some embodiments, said reservoir or said member are configured to stir fluids. In some embodiments, said reservoir or said member are configured to agitate fluids. In some embodiments, the method further comprises providing a metal pin with a hydrophobic coating. In some embodiments, said metal pin is a Precision Pin. In some embodiments, said Precision Pin can hold about 1 μL to about 10 μL of said volume of fluid. In some embodiments, the method further comprises providing at least one pressure valve. In some embodiments, the method further comprises providing at least one vacuum valve. In some embodiments, the method further comprises: providing a sample droplet on an electrowetting array; suspending and mixing a bead in said sample droplet; introducing a magnet into said sample droplet, and moving said magnet in one or more axes while said sample droplet is held in place by said electrowetting array; and separating said bead from said sample droplet.

In some aspects, the present disclosure provides a method for controlling motion of liquid droplets, the method comprising: (a) providing an array, wherein said array comprises a surface configured to support a droplet, wherein the droplet comprises a biological sample; (b) providing a tray adjacent to said array, wherein said tray contains at least one reservoir, and wherein at least said one reservoir comprises at least one reagent; (c) providing a motion system configured to position a member with respect to at least two axes; (d) providing a pneumatic engine configured to provide a pressure or a vacuum; (e) manipulating said motion system to position said member in contact with said at least one reagent; (f) drawing at least a volume of said at least one reagent by said pneumatic engine; and (g) dispensing said at least a volume of said at least one reagent by said pneumatic engine onto said array. In some embodiments, said array is in an open configuration. In some embodiments, said array further comprises a top plate and a bottom plate, wherein said top plate comprises one or more inlets configured to receive a droplet from said droplet dispenser. In some embodiments, said top plate has at least one hole. In some embodiments, said member is robotic. In some embodiments, said member is automated. In some embodiments, said member makes contact with the surface of said array. In some embodiments, said member does not make contact with the surface of said array. In some embodiments, said member is configured to motion with respect to at least three axes. In some embodiments, said member is configured to motion with respect to at least four axes. In some embodiments, said member dispenses in non-continuous volumes. In some embodiments, said member dispenses in continuous volumes. In some embodiments, said array further comprises a lubricant and/or a film. In some embodiments, said member does not make contact with said lubricant and/or film. In some embodiments, said reservoir and said member are integrated into a single unit. In some embodiments, said reservoir and said member are configured to regulate temperature. In some embodiments, said reservoir or said member are configured to stir fluids. In some embodiments, said reservoir or said member are configured to agitate fluids. In some embodiments, said droplet comprises at least one biological sample, and wherein said member does not make contact with said biological sample. In some embodiments, the method further comprises: providing a sample droplet on an electrowetting array; suspending and mixing a bead in said sample droplet; introducing a magnet into said sample droplet, and moving said magnet in one or more axes while said sample droplet is held in place by said electrowetting array; and separating said bead from said sample droplet.

In some aspects, the present disclosure provides a method for controlling motion of liquid droplets, the method comprising: (a) providing an array, wherein said array comprises a surface configured to support a droplet, wherein the volume of said droplet is about 1 picoliter (pL) to about 1 milliliter (mL); (b) providing a member that is configured to dispense a plurality of droplets comprising at least one reagent at a continuous flow; and (c) using said member to dispense said plurality of droplets at said continuous flow. In some embodiments, the method further comprises providing a tray adjacent to said array, wherein said tray contains at least one reservoir, and wherein at least said one reservoir comprises at least one reagent. In some embodiments, (e) occurs before (a), (b), (c), or (d). In some embodiments, said array is in an open configuration. In some embodiments, said array further comprises a top plate and a bottom plate, wherein said top plate comprises one or more inlets configured to receive a droplet from said droplet dispenser. In some embodiments, said top plate has at least one hole. In some embodiments, said member is robotic. In some embodiments, said member is automated. In some embodiments, said member makes contact with the surface of said array. In some embodiments, said member does not make contact with the surface of said array. In some embodiments, said member is configured to motion with respect to at least three axes. In some embodiments, said member is configured to motion with respect to at least four axes. In some embodiments, said member dispenses in non-continuous volumes. In some embodiments, said member dispenses in continuous volumes. In some embodiments, said array further comprises a lubricant and/or a film. In some embodiments, said member does not make contact with said lubricant and/or film. In some embodiments, said reservoir and said member are integrated into a single unit. In some embodiments, said reservoir and said member are configured to regulate temperature. In some embodiments, said reservoir or said member are configured to stir fluids. In some embodiments, said reservoir or said member are configured to agitate fluids. In some embodiments, said droplet comprises at least one biological sample, and wherein said member does not make contact with said biological sample. In some embodiments, the method further comprises providing a metal pin with a hydrophobic coating. In some embodiments, said metal pin is a Precision Pin. In some embodiments, said Precision Pin can hold about 1 μL to about 10 μL of said volume of fluid. In some embodiments, the method further comprises providing at least one pressure valve. In some embodiments, the method further comprises providing at least one vacuum valve.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Another aspect of the present disclosure provides a system further comprising a computer processor configured to process a signal detected by said one or more sensors and a threshold value or value range, wherein said threshold value or value range is specific to said signal. In some embodiments, the system further comprises a feedback loop, wherein said feedback loop comprises communication between said array, said one or more liquid handling units, said one or more sensors, said computer processor, or any combination thereof. In some embodiments, said feedback loop is configured to discover, optimize, or both, reaction conditions on said array autonomously.

Another aspect of the present disclosure comprises a system for droplet processing, comprising: a droplet dispenser configured to be disposed over a substrate comprising a discrete location, and further configured to generate said droplet; and a controller operatively coupled to said droplet dispenser, wherein said controller is programmed to manipulate said droplet dispenser to contact said droplet with said discrete location of said surface of said substrate without creating contact between said droplet dispenser and said discrete region of said surface of said substrate. In some embodiments, said one or more electrodes is a plurality of electrodes. In some embodiments, said droplet dispenser comprises a droplet handling arm that is configured to move towards or away from said substrate. In some embodiments, said discrete location is a second droplet. In some embodiments, the system further comprises merging said droplet with said second droplet to form a merged droplet. In some embodiments, the system further comprises using vibration to mix said merged droplet. In some embodiments, said droplet or said second droplet comprise a plurality of artifacts. In some embodiments, said plurality of artifacts are responsive to a magnetic field. In some embodiments, a magnetic field adjacent to said substrate is applied to said merged droplet. In some embodiments, said magnetic field is supplied by a magnet. In some embodiments, said magnet is actuated to supply said magnetic field to said merged droplet. In some embodiments, said magnetic field is used to separate said plurality of artifacts from said merged droplet. In some embodiments, the system further comprises displacing said droplet to a tip of said droplet dispenser. In some embodiments, the system further comprises maintaining a first surface tension between said tip and said droplet. In some embodiments, said discrete location comprises a surface. In some embodiments, the system further comprises displacing said droplet dispenser in contact to said surface of said discrete location and said droplet. In some embodiments, the system further comprises generating a second surface tension between said droplet and said surface, wherein said first surface tension between said droplet and said tip is overcome by said second surface. In some embodiments, said first surface tension and said second surface tension are calculated using equation: upon said contact between said droplet and said surface, said first surface tension is disrupted. In some embodiments, said droplet dispenser aspirates air prior to said contact of said droplet and said surface. In some embodiments, said aspiration creates an air pressure to overcome said first surface tension.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIGS. 1A-1B show a planar view of droplets on an electrowetting surface. FIG. 1A represents the top view of the plan view of droplets on an electrowetting surface. FIG. 1B represents a side sectional view of the plan view of droplets on an electrowetting surface.

FIG. 2 illustrates an array for manipulating liquids that may use electrowetting, dielectrowetting or dielectrophoresis for dispensing liquid and droplet creation. The array (100) may have regions that perform electrowetting on dielectric (EWOD, 1410), dielectrowetting (DEW, 1420), dielectrophoresis (DEP, 1430), or a combination thereof.

FIG. 3 depicts an example of a dispense pin, such as a precision pin, for the transfer and dispense of a reagent. A reagent is drawn up through the dispense pin and dispensed on an electrowetting array at a distance from the surface of the array. The dispense pin may then be cleaned in a cleaning solution.

FIG. 4 depicts an example of single-shot dispensing. Pipette tips prefilled with a reagent may be picked up by a motion system using an interface adapter that connects the pipette tip to a pressure source. The motion system may move the pipette tips and interface adapter to a target location, where pressure may be applied and the contents of the pipette tip may be emptied.

FIG. 5 depicts an example of a microfluidic chip (MDC) in a dispenser system. MDCs may be fluidically connected to the reagent reservoir, and may draw and dispense precise volumes through the actuation of valves and small reservoirs triggered by a succession of pressure and vacuum pulses provided by a pneumatic engine.

FIGS. 6A-6B depict an example of a pipette tip in contact with a tool-changer. Pipette tips may be placed over a reservoir to draw up reagent via action of a syringe pump as shown in FIG. 6A, after which the dispenser is moved above the appropriate dispense location on the electrode array, and the droplet is dispensed as shown in FIG. 6B.

FIGS. 7A-7B depict an example of a pipette tip in contact with a tool-changer. FIG. 7A shows multiple sized pipette tips can be used with a single carousel by using pipette adapters sized appropriately for various different tip sizes. FIG. 7B shows the reagent can be dispensed over multiple sites by rotating the tool-changer arm or by adding an additional axis of motion to the mechanism.

FIGS. 8A-8C depict examples of a motion gantry system. FIG. 8A shows a linear gantry is designed such that it can dispense within one axis over multiple locations on the electrode array; FIG. 8B shows multi-axis dispensing may be enabled by a gantry with a linear degree of freedom and a rotary degree of freedom; FIG. 8C shows dispensing using two linear degrees of freedom allows dispensation at any location on the electrode array.

FIG. 9 depicts an example of sharing at least one centralized dispenser. Reaction droplets are large droplets at the top position in each electrode array. Newly dispensed reagent droplets are smaller droplets at the bottom position in each electrode array. A centralized dispenser can dispense reagents into each sample region consecutively, holding all newly dispensed reagent droplets adjacent to reaction droplets (panels 1-4). After all new reagent droplets have been dispensed, reagent droplets can be manipulated to move towards the reaction droplet (panel 5) until they combine (panel 6).

FIG. 10 depicts represents a cartoon of computer systems used for arrays described herein.

FIG. 11 depicts an example of a next-generation sequencing library preparation platform.

FIGS. 12A-12B depict a configuration for the synthesis and assembly of biopolymers (e.g., DNA) using systems and methods described herein. FIG. 12A and FIG. 12B show example workflows to afford the synthesis of DNA.

FIG. 13 shows a schematic diagram for a single reaction site that performs step by step addition of nucleotides to synthesize a long molecule of DNA.

FIG. 14 depicts data for the distribution of the size of DNA isolated using systems and methods described herein.

FIG. 15 shows the library size distribution for on-chip vs. off-chip experiments of a NGS library preparation using systems and methods described herein.

FIG. 16 depicts the quality for sequencing libraries for on-chip vs. off-chip experiments of a NGS library preparation using systems and methods described herein.

FIG. 17 depicts the level of duplicates for sequencing libraries for on-chip vs. off-chip experiments of a NGS library preparation using systems and methods described herein.

FIGS. 18A-18B depict levels of adapter contamination for experiments of a NGS library preparation. Initial shallow sequencing (2×75) indicated <1% adapter contamination as shown in FIG. 18A, while up to 15% and 10% adapters for on-chip and off-chip libraries, respectively, were detected when increasing sequencing depth and read length to 2×150 as shown in FIG. 18B.

FIG. 19 depicts the level coverage across the human genome for experiments of a NGS library preparation using systems and methods described herein.

FIG. 20 depicts the single nucleotide polymorphism (SNP) sensitivity for experiments of a NGS library preparation using systems and methods described herein.

FIGS. 21A-21B show the distribution of read lengths on a MinION sequencing system using gDNA extracted using two different experimental runs.

FIG. 22 shows the improved gDNA extraction results using the methods and devices of the present disclosure compared to manual sample and/or reagent handling.

FIG. 23 shows the improved sequencing results on a MinION sequencing system using gDNA extracted using the methods and devices of the present disclosure compared to manual sample and/or reagent handling.

FIG. 24 shows improved sequencing data generated on a MinION sequencing system using gDNA extracted using the methods and devices of the present disclosure.

FIG. 25 shows improved sequencing data generated on a MinION sequencing system using gDNA extracted using the methods and devices of the present disclosure.

FIG. 26 depicts an example schematic NGS workflow using systems and methods described herein. The example workflow comprises manipulating (e.g., lysing cells, digesting protein, and DNA clean-up) biological samples on an array described herein.

FIGS. 27A-27B show embodiments of the systems and devices described herein comprising a movable magnet to induce motion in magnetically responsive materials contained in droplets on the arrays/substrates described herein. FIG. 27A illustrates the effect of a movable magnet (not depicted) manipulating a droplet comprising a magnetically responsive material. FIG. 27B shows the motion of the magnet manipulating the magnetically responsive material to be removed from the droplet.

FIG. 28 shows the results of high molecular weight (HMW) DNA extraction from GM12878 cells using the methods and devices of the present disclosure.

FIGS. 29A-C show the results of high molecular weight (HMW) DNA extraction from whole human blood samples using the methods and devices of the present disclosure. FIGS. 29A-C show multiple lanes of extraction were run simultaneously resulting in rapid high yield isolation of gDNA.

FIGS. 30A-B show the improved gDNA extraction results using the methods and devices of the present disclosure compared to manual sample and/or reagent handling. The results in FIGS. 30A-B demonstrate that the extraction performed on the platform had similar or greater average gDNA fragment lengths.

FIGS. 31A-B show the distribution of the library fragment size for one GM12878 as shown in FIG. 31A, and one whole blood sample extracted using the methods and devices of the present disclosure as shown in FIG. 31B.

FIGS. 32A-E shows the sequencing results on a Pacific Biosciences of California HiFi sequencing system using gDNA extracted using the methods and devices of the present disclosure; including read length (FIG. 32A), subread length (FIG. 32B), read quality distribution (FIG. 32C), HiFi read length distribution (FIG. 32D), and a model of predicted accuracy v. read length (FIG. 32E).

FIG. 33 depicts a droplet with low surface tension drop (above) and higher surface tension drop (below) optimally agitated at 5 Hz and 47 Hz, respectively.

FIG. 34 depicts vigorous agitation accomplished for 150 μL (302), 100 μL (304), and 50 μL (306) droplets with a checkerboard electrode activation pattern.

FIG. 35 depicts positioning uncertainty for systems as described herein. The exemplary system comprises antagonistically driven electrodes with no reference voltage or grounding of the droplet. The equilibrium position will try to optimize as much projected area on activated electrodes as on deactivated electrodes.

FIGS. 36A-C depict exemplary electrode activation for improving the localization of a droplet. In this FIG. 36A, a 2×2 configuration with alternating activation of the diagonal elements;

FIG. 36B, a cross shape with alternating activation of vertical and horizontal elements; and FIG. 36C, a diagonal cross with alternating activation of the diagonal elements are depicted.

FIG. 37 depicts a circuit map of a system without a dedicated reference electrode as described herein.

FIG. 38 depicts an exemplary mechanism of droplet dispersion that creates an uncertainty for a landing location of a droplet onto a substrate. V₀ represents the horizontal velocity of droplet when it detaches from the tip of the droplet dispenser, H₀ represents the height of the dispenser above the substrate at the time of droplet dispensation, and H(t) represents the parabolic trajectory of the droplet after leaving the dispenser towards the substrate, or the height of the droplet above the substrate as a function of time. The difference between an expected landing location and an actual landing location (ΔX) is proportional to the droplet's horizontal velocity (V₀) multiplied by the square root of two times the height of the dispenser multiplied by the gravitational acceleration constant (g). In an equation: ΔX˜V₀*sqrt(2gH₀). The range of values and directions that V₀ can take may create the uncertainty with respect to a landing location. A narrower range of values and directions that V₀ can take may create less uncertainty with respect to a landing location.

FIGS. 39A and 39B depict exemplary mechanisms by which distribution of droplets by pseudo-contact may be accomplished. P₀ represents a pressure outside of a pipette tip and P₁ represents a pressure within the pipette tip which may make it more difficult the droplet from being distributed through other forces, e.g., gravity when combined with surface tension of the droplet to the pipette. P1 may be greater than P₀. P1 may be equal to P₀. R is the height of the droplet. In the exemplary mechanism of FIG. 39A, pseudo-contact is achieved through droplet-to-droplet contact, which can occur at a maximum height. The maximum height may be calculated as a sum of a height of the droplet (R) and the height of a second droplet (H). The second droplet may be provided, e.g., on the surface of a substrate. In the exemplary mechanism of FIG. 39B, pseudo-contact is achieved through contact of the droplet with the surface of the substrate, which can occur at a maximum height of the height of the first droplet (R).

FIGS. 40A and 40B depict exemplary_mechanical difficulties associated with implementation of pseudo-contact dispensation using a pipette gantry which may be on a plane that is misaligned to a plane of a substrate. The substrate may comprise one or more tiles. FIG. 40A demonstrates an exemplary outcome wherein a system fails to correct for the misalignment of the substrate to the pipette gantry. In this example, when a system properly calculates a pseudo-contact height for a tile to which a droplet is to be dispensed, the resulting dispensation may be inconsistent in the individual lanes. In this example the tile has four lanes on it. In some lanes of the substrate may fail to make pseudo-contact, while in other lanes, the pipette tip may make actual contact with the substrate. FIG. 40B represents results after a proper transformation is applied to the position and height of the tiles with respect to the pipette gantry. With proper transformation pseudo-contact heights may be consistent across entire tiles, thereby leading to proper droplet distribution in every lane.

FIG. 41 represents an exemplary vibrational pattern of a droplet dispenser with respect to the X and Z axes. In this example, a combination of horizontal and vertical motion is used to detach a droplet from the droplet dispenser. This “FIG. 8” helps improve the consistency of the actual position of droplet dispensation, because it creates a consistent condition in which the force to detach the droplet from the droplet dispenser is maximal. This vibrational pattern also helps to reduce the necessary amplitude needed to detach the droplet.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Electrowetting Devices and Systems

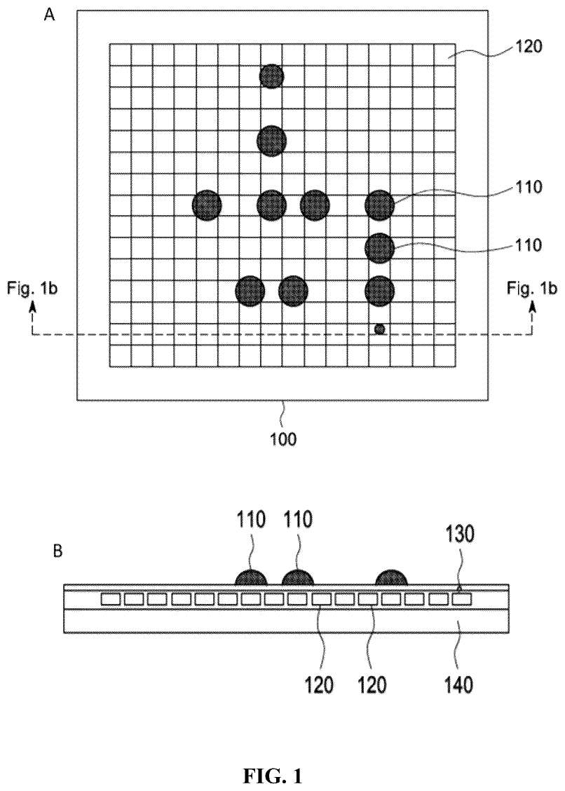

The present disclosure provides electrowetting devices and systems for processing one or more droplets. Referring to FIGS. 1A and 1B), an electrowetting device may be used to move individual droplets of water (or other aqueous, polar, or conducting solution) from place to place. The surface tension and wetting properties of water may be altered by electric field strength using the electrowetting effect. The electrowetting effect may arise from the change in solid-liquid contact angle due to an applied potential difference between the solid and the liquid. Differences in wetting surface tension that may vary over the width of the droplet, and corresponding change in contact angle, may provide motive force to cause the droplets to move, without moving parts or physical contact. The electrowetting device (100) may include a grid of electrodes (120) with a dielectric layer (130) with appropriate electrical and surface priorities overlaying electrodes (120), all laid on a rigid insulating substrate (140). The substrate may be in an open configuration, wherein the substrate does not comprise an overlying substrate. A droplet may be dispensed onto or removed from a substrate in an open configuration, where the substrate does not comprise an overlying substrate.

The surface of the electrode grid may be prepared so that it has low adhesion with water. This may allow water droplets (110) to be moved along the surface by small forces generated by gradients in electric field and surface tension across the width of the droplet. A surface with low adhesion may reduce the trail left behind from a droplet. A smaller trail may reduce droplet cross contamination, and may reduce sample loss during droplet movement. Low adhesion to surface may also allow for low actuation voltage for droplet motion and repeatable behavior of droplet motion. There are several ways to measure low adhesion between a surface and a droplet including slide angle and contact angle hysteresis, such as, for example, using a contact angle goniometer or a charge-coupled device (CCD) camera.

There may be several ways to achieve low surface adhesion; for example, mechanically polishing, chemically etching, or a combination thereof until smooth within a few nanometers, applying coating to fill surface irregularities, applying liquids to fill surface irregularities, chemically modifying the surface to create desirable surface properties (hydrophobic, hydrophilic, resistance to biofouling, varying with electric field strength, etc.).

Droplets may be manipulated on an open surface, without sandwiching them between the electrode array and a cover plate (either a neutral glass, or an upper electrode array, or simply just a large ground electrode). A cover plate above the droplet may be used that does not physically make contact with the droplet.

Electrode arrays and electrowetting on an open surface and arbitrarily large area may allow for actuation of droplets of volumes between 1 nanoliter from 1 milliliter (6 orders of magnitude apart). This implementation shows multi-scale fluid manipulation digitally on a single device.

Two-dimensional arrays (grids) of electrodes of arbitrarily-large size may be prepared for electrowetting droplet actuation. Two-dimensional arrays may allow for multiple paths for droplets compared to prescribed one-dimensional tracks. These grids may be leveraged to avoid cross-contamination between droplets of two different compositions. For example, a two-dimensional grid may allow for multiple droplets actuated in parallel. Droplets carrying different solutes may be run on separate parallel tracks to reduce contamination. Multiple distinct biological experiments may be run in parallel.

The present further disclosure provides systems and methods for liquid-on-liquid electrowetting (LLEW). LLEW takes advantage of an electrowetting phenomenon that occurs at a liquid-liquid-gas interface. A droplet riding on the surface of a layer of a low surface energy liquid (such as oil) and substantially surrounded by gas (such as air, nitrogen, argon, etc.) may create a liquid-liquid-gas interface at the contact line. The oil may be stabilized in place on the solid substrate by a textured surface of the solid substrate, and the conductive layer of metal electrodes may be embedded in the body of this solid. When an electric potential is applied across the height of droplet, the liquid-liquid-gas interface may cause the droplet to wet the oil and spread across the surface while still riding on the oil. Systems as described herein may comprise a layer of oil on the surface of the electrowetting array.

### Substrates for Electrowetting

An electrowetting microfluidic device may be formed by creating a slippery (in the sense of low surface energy) surface directly on the electrode array. Electrode arrays may consist of conductive plates that charge electrically to actuate the droplets. Electrodes in an array may be arranged in an arbitrary layout, for example a rectangular grid, or a collection of discrete paths. The electrodes themselves may be made of one or more conductive metals (including gold, silver, copper, nickel, aluminum, platinum, titanium), one or more conductive oxides (including indium tin oxide, aluminum doped zinc oxide), one or more conductive organic compounds (including PEDOT and polyacetylene), one or more semiconductors (including, silicon dioxide), or any combination thereof. The substrates for laying out the electrode array may be any insulating materials of any thickness and any rigidity.

The electrode arrays may be fabricated on standard rigid and flexible printed circuit board substrates. The substrate for the PCB may be FR4 (glass-epoxy), FR2 (glass-epoxy), Rogers material (hydrocarbon-ceramic), or insulated metal substrate (IMS), polyimide film (example commercial brands include Kapton, Pyralux), polyethylene terapthalate (PET), ceramic or other commercially available substrates of thickness from 1 pm to 10,000 pm. Thicknesses from 500 pm to 2000 pm may be utilized in some embodiments.

The electrode arrays may also be made of conductive elements, semiconductive elements, or any combination thereof which may be fabricated with active matrix technologies and passive matrix technologies such as thin film transistor (TFT) technology. The electrode arrays may also be made of arrays of pixels fabricated with traditional CMOS or HV-CMOS fabrication techniques.

The electrode arrays may also be fabricated with transparent conductive materials such as indium tin oxide (ITO), aluminum doped zinc oxide (AZO), fluorine doped tin oxide (FTO) deposited on sheets of glass, polyethylene terapthalate (PET) and any other insulating substrates.

The electrode arrays may also be fabricated with metal deposited on glass, polyethylene terapthalate (PET) and any other insulating substrates.

In constructing the electrowetting microfluidic device, many layers of laminations (from 1 to 50 layers) may be used to isolate multiple layers of electrical interconnect routing (from 2 to 50 layers). One of the outermost layers of lamination may contain electrode pads for actuating droplets and may contain reference electrodes. The interconnects may connect the electrical pads to high voltages for actuation and for capacitive sensing. The actuation voltage may be from IV to 350V. This actuation voltage may be an AC signal or DC signal.

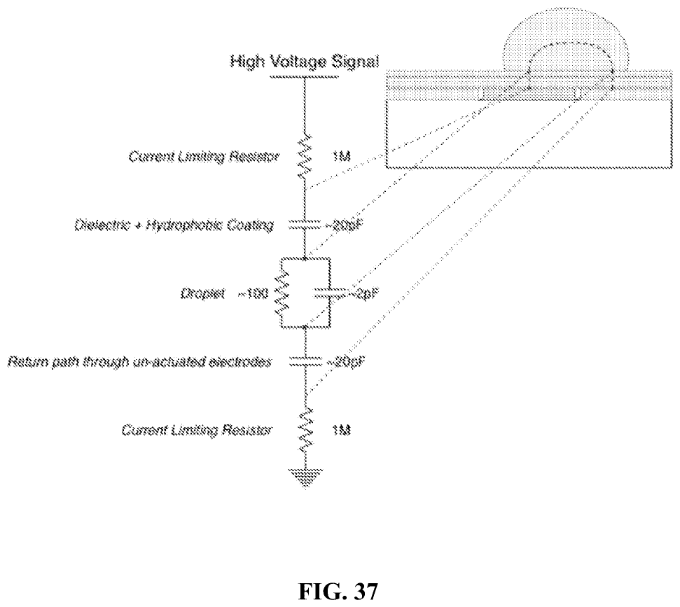

In further embodiments, the substrate does not have a dedicated reference electrode. The circuit with a conventional dedicated reference electrode includes a resistive return path which acts to ground the droplet. Without a dedicated reference electrode, the return path includes a capacitive element formed between the inactive electrode(s) and the droplet across the dielectric membrane (FIG. 37). For this reason, activating the electrodes with a time-varying voltage is necessary in order for this current-return path to be effective. This time varying voltage may be bipolar in which case the high voltage signal is both positive and negative relative to the “0V” inactive electrodes. In another embodiment, the time varying voltage may be unipolar in which case the high voltage signal is only positive and neighboring electrodes are driven antagonistically such that the electric field across the droplet flips direction periodically.

Additional examples of substrates for EWOD droplet actuation can be found in WO2021041709, which is hereby incorporated by reference in its entirety.

Some aspects of the present disclosure provide for different surface. In some embodiments, the surface is dielectric. In some embodiments, the surface comprises a dielectric layer disposed over one or more electrodes. In some embodiments, the surface is the surface of a polymeric film. In some embodiments, the surface comprises one or more nucleotides bound to the surface. In some embodiments, the surface is the surface is the surface of a lubricating liquid layer.

### Liquid Dispensers

Storing liquid reagents outside the electrode array allows for managing a dynamic range of dispensing from a few nanoliters to several milliliters, and it is also possible to rely on modern dispensing technologies with nanoliter volume precision and very high repeatability. Moreover, not having the reagent storage on the electrode array reduces the real estate needed on the array itself for sample manipulation. This approach allows for increased throughputs in a smaller-footprint instrument based on electrowetting-on-dielectric (EWOD).

Provided herein are methods and systems for controlling motion of liquid droplets. The system may comprise an electrowetting array. The system may comprise at least one liquid dispenser. The electrowetting array may have a bottom substrate. In some cases, the electrowetting array may be in a closed configuration, or have a top plate. The top plate may have at least one hole. In some cases, the electrowetting array may be in an open configuration (no second plate) and droplets may be loaded directly onto the array. In some cases, the electrowetting array may have a closed configuration. For example, the electrowetting array may have a second plate that sandwiches the droplet between an electrode array and a ground electrode. In some cases, the second plate (cover plate with or without ground) may have holes to allow the droplets in transit. In some cases, the droplets may be first loaded on an open plate and then a second plate may be added. In some cases, the electrowetting array may integrate at least one reservoir. In some case, the electrowetting array may integrate at least one dispenser. The dispenser may be external to the array.

### Reagent Reservoirs

The present disclosure provides systems and methods for storing and distributing reagents and samples onto one or more electrode arrays. The system may comprise one or more reservoirs to store reagents and samples. At least one reagent reservoir may be stored external to an electrode array. The reagent reservoir may be, for example, adjacent to the electrode array. The system may further comprise one or more liquid dispensers to draw at least one reagent from the one or more reservoirs. The one or more liquid dispensers may contact the one or more reservoirs, move to a location above the electrowetting array, and dispense the at least one reagent. A user may fill the reservoirs before starting a run on the electrowetting-based liquid manipulation system. Alternatively, the user may load reservoirs that come pre-filled by a reagent supplier. The systems described herein may also be used for aspiration and repositioning of samples or droplets on electrode arrays.

In some embodiments, the reagent reservoir and dispense module are integrated into a single unit. In some embodiments, the reagent reservoir and dispense module are not integrated into a single unit. The reagent reservoir and the dispense unit may have the ability to regulate the temperature of the reagents. For example, the reagent reservoir and the dispense unit may have the ability to cool the reagents to 4° C. This may be beneficial if the electrode array or other parts of the system are heated. The reagents reservoir or dispense modules may have the ability to stir the fluids prior to dispensing. The reagents reservoir or dispense modules may have the ability to continuously agitate the liquids. With reagents containing suspended particles, such as magnetic beads, continuous agitation may be necessary to prevent the particles from settling.

Reagent storage containers may be single-use consumables that are pre-filled by a reagent supplier. Reagent storage containers may be rinsed and reused. If reused, reagent containers may be refilled with the same reagents to prevent cross contamination. To that end, it may be advantageous to have designating reagent containers (or the like) for use with particular reagents. This may be done with physical labels or electronically with the use of RFID or NFC tags.

### Dispensing

The present disclosure provides systems and methods for transferring and dispensing reagents onto an electrowetting array. The dispensing unit may be capable of transferring volumes ranging from at least about 1 picoliter (pL) to at least about 100 milliliters (mL). The dispensing unit may be capable of transferring volumes ranging from at least about 1 picoliter (pL), at least about 2 pL, at least about 3 pL, at least about 4 pL, at least about 5 pL, at least about 6 pL, at least about 7 pL, at least about 8 pL, at least about 9 pL, at least about 10 pL, at least about 20 pL, at least about 30 pL, at least about 40 pL, at least about 50 pL, at least about 60 pL, at least about 70 pL, at least about 80 pL, at least about 90 pL, at least about 100 pL, at least about 200 pL, at least about 300 pL, at least about 400 pL, at least about 500 pL, at least about 600 pL, at least about 700 pL, at least about 800 pL, at least about 900 pL, at least about 1 nanoliter (nL), at least about 2 nL, at least about 3 nL, at least about 4 nL, at least about 5 nL, at least about 6 nL, at least about 7 nL, at least about 8 nL, at least about 9 nL, at least about 10 nL, at least about 20 nL, at least about 30 nL, at least about 40 nL, at least about 50 nL, at least about 60 nL, at least about 70 nL, at least about 80 nL, at least about 90 nL, at least about 100 nL, at least about 200 nL, at least about 300 nL, at least about 400 nL, at least about 500 nL, at least about 600 nL, at least about 700 nL, at least about 800 nL, at least about 900 nL, at least about 1 μL, at least about 2 μL, at least about 3 μL, at least about 4 μL, at least about 5 μL, at least about 6 μL, at least about 7 μL, at least about 8 μL, at least about 9 μL, at least about 10 μL, at least about 20 μL, at least about 30 μL, at least about 40 μL, at least about 50 μL, at least about 60 μL, at least about 70 μL, at least about 80 μL, at least about 90 μL, at least about 100 μL, at least about 200 μL, at least about 300 μL, at least about 400 μL, at least about 500 μL, at least about 600 μL, at least about 700 μL, at least about 800 μL, at least about 900 μL, at least about 1 milliliter (mL), at least about 2 mL, at least about 3 mL, at least about 4 mL, at least about 5 mL, at least about 6 mL, at least about 7 mL, at least about 8 mL, at least about 9 mL, at least about 10 mL, at least about 20 mL, at least about 30 mL, at least about 40 mL, at least about 50 mL, at least about 60 mL, at least about 70 mL, at least about 80 mL, at least about 90 mL, at least about 100 mL, or more, The dispensing unit may be capable of transferring volumes ranging from at least about 100 mL, 10 mL, 1 mL, 100 μL, 10 μL, 1 μL, 100 nL, 10 nL, 1 nL, 100 pL, 10 pL, 1 pL, or less.

In systems and methods as described herein, the dispensing unit may have an end or nozzle. The nozzle or the end of the dispensing unit may not need to make contact with the liquids or any physical surface to transfer the liquid onto the electrowetting array. The nozzle or the end of the dispensing unit may not need to make contact with, for example, a film or other consumable on the surface of the electrowetting array. The nozzle or the end of the dispensing unit may not need to make contact with, for example, a lubricant or other liquid on the surface of the electrowetting array. The dispensing unit may transfer fluids by ejecting droplets on the surface of the electrode array from a distance. It may be possible in some cases that the dispensing unit makes contact with an already present droplet on the electrode array to complete the transfer. It is also possible that the dispenser is brought close to the surface of the electrode array to complete the transfer of the liquid in droplet form. In systems and methods as disclosed herein, a reagent may be dispensed on the surface of the electrowetting array in continuous volumes. In systems and methods as disclosed herein, a reagent may be dispensed on the surface of the electrowetting array in non-continuous volumes.

In systems and methods as described herein, an automated reagent dispenser may be integrated with one or more electrowetting devices or electrode arrays. The automated reagent dispenser may automatically introduce reagents as needed while carrying out, for example, a biological protocol. The techniques described here are generally applicable to implementing dispensing mechanisms for other fluidics devices similar to electrowetting arrays (e.g., electrophoretic arrays, optoelectrowetting, optoelectropositioning, etc). The automated reagent dispenser may be composed of a motion system to position the dispensing head, a pneumatic engine that produces the necessary pressures and vacuums needed to dispense reagents, and valving to control the dispense.

Systems and methods as described herein may further comprise a robotic system. The robotic system may comprise a robotic arm. The robotic arm may comprise an end effector. At least one reagent may be transferred to one or more reaction zones on an electrode array using automated dispensers controlled by a robotic arm. The robotic system may be a gantry motion system. The robotic arm may be a gantry arm. The automated dispensers may move the reagents in 1, 2, 3, or 4 axes. The dispensers may move the reagents in the X, Y, or Z axes relative to the electrode array. The dispensers may move the reagents horizontally or vertically, with respect to a two-dimensional plane, or transversally. The dispensers may move the reagents in a circular motion. The system may further comprise reagent reservoirs. The reagent reservoirs may be external to the electrode array. The reagent reservoirs themselves may be moved by the dispensers. The reagent reservoirs may be moved by the dispensers in the X, Y and/or Z axes relative to the electrode array. The reagent storage units may stay stationary, but part of the dispensing unit alone may move in 3D space relative to the electrode array. The one or more reagent reservoirs may store and/or distribute reagents onto one or more reaction zones. To do so, the system may use a motion system to transfer the fluids from one location to another.

In systems and methods as described herein, various processes described herein may be implemented by dispensing liquids and creating droplets. Small, precise volumes of precious reagents may be dispensed. Liquids may be dispensed individually or in combination to introduce liquids to an array. Introduced liquids may form a droplet, or a plurality thereof, on the array. A liquid handling system, robotic arm, acoustic dispenser, inkjet, or any combination thereof may be used to dispense fluids directly on an array or to a reservoir of the array. These dispensers may use channels, such as, for example, tubes, nozzles, pipettes, or any combination thereof as well as holes in the array.

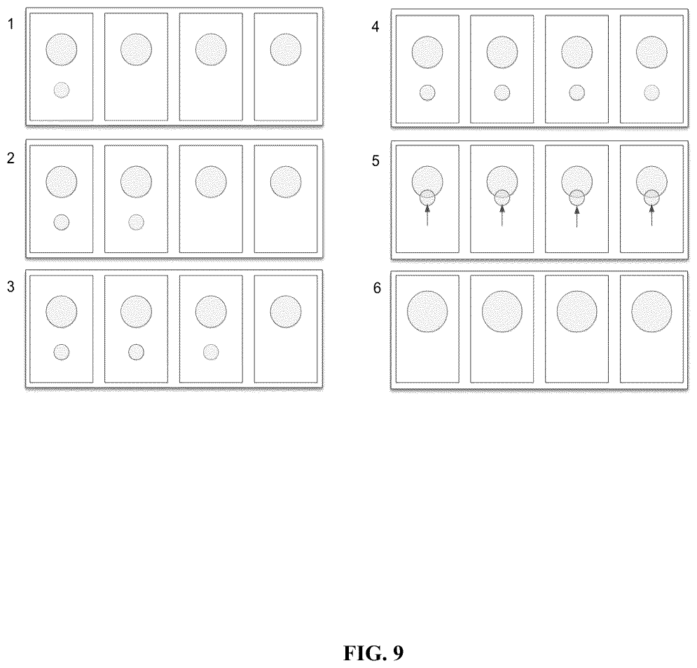

Systems and methods as described herein may further comprise use of at least one centralized dispenser across multiple sample regions. A sample region is a region on the surface of a chip, e.g., an electrowetting array, that carries out a reaction. Electrowetting on dielectric (EWOD) may be used in order to synchronize multiple biological and biochemical reactions on one or more sample regions with a centralized reagent dispenser, as depicted in FIG. 9. The centralized dispenser may dispense reagents into each sample region sequentially. The centralized dispenser may dispense reagents such that they are not directly dispensed into the reaction droplet. These newly dispensed reagent droplets may be held temporarily adjacent to a reaction droplet with the use of electrowetting. Once all new reagent droplets have been dispensed, electrowetting (or other droplet manipulation methods) may be used to introduce each reagent droplet into each reaction droplet. Other examples of droplet manipulation methods may include, but are not limited to, dielectrophoresis (DEP) or dielectrowetting (DEW).

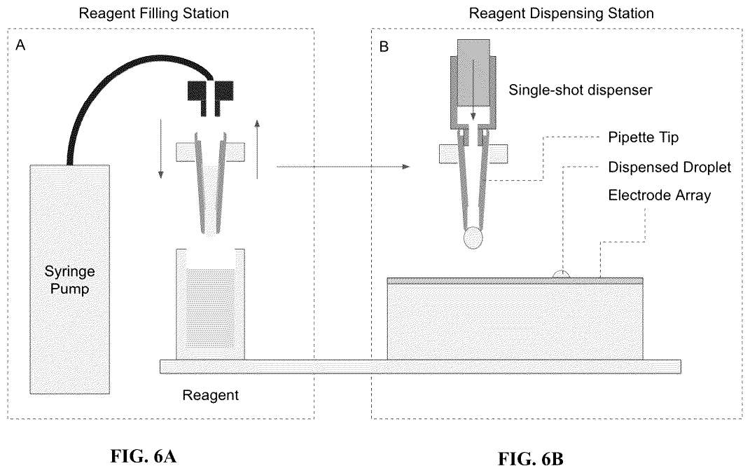

Systems and methods as described herein may further comprise use of at least one tool-changer. For example, one or more pipette tips may be connected to one or more tool-changers. Pipette tips may be stored in a carousel and be subsequently picked up they are picked up by a rotating tool-changer. Pipettes in this carousel are either pre-filled with single-shots of low volume fluid, or may be placed over a reservoir from which the fluid is drawn via the action of a syringe pump connected to the pipette tip (FIG. 6).

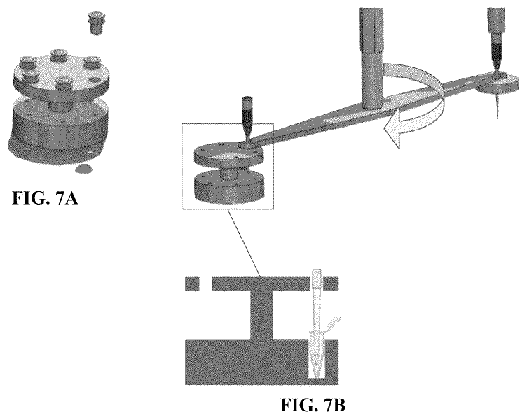

Once aspirated, the reagent may be dispensed accurately over multiple sites. This may be accomplished by rotating the “tool-changer” arm or by adding an additional axis of motion to the mechanism. Multiple sized pipette tips can be used with a single carousel by using pipette adapters sized appropriately for various different tip sizes (FIGS. 7A-7B).

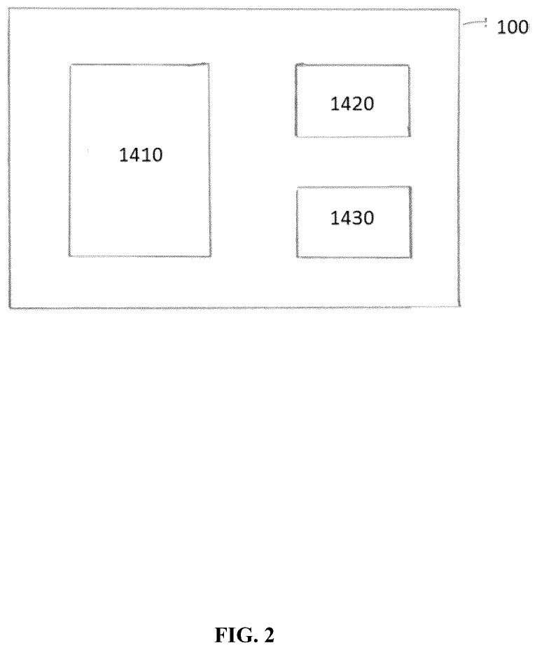

FIG. 2 provides an example of a system as described herein. An array (100) may have regions that perform EWOD (1410), dielectrowetting (1420), dielectrophoresis (1430), or a combination thereof. Liquids may be stored on the array in reservoirs. Droplets may be dispensed from the reservoirs on the array using DEP, DEW, EWOD, or any combination thereof, and subsequently actuated by EWOD. EWOD actuation of droplets can be used to move droplets of reagents to desired reactions. Alternatively, EWOD may be used to compensate for evaporative losses in existing droplets of the array. Additionally, a droplet may be split into two, three, four, five, six, or more droplets using EWOD, DEW, DEP, or any combination thereof.

### Dispenser Types

The present disclosure provides systems and methods for storing, transferring, and/or dispensing reagents onto an electrowetting array. Provided herein are numerous examples of dispensers.

### Precision Pins

The present disclosure provides systems and methods for dispensing liquids using a metal pin with a hydrophobic coating. The metal pin may be a precision pin. The metal pin may be useful for various applications. For example, in applications such as next-generation sequencing sample prep, there may be reagents unique to each sample. For example, there may be adaptors or barcodes that are unique to each sample. Precision pins may be useful in dispensing such reagents. Precision pins may be used for transferring small volumes of biological reagents, and may be used in pin spotters for DNA microarrays.

A precision pin may comprise a steel pin coated with a hydrophobic coating. Pins may be stored on a rack adjacent to an electrowetting device. Pins may be picked up individually by a robotic end effector. Pins may then be lowered into a reagent well and draw a designated volume. Examples of reagents wells include, but are not limited to, a tube strip of reservoirs, a standard 96-well plate, any SBS-format well plate, 2 mL standard reagent tubes, or any other reagent containers. A pin may be lifted out of the reagent reservoir and lowered onto the surface of an electrowetting array to transfer a liquid volume from the pin to the electrowetting device. The pin may either make contact with the electrowetting array or eject a liquid from a distance above the electrowetting array.

Pins may have specific volume designations. Precision pins may be designed to pick up volumes from at least about 1 nanoliter (nL) to at least about 10 microliters (μL). Precision pins may be designed to pick up volumes of at least about 1 nanoliter (nL), at least about 2 nL, at least about 3 nL, at least about 4 nL, at least about 5 nL, at least about 6 nL, at least about 7 nL, at least about 8 nL, at least about 9 nL, at least about 10 nL, at least about 20 nL, at least about 30 nL, at least about 40 nL, at least about 50 nL, at least about 60 nL, at least about 70 nL, at least about 80 nL, at least about 90 nL, at least about 100 nL, at least about 200 nL, at least about 300 nL, at least about 400 nL, at least about 500 nL, at least about 600 nL, at least about 700 nL, at least about 800 nL, at least about 900 nL, at least about 1 μL, at least about 2 μL, at least about 3 μL, at least about 4 μL, at least about 5 μL, at least about 6 μL, at least about 7 μL, at least about 8 μL, at least about 9 μL, at least about 10 μL, or more.

A pin may make contact with the surface of the electrode array directly. The pin may make contact with a droplet or liquid volume that is already on the surface of the electrowetting array. A pin may make contact with a sample in a droplet that is already on the surface of the electrowetting array. Upon contact either with the surface of the electrowetting device, or the receiving droplet (for example, reagent mixture), capillary forces may draw a liquid away from the pin. This process may be repeated two or more times to reach a desired volume.

The pin may not need to make contact with the electrowetting array. The pin may not need to make contact with, for example, a film or other consumable on the surface of the electrowetting array. The pin may not need to make contact with, for example, a lubricant or other liquid on the surface of the electrowetting array. The pin may transfer fluids by ejecting droplets on the surface of the electrode array from a distance. After the pin ejects one or more droplets on the surface of the electrowetting array, the one or more droplets may be combined by electrowetting forces. The pin may be brought close to the surface of the electrode array to complete the transfer of the liquid in droplet form.

Small, precise volumes of precious reagents may be dispensed. Liquids may be dispensed individually or in combination to introduce liquids to an array. Introduced liquids may form a droplet, or a plurality thereof, on the array. The pin may dispense a reagent on the surface of the electrowetting array in continuous volumes. The pin may dispense a reagent on the surface of the electrowetting array in non-continuous volumes.

The pin may be fluidically connected to one or more automated reagent dispensers. The automated reagent dispenser may be composed of a motion system to position the dispensing head, a pneumatic engine that produces the necessary pressures and vacuums needed to dispense reagents, and valving to control the dispense. The pin may be fluidically connected to a robotic system. The robotic system may comprise a robotic arm. The robotic arm may comprise an end effector. At least one reagent may be transferred to one or more reaction zones on an electrode array using automated dispensers controlled by a robotic arm. The robotic system may be a gantry motion system. The robotic arm may be a gantry arm. The automated dispensers may move the reagents in 1, 2, 3, or 4 axes. The dispensers may move the reagents in the X, Y, or Z axes relative to the electrode array. The dispensers may move the reagents horizontally or vertically, with respect to a two-dimensional plane, or transversally. The dispensers may move the reagents in a circular motion.

The system may further comprise reagent reservoirs. The reagent reservoirs may be external to the electrode array. The reagent reservoirs themselves may be moved by the dispensers. The reagent reservoirs may be moved by the dispensers in the X, Y and/or Z axes relative to the electrode array. The reagent storage units may stay stationary, but part of the dispensing unit alone may move in 3D space relative to the electrode array. The one or more reagent reservoirs may store and/or distribute reagents onto one or more reaction zones. To do so, the system may use a motion system to transfer the fluids from one location to another.

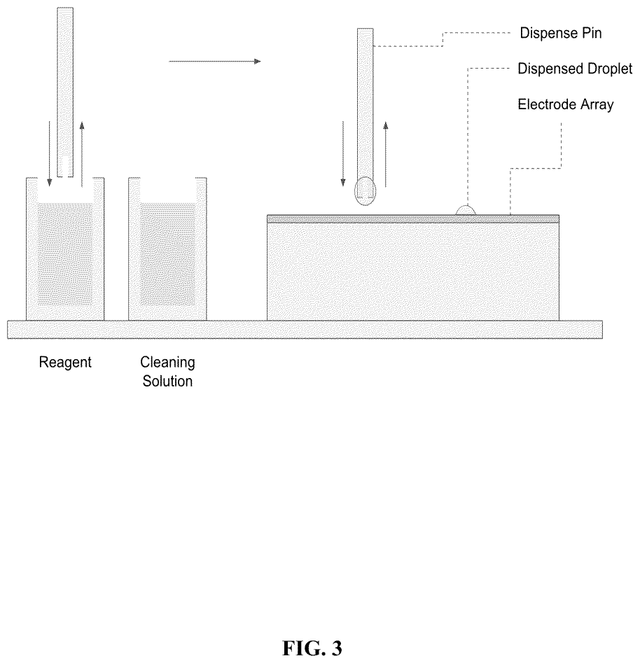

After the volume is dispensed, the pin can be washed in a cleaning solution. The cleaning solution may be located adjacent to the electrowetting device. Then pin may be dried using appropriate techniques as used in the industry (FIG. 3). Depending on the level of cleaning, the same pin may be rinsed in a cleaning solution and reused for different reagents, or parked back in its designated spot on the rack. If the cleaning is not adequate to prevent carry-over, a separate pin may be used for a different reagent. Pins may include features that enable easy handling and manipulation by a robotic machine. For example, pins may be fabricated from magnetic materials for easy pickup by the robotic end effector. Pins can also be disposed of after a single use.

### Single-Shot Dispensing

The present disclosure provides systems and methods for single-shot dispensing. A reagent reservoir may be pre-filled with at least one reagent. A dispensing system comprising one or more dispensing elements may draw the entire contents of at least one reagent reservoir, move the reagent to a location over the electrowetting array, and dispense the reagent. The reagent may simply be ejected all at once by the dispenser system in order to dispense the liquids in the appropriate location at the appropriate time. This method may rely on an upfront manual or automated step to pre-aliquot dispense volumes that are then dispensed fully.

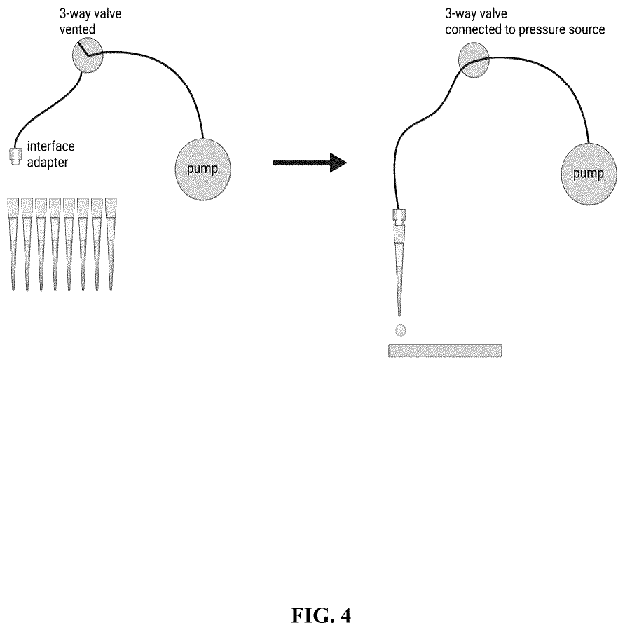

The dispensing system may comprise a dispensing element from which the reagent is ejected. The dispensing element may be a disposable pipette tip. The dispensing system may comprise a manual pipettor. The pipette tips may be filled with a pre-determined volume and a pre-determined reagent with respect to a specific assay. A user may aspirate reagents into the pipette tip using a manual pipettor and place the pipette tips on a rack. The rack may sit adjacent to the electrowetting array or to a fluidics chip that manipulates the dispensed liquids. The dimensions and surface properties of the tip may be such that when disengaged from the pipettor, the fluid is retained without any dripping. As depicted in FIG. 4, the full tips may be picked up by a motion system using an interface adapter that connects the pipette tip to a pressure source. The pressure source may be a pump. The pressure source may be valved. The valve may be a 3-way valve vented. The valve may be, for example, a pressure valve, a vacuum valve, or any other type of valve. The motion system may move the pipette tips and interface adapter to a target location, where pressure may be applied and the contents of the pipette tip may be emptied. Alternatively, the pipette tips may be loaded empty, and the interface adapter may be equipped with a method for precisely aspirating the prescribed volume. The pipette tip and interface adapter may be used to aspirate a reagent from a well before proceeding to a site to release the contents.

A pipette tip may make contact with the surface of the electrode array directly. The pipette tip may make contact with a droplet or liquid volume that is already on the surface of the electrowetting array. The pipette tip may make contact with a sample in a droplet that is already on the surface of the electrowetting array. Upon contact either with the surface of the electrowetting device, or the receiving droplet (for example, reagent mixture), capillary forces may draw a liquid away from the pin. This process may be repeated two or more times to reach a desired volume.

The pipette tip may not need to make contact with the electrowetting array. The pipette tip may not need to make contact with, for example, a film or other consumable on the surface of the electrowetting array. The pipette tip may not need to make contact with, for example, a lubricant or other liquid on the surface of the electrowetting array. The pipette tip may transfer fluids by ejecting droplets on the surface of the electrode array from a distance. After the pipette tip ejects one or more droplets on the surface of the electrowetting array, the one or more droplets may be combined by electrowetting forces. The pipette tip may be brought close to the surface of the electrode array to complete the transfer of the liquid in droplet form.

Small, precise volumes of precious reagents may be dispensed. Liquids may be dispensed individually or in combination to introduce liquids to an array. Introduced liquids may form a droplet, or a plurality thereof, on the array. The pipette tip may dispense a reagent on the surface of the electrowetting array in continuous volumes. The pipette tip may dispense a reagent on the surface of the electrowetting array in non-continuous volumes.

The pipette tip may be fluidically connected to one or more automated reagent dispensers. The automated reagent dispenser may be composed of a motion system to position the dispensing head, a pneumatic engine that produces the necessary pressures and vacuums needed to dispense reagents, and valving to control the dispense. The pipette tip may be fluidically connected to a robotic system. The robotic system may comprise a robotic arm. The robotic arm may comprise an end effector. The robotic arm may move to a pipette disposal location to release the pipette tip. The robotic arm may not need to make contact with the electrowetting array. The robotic arm may not need to make contact with, for example, a film or other consumable on the surface of the electrowetting array. The robotic arm may not need to make contact with, for example, a lubricant or other liquid on the surface of the electrowetting array. At least one reagent may be transferred to one or more reaction zones on an electrode array using automated dispensers controlled by a robotic arm. The robotic system may be a gantry motion system. The robotic arm may be a gantry arm. The automated dispensers may move the reagents in 1, 2, 3, or 4 axes. The dispensers may move the reagents in the X, Y, or Z axes relative to the electrode array. The dispensers may move the reagents horizontally or vertically, with respect to a two-dimensional plane, or transversally. The dispensers may move the reagents in a circular motion.

The reagent reservoirs may be external to the electrode array. The reagent reservoirs themselves may be moved by the dispensers. The reagent reservoirs may be moved by one or more liquid dispensers in the X, Y and/or Z axes relative to the electrode array. The reagent storage units may stay stationary, but part of the dispensing unit alone may move in 3D space relative to the electrode array. The one or more reagent reservoirs may store and/or distribute reagents onto one or more reaction zones. To do so, the system may use a motion system to transfer the fluids from one location to another.

### Dispensing Common Reagents Across Multiple Reactions

The present disclosure provides dispenser systems capable of carrying out multiple reactions in parallel. In some instances, a reagent may be common to multiple reactions. These reagents may be dispensed sequentially on multiple locations of a single array or dispensed in rapid succession on multiple arrays. Reagents may be dispensed in multiple locations precisely and quickly.

Micro-Diaphragm Chips (MDCs) with Electrode and Fluidic Arrays

The present disclosure provides dispenser systems with MDCs. MDCs may comprise one or more small diaphragms. The one or more diaphragms may be configured to draw liquids, meter the volumes precisely, and dispense liquids. In some embodiments, MDCs may help achieve parallelization in a system where different reagents need to be dispensed sequentially to multiple locations. For example, MDCs may be assigned to particular reagents to avoid the risk of cross-contamination.

MDCs may be fluidically connected to a reagent reservoir. The reagent reservoirs may be external to the electrode array. The reagent reservoirs themselves may be moved by the dispensers. The reagent reservoirs may be moved by one or more liquid dispensers in the X, Y and/or Z axes relative to the electrode array. The reagent storage units may stay stationary, but part of the dispensing unit alone may move in 3D space relative to the electrode array. The one or more reagent reservoirs may store and/or distribute reagents onto one or more reaction zones. To do so, the system may use a motion system to transfer the fluids from one location to another.

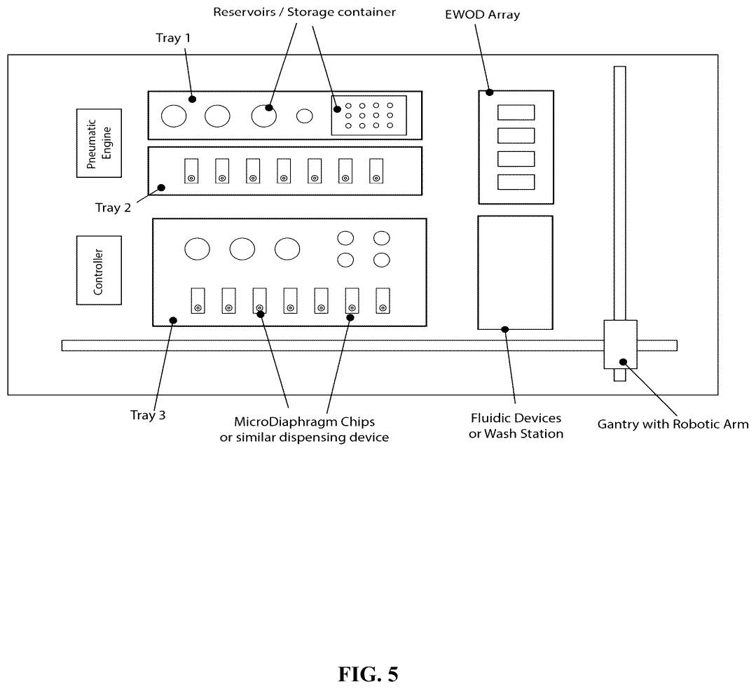

MDCs may be fluidically connected to at least one pneumatic engine. The pneumatic engine may enable the MDC to draw liquid from the reagent reservoir. The pneumatic engine may apply a succession of pressure and vacuum pulses. MDCs may be fluidically connected to the reagent reservoir, and may draw and dispense precise volumes through the actuation of valves and small reservoirs triggered by a succession of pressure and vacuum pulses provided by the “pneumatic engine”, as shown in FIG. 5. Alternatively, the MDCs may be preloaded with at least one liquid.

The present disclosure provides systems and methods for storing and drawing one or more reagents using one or more MDCs. The system may be arranged with multiple removable trays that hold the MDCs and reagents specific to a particular application. MDCs for specific reagents may be located on specific parts of the tray. Reagents may be loaded in various methods. For example, reagents may be loaded directly via a pipette tip which interfaces with the MDC. In another example, reagents may be loaded through a connection tube fluidically connected to a reagent reservoir. To load reagents for a specific application, the operator may prepare reagents specific to that protocol, and load prescribed volumes in the appropriate reservoirs or pipette tips. The tray may then be loaded into the dispenser system where a robotic arm fluidically connected to the pneumatic engine picks up the MDCs and precisely dispenses the desired volumes of the reservoirs in pre-programmed locations.

The present disclosure provides systems and methods for using one or more MDCs to draw and dispense reagents. The MDCs may be manipulated manually. As depicted in FIG. 5, for example, a user may load reagent reservoirs and storage containers in a reagent tray outside of the electrowetting device (e.g., Tray 1). The user may then load the reagent tray into the electrowetting device as a whole. Similarly, a user may load more MDCs in predetermined locations in Tray 2. The trays may be removable from the device. Alternatively, an operator may load the reagents and chips onto a tray that is fixed inside the device (e.g., Tray 3 of FIG. 5). There may be one or more EWOD arrays or other fluidic arrays adjacent to the trays containing MDCs and reservoirs. The user may manipulate the MDC to a position over the electrowetting array and dispense the reagent.

The MDC may also be manipulated by an end effector. The end effector may manipulate the MDCs to draw and dispense reagents. The end effect may manipulate different MDCs to draw different reagents. The end effector may manipulate an MDC, bring the MDC in contact with a reagent reservoir, draw the reagent, move to a location at a distance above an electrowetting array, and dispense the reagent. After completing a cycle of dispensing, the robotic arm may return the MDC chip to its predetermined location and picks up the next MDC chip for the next dispense and so on. The tray where the MDC chip is returned may have the ability to accurately retain each MDC chip such that they can later be picked up and accurately aligned with a toolhead. The system may have the ability to wash the MDCs one by one and prepare them for running a new workflow. The system may have the ability to wash the MDCs after the final dispense at the end of the workflow or between workflows. The speed of a gantry motion system may be increased in order to facilitate higher throughput processing of samples. This may be done by directly speeding up the gantry by choosing a motion system architecture that reduces moving mass and is capable of high-speed operation. Additional gantry motion systems may be used in parallel. One or more gantries may share access to reagent trays. Alternatively, there may be separate reagent trays for individual gantry motion systems.

Examples of end effectors include, but are not limited to, a robotic arm. The robotic arm may be part of a gantry motion system. The robotic arm may not need to make contact with the electrowetting array. The robotic arm may not need to make contact with, for example, a film or other consumable on the surface of the electrowetting array. The robotic arm may not need to make contact with, for example, a lubricant or other liquid on the surface of the electrowetting array. The automated dispensers may move the reagents in 1, 2, 3, or 4 axes. The dispensers may move the reagents in the X, Y, or Z axes relative to the electrode array. The dispensers may move the reagents horizontally or vertically, with respect to a two-dimensional plane, or transversally. The dispensers may move the reagents in a circular motion.

An MDC may make contact with the surface of the electrode array directly. The MDC may make contact with a droplet or liquid volume that is already on the surface of the electrowetting array. The MDC may make contact with a sample in a droplet that is already on the surface of the electrowetting array.

The MDC may not need to make contact with the electrowetting array. The MDC may not need to make contact with, for example, a film or other consumable on the surface of the electrowetting array. The MDC may not need to make contact with, for example, a lubricant or other liquid on the surface of the electrowetting array. The MDC may transfer fluids by ejecting droplets on the surface of the electrode array from a distance. After the MDC ejects one or more droplets on the surface of the electrowetting array, the one or more droplets may be combined by electrowetting forces. The MDC may be brought close to the surface of the electrode array to complete the transfer of the liquid in droplet form.

Small, precise volumes of precious reagents may be dispensed. Liquids may be dispensed individually or in combination to introduce liquids to an array. Introduced liquids may form a droplet, or a plurality thereof, on the array. The MDC may dispense a reagent on the surface of the electrowetting array in continuous volumes. The MDC may dispense a reagent on the surface of the electrowetting array in non-continuous volumes.

MDCs may be replaced with alternate dispensers with similar functionality. Trays, reservoirs, dispensing chips, gantries, EWOD arrays, and fluidic arrays may be replaced with other mechanisms described herein. EWOD arrays or fluidic devices may be replaced with other fluidic control devices described herein.

### Robotic System

The present disclosure provides systems and methods for dispensing liquids with a dispenser motion system. Systems and methods as described herein may further comprise a robotic system. The robotic system may comprise a robotic arm. The robotic arm may comprise an end effector. At least one reagent may be transferred to one or more reaction zones on an electrode array using automated dispensers controlled by a robotic arm. The robotic system may be a gantry motion system. The robotic arm may be a gantry arm.

In a gantry motion system, at least one reagent may be transferred to one or more reaction zones on an electrode array using automated dispensers controlled by a gantry arm. The automated dispensers may move the reagents in 1, 2, 3, or 4 axes. The dispensers may move the reagents in the X, Y, or Z axes relative to the electrode array. The dispensers may move the reagents horizontally or vertically, with respect to a two-dimensional plane, or transversally. The dispensers may move the reagents in a circular motion. The system may further comprise reagent reservoirs. The reagent reservoirs may be external to the electrode array. The reagent reservoirs themselves may be moved by the gantry arm. The reagent reservoirs may be moved by the gantry arm in the X, Y and/or Z axes relative to the electrode array. The reagent storage units may stay stationary, but part of the dispensing unit alone may move in 3D space relative to the electrode array. The one or more reagent reservoirs may store and/or distribute reagents onto one or more reaction zones. To do so, the system may use a motion system to transfer the fluids from one location to another.

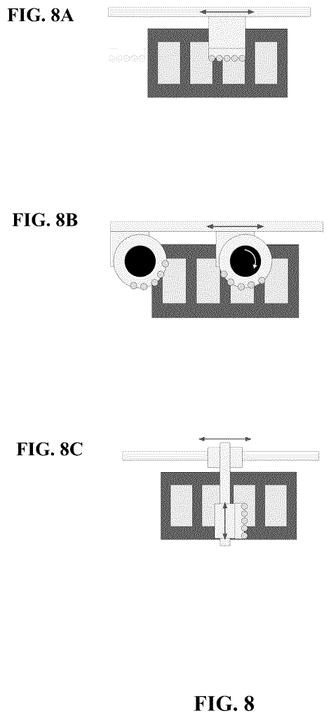

The dispenser motion system may be implemented in a number of different ways. The dispenser motion system may have a single degree of freedom motion. The movement of the dispenser motion system with a single degree of freedom may be either linear or rotary, as depicted in FIG. 8A. The movement of the dispenser motion system with a single degree of freedom may be designed such that the path of the motion system positions one or more dispenser heads over one or more dispense locations on a chip. The dispenser motion system may also be used to position a dispenser to multiple different sample regions within a given chip. Dispense heads may have multiple channels and/or nozzles with multiple sample regions. For such dispense heads, the dispense nozzles may be aligned in the direction of travel such that one or more of the nozzles may be positioned over one or more portion of the chip. This may allow the instrument to switch between sample regions and to align the necessary nozzle in the desired chip location. The chip may be, for example, an electrowetting array.

The dispenser motion system may have more than a single degree of freedom motion. The dispenser motion system may be implemented with two, three, or more degrees of freedom. The dispenser motion system may be implemented with linear and/or rotary degrees of freedom. A multi-axis dispense capability may be implemented with a linear degree of freedom and/or a rotary degree of freedom, as depicted in FIG. 8B. A multi-axis dispense capability may be implemented with two linear degrees of freedom as depicted in FIG. 8C. A multi-axis dispense capability may be implemented with two rotary degrees of freedom. The rotary and linear axis embodiment may enable a way of selecting the appropriate dispense channel with the rotary axis and positioning the dispense nozzle with the linear axis, as depicted in FIG. 8B. A dispenser motion system with two linear degrees of freedom may position any dispense nozzle over any location on any of the sample regions (FIG. 8C). A major benefit of this approach is that it is arbitrarily extensible and may be used to position a dispense in any portion of each sample region across multiple separate chips.

### Lubrication Replenishment

The present disclosure provides systems and methods for lubrication replenishment of an electrowetting array. Certain constructions of surface substrates (surface of the dielectric) for EWOD-based liquid manipulation involve the use of a lubricated surface. This lubricant may become depleted throughout the course of certain biological protocols. This is especially true for long-duration protocols (>45 minutes) involving reagents with high concentrations of surfactants. In these circumstances, it may be advantageous to be able to restore or refill the lubricant layer to keep droplet mobility consistent throughout the protocol.

Dispensing systems as described herein may be utilized for lubricant replenishment. Dispensing systems may include metal pins (e.g., precision pins), single-shot dispensing, one or more robotic arms, tool-changers, or MDCs. Components of dispensing systems may further include one or more valves or one or more pumps. The dispensing system may dispense lubricant in least one region of a chip, e.g., an electrowetting array. Small volumes of lubricant may be dispensed in a distributed way throughout the at least one region. Depending on the viscosity of the lubricant, it may take time, e.g., several minutes or hours, in order for the lubricant layer to stabilize and settle into a uniform layer. Mechanisms for dispensing a lubricant on an electrowetting array include, but are not limited to, spray nozzle, inkjet, syringe pump or any other dispensing mechanism described herein to accomplish this dispensing task.

### Droplet Manipulation

In an aspect, the present disclosure provides a method for processing a plurality of biological samples. The method may comprise receiving, adjacent to an array, a plurality of droplets that may comprise the plurality of biological samples, and using at least the array to process the plurality of biological samples in the plurality of droplets or derivatives thereof at a coefficient of variation (CV) of at least one parameter of the plurality of droplets or derivatives thereof, or the array, of less than 20% at cross-talk between the plurality of droplets at less than 5%. This may be used to process the plurality of biological samples. The array may be an electrowetting device, as described elsewhere herein.

In another aspect, the present disclosure provides a system for processing a plurality of biological samples. The system may comprise receiving, adjacent to an array, a plurality of droplets that may comprise the plurality of biological samples, and using at least the array to process the plurality of biological samples in the plurality of droplets or derivatives thereof at a coefficient of variation (CV) of at least one parameter of the plurality of droplets or derivatives thereof, or the array, of less than 20% at cross-talk between the plurality of droplets at less than 5%. The system may be used to process the plurality of biological samples.

In another aspect, the present disclosure provides a system for biological sample processing, comprising: a housing configured to contain a plurality of arrays, wherein an array of the plurality of arrays is configured to (i) receive, adjacent to the array, a plurality of droplets comprising the plurality of biological samples, and (ii) use at least the array to process said plurality of biological samples in the plurality of droplets or derivatives thereof at a coefficient of variation (CV) of at least one parameter of the plurality of droplets or derivatives thereof, or the array, of less than 20% at cross-talk between the plurality of droplets at less than 5%. The plurality of arrays may be removable from the housing. The housing may be configured to couple to a nucleic acid sequencing platform. The housing may be a nucleic acid sequencing platform.

In another aspect, the present disclosure provides a method for customizing an array system for processing a plurality of biological samples. The method may comprise receiving a request for a configured array system from a user, which request may comprise one or more specifications, and using the one or more specifications to configure the array system to yield the configured array system, which configured array system may be configured to receive a plurality of droplets that may comprise the plurality of biological samples and may process the plurality of droplets or derivatives thereof at a coefficient of variation (CV) of at least one parameter of the plurality of droplets or derivatives thereof, or the array, of less than 20% at cross-talk between the plurality of droplets may be at less than 5%.

In another aspect, the present disclosure provides a method for processing a biological sample. The method may comprise providing, adjacent to an open array, a droplet that may comprise the biological sample, and that may use the open array to process the biological sample in the droplet or derivative thereof. During processing, a position of the static (or sessile) droplet may vary by at most 5% over a time period of at least 10 seconds.

In another aspect, the present disclosure provides a method for processing a biological sample. The method may comprise receiving, adjacent to an array, a droplet comprising the biological sample, and may use at least the array to process the biological sample in the plurality of droplets or derivatives thereof at a coefficient of variation (CV) of at least one parameter of the droplet or derivative thereof, or the array, of less than 20% at cross-talk between the droplet at less than 5%.

The at least one parameter may comprise one or more members selected from the group consisting of droplet size, droplet volume, droplet position, droplet speed, droplet wetting, droplet temperature, droplet pH, beads in droplets, number of cells in droplets, droplet color, concentration of chemical material, concentration of biological substance, or any combination thereof. The at least one parameter may be at least 1, 2, 3, 4, 5, 6, 7, 8, 9, 10, or more parameters. The at least one parameter may be a measurable property of a droplet.

In some embodiments, the concentration of a chemical material or biological substance within a droplet is monitored such that it does not exceed or fall below a predetermine threshold. In some embodiments, the predetermined threshold of a concentration of a chemical material or biological substance is 5%, 10%, 15%, 20%, 25%, 30%, 35%, 40%, 45%, 50%, 55%, 60%, 65%, 70% 75%, 80%, 85%, 90%, or 95%.

The configuration of the array may be selected from the group consisting of an open configuration with an electrode array, open configuration with no electrode array, open configuration with non-coplanar set of electrodes, two plates with an array of electrodes on one plate and no electrodes on the other plate, two plates with non-coplanar set of electrodes on one plate and no electrodes on the other plate, two plates with an array of electrodes on one plate and single electrode on the other plate, two plates with an non-coplanar set of electrodes on one plate and single electrode on other plate, two plates with electrodes arrays on both plates, two plates with non-coplanar set of electrodes on both plates, or any combination thereof. An open configuration may include an array with a set of electrodes and no opposing electrodes. An electrode array may be one or more electrodes. An electrode array may be embedded within another material. An array may be an electrowetting device. The array may be accessed at any time. The biological sample or droplet may be accessed at any time. The array, biological sample, droplet, or any combination thereof may be accessed by user or by a component of the array. The array, biological sample, droplet, or any combination thereof may be accessed by user or by a component of the array at any time. An open electrode array may allow access of samples from any angle without requiring the removal of a top plate. An open electrode array may have less friction than a closed array. An open array may allow for faster and more complete mixing due to the three dimensional nature of sample mixing.

In an open configuration, the array may include a plurality of electrodes in a substrate. The plurality of electrodes may be coplanar. Alternatively, subsets of the plurality of electrodes may not be coplanar. The array may not include any opposing electrode (i.e., a surface of the array may be open and not include an opposing plate). Alternatively, at least a portion of the array may include an opposing plate. The opposing plate may include one or more electrodes.

The plurality of biological samples may be processed using an electric force. The plurality of biological samples may be processed using an electric field. The plurality of biological samples may be processed using a force field. The plurality of biological samples may be processed by combining a force field with an electric field. The force field may be generated by fluid flow on the array or vibration of the array in which the force field or force may be selected from the group consisting of acoustic waves, vibrations, air pressure, light field (or electromagnetic field), magnetic field, gravitational field, centrifugal force, hydrodynamic force, electrophoretic force, dielectrowetting force, and capillary force. The force field may be a combination of two or more of the members of the group.

The plurality of biological samples may be processed with no more than 4, 3, 2, or 1 pipetting operation(s). For example, for two pipetting operations, the plurality of droplets may be deposited adjacent to the array using a pipette, processed on the array, and processed droplets may be removed from the array using another pipetting operation.

The array may comprise a plurality of sensors. The plurality of sensors may be used to measure signals from the plurality of droplets or the derivatives thereof before, during, or subsequent to the processing of the plurality of biological samples. The plurality of sensors may comprise an impedance sensor, a capacitance sensor (e.g., touchscreen), a pH sensor, a temperature sensor, an optical sensor, a camera (e.g., charged-coupled device (CCD) camera), a current measurement sensor, an electronic sensor for biomolecular detection, an x-ray sensor, electrochemical sensors, electrochemiluminescent sensors, piezoelectric sensors, or any combination thereof. The plurality of sensors may be used to detect contamination. The plurality of sensors may be used to detect biological materials (e.g., cells, tissue, nucleic acids, proteins, peptides), chemical materials (e.g., nanoparticles, beads, small-molecules), or a combination thereof.

The array may use the plurality of sensors in a feedback loop to regulate one or more parameters of the array while processing the plurality of biological samples. The plurality of sensors and feedback loop may be used to discover and optimize reaction conditions autonomously (e.g., without any user input). The plurality of sensors may be directly coupled to at least one droplet, such as directly in contact with the droplet or in contact with the droplet through one or more intervening layers (e.g., a dielectric layer).

The array may have the intake of at least one sensor directed towards at least one droplet. For example, for an optical sensor, a fiber optic may be directed towards at least one droplet. The fiber optic may then be coupled to a monochrometer with an attached CCD camera. This example may be used to determine the absorption or fluorescence spectrum of at least one droplet for the duration of the processing.

The temperature sensor may be a thermocouple. As an alternative, the temperature sensor may be an infrared (IR) temperature sensor.

The optical sensor may be a CCD camera or a photomultiplier tube. The optical sensor may have attached optics such as a monochrometer, one or more filters, or a series of lenses. The camera may be a camera with a fast refresh rate that may be used to capture the contact angle of one or more droplets. The camera may be a monochrome camera or a color camera. The current measurement sensor may have electrodes that may be used to interface with at least one droplet. The current sensor may be contactless. The electronic sensor for biomolecular detection may be based on enzymes or graphene. The x-ray sensor may be an x-ray diffraction instrument. The x-ray sensor may be an x-ray fluorescence detector.

The biological material detected using a sensor of the plurality of sensors may be, for example, a fluorescent protein, an antibody, an enzyme, a nucleic acid pair, or a combination of two or more biological materials. The cells detected using a sensor of the plurality of sensors may be, for example, prokaryotic cells, eukaryotic cells, or cells for the detection of toxins. The tissues detected using a sensor of the plurality of sensors may be, for example, any tissue (e.g., brain, skin, muscle, heart, lung, etc.) isolated from a subject or patient. The chemical materials detected using a sensor of the plurality of sensors may be, for example, fluorescent chemicals, chemicals with strong binding towards metals, or chemicals that undergo a transformation in the presence of an object of interest (e.g., a bicarbonate salt that is converted to CO₂ gas in the presence of an acid).

The biological materials as a sensor may be a fluorescent protein, an antibody, an enzyme, a nucleic acid pair, or a combination of two or more biological materials. The cells as sensors may be prokaryotic cells, eukaryotic cells, or cells for the detection of toxins. The tissues as sensors may be muscle fibers. The chemical materials as sensors may be fluorescent chemicals, chemicals with strong binding towards metals, or chemicals that undergo a transformation in the presence of an object of interest (e.g., a bicarbonate salt that is converted to CO₂ gas in the presence of an acid). In some embodiments, biomolecules (e.g., proteins/nucleic acids) are used as sensing elements in a sensor in order to detect, for example, target biomolecules or relevant analytes.

The electrochemical sensor may be an electrochemical gas sensor. The electrochemiluminescent sensor may be tris(bipyridine) ruthenium (II) chloride, a quantum dot, or a nanoparticle. The piezoelectric sensor may be used to detect pressure, acceleration, temperature, strain, force, or any combination thereof. The piezoelectric sensor may be made of a piezoelectric ceramic or a single crystal. The nucleic acid as a sensor may utilize a complimentary set of base pairs to a nucleic acid of interest. The nucleic acid as a sensor may be DNA or RNA. The nucleic acid as a sensor may be free in solution or associated with a substrate. The protein as a sensor may be an enzyme. The protein as a sensor may be fluorescent. The protein as a sensor may be free in solution or associated with a substrate. The nanoparticle sensors may be fluorescent, magnetic, or any combination of the two. The small molecule sensor may detect metals. The small molecule sensors may be fluorescent. The metals may be zinc, copper, iron, cobalt, mercury, silver, gold, manganese, chromium, nickel, or a combination thereof.

The at least one sensor of the plurality of sensors can measure location, droplet volume, presence of biological material, activity of biological material, droplet velocity, kinematics, droplet radius, droplet shape, droplet height, color, surface area, contact angle, reaction state, emittance, absorbance, or any combination thereof. A measurement of at least one sensor of the plurality of sensors may be used to further process at least one droplet, biological sample, or a combination thereof of the plurality of droplets, the plurality of biological samples, or a combination thereof. The further processing may comprise giving a command to actuate inputs, outputs, or a combination thereof adjacent to or on, or a combination thereof, the array in real time. The command may provide instructions to correct an error of the array. The error may be an error in location, droplet volume, presence of biological material, activity of biological material, droplet velocity, droplet kinetics, droplet radius, droplet shape, droplet height, color, surface area, contact angle, reaction state, emittance, absorbance, or any combination thereof.

The location may be of a droplet, a reagent, a biological sample, a component of the array, a position of the array, an area of the array, an area adjacent to the array, a point of the array, or any combination thereof. The location may be corrected by at least 0.001%, 0.01%, 0.1%, 1%, 5%, 10%, 15%, 20%, 30%, 40%, 50%, 60%, 70%, 80%, 90%, 95%, 99%, or more. The location may be corrected by at most 99%, 95%, 90%, 80%, 70%, 60%, 50%, 40%, 30%, 20%, 15%, 10%, 5%, 1%, 0.1%, 0.01%, 0.001%, or less. The location may be corrected from 0.001% to 20%, 0.01% to 10%, 0.01% to 5%, or 0.1% to 1%.

The droplet volume may comprise a volume of at least 1 picoliter (pL), 10 pL, 100 pL, 1 nanoliter (nL), 10 nL, 100 nL, 1 μL, 10 μL, 100 μL, 1 milliliter (mL), 10 mL or more. The droplet volume may comprise a volume of at most 10 mL, 1 mL, 100 μL, 10 μL, 1 μL, 100 nL, 10 nL, 1 nL, 100 pL, 10 pL, 1 pL, or less. The droplet volume may be corrected by at least 0.001%, 0.01%, 0.1%, 1%, 5%, 10%, 15%, 20%, 30%, 40%, 50%, 60%, 70%, 80%, 90%, 95%, 99%, or more. The droplet volume may be corrected by at most 99%, 95%, 90%, 80%, 70%, 60%, 50%, 40%, 30%, 20%, 15%, 10%, 5%, 1%, 0.1%, 0.01%, 0.001%, or less. The droplet volume may be corrected from 0.001% to 20%, 0.01% to 10%, 0.01% to 5%, or 0.1% to 1%. In some embodiments, a droplet is replenished if the volume of the droplet falls below a predetermined threshold. In some embodiments, the predetermined threshold may be a volume of at least 1 picoliter (pL), 10 pL, 100 pL, 1 nanoliter (nL), 10 nL, 100 nL, 1 μL, 10 μL, 100 μL, 1 milliliter (mL), 10 mL or more. In some embodiments, the predetermined threshold may be a volume at most 10 mL, 1 mL, 100 μL, 10 μL, 1 μL, 100 nL, 10 nL, 1 nL, 100 pL, 10 pL, 1 pL, or less. In some embodiments, a droplet is reduced if the volume of the droplet exceeds a predetermined threshold. In some embodiments, the predetermined threshold may be a volume of at least 1 picoliter (pL), 10 pL, 100 pL, 1 nanoliter (nL), 10 nL, 100 nL, 1 μL, 10 μL, 100 μL, 1 milliliter (mL), 10 mL or more. In some embodiments, the predetermined threshold may be a volume at most 10 mL, 1 mL, 100 μL, 10 μL, 1 μL, 100 nL, 10 nL, 1 nL, 100 pL, 10 pL, 1 pL, or less.

A biological sample may comprise a nucleic acid, protein, cell, salt, buffer, or enzyme, wherein said droplet comprises one or more reagents for nucleic acid isolation, cell isolation, protein isolation, peptide purification, isolation or purification of a biopolymer, immunoprecipitation, in vitro diagnostics, exosome isolation, cell activation, cell expansion, or isolation of a specific biomolecule, and wherein said droplet is manipulated by said reagents to perform said nucleic acid isolation, cell isolation, protein isolation, peptide purification, isolation or purification of a biopolymer, immunoprecipitation, in vitro diagnostics, exosome isolation, cell activation, cell expansion, or isolation of a specific biomolecule. The presence of the biological sample may be corrected by an amount of at least 0.001%, 0.01%, 0.1%, 1%, 5%, 10%, 15%, 20%, 30%, 40%, 50%, 60%, 70%, 80%, 90%, 95%, 99%, or more. The presence of the biological sample may be corrected by an amount of at most 99%, 95%, 90%, 80%, 70%, 60%, 50%, 40%, 30%, 20%, 15%, 10%, 5%, 1%, 0.1%, 0.01%, 0.001%, or less. The presence of the biological sample may be corrected by an amount from 0.001% to 20%, 0.01% to 10%, 0.01% to 5%, or 0.1% to 1%.

The activity of biological material may comprise enzymatic activity, cellular activity, small-molecule activity, reagent activity, wherein the activity may be a measure of affinity, specificity, reactivity, rate, inhibition, toxicity (e.g., IC₅₀, LD₅₀, EC₅₀, ED₅₀, GI₅₀, etc.), or any combination thereof. The activity of the biological sample may be corrected by an amount of at least 0.001%, 0.01%, 0.1%, 1%, 5%, 10%, 15%, 20%, 30%, 40%, 50%, 60%, 70%, 80%, 90%, 95%, 99%, or more. The activity of the biological sample may be corrected by an amount of at most 99%, 95%, 90%, 80%, 70%, 60%, 50%, 40%, 30%, 20%, 15%, 10%, 5%, 1%, 0.1%, 0.01%, 0.001%, or less. The activity of the biological sample may be corrected by an amount from 0.001% to 20%, 0.01% to 10%, 0.01% to 5%, or 0.1% to 1%.

In some embodiments, the droplet has a viscosity of about 0% glycerol to about 60% glycerol at room temperature (˜25° C.). In some embodiments, the droplet has a viscosity of about 0% glycerol to about 10% glycerol, about 0% glycerol to about 15% glycerol, about 0% glycerol to about 20% glycerol, about 0% glycerol to about 25% glycerol, about 0% glycerol to about 30% glycerol, about 0% glycerol to about 35% glycerol, about 0% glycerol to about 40% glycerol, about 0% glycerol to about 45% glycerol, about 0% glycerol to about 50% glycerol, about 0% glycerol to about 55% glycerol, about 0% glycerol to about 60% glycerol, about 10% glycerol to about 15% glycerol, about 10% glycerol to about 20% glycerol, about 10% glycerol to about 25% glycerol, about 10% glycerol to about 30% glycerol, about 10% glycerol to about 35% glycerol, about 10% glycerol to about 40% glycerol, about 10% glycerol to about 45% glycerol, about 10% glycerol to about 50% glycerol, about 10% glycerol to about 55% glycerol, about 10% glycerol to about 60% glycerol, about 15% glycerol to about 20% glycerol, about 15% glycerol to about 25% glycerol, about 15% glycerol to about 30% glycerol, about 15% glycerol to about 35% glycerol, about 15% glycerol to about 40% glycerol, about 15% glycerol to about 45% glycerol, about 15% glycerol to about 50% glycerol, about 15% glycerol to about 55% glycerol, about 15% glycerol to about 60% glycerol, about 20% glycerol to about 25% glycerol, about 20% glycerol to about 30% glycerol, about 20% glycerol to about 35% glycerol, about 20% glycerol to about 40% glycerol, about 20% glycerol to about 45% glycerol, about 20% glycerol to about 50% glycerol, about 20% glycerol to about 55% glycerol, about 20% glycerol to about 60% glycerol, about 25% glycerol to about 30% glycerol, about 25% glycerol to about 35% glycerol, about 25% glycerol to about 40% glycerol, about 25% glycerol to about 45% glycerol, about 25% glycerol to about 50% glycerol, about 25% glycerol to about 55% glycerol, about 25% glycerol to about 60% glycerol, about 30% glycerol to about 35% glycerol, about 30% glycerol to about 40% glycerol, about 30% glycerol to about 45% glycerol, about 30% glycerol to about 50% glycerol, about 30% glycerol to about 55% glycerol, about 30% glycerol to about 60% glycerol, about 35% glycerol to about 40% glycerol, about 35% glycerol to about 45% glycerol, about 35% glycerol to about 50% glycerol, about 35% glycerol to about 55% glycerol, about 35% glycerol to about 60% glycerol, about 40% glycerol to about 45% glycerol, about 40% glycerol to about 50% glycerol, about 40% glycerol to about 55% glycerol, about 40% glycerol to about 60% glycerol, about 45% glycerol to about 50% glycerol, about 45% glycerol to about 55% glycerol, about 45% glycerol to about 60% glycerol, about 50% glycerol to about 55% glycerol, about 50% glycerol to about 60% glycerol, or about 55% glycerol to about 60% glycerol at room temperature (˜25° C.). In some embodiments, the droplet has a viscosity of about 0% glycerol, about 10% glycerol, about 15% glycerol, about 20% glycerol, about 25% glycerol, about 30% glycerol, about 35% glycerol, about 40% glycerol, about 45% glycerol, about 50% glycerol, about 55% glycerol, or about 60% glycerol. In some embodiments, the droplet has a viscosity of at least about 0% glycerol, about 10% glycerol, about 15% glycerol, about 20% glycerol, about 25% glycerol, about 30% glycerol, about 35% glycerol, about 40% glycerol, about 45% glycerol, about 50% glycerol, or about 55% glycerol at room temperature (˜25° C.). In some embodiments, the droplet has a viscosity of at most about 10% glycerol, about 15% glycerol, about 20% glycerol, about 25% glycerol, about 30% glycerol, about 35% glycerol, about 40% glycerol, about 45% glycerol, about 50% glycerol, about 55% glycerol, or about 60% glycerol. In some embodiments, the droplet has a viscosity of about 40% glycerol at room temperature (˜25° C.).

In some embodiments, the droplet has a viscosity of about 0.1 centipoise (cP) to about 200 cP at room temperature (˜25° C.). In some embodiments, the droplet has a viscosity of about 0.1 cP to about 1 cP, about 0.1 cP to about 2 cP, about 0.1 cP to about 5 cP, about 0.1 cP to about 10 cP, about 0.1 cP to about 30 cP, about 0.1 cP to about 50 cP, about 0.1 cP to about 70 cP, about 0.1 cP to about 100 cP, about 0.1 cP to about 150 cP, about 0.1 cP to about 200 cP, about 1 cP to about 2 cP, about 1 cP to about 5 cP, about 1 cP to about 10 cP, about 1 cP to about 30 cP, about 1 cP to about 50 cP, about 1 cP to about 70 cP, about 1 cP to about 100 cP, about 1 cP to about 150 cP, about 1 cP to about 200 cP, about 2 cP to about 5 cP, about 2 cP to about 10 cP, about 2 cP to about 30 cP, about 2 cP to about 50 cP, about 2 cP to about 70 cP, about 2 cP to about 100 cP, about 2 cP to about 150 cP, about 2 cP to about 200 cP, about 5 cP to about 10 cP, about 5 cP to about 30 cP, about 5 cP to about 50 cP, about 5 cP to about 70 cP, about 5 cP to about 100 cP, about 5 cP to about 150 cP, about 5 cP to about 200 cP, about 10 cP to about 30 cP, about 10 cP to about 50 cP, about 10 cP to about 70 cP, about 10 cP to about 100 cP, about 10 cP to about 150 cP, about 10 cP to about 200 cP, about 30 cP to about 50 cP, about 30 cP to about 70 cP, about 30 cP to about 100 cP, about 30 cP to about 150 cP, about 30 cP to about 200 cP, about 50 cP to about 70 cP, about 50 cP to about 100 cP, about 50 cP to about 150 cP, about 50 cP to about 200 cP, about 70 cP to about 100 cP, about 70 cP to about 150 cP, about 70 cP to about 200 cP, about 100 cP to about 150 cP, about 100 cP to about 200 cP, or about 150 cP to about 200 cP at room temperature (˜25° C.). In some embodiments, the droplet has a viscosity of about 0.1 cP, about 1 cP, about 2 cP, about 5 cP, about 10 cP, about 30 cP, about 50 cP, about 70 cP, about 100 cP, about 150 cP, or about 200 cP at room temperature (˜25° C.). In some embodiments, the droplet has a viscosity of at least about 0.1 cP, about 1 cP, about 2 cP, about 5 cP, about 10 cP, about 30 cP, about 50 cP, about 70 cP, about 100 cP, or about 150 cP at room temperature (˜25° C.). In some embodiments, the droplet has a viscosity of at most about 1 cP, about 2 cP, about 5 cP, about 10 cP, about 30 cP, about 50 cP, about 70 cP, about 100 cP, about 150 cP, or about 200 cP at room temperature (˜25° C.).

In some embodiments, the droplet has a viscosity of about 0% glycerol to about 30% glycerol at room temperature (˜25° C.). In some embodiments, the droplet has a viscosity of about 0% glycerol to about 5% glycerol, about 0% glycerol to about 7.5% glycerol, about 0% glycerol to about 10% glycerol, about 0% glycerol to about 12.5% glycerol, about 0% glycerol to about 15% glycerol, about 0% glycerol to about 17.5% glycerol, about 0% glycerol to about 20% glycerol, about 0% glycerol to about 22.5% glycerol, about 0% glycerol to about 25% glycerol, about 0% glycerol to about 27.5% glycerol, about 0% glycerol to about 30% glycerol, about 5% glycerol to about 7.5% glycerol, about 5% glycerol to about 10% glycerol, about 5% glycerol to about 12.5% glycerol, about 5% glycerol to about 15% glycerol, about 5% glycerol to about 17.5% glycerol, about 5% glycerol to about 20% glycerol, about 5% glycerol to about 22.5% glycerol, about 5% glycerol to about 25% glycerol, about 5% glycerol to about 27.5% glycerol, about 5% glycerol to about 30% glycerol, about 7.5% glycerol to about 10% glycerol, about 7.5% glycerol to about 12.5% glycerol, about 7.5% glycerol to about 15% glycerol, about 7.5% glycerol to about 17.5% glycerol, about 7.5% glycerol to about 20% glycerol, about 7.5% glycerol to about 22.5% glycerol, about 7.5% glycerol to about 25% glycerol, about 7.5% glycerol to about 27.5% glycerol, about 7.5% glycerol to about 30% glycerol, about 10% glycerol to about 12.5% glycerol, about 10% glycerol to about 15% glycerol, about 10% glycerol to about 17.5% glycerol, about 10% glycerol to about 20% glycerol, about 10% glycerol to about 22.5% glycerol, about 10% glycerol to about 25% glycerol, about 10% glycerol to about 27.5% glycerol, about 10% glycerol to about 30% glycerol, about 12.5% glycerol to about 15% glycerol, about 12.5% glycerol to about 17.5% glycerol, about 12.5% glycerol to about 20% glycerol, about 12.5% glycerol to about 22.5% glycerol, about 12.5% glycerol to about 25% glycerol, about 12.5% glycerol to about 27.5% glycerol, about 12.5% glycerol to about 30% glycerol, about 15% glycerol to about 17.5% glycerol, about 15% glycerol to about 20% glycerol, about 15% glycerol to about 22.5% glycerol, about 15% glycerol to about 25% glycerol, about 15% glycerol to about 27.5% glycerol, about 15% glycerol to about 30% glycerol, about 17.5% glycerol to about 20% glycerol, about 17.5% glycerol to about 22.5% glycerol, about 17.5% glycerol to about 25% glycerol, about 17.5% glycerol to about 27.5% glycerol, about 17.5% glycerol to about 30% glycerol, about 20% glycerol to about 22.5% glycerol, about 20% glycerol to about 25% glycerol, about 20% glycerol to about 27.5% glycerol, about 20% glycerol to about 30% glycerol, about 22.5% glycerol to about 25% glycerol, about 22.5% glycerol to about 27.5% glycerol, about 22.5% glycerol to about 30% glycerol, about 25% glycerol to about 27.5% glycerol, about 25% glycerol to about 30% glycerol, or about 27.5% glycerol to about 30% glycerol at room temperature (˜25° C.). In some embodiments, the droplet has a viscosity of about 0% glycerol, about 5% glycerol, about 7.5% glycerol, about 10% glycerol, about 12.5% glycerol, about 15% glycerol, about 17.5% glycerol, about 20% glycerol, about 22.5% glycerol, about 25% glycerol, about 27.5% glycerol, or about 30% glycerol at room temperature (˜25° C.). In some embodiments, the droplet has a viscosity of at least about 0% glycerol, about 5% glycerol, about 7.5% glycerol, about 10% glycerol, about 12.5% glycerol, about 15% glycerol, about 17.5% glycerol, about 20% glycerol, about 22.5% glycerol, about 25% glycerol, or about 27.5% glycerol at room temperature (˜25° C.). In some embodiments, the droplet has a viscosity of at most about 5% glycerol, about 7.5% glycerol, about 10% glycerol, about 12.5% glycerol, about 15% glycerol, about 17.5% glycerol, about 20% glycerol, about 22.5% glycerol, about 25% glycerol, about 27.5% glycerol, or about 30% glycerol at room temperature (˜25° C.).

In some embodiments, the droplet has a viscosity of about 0.5 cP to about 15 cP at room temperature (˜25° C.). In some embodiments, the droplet has a viscosity of about 0.5 cP to about 1 cP, about 0.5 cP to about 2 cP, about 0.5 cP to about 3 cP, about 0.5 cP to about 4 cP, about 0.5 cP to about 5 cP, about 0.5 cP to about 7 cP, about 0.5 cP to about 9 cP, about 0.5 cP to about 11 cP, about 0.5 cP to about 13 cP, about 0.5 cP to about 15 cP, about 1 cP to about 2 cP, about 1 cP to about 3 cP, about 1 cP to about 4 cP, about 1 cP to about 5 cP, about 1 cP to about 7 cP, about 1 cP to about 9 cP, about 1 cP to about 11 cP, about 1 cP to about 13 cP, about 1 cP to about 15 cP, about 2 cP to about 3 cP, about 2 cP to about 4 cP, about 2 cP to about 5 cP, about 2 cP to about 7 cP, about 2 cP to about 9 cP, about 2 cP to about 11 cP, about 2 cP to about 13 cP, about 2 cP to about 15 cP, about 3 cP to about 4 cP, about 3 cP to about 5 cP, about 3 cP to about 7 cP, about 3 cP to about 9 cP, about 3 cP to about 11 cP, about 3 cP to about 13 cP, about 3 cP to about 15 cP, about 4 cP to about 5 cP, about 4 cP to about 7 cP, about 4 cP to about 9 cP, about 4 cP to about 11 cP, about 4 cP to about 13 cP, about 4 cP to about 15 cP, about 5 cP to about 7 cP, about 5 cP to about 9 cP, about 5 cP to about 11 cP, about 5 cP to about 13 cP, about 5 cP to about 15 cP, about 7 cP to about 9 cP, about 7 cP to about 11 cP, about 7 cP to about 13 cP, about 7 cP to about 15 cP, about 9 cP to about 11 cP, about 9 cP to about 13 cP, about 9 cP to about 15 cP, about 11 cP to about 13 cP, about 11 cP to about 15 cP, or about 13 cP to about 15 cP at room temperature (˜25° C.). In some embodiments, the droplet has a viscosity of about 0.5 cP, about 1 cP, about 2 cP, about 3 cP, about 4 cP, about 5 cP, about 7 cP, about 9 cP, about 11 cP, about 13 cP, or about 15 cP at room temperature (˜25° C.). In some embodiments, the droplet has a viscosity of at least about 0.5 cP, about 1 cP, about 2 cP, about 3 cP, about 4 cP, about 5 cP, about 7 cP, about 9 cP, about 11 cP, or about 13 cP at room temperature (˜25° C.). In some embodiments, the droplet has a viscosity of at most about 1 cP, about 2 cP, about 3 cP, about 4 cP, about 5 cP, about 7 cP, about 9 cP, about 11 cP, about 13 cP, or about 15 cP at room temperature (˜25° C.).

The droplet velocity may be at least 0.0001 centimeters/second (cm/s), 0.001 cm/s, 0.01 cm/s, 0.1 cm/s, 1 cm/s, 10 cm/s, 20 cm/s, 30 cm/s, 40 cm/s, 50 cm/s, 60 cm/s, 70 cm/s, 80 cm/s, 90 cm/s, 100 cm/s, or more. The droplet velocity may be at most 100 cm/s, 90 cm/s, 80 cm/s, 70 cm/s, 60 cm/s, 50 cm/s, 40 cm/s, 30 cm/s, 20 cm/s, 10 cm/s, 1 cm/s, 0.1 cm/s, 0.01 cm/s, 0.001 cm/s, 0.0001 cm/s, or less. The droplet velocity may be from 0.0001 cm/s to 100 cm/s, 0.001 cm/s to 70 cm/s, 0.01 cm/s to 50 cm/s, 0.1 cm/s to 40 cm/s, 1 cm/s to 25 cm/s, or 1 cm/s to 10 cm/s. The droplet velocity may be corrected by an amount of at least 0.001%, 0.01%, 0.1%, 1%, 5%, 10%, 15%, 20%, 30%, 40%, 50%, 60%, 70%, 80%, 90%, 95%, 99%, or more. The droplet velocity may be corrected by an amount of at most 99%, 95%, 90%, 80%, 70%, 60%, 50%, 40%, 30%, 20%, 15%, 10%, 5%, 1%, 0.1%, 0.01%, 0.001%, or less. The droplet velocity may be corrected by an amount from 0.001% to 20%, 0.01% to 10%, 0.01% to 5%, or 0.1% to 1%.

The kinematics may comprise the motion of points of the array, the motion of objects of the array, and the motion of systems of the array. The kinematics may be of a droplet, a reagent, a liquid, a solid, a gas, or any combination thereof. The kinematics may be corrected by an amount of at least 0.001%, 0.01%, 0.1%, 1%, 5%, 10%, 15%, 20%, 30%, 40%, 50%, 60%, 70%, 80%, 90%, 95%, 99%, or more. The kinematics may be corrected by an amount of at most 99%, 95%, 90%, 80%, 70%, 60%, 50%, 40%, 30%, 20%, 15%, 10%, 5%, 1%, 0.1%, 0.01%, 0.001%, or less. The kinematics may be corrected by an amount from 0.001% to 20%, 0.01% to 10%, 0.01% to 5%, or 0.1% to 1%.

The droplet radius may be at least 0.0001 μm, 0.001 μm, 0.01 μm, 0.1 μm, 1 μm, 5 μm, 10 μm, 20 μm, 30 μm, 40 μm, 50 μm, 60 μm, 70 μm, 80 μm, 90 μm, 100 μm, 500 μm, 1000 μm, 5000 μm, 10,000 μm, 50,000 μm, 100,000 μm, or more. The droplet radius may be at most 100,000 μm, 50,000 μm, 10,000 μm, 5000 μm, 1000 μm, 500 μm, 100 μm, 90 μm, 80 μm, 70 μm, 60 μm, 50 μm, 40 μm, 30 μm, 20 μm, 10 μm, 5 μm, 1 μm, 0.1 μm, 0.01 μm, 0.001 μm, 0.0001 μm, or less. The droplet radius may be from 1000 μm to 0.0001 μm, 500 μm to 0.01 μm, or 100 μm to 1 μm. The droplet radius may be corrected by an amount of at least 0.001%, 0.01%, 0.1%, 1%, 5%, 10%, 15%, 20%, 30%, 40%, 50%, 60%, 70%, 80%, 90%, 95%, 99%, or more. The droplet radius may be corrected by an amount of at most 99%, 95%, 90%, 80%, 70%, 60%, 50%, 40%, 30%, 20%, 15%, 10%, 5%, 1%, 0.1%, 0.01%, 0.001%, or less. The droplet radius may be corrected by an amount from 0.001% to 20%, 0.01% to 10%, 0.01% to 5%, or 0.1% to 1%.

In some embodiments, a droplet is replenished if the size of the droplet falls below a predetermined threshold. In some embodiments, a droplet is reduced if the size of the droplet exceeds a predetermined threshold. In some embodiments, the predetermined threshold may be a radius of at least 0.0001 μm, 0.001 μm, 0.01 μm, 0.1 μm, 1 μm, 5 μm, 10 μm, 20 μm, 30 μm, 40 μm, 50 μm, 60 μm, 70 μm, 80 μm, 90 μm, 100 μm, 500 μm, 1000 μm, 5000 μm, 10,000 μm, 50,000 μm, 100,000 μm, or more. In some embodiments, the predetermined threshold may be a volume at most 100,000 μm, 50,000 μm, 10,000 μm, 5000 μm, 1000 μm, 500 μm, 100 μm, 90 μm, 80 μm, 70 μm, 60 μm, 50 μm, 40 μm, 30 μm, 20 μm, 10 μm, 5 μm, 1 μm, 0.1 μm, 0.01 μm, 0.001 μm, 0.0001 μm, or less.

The droplet shape may be flat, round, spherical, oblong, oval, circular, or any combination thereof. The droplet shape may be corrected to be any shape. The droplet may be corrected to be flat, round, spherical, oblong, oval, circular, or any combination thereof.

The droplet height may be at least 0.0001 μm, 0.001 μm, 0.01 μm, 0.1 μm, 1 μm, 5 μm, 10 μm, 20 μm, 30 μm, 40 μm, 50 μm, 60 μm, 70 μm, 80 μm, 90 μm, 100 μm, 500 μm, 1000 μm, 5000 μm, 10,000 μm, 50,000 μm, 100,000 μm, or more. The droplet height may be at most 100,000 μm, 50,000 μm, 10,000 μm, 5,000 μm, 1000 μm, 500 μm, 100 μm, 90 μm, 80 μm, 70 μm, 60 μm, 50 μm, 40 μm, 30 μm, 20 μm, 10 μm, 5 μm, 1 μm, 0.1 μm, 0.01 μm, 0.001 μm, 0.0001 μm, or less. The droplet height may be from 1000 μm to 0.0001 μm, 500 μm to 0.01 μm, or 100 μm to 1 μm. The droplet height may be corrected by an amount of at least 0.001%, 0.01%, 0.1%, 1%, 5%, 10%, 15%, 20%, 30%, 40%, 50%, 60%, 70%, 80%, 90%, 95%, 99%, or more. The droplet height may be corrected by an amount of at most 99%, 95%, 90%, 80%, 70%, 60%, 50%, 40%, 30%, 20%, 15%, 10%, 5%, 1%, 0.1%, 0.01%, 0.001%, or less. The droplet height may be corrected by an amount from 0.001% to 20%, 0.01% to 10%, 0.01% to 5%, or 0.1% to 1%.

The array may interface with a liquid handling unit, which the liquid handling unit may direct the plurality of droplets adjacent to the array. The liquid handling unit may be selected from the group consisting of robotic liquid handling systems, acoustic liquid dispensers, syringe pumps, inkjet nozzles, microfluidic devices, needles, diaphragm based pump dispensers, piezoelectric pumps, and other liquid dispensers. The robotic liquid handling systems may be stationary liquid dispensing platforms or be motorized for mapped liquid dispensing. The robotic liquid handling systems may have one or more tips for dispensing liquid. The acoustic liquid dispensers may dispense liquid volumes from less than 1 nanoliter (nL). The acoustic liquid dispensers may have from about 1 to 1600 wells for liquid storage. The syringe pumps may be configured to handle from 1 to 10 or more syringes in parallel. The syringe pumps may use syringes from less than 1 mL in volume to 50 mL or more. The inkjet nozzles may be fixed head or disposable head nozzles. The inkjet nozzles may comprise an array of nozzles from about 1 nozzle to 10 nozzles or more. The inkjet nozzles may be driven by piezoelectric actuators or by thermal drop creation. The microfluidic devices may comprise arrays of microfluidic channels ranging from 1 channel to 1000 or more. The microfluidic devices may be used to start a reaction before the liquid is dispensed into the droplet. The needles may range in size from less than 7 gauge to 24 gauge or more. The needles may comprise an array with a number of needles from 1 needle to 100 needles or more. The diaphragm pump may have a diaphragm made from rubber, thermoplastic, fluorinated polymer, another plastic, or any combination thereof.

The processing of the plurality of biological samples may comprise nucleic acid sequencing. The nucleic acid sequencing may comprise polymerase chain reaction (PCR). The PCR may comprise highly multiplexed PCR, quantitative PCR, droplet digital PCR, reverse transcriptase PCR, or any combination thereof. The highly multiplexed PCR may be a single or multiple template PCR reaction. The quantitative PCR may use a variety of makers to show the PCR products in real time, such as Sybr green or the TaqMan probe. The droplet digital PCR may use initial droplets from less than 1 microliter to more than 50 microliters, and may separate those droplets into more than 10,000 droplets via a lubricant water emulsion technique. The reverse transcriptase PCR may be one step or two steps, (i.e., it may require only one droplet or multiple droplets to be completed). The reverse transcriptase PCR may utilize endpoint or real time quantification of the products, which can be done using fluorescence measurements.

The processing of the plurality of biological samples may comprise sample preparation for genomic sequencing. The preparation for genomic sequencing may involve removing DNA from a host cell, cell-free DNA, or any combination thereof. The preparation for genomic sequencing may involve amplification to provide enough DNA for sequencing. The preparation for genomic sequencing may utilize enzymatic fragmentation of the DNA, mechanical fragmentation of the DNA, or any combination thereof.

The processing of the plurality of biological samples may comprise a combinatorial assembly of genes. The combinatorial assembly of genes may comprise a Gibson Assembly, restriction enzyme cloning, gBlocks fragments assembly (IDT), BioBricks assembly, NEBuilder HiFi DNA assembly, Golden Gate assembly, site-directed mutagenesis, sequence and ligase independent cloning (SLIC), circular polymerase extension cloning (CPEC), and seamless ligation cloning extract (SLICE), topoisomerase mediated ligation, homologous recombination, Gateway cloning, GeneArt gene synthesis, or any combination thereof.

The processing of the plurality of biological samples may comprise cell-free protein expression. The cell-free protein expression may be used to express toxic proteins. The cell-free protein expression may be used to incorporate non-natural amino acids. The cell-free protein expression may utilize phosphoenol pyruvate, acetyl phosphate, creatine phosphate, or any combination thereof as an energy source. The cell-free protein expression may be done at ambient temperatures, temperatures below ambient temperature (e.g., 0° C.), temperatures above ambient temperature (e.g., 60° C.), or any combination thereof.

The processing of the plurality of biological samples may comprise preparation for plasmid DNA extraction. The preparation for plasmid DNA extraction may comprise precipitating the DNA from a lysed cell solution. The preparation for plasmid DNA extraction may comprise using a spin-column based separation technique. The preparation for plasmid DNA extraction may comprise a phenol-chloroform extraction.

The processing of the plurality of biological samples may comprise extracting ribosomes, mitochondria, endoplasmic reticulum, golgi apparatus, lysosomes, peroxisomes, centrioles, or any combination thereof. The ribosomes, mitochondria, endoplasmic reticulum, golgi apparatus, lysosomes, peroxisomes, centrioles, or any combination thereof may remain intact.

The processing of the plurality of biological samples may comprise extraction of nucleic acids from cells. The extraction of nucleic acids from cells may further comprise extracting long strands of nucleic acid, where the long strands of nucleic acid remain completely intact. The long strands of nucleic acid may also be at least 10, 100, 1,000, 10,000, 100,000, 1,000,000, or more base pairs long. The extraction of nucleic acid may involve the lysing of cells via the addition of surfactants and detergents such as octyl glucoside, sodium dodecyl sulfate, or octyl phenol ethoxylate. The extraction of nucleic acids may involve centrifugation, including ultracentrifugation.

The processing of the plurality of biological samples may comprise sample preparation for mass spectrometry. Sample preparation for mass spectrometry may involve cell lysis, digestion, protein amplification, DNA amplification, or other standard sample preparations. Sample preparation for mass spectrometry may include application of a sample to an electrospray ionization (ESI) substrate, incorporation into a matrix-assisted laser desorption ionization (MALDI) matrix, or other preparation for ionization. Mass spectrometry may include ion trap, quadrupole, and other detection methods. The inlet of the mass spectrometer may be directly coupled to at least one droplet. The inlet of the mass spectrometer may be adjacent to one or more droplets. The sample for mass spectrometry may be transferred to the inlet of the mass spectrometer by pipetting.

The processing of the plurality of biological samples may comprise sample extraction and library preparation for nucleic acid sequencing. The nucleic acid sequencing may comprise sequencing by synthesis, pyrosequencing, sequencing by hybridization, sequencing by ligation, sequencing by detection of ions released during polymerization of DNA, single-molecule sequencing, or any combination thereof. The single molecule sequencing may be nanopore sequencing. The single molecule sequencing may be single molecule real time (SMRT) sequencing.

The processing of the plurality of biological samples may comprise DNA synthesis using oligonucleotide synthesis, enzymatic synthesis, or any combination thereof. The oligonucleotide synthesis may be solid state, liquid phase, performed in solution, or any combination thereof. The oligonucleotide synthesis may produce oligonucleotides that may be at least 2, 5, 10, 20, 30, 40, 50, 100, 200, 300, 400, 500, or more nucleotides. The enzymatic synthesis may use polymerases, transferases, other enzymes, or any combination thereof.

The processing of the plurality of biological samples may comprise DNA data storage, random-access of stored DNA and DNA data retrieval through DNA sequencing. DNA data storage may utilize strands of DNA having greater than about 10, 50, 100, 150, 200, 250, 500, 1,000, 5,000, 10,000, 100,000, 1,000,000, or more base pairs. DNA sequencing may include at least one PCR reaction, a Maxam-Gilbert sequencer, a Sanger sequencer, or any combination thereof. The nucleic acid sequencing may comprise sequencing by synthesis, pyrosequencing, sequencing by hybridization, sequencing by ligation, sequencing by detection of ions released during polymerization of DNA, single-molecule sequencing, or any combination thereof. The single molecule sequencing may be nanopore sequencing. The single molecule sequencing may be single molecule real time (SMRT) sequencing.

The processing of the plurality of biological samples may comprise nucleic acid extraction and sample preparation integrated directly into a sequencer. The nucleic acid extraction and sample preparation may be performed directly on the array. The nucleic acid extraction and sample preparation may be performed adjacent to the array. The sequencer may be adjacent to the array. The sequencer may be coupled to the array. The sequencer may be directly on the array.

The processing of the plurality of biological samples may comprise CRISPR genome editing. The editing may comprise Cas9 protein, Cpf1 endonuclease, crRNA, tracrRNA, or any combination thereof. A repair DNA template may be used during the editing process. The repair DNA template may be a single-stranded oligonucleotide, double-stranded oligonucleotide, or a double-stranded DNA plasmid.

The processing of the plurality of biological samples may comprise transcription activator-like effector nucleases (TALENs) genome editing. The processing of the plurality of biological samples may comprise zinc fingers nuclease gene editing.

The processing of the plurality of biological samples may comprise at least one high-throughput process. The high-throughput process may be automated to not require input. The high-throughput process may comprise at least one of the assays or characterization methods applied to at least one of the sample types that are described herein.

The processing of the plurality of biological samples may comprise the screening of a plurality of chemical compounds against a plurality of cells. The chemical compound may be one or more chemical compounds. The chemical compound may show a biological effect. A biological effect may be the promotion or inhibition of cellular growth, the signaling of a cellular process to begin or end, the induction of cell division, or the like.

The chemical compounds may be antibacterial. Antibacterial chemicals may inhibit the growth of bacteria from at least 5% to greater than 99%. Antibacterial chemicals may kill bacteria.

The chemical compound may be screened for biological activity. The chemical compound may use the sensors of the array to determine biological activity. For example, an array of fluorescence detectors may be used to determine the relative amount of a fluorescent protein in a biological sample exposed to a chemical compound of interest. Similarly, for example, a microscope may be used to assay the total number of a cell species after exposure to a chemical compound. The chemical compound may be isolated. The isolation may involve centrifugation, transfer via pipetting or another liquid transfer technique, precipitation, a chromatographic technique (e.g., column chromatography, thin layer chromatography, etc.), distillation, lyophilization, or recrystallization. The screen for biological activity may involve mixing at least one biological sample in at least one droplet with at least one chemical.

The cells may be bacterial cells. The bacterial cells may be disease causing. The bacterial cells may be resistant to antibiotics. The bacterial cells may be genetically modified.

The cells may be eukaryotic cells. The eukaryotic cells may be single celled organisms (e.g. protozoans, algae), diatoms, fungal cells, insect cells, animal cells, mammalian cells, or human cells. The eukaryotic cells may be derived from single celled organisms (e.g. protozoans, algae), diatoms, fungi, insects, animals, mammalians, or humans. The eukaryotic cells may be derived from a larger tissue or organ. The eukaryotic cells may be genetically modified. The eukaryotic cells may be suspected of having or carrying a disease.

The cells may be prokaryotic cells. The prokaryotic cells may be genetically modified.

The processing of the plurality of biological samples may comprise culturing cells, thereby producing cultured cells. The culturing of the cells may occur in discrete droplets. The culturing of the cells may occur in discrete physical compartments. The culturing of cells may be done autonomously (with no input required). The culturing of cells may be performed on solid, liquid or semi-solid media. The culturing of cells may occur in 2 or 3 dimensions. The culturing of cells may be done under ambient or non-ambient conditions (e.g., elevated temperature, low pressure, etc.). The discrete physical compartments may be discrete electrowetting chips.

The interactions between the cultured cells or between cultured cells and at least one biological sample may be determined. The interaction of two or more samples of cultured cells may be determined by mixing. The interaction of at least one biological sample and the cultured cells may be determined by mixing, applying the cultured cells directly onto the biological sample, or applying the biological sample directly onto the cultured cells. Applying the cultured cells may involve transferring liquid cell culture or placing a solid cell culture onto the sample of interest.

The cultured cells may be assayed on the array, or the plurality of arrays as described herein.

The cultured cells may be isolated from culture. The isolation may involve centrifugation, transfer via pipetting or another liquid transfer technique, precipitation, scraping the cells off of the culture, or a chromatographic technique (e.g., cellular chromatography). The isolated cells may be transferred to an external container. The external container may be a society for biomolecular screening (SBS) format plate, a petri dish, a bottle, a box, another culture medium, or the like.

The isolated cells may be prepared for nucleic acid sequencing.

The isolated cells may be prepared for protein analysis. The protein analysis may be an amino acid analysis, size analysis, absorption analysis, the Kjeldahl method, the Dumas method, western blot analysis, high-performance liquid chromatography (HPLC) analysis, liquid chromatography-mass spectrometry (LC/MS) analysis, or enzyme-linked immunosorbent assay (ELISA) analysis.

The isolated cells may be prepared for metabolomic analysis. The metabolomic analysis may be aqueous metabolite profiling, lipid metabolite profiling, nuclear magnetic resonance spectroscopy (NMR) analysis, or a mass spectrometry analysis.

The array may comprise a plurality of lyophilized reagents, dry reagents, stored beads, or any combination thereof. The plurality of lyophilized reagents, dry reagents, stored beads, or any combination thereof may be reconstituted. The lyophilized reagents may include proteins, bacteria, microorganisms, vaccines, pharmaceuticals, molecular barcodes, oligonucleotides, primers, DNA sequences for hybridization, enzymes (e.g., glucosidase, alcohol dehydrogenase, a DNA polymerase, etc.) and dehydrated chemicals. The dry reagents may include chemical powders (e.g. salts, metal oxides, etc.), biologically derived chemicals, dry buffer chemicals, other bioactive chemicals, and the like. The stored beads may be magnetic beads, beads for the storage of bacteria, enzymes, oligonucleotides, or molecular sieves. The molecular barcodes may be DNA fragments with at least 5, 10, 20, 30, 40, 50, 60, or more base pairs. The oligonucleotides may be at least 2, 5, 10, 20, 30, 40, 50, 100, 200, 300, 400, 500, or more nucleotides. The primer may be DNA or RNA. The DNA sequences for hybridization may be used to detect small differences in nucleotide order. The DNA sequence may be used in conjunction with mismatch detection proteins.

The droplet, a plurality of droplets, derivatives thereof, or any combination thereof may be used to reconstitute the lyophilized reagents, dry reagents, stored beads, or any combination thereof. The reconstitution may solubilize, suspend, or form colloids of the lyophilized reagents, dry reagents, stored beads, or any combination thereof. The reagents may be prefabricated into a component of the array.

The array may store a plurality of reagents as a solid, liquid, gas, or any combination thereof. The array may condense, sublime, thaw, evaporate, or any combination thereof, the stored reagent. The reagent may be a compressed gas (e.g., air, argon, nitrogen, oxygen, carbon dioxide, etc.), a solvent (e.g., water, dimethyl sulfoxide, acetone, ethanol, etc.), a cleaner (e.g., ethanol, SDS, liquid soap, etc.), or a solution (e.g., a buffer, a chemical dissolved in a liquid, etc.). For an example of the array performing a physical state transformation of a stored reagent, solid carbon dioxide (dry ice) may be sublimed to provide cold carbon dioxide gas to a droplet. Another example may be for the array to boil water to introduce steam into a droplet or to clean the array.

The array may dispense a plurality of liquids. The array may use a variety of methods to dispense the plurality of liquids, such as, for example by pipetting, condensing, decanting, or any combination thereof, employing devices such as: microfluidic device, diaphragm pump, nozzle, piezoelectric pump, needle, tube, acoustic dispenser, capillary, or any combination thereof. The plurality of liquids may be from at least 2, 3, 4, 5, 6, 7, 8, 9, 10, 20, 30, 40, 50, 60, 70, 80, 90, 100, 500, 1,000, or more liquids.

The array may mix a plurality of liquids. The mixing may be performed by stirring, sonication, vibration, gas flow, bubbling, shaking, swirling, and electrowetting forces. The plurality of liquids may be from at least 2, 3, 4, 5, 6, 7, 8, 9, 10, 20, 30, 40, 50, 60, 70, 80, 90, 100, 500, 1,000, or more liquids. The liquids may be in the form of at least one droplet. The at least one droplet may be on an electrowetting array.

The processing of the plurality of biological samples may be automated (e.g., made able to be run without user input). The automation may use a program to run. The program may be a machine learning algorithm. The program may utilize a neural network. The automation may be controlled by a device. The device may be a computer, a tablet, a smartphone, or any other device capable of executing the code. The automation may interface with one or more components of the array (e.g., sensors, liquid handling devices, etc.) to perform the processing. In some embodiments, the automation may use a camera that tracks the size of a droplet on the array. When the droplet has lost sufficient volume due to evaporation, as determined by a computer vision program, the automation may instruct the liquid handling unit to dispense a precise amount of liquid to the droplet to maintain a pre-programmed volume. In this embodiment, an open configuration may allow for easier observation of the droplets.

The array may be reusable. The array may have a replaceable surface. The array may have a replaceable film. The array may have a replaceable cartridge. The replaceable cartridge may comprise a film. The film may be attached to the array. The film may be fastened to the array using vacuum. The film may be coupled to the array using an adhesive. The adhesive may be non-reactive, pressure-sensitive, contact reactive, heat reactive (e.g., anaerobic, multi-part (e.g., polyester, polyols, acrylic, etc.), pre-mixed, frozen, one-part), natural, synthetic, or any combination thereof. The adhesive may be applied by spraying, brushing, rolling, or by a film or applicator. The adhesive may be, but is not limited to, silicone, acrylic, epoxy, polyurethane, starch, cyanoacrylate, polyimide, or any combination thereof. The array may be reused from at least 2, 3, 4, 5, 6, 7, 8, 9, 10, 20, 30, 40, 50, 60, 70, 80, 90, 100, 500, 1,000, or more times. The replaceable surface may be easy to remove and reattach to the array. The replicable surface may be a layer of a liquid. The liquid may be a lubricant. The replaceable film may be a polymer (e.g., polyethylene, polytetrafluoroethylene, polydimethylsiloxane, etc.). The replaceable film may be from 1 nanometer to 1 millimeter thick. The replaceable cartridge may comprise a new electrowetting chip. The replaceable cartridge may comprise a new surface to be placed on the electrodes of an electrowetting chip.

The array may be washed. The array may be washed entirely. The array may be washed partially. The array may be washed using a material stored in the reagent dispensing array. The array may be washed using a solid cleaner (e.g., powdered soap, a solid antimicrobial, etc.), a liquid cleaner (e.g., liquid soap, ethanol, etc.), or a gaseous cleaner (e.g., steam). About 1% to 100% of the array may be washable.

The array may be disposable. The disposable array may comprise the entire sample assembly. The disposable array may comprise the surface of an electrowetting chip. The disposable array may be easily removed.

The volume of biomolecules of the array may be manipulated as a mixture. The volume of biomolecules may comprise a plurality of nucleic acids, protein sequences, or a combination thereof. The plurality of nucleic acid, protein sequences, or a combination thereof may be manipulated by modulation of local surface charge without physical contact on the mixture by another component of the array. For example, an electrowetting chip may be used to move a droplet containing a number of nucleic acids by changing the surface wetting properties of the droplet. This may allow the droplet to move without contact from another component of the array. The mixture may be within a droplet. The droplet may comprise a volume of at least 1 picoliter (pL), 10 pL, 100 pL, 1 nanoliter (nL), 10 nL, 100 nL, 1 μL, 10 μL, 100 μL, 1 milliliter (mL), 10 mL or more. The mixture may comprise a protein with DNA ligase activity. The mixture may comprise a protein with DNA transposase activity. The protein with DNA ligase activity may be derived from a virus (e.g., T4), a bacteria (e.g., E. coli), or a mammal (e.g., human DNA ligase 1). The protein with DNA transposase activity may be derived from a bacteria (e.g., Tn5) or a mammal (e.g., sleeping beauty (SB) transposase). The volume of biomolecules of the assay may be manipulated with lateral geospatial movement of the mixture of at least 1 mm. The volume of biomolecules of the assay may be manipulated by a predetermined or preprogrammed set of commands. The commands may be associated with a particular location of the array.

The array may comprise reagents for conducting a strand displacement amplification reaction, a self-sustained sequence replication and amplification reaction or a Q3 replicase amplification reaction. The reagent for conducting a strand displacement amplification reaction may be Bst DNA polymerase, cas9, or another hemiphosphorothioate form nicking protein. A self-sustained sequence replication and amplification reaction reagents may be avian myeloblastosis virus (AMV) reverse transcriptase (RT), Escherichia coli RNase H, T7 RNA polymerase, or any combination thereof. The reagents for the Q3 replicase amplification reaction may be derived from the Q3 bacteriophage, E. coli, or any combination thereof.

The array may comprise reagents including a DNA ligase, a nuclease or a restriction endonuclease. The DNA ligase may be derived from a virus (e.g., T4), a bacteria (e.g., E. coli), or a mammal (e.g., human DNA ligase 1). The nuclease may be an exonuclease (starting digestion from the end of a molecule) or an endonuclease (digesting from somewhere other than the end of a molecule). The nuclease may be a deoxyribonuclease (operating on DNA) or a ribonuclease (operating on RNA). The restriction endonuclease may be a type I, II, III, IV, or V restriction endonuclease. An example of a restriction endonuclease may be cas9 or a zinc finger nuclease.

The array may comprise reagents for the preparation of an amplified nucleic acid product. The reagents for the preparation of an amplified nucleic acid product may be Bst DNA polymerase, deoxyribonucleotide triphosphate, fragments of E. coli DNA polymerase 1, avian myeloblastosis virus reverse transcriptase, RNase H, T7 DNA dependent RNA polymerase, Taq polymerase, other DNA polymerases/transcriptases, or any combination thereof.

The array may be a component in the manufacture of a kit or system for the diagnosis or prognosis of a disease. The kit may process a biological sample. The biological sample may be a sample derived from a patient. In some embodiments, the array may be used to process a sample derived from a patient suspected of having a disease. The disease may be a disease classified by the Centers for Disease Control and Prevention (CDC). The array may mix the sample with a reagent. The array may mix the sample with a reagent for separating cells from serum. The array may process the cells, or derivatives thereof. The array may transfer cells, or derivatives thereof, to an optical device coupled to the array. The cells, or derivatives thereof, may be processed according to methods described herein.

The array may include a protein with nucleic acid cleavage activity. The array may include a biomolecule with RNA cleavage activity. The protein with nucleic acid cleavage activity may be a ribonuclease, a deoxyribonuclease, or any combination thereof. The biomolecule with RNA cleavage activity may be a small ribonucleolytic ribozyme, a large ribonucleolytic ribozyme, or any combination thereof.

An interchangeable set of reagents may be introduced by at least one solid phase support. The solid phase support may be a paper strip. The solid phase support may be a microbead. The solid phase support may be a pillar. The pillar may be attached to the base of the support or integral to the support. The solid phase support may be a strip of microwells. The solid phase support may be a glass slide, a scoop, or a plastic film. The solid phase support may be a bead. The bead may be magnetic. The interchangeable set of reagents may be chemical reagents (e.g., small molecules, metals, etc.), biological species (e.g., proteins, DNA, RNA, etc.), processing reagents (e.g., PCR reagents, etc.).

The interchangeable set of reagents may be introduced by at least one secondary support. The secondary support may be a strip of microwells. The secondary support may be a SBS plate, petri dish, bottle, slide, or another container. The interchangeable set of reagents may be chemical reagents (e.g., small molecules, metals, etc.), biological species (e.g., proteins, DNA, RNA, etc.), processing reagents (e.g., PCR reagents, etc.).

The array may contain a template independent polymerase. The template independent polymerase may be a terminal deoxynucleotidyl transferase (TdT). The array may include an enzyme that limits nucleic acid polymerization. The enzyme that limits nucleic acid polymerization may be an apyrase. The array may have sensors to detect the presence of at least one terminal ‘C’ tail in a nucleic acid molecule. The at least one terminal ‘C’ tail may be isolated. The apyrase may be derived from E. coli, S. tuberosum, or an arthropod.

The plurality of biological samples of the array may be stored by drying. The drying may be performed by heating, vacuum, flowing gas, lyophilization, or any combination thereof. The samples may be stored on the array or in another container. The other container may be a glass slide, petri dish, media bottle, tube, or (micro) well array.

The plurality of biological samples of the array may be retrieved by rehydration. The rehydration may be performed by adding liquid to or blowing a gas containing liquid over the dried plurality of biological samples. The rehydrated plurality of biological samples may be manipulated with any of the liquid handling mechanisms stated above.

The plurality of biological samples may be deposited onto the plurality of arrays in SBS format or on any random location of the plurality of arrays, thereby producing at least one deposited biological sample. The SBS format may be the dimensions of a 96 well plate. The deposited biological sample may be a solid or a liquid.

The plurality of biological samples may be deposited using commercial acoustic liquid handlers in preparation for manipulating samples on the chip. The acoustic liquid handlers may be an Echo® or an ATS Gen5®. The at least one deposited biological sample may be used for cell-free synthesis. The at least one deposited biological sample may be used for combinatorially assembling large DNA constructs. The combinatorially assembling large DNA constructs may be a Gibson assembly, circular polymerase extension cloning, and DNA Assembler method.

The processing of the plurality of biological samples may comprise at least one of the following assays, or any combination thereof: digital PCR, isothermal amplification of nucleic acids, antibody mediated detection, enzyme linked immunoassay (ELISA), electrochemical detection, colorimetric assay, fluorometric assay, and micronucleus assay.

The digital PCR assay may process droplets from at most about 1,000 microliters, 900 microliters, 800 microliters, 700 microliters, 600 microliters, 500 microliters, 400 microliters, 300 microliters, 200 microliters, 100 microliters, 50 microliters, 10 microliters, 1 microliter, 0.1 microliters, 0.01 microliters, 0.001 microliters, 0.0001 microliters, or less. The digital PCR may use initial droplets from at least about 0.0001 microliters, 0.001 microliters, 0.01 microliters, 0.1 microliters, 1 microliter, 10 microliters, 50 microliters, 100 microliters, 200 microliters, 300 microliters, 400 microliters, 500 microliters, 600 microliter, 700 microliters, 800 microliters, 900 microliters, 1,000 microliters, or more. The digital PCR may use initial droplets from about 100 microliters to about 1 microliter. The digital PCR may use initial droplets from about 50 microliters to about 1 microliter. In some embodiments, the digital PCR assay may separate a droplet, or a plurality thereof, into at least about 1, 2, 5, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, or more, droplets. The droplet, or plurality thereof, may be separated by a lubricant water emulsion technique.

The isothermal amplification of nucleic acids may be PCR, strand-displacement amplification (SDA), rolling circle amplification (RCA), loop-mediated isothermal amplification (LAMP), nucleic acid sequence based amplification (NASBA), helicase-dependent amplification (HDA), recombinase polymerase amplification (RPA), cross-priming amplification (CPA), or any combination thereof.

The antibody mediated detection may be used to detect cells, proteins, nucleic acid molecules (e.g., DNA, RNA, PNA, etc.), hormones, antibodies, small molecules, or any combination thereof. The antibody mediated detection may comprise antibodies that comprise antigen-binding sites specific to detect a cell, protein, nucleic acid, or any combination thereof. The antibody may be naturally-derived. The antibody may be a synthetic antibody. The synthetic antibody may be a recombinant antibody, a nucleic acid aptamer, a non-immunoglobulin protein scaffold, or any combination thereof.

The enzyme linked immunoassay (ELISA) may be direct, sandwich, competitive, reverse type, or any combination thereof. The ELISA may detect, quantify, or a combination thereof, substances, such as, for example, peptides, proteins, antibodies, hormones, small-molecules, or any combination thereof.

The electrochemical detection may be an oxidation- or reduction-based electrochemical detection. The oxidation- or reduction-based electrochemical detection may be conductometric, potentiometric, voltammetric, amperometric, coulometric, impedimetric, or any combination thereof. The electrochemical detection may be used to detect a cell, proteins, nucleic acids, hormones, small-molecules, antibodies, or any combination thereof. The electrochemical detection may detect electric currents generated from oxidative or reductive reactions of biological samples. The electrochemical detection may detect electric currents generated from oxidative or reductive reactions of biological samples.

The colorimetric assay may be used to detect cells, nucleic acids, proteins, small-molecules, antibodies, hormones, or any combination thereof. The colorimetric assay may be used to assay an absorption of a wavelength of at least 240 nm, 280 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1250 nm, 1500 nm, 1750 nm, 2000 nm, 2400 nm, or more. The colorimetric assay may be used to assay an absorption of a wavelength of at most 2400 nm, 2000 nm, 1750 nm, 1500 nm, 1250 nm, 1000 nm, 950 nm, 900 nm, 850 nm, 800 nm, 750 nm, 700 nm, 650 nm, 600 nm, 550 nm, 500 nm, 450 nm, 400 nm, 350 nm, 300 nm, 280 nm, 240 nm, or less. The colorimetric assay may be used to assay an absorption of a wavelength from about 2400 nm to about 240 nm. The colorimetric assay may be used to assay an absorption of a wavelength from about 1000 nm to about 100 nm. The colorimetric assay may be used to assay an absorption of a wavelength from about 900 nm to about 400 nm. The colorimetric assay may be performed on solid, liquid, or gaseous samples. The colorimetric assay may use a broadband light source (e.g., an incandescent source, an LED, etc.), a laser source, or a combination thereof. The light source may be passed through a variety of optical elements (e.g., lenses, filters, mirrors, etc.) before and after it interacts with the sample. The transmitted or reflected light may be detected (e.g., by a mirror, a fiber optic, etc.) via a charge-coupled device (CCD), a photomultiplier tube, an avalanche photodiode, or any combination thereof. The detector may be coupled to a wavelength selecting device, such as, for example, a monochrometer or a filter or set of filters.

The fluorometric assay may be used to detect cells, nucleic acids, proteins, small-molecules, antibodies, hormones, or any combination thereof. The fluorometric assay may be used to assay an absorption of a wavelength of at least 240 nm, 280 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1250 nm, 1500 nm, 1750 nm, 2000 nm, 2400 nm, or more. The fluorometric assay may be used to assay an absorption of a wavelength of at most 2400 nm, 2000 nm, 1750 nm, 1500 nm, 1250 nm, 1000 nm, 950 nm, 900 nm, 850 nm, 800 nm, 750 nm, 700 nm, 650 nm, 600 nm, 550 nm, 500 nm, 450 nm, 400 nm, 350 nm, 300 nm, 280 nm, 240 nm, or less. The fluorometric assay may be used to assay an emission of a wavelength from about 2400 nm to about 240 nm. The fluorometric assay may be used to assay an emission of a wavelength from about 1000 nm to about 100 nm. The fluorometric assay may be used to assay an emission of a wavelength from about 900 nm to about 400 nm. The fluorometric assay may use a broadband light source (e.g., an incandescent source, an LED, etc.), a laser source, or a combination thereof. The light source may be passed through a variety of optical elements (e.g., lenses, filters, mirrors, etc.) before and after it interacts with the sample. The fluoresced light may be detected via a CCD, a photomultiplier tube, an avalanche photodiode, or any combination thereof. The detector may be coupled to a wavelength selecting device, such as a monochrometer or a filter or set of filters. For example, a fluorometric assay may be used to determine the concentration of reduced NADPH, as it fluoresces in its reduced form but not in its oxidized form. In this example, the intensity of the observed fluorescence over time may correspond linearly with the amount of reduced NADPH in the sample.

The micronucleus assay may evaluate the presence of micronuclei in a biological sample. The micronuclei may contain chromosome fragments produced from DNA breakage (clastogens) or whole chromosomes produced by disruption of the mitotic apparatus (aneugens). The micronucleus assay may be used to identify genotoxic compound. The genotoxic compound may be a carcinogen. The micronucleus assay may be performed in vivo or in vitro. The in vivo micronucleus assay may utilize bone marrow or peripheral blood from a biological sample. The in vitro micronucleus assay may utilize cells or tissues derived from a plurality of biological samples.

The processing of the plurality of biological samples may comprise isothermal amplification of at least one selected nucleic acid, which may comprise: providing at least one sample that may comprise at least one nucleic acid by merging droplets containing a plurality of reagents effective to permit at least one isothermal amplification reaction of the sample without mechanical manipulation; and conducting at least one isothermal amplification reaction to amplify the nucleic acid.

The at least one isothermal amplification of at least one selected nucleic acid may be PCR, strand-displacement amplification (SDA), rolling circle amplification (RCA), loop-mediated isothermal amplification (LAMP), nucleic acid sequence based amplification (NASBA), helicase-dependent amplification (HDA), recombinase polymerase amplification (RPA), cross-priming amplification (CPA), or any combination thereof. The at least one isothermal amplification may be at least 2, 3, 4, 5, 6, 7, 8, 9, 10 or more isothermal amplifications.

The at least one nucleic acid may be at least 10, 100, 1,000, 10,000, 100,000, 1,000,000, or more base pairs long. The merging droplets may be at least 2, 3, 4, 5, 6, 7, 8, 9, 10 or more droplets. The plurality of reagents may be any of the isothermal amplification reagents described herein.

The processing of the plurality of biological samples may comprise a device to detect a polymerase chain reaction (PCR) product on at least one droplet. The droplet may be an aqueous droplet. The device may: create at least one droplet containing a plurality of nucleic acid and protein molecules on an electrowetting array; perform the PCR reaction while the aqueous droplets are present on the array surface; and interrogate the droplet with a detector. The PCR product may be DNA or RNA. The protein molecules may be enzymes, utilized in the PCR reaction, or used to report the progress of a reaction (e.g., luminescent). The performance of the PCR reaction may include agitating the sample (e.g., stirring, vibration, electrowetting based movement, etc.), heating or cooling the sample (using the aforementioned heater and cooler arrays), and controlling the droplet size. The detector may be any detector described herein.

The device may comprise a plurality of reporter molecules. The reporter molecules may be fluorescent reporter molecules. The plurality of fluorescent reporter molecules may be separated by at least one enzyme from at least one quencher molecule during the PCR reaction. The at least one enzyme may comprise a polymerase, oxidoreductase, transferase, hydrolase, lyase, isomerase, or ligase. The plurality of fluorescent reporter molecules may be a protein, a luminescent small molecule, a luminescent nucleic acid, or a nanoparticle.

The nucleic acid may be detected by a sensor. The sensor may detect a radiolabel. The sensor may detect a fluorescent label. The sensor may detect a chromophore. The sensor may detect a redox label. The sensor may be a p-n-type diffusion diode. The nucleic acid may be detected by a smartphone.

The processing of the plurality of biological samples may include binding at least one biomolecule on the array. The at least one biomolecule may be immobilized on a surface. The at least one biomolecule may be immobilized on a diffusible matrix. The at least one biomolecule may be immobilized on a diffusible bead. The at least one biomolecule may be a protein, a compound derived from a biological system (e.g., a signaling molecule, a cofactor, etc.), a pharmaceutical, a molecule exhibiting or suspected of exhibiting biological activity, a carbohydrate, lipid, a nucleic acid, a natural product, or a nutrient. The immobilization may be by adsorption, ionic interaction, covalent bonding, or intercalation. The surface may be an electrowetting chip, a polymer, a dielectric, a metal, a fiber based sheet (e.g., a paper strip), or a stationary phase (e.g., silica gel). The diffusible matrix may be a polymer, a tissue (e.g., collegian), or an aerogel. The diffusible bead may be a polymer bead, a molecular sieve, or a bead formed of biological materials (e.g., a beaded protein or nucleic acid). The location of the biomolecule may be identified by a coding scheme. The coding scheme may be a preprogrammed method to determine the location of the biomolecule. The coding scheme may be based on a moiety to which it is immobilized.

In some embodiments, detectable labels may fluorescent labels for emitting a specific wavelength. In some embodiments, the fluorescent labels emit light upon excitation by a light source. In some embodiments, the detectable labels emit light at a wavelength of 380-450 nm. In some embodiments, the detectable labels emit light at a wavelength of 450-495 nm. In some embodiments, the detectable labels emit light at a wavelength of 495-570 nm. In some embodiments, the detectable labels emit light at a wavelength of 570-590 nm. In some embodiments, the detectable labels emit light at a wavelength of 590-620 nm. In some embodiments, the detectable labels emit light at a wavelength of 620-750 nm. In some embodiments, interchangeable optical filters are utilized by a computer-vision system. In some embodiments, optical filters are used in combination with one or more optical sensors or image sensors of the computer-vision system. In some embodiments, the optical filters are provided to filter wavelengths produced by detectable labels, such that only one or more labels corresponding to samples of a particular type are to be detected or monitored by the system. In some embodiments, the system may comprise one or more optical sensors, wherein each optical sensor is provided with a specific filter to monitor a specified label corresponding to samples of a particular type, as described herein.

In some embodiments, the array may induce an interaction of the plurality of biomolecules from two or more non-continuous liquid volumes without mechanical manipulations. The interaction may be mixing, a chemical reaction, adsorption, or an enzymatic reaction. Without mechanical manipulations may mean that the moving part of the interaction may be the two or more non-continuous liquid volumes. The plurality of biomolecules may be at least one of a protein, a compound derived from a biological system (e.g., a signaling molecule, a cofactor, etc.), a pharmaceutical, a molecule exhibiting or suspected of exhibiting biological activity, a carbohydrate, lipid, a nucleic acid, a natural product, or a nutrient.

The array may prepare an amplified nucleic acid product without mechanical manipulations. The array may conduct a diagnostic test on a nucleic acid sample without mechanical manipulations. The array may conduct a diagnostic or prognostic test on a biological sample without mechanical manipulations. The plurality of biological samples may be suspected of containing a nucleic acid biomarker.

The array may comprise a gas source that contacts and may be absorbed by at least one droplet. The at least one droplet may be manipulated on the device. The gas may be air, nitrogen, argon, carbon dioxide, hydrogen, or water vapor. The at least one droplet may absorb at least 0%, 10%, 20%, 30%, 40%, 50%, 60%, 70%, 80%, 90%, 99%, or more of the gas. The manipulation may be due to the pressure the gas exerts on the at least one droplet.

The plurality of biological samples may include reagents for conducting a strand displacement amplification reaction, a self-sustained sequence replication, an amplification reaction, or a Q3 replicase amplification reaction. The reagent for conducting a strand displacement amplification reaction may be Bst DNA polymerase, cas9, or another hemiphosphorothioate form nicking protein. A self-sustained sequence replication and amplification reaction reagents may be avian myeloblastosis virus (AMV) reverse transcriptase (RT), Escherichia coli RNase H, T7 RNA polymerase, or any combination thereof. The reagents for the Q3 replicase amplification reaction may be derived from the Q3 bacteriophage, E. coli, or any combination thereof i.

The array may receive at least one instruction from a remote computer to process the array of biological samples. The at least one instruction may be at least 1, 2, 3, 4, 5, 6, 7, 8, 9, 10, 20, 30, 40, 50, 60, 70, 80, 90, 100, 200, 300, 400, 500, 600, 700, 800, 900, 1,000 or more instructions. The remote computer may be any system capable of sending instructions (e.g., a desktop computer, a laptop computer, a tablet, a smartphone, an application-specific integrated circuit, etc.). The remote computer may not require user input to send the at least one instruction.

The array may be preprogrammed to perform the process on the array of biological samples. The preprogramming may be for at least 1, 2, 3, 4, 5, 6, 7, 8, 9, 10, 20, 30, 40, 50, 60, 70, 80, 90, 100, 200, 300, 400, 500, 600, 700, 800, 900, 1,000 or more steps of the process. The preprogramming may be stored in the array (e.g., on a hard drive, on a flash memory unit, on erasable programmable read-only memory (EPROM), on a tape cassette, etc.) or stored on an attached system capable of sending instructions (e.g., a desktop computer, a laptop computer, a tablet, a smartphone, an application-specific integrated circuit, etc.).

The array may receive information related to a DNA sequence. The information related to a DNA sequence may include the length of the DNA sequence, the composition of the DNA sequence (e.g., the total number of a given base, the sequence of the bases, etc.), or the presence of a particular DNA sequence. The DNA sequence may trigger an automated process. The information related to the DNA sequence may trigger an automated process. The automated process may include conversion of the DNA sequence into at least one constituent oligonucleotide sequence. The at least one constituent oligonucleotide sequence may be assembled, error corrected, reassembled, or any combination thereof, into DNA amplicons. The DNA amplicons may direct production of RNA, proteins, biological particles, or any combination thereof. The biological particles may be derived from a virus.

The array may produce at least one peptide or antibody from a DNA template. The array may produce using in vivo methods (e.g., using cells to produce) or cell-free production (e.g., not requiring a living organism to produce). The peptide may be at least 1, 2, 3, 4, 5, 6, 7, 8, 9, 10, 15, 20, 25, 30, 35, 40, 45, 50, or more amino acids. The amino acids may be naturally occurring or non-naturally occurring. The antibody may be surface bound or free. The antibody may be derived from any of the plurality of biological samples.

The array may partition at least one droplet into a plurality of droplets by: electromotive force, electrowetting force, dielectrowetting force, dielectrophoretic effect, acoustic force, hydrophobic knife, or any combination thereof. The electrowetting force may be induced by a configuration of the array mentioned above. The dielectrophoretic effect may be photoinduced (electromagnetic radiation may be used to induce the effect). The dielectrophoretic effect may be induced by wires, sheets, electrodes, or any combination thereof created by photolithography, laser ablation, electron beam patterning, or any combination thereof. The wires, sheets, and electrodes may be made of metals (e.g., gold, copper, silver, titanium, etc.), alloys of metals, semiconductors (e.g., silicon, gallium nitride), or conductive oxides (e.g., indium tin oxide). The acoustic force may be ultrasonic. The acoustic force may be generated by a transducer. The hydrophobic knife may be a hydrophobic microtome or a hydrophobic razor blade.

The partitioning may dispense reagents. The reagents may be any of the reagents as described herein.

The partitioning may dispense samples. The samples may be a plurality of biological samples. The samples may be non-biological samples (e.g., chemicals).

The partitioned droplets may be mixed to execute a reaction. The reaction may be an amplification reaction, a chemical transformation, a binding reaction, the reaction of an antimicrobial agent with a microbe, or a reaction mentioned above.

The partitioned droplets may be analyzed using the sensors. The sensors may be any of the sensors from the array of sensors mentioned above.

The partitioned droplets may be mixed with at least one target droplet to maintain a constant volume on the at least one target droplet. The constant volume may be determined by computer vision (coupled cameras and an algorithm), mass, or optical spectroscopy (e.g., absorption spectroscopy).

The array may process multiphase fluids. The fluids may have at least 2, 3, 4, 5, 6, or more phases. For example, a droplet of water containing a colloid that is itself surrounded by a droplet of oil may have 3 phases.

The array may use dielectrophoretic forces (DEP) for cell sorting, cell separation, manipulating at least one bead, or any combination thereof. The DEP may be photoinduced (electromagnetic radiation may be used to induce the effect). The DEP may be induced by wires, sheets, electrodes, or any combination thereof created by photolithography, laser ablation, electron beam patterning, or any combination thereof. The wires, sheets, and electrodes may be made of metals (e.g., gold, copper, silver, titanium, etc.), alloys of metals, semiconductors (e.g., silicon, gallium nitride), or conductive oxides (e.g., indium tin oxide). The bead may comprise a magnetic bead, a bead for the storage of bacteria, an enzyme, an oligonucleotide, a nucleic acid, an antibody, a PCR primer, a ligand, a molecular sieve, or any combination thereof. The sorting and separation may be used for pre-concentrating at least one cell in raw clinical samples. The raw clinical samples may be derived from the plurality of biological samples. The raw clinical samples may be from a subject having or suspected of having a disease.

A biological sample, or a plurality thereof, may be deposited on an array or a plurality of arrays. The plurality of array may comprise at least two arrays. An array of the plurality of arrays may comprise a surface. The surface may comprise glass, a polymer, ceramic, metal, or any combination thereof. The surface may comprise a EWOD array, a DEW array, a DEP array, a microfluidic array, or any combination thereof. The plurality of arrays may comprise at least 2, 3, 4, 5, 6, 7, 8, 9, 10, 20, 30, 40, 50, 60, 70, 80, 90, 100, 200, 300, 400, 500, 600, 700, 800, 900, 1,000, or more arrays. The plurality of arrays may comprise most 1,000, 900, 800, 700, 600, 500, 400, 300, 200, 100, 90, 80, 70, 60, 50, 40, 30, 20, 10, 9, 8, 7, 6, 5, 4, 3, or 2 arrays. The plurality of arrays may comprise from 1,000 to 2 arrays, 500 to 2 arrays, 500 to 100 arrays, 100 to 2 arrays, 100 to 50 arrays, 50 to 2 arrays, 50 to 10 arrays, or 10 to 2 arrays. An array of the at plurality of arrays may be adjacent to another array of the plurality of arrays. The arrays may be horizontally, vertically, or diagonally adjacent.

The surface may have a thickness of at most 1,000 μm, 500 μm, 100 μm, 90 μm, 80 μm, 70 μm, 60 μm, 50 μm, 40 μm, 30 μm, 20 μm, 10 μm, 5 μm, 1 μm, 0.1 μm, 0.01 μm, or less. The surface may have a thickness of at least 0.01 μm, 0.1 μm, 1 μm, 5 μm, 10 μm, 20 μm, 30 μm, 40 μm, 50 μm, 60 μm, 70 μm, 80 μm, 90 μm, 100 μm, 500 μm, 1,000 μm, or more. The surface may have a thickness from 1,000 μm to 0.01 μm, 500 μm to 1 μm, 100 μm to 1 μm, or 50 μm to 1 μm.

The surface may have a roughness of at most 1,000 μm, 500 μm, 100 μm, 90 μm, 80 μm, 70 μm, 60 μm, 50 μm, 40 μm, 30 μm, 20 μm, 10 μm, 5 μm, 1 μm, 0.1 μm, 0.01 μm, 0.001 μm, or less. The surface may have a roughness of at least 0.001 μm, 0.01 μm, 0.1 μm, 1 μm, 5 μm, 10 μm, 20 μm, 30 μm, 40 μm, 50 μm, 60 μm, 70 μm, 80 μm, 90 μm, 100 μm, 500 μm, 1,000 μm, or more. The surface may have a roughness from 1,000 μm to 0.001 μm, 500 μm to 0.01 μm, 100 μm to 0.1 μm, or 50 μm to 0.1 μm.

The surface may comprise a layer of a liquid that has a wetting affinity characteristic for the surface. The liquid may be immiscible with a droplet or a plurality thereof. The liquid may be dispensed on the surface. An upper surface of the liquid may reduce friction between a droplet, or a plurality thereof, and the surface as compared to the droplet directly contacting the surface.

The plurality of arrays may contain a channel, a hole, or any combination thereof. The plurality of arrays may contain a plurality of channels, a plurality of holes, or any combination thereof. The channel, or plurality thereof, may traverse between at least one surface. A gas, liquid, solid, or any combination thereof may be transferred through a channel or a hole. A gas, liquid, solid, or any combination thereof may be transferred through a plurality of channels or a plurality of holes. The gas, liquid, solid, or any combination thereof may be transferred from one array to another array. The arrays may be adjacent to each other. The gas, liquid, solid, or any combination thereof may be transferred from one array to at least one other array. The gas, liquid, solid, or any combination thereof may be transferred from one array to at least two, three, four, five, six, seven, eight, nine, ten, or more arrays.

At least two droplets of the plurality of droplets may be separated by at least one membrane. The membrane may comprise metal, ceramic (e.g., aluminum oxide, silicon carbide, zirconium oxide, etc.), homogeneous films (e.g., polymers (e.g., cellulose acetate, nitrocellulose, cellulose esters, polysulfone, polyether sulfone, polyacrilonitrile, polyamide, polyimide, polyethylene, polypropylene, polytetrafluoroethylene, polyvinylidene fluoride, polyvinylchloride, etc.)), heterogeneous solids (e.g., polymeric mixes, mixed glasses, etc.), a liquid (e.g., emulsion liquid membranes, immobilized (supported), liquid membranes, molten salts, hollow-fiber contained liquid membranes, etc.), or any combination thereof. The membrane may allow passage of molecules, ions, or a combination thereof from one side of the membrane to the other. The membrane may be impermeable, semi-permeable, permeable, or a combination thereof. The permeability may separate according to size, solubility, charge, affinity, or a combination thereof. The membrane may be porous or semi-porous. The membrane may be biological, synthetic, or a combination thereof. The membrane may facilitate exchange of constituents of one droplet to another droplet. The may membrane facilitate passive diffusion, active diffusion, passive transport, active transport, or any combination thereof. The membrane may be a cation exchange membrane, a charge mosaic membrane, a bipolar membrane, an anion exchange membrane, an alkali anion exchange membrane, a proton exchange membrane, or a combination thereof. The membrane may be permanently or temporarily attached to the array, or plurality thereof.

### Synchronization

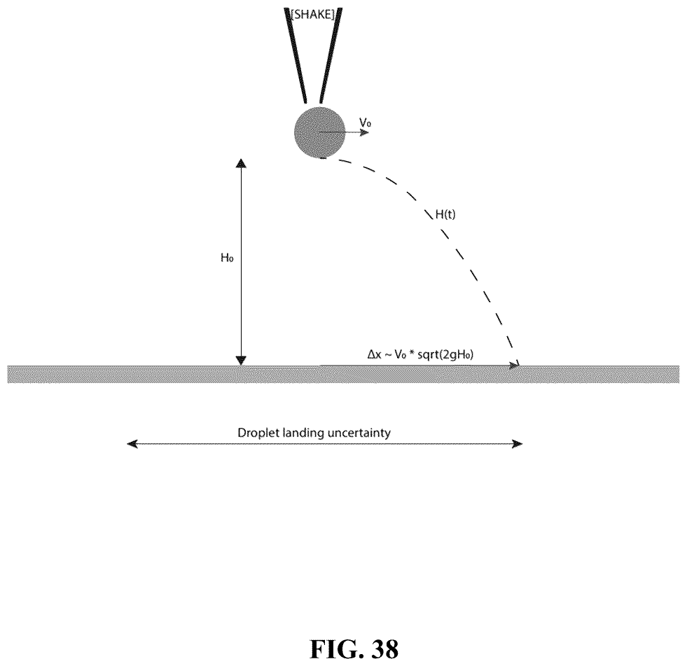

The present disclosure provides a method for droplet processing where the activity of an electrode is synchronized with the droplet processing. This may be used to minimize the uncertainty of the location of a droplet after it has been dispensed onto the substrate. This uncertainty is demonstrated in FIG. 38. The method may comprise providing a substrate comprising a discrete location. The method may further comprise providing one or more electrodes disposed adjacent to the discrete location of substrate. The method may further comprise providing a droplet dispenser disposed over the substrate. The method may further comprise activating or deactivating an electrode of the one or more electrodes, which activating or deactivating is synchronized with dispensing the droplet to the discrete location or removal of the at least the portion of the droplet from the discrete location. In some embodiments, the one or more electrodes is a plurality of electrodes. In some embodiments, the droplet dispenser comprises a droplet handling arm that moves towards or away from the substrate. In some embodiments, the droplet dispenser is used to dispense the droplet to the discrete location. In some embodiments, the droplet dispenser is used to remove at least a portion of the droplet from the discrete location.

In some embodiments, an error margin is calculated based at least in part on a difference between an intended dispensing location and an actual dispensing location of the droplet. In some embodiments, the droplet is dispensed at the discrete location at an error margin of no more than about 20 millimeters (mm), no more than about 19 mm, no more than about 18 mm, no more than about 17 mm, no more than about 16 mm, no more than about 15 mm, no more than about 14 mm, no more than about 13 mm, no more than about 12 mm, no more than about 11 mm, no more than about 10 mm, no more than about 9 mm, no more than about 8 m no more than about 7 mm, no more than about 6 mm, no more than about 5 mm, no more than about 4 mm, no more than about 3 mm, no more than about 2 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, no more than about 0.1 mm, no more than about 0.05 mm, or less. In some embodiments, the droplet is dispensed at the discrete location at an error margin of no more than 20 millimeters (mm). In some embodiments, the droplet is dispensed at the discrete location comprising the error margin of no more than about 1 mm. In some embodiments, the droplet is dispensed at the discrete location comprising an error margin of no more than about 0.1 mm.

In some embodiments, the droplet dispenser is programmed to displace itself in an oscillating motion at an amplitude of at least about 0.05 mm to at least about 20 mm during dispensation. In some embodiments, the droplet dispenser is programmed to displace itself in an oscillating motion at an amplitude of at least about 0.05 mm, at least about 0.06 mm, at least about 0.07 mm, at least about 0.08 mm, at least about 0.09 mm, at least about 0.1 mm, at least about 0.2 mm, at least about 0.3 mm, at least about 0.4 mm, at least about 0.5 mm, at least about 0.6 mm, at least about 0.7 mm, at least about 0.8 mm, at least about 0.9 mm, at least about 1 mm, at least about 2 mm, at least about 3 mm, at least about 4 mm, at least about 5 mm, at least about 6 mm, at least about 7 mm, at least about 8 mm, at least about 9 mm, at least about 10 mm, at least about 11 mm, at least about 12 mm, at least about 13 mm, at least about 14 mm, at least about 15 mm, at least about 16 mm, at least about 17 mm, at least about 18 mm, at least about 19 mm, at least about 20 mm or more. In some embodiments, the droplet dispenser is programmed to displace itself in an oscillating motion at an amplitude of at least about 0.1 mm to at least about 5 mm during dispensation. In some embodiments, the droplet dispenser is programmed to displace itself in an oscillating motion at an amplitude of at least about 0.1 mm to at least about 1 mm during dispensation.

In some embodiments, the droplet dispenser is programmed to displace itself in an oscillating motion at a frequency of at least about 0.1 Hertz (Hz) to at least about 20 kilohertz (kHz) during dispensation. In some embodiments, the droplet dispenser is programmed to displace itself in an oscillating motion at a frequency of at least about 0.1 Hz, at least about 0.2 Hz, at least about 0.3 Hz, at least about 0.4 Hz, at least about 0.5 Hz, at least about 0.6 Hz, at least about 0.7 Hz, at least about 0.8 Hz, at least about 0.9 Hz, at least about 1 Hz, at least about 2 Hz, at least about 3 Hz, at least about 4 Hz, at least about 5 Hz, at least about 6 Hz, at least about 7 Hz, at least about 8 Hz, at least about 9 Hz, at least about 10 Hz, at least about 11 Hz, at least about 12 Hz, at least about 13 Hz, at least about 14 Hz, at least about 15 Hz, at least about 16 Hz, at least about 17 Hz, at least about 18 Hz, at least about 19 Hz, at least about 20 Hz, at least about 30 Hz, at least about 40 Hz, at least about 50 Hz, at least about 60 Hz, at least about 70 Hz, at least about 80 Hz, at least about 90 Hz, at least about 100 Hz, at least about 200 Hz, at least about 300 Hz, at least about 400 Hz, at least about 500 Hz, at least about 600 Hz, at least about 700 Hz, at least about 800 Hz, at least about 900 Hz, at least about 1000 Hz, or more. In some embodiments, the droplet dispenser is programmed to displace itself in an oscillating motion at a frequency of at least about 0.1 kHz, at least about 0.2 kHz, at least about 0.3 kHz, at least about 0.4 kHz, at least about 0.5 kHz, at least about 0.6 kHz, at least about 0.7 kHz, at least about 0.8 kHz, at least about 0.9 kHz, at least about 1 kHz, at least about 2 kHz, at least about 3 kHz, at least about 4 kHz, at least about 5 kHz, at least about 6 kHz, at least about 7 kHz, at least about 8 kHz, at least about 9 kHz, at least about 10 kHz, at least about 11 kHz, at least about 12 kHz, at least about 13 kHz, at least about 14 kHz, at least about 15 kHz, at least about 16 kHz, at least about 17 kHz, at least about 18 kHz, at least about 19 kHz, at least about 20 kHz, at least about 30 kHz, at least about 40 kHz, at least about 50 kHz, at least about 60 kHz, at least about 70 kHz, at least about 80 kHz, at least about 90 kHz, at least about 100 kHz, at least about 200 kHz, at least about 300 kHz, at least about 400 kHz, at least about 500 kHz, at least about 600 kHz, at least about 700 kHz, at least about 800 kHz, at least about 900 kHz, at least about 1000 kHz or more. In some embodiments, the droplet dispenser is programmed to displace itself in an oscillating motion at a frequency of at least about 0.1 MHZ, at least about 0.2 MHZ, at least about 0.3 MHZ, at least about 0.4 MHz, at least about 0.5 MHZ, at least about 0.6 MHZ, at least about 0.7 MHz, at least about 0.8 MHz, at least about 0.9 MHZ, at least about 1 MHZ, at least about 2 MHZ, at least about 3 MHz, at least about 4 MHZ, at least about 5 MHZ, at least about 6 MHZ, at least about 7 MHz, at least about 8 MHz, at least about 9 MHZ, at least about 10 MHZ, at least about 11 MHZ, at least about 12 MHz, at least about 13 MHz, at least about 14 MHZ, at least about 15 MHz, at least about 16 MHZ, at least about 17 MHz, at least about 18 MHZ, at least about 19 MHz, at least about 20 MHz, at least about 30 MHz, at least about 40 MHz, at least about 50 MHz, at least about 60 MHz, at least about 70 MHz, at least about 80 MHZ, at least about 90 MHZ, at least about 100 MHZ, at least about 200 MHZ, at least about 300 MHz, at least about 400 MHZ, at least about 500 MHz, at least about 600 MHZ, at least about 700 MHZ, at least about 800 MHZ, at least about 900 MHZ, at least about 1000 MHz or more. In some embodiments, the droplet dispenser is programmed to displace itself in an oscillating motion at a frequency of at least about 1 Hz to at least about 20 kilohertz (kHz) during dispensation. In some embodiments, the droplet dispenser is programmed to displace itself in an oscillating motion at a frequency of at least about 1 Hz and at least about 500 Hz during dispensation. In some embodiments, the droplet dispenser is programmed to displace itself in an oscillating motion at a frequency of at least about 1 Hz and 20 Hz during dispensation.

In some embodiments, the droplet is dispensed at a height of no more than about 100 centimeters to no more than about 0.01 millimeters (mm). In some embodiments, the droplet is dispensed at a height of no more than 100 centimeters (cm), no more than about 75 cm, no more than about 30 cm, no more than about 25 cm, no more than about 20 cm, no more than about 15 cm, no more than about 10 cm, no more than about 5 cm, no more than about 1 cm, no more than about 750 mm, no more than about 500 mm, no more than about 250 mm, no more than about 200 m no more than about 150 mm, no more than about 100 mm, no more than about 75 mm, no more than about 50 mm, no more than about 25 mm, no more than about 20 mm, no more than about 10 mm, no more than about 9 mm, no more than about 8 m no more than about 7 mm, no more than about 6 mm, no more than about 5 mm, no more than about 4 mm, no more than about 3 mm, no more than about 2 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, no more than about 0.1 mm, no more than about 0.05 mm, no more than about 0.01 mm, or less. In some embodiments, the droplet is dispensed at a height of no more than 100 centimeters (cm). In some embodiments, droplet is dispensed at a height of no more than about 20 mm. In some embodiments, the droplet is dispensed at a height of no more than about 0.1 mm.

In some embodiments, the rate of manipulation (e.g., dispensation, aspiration, etc.) of the droplet on to the discrete location is no more than about 2,000 microliters per second (μL/s) to no more than about 0.01 μL/s. In some embodiments, the rate of manipulation (e.g., dispensation, aspiration, etc.) of the droplet on to the discrete location is no more than about 2,000 μL/s, no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, or no more than about 50 μL/s. not more than at most no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, no more than about 50 μL/s, or no more than about 25 μL/s, no more than about 15 μL/s, no more than about 10 μL/s, no more than about 5 μL/s, no more than about 1 μL/s, no more than about 0.75 μL/s, no more than about 0.5 μL/s, no more than about 0.25 μL/s, no more than about 0.1 μL/s, no more than about 0.05 μL/s, or no more than about 0.01 L/s. In some embodiments, the rate of manipulation (e.g., dispensation, aspiration, etc.) of the droplet on to the discrete location is no more than about 1000 μL/s. In some embodiments, the rate of manipulation (e.g., dispensation, aspiration, etc.) of the droplet on to the discrete location is no more than about 100 μL/s. In some embodiments, the rate of manipulation (e.g., dispensation, aspiration, etc.) of the droplet on to the discrete location is no more than about 0.5 L/s. In some embodiments, the rate of manipulation (e.g., dispensation, aspiration, etc.) of the droplet on to the discrete location is no more than about 0.1 μL/s.

In some embodiments, one or more electrodes are activated during the manipulation. In some embodiments, one or more electrodes are activated before the manipulation. In some embodiments, the one or more electrodes are activated after the manipulation. In some embodiments, one or more electrodes are activated in a time dependent pattern by the controller. In some embodiments, one or more electrodes are activated in an alternating checkerboard like pattern by the controller. In some embodiments, one or more electrodes are activated in a square like pattern by the controller. In some embodiments, one or more electrodes are deactivated by the controller. In some embodiments, the droplet dispenser is in an open configuration. In some embodiments, the droplet comprises at least one biological sample. In some embodiments, the manipulation is a dispensation of the droplet from the liquid handling arm. In some embodiments, the manipulation is an aspiration of the droplet from the liquid handling arm. In some embodiments, the substrate further comprises a top plate and a bottom plate. In some embodiments, the top plate has at least one hole. In some embodiments, the droplet dispenser is robotic. In some embodiments, the droplet dispenser is automated. In some embodiments, the droplet dispenser makes contact with the surface of the substrate. In some embodiments, the droplet dispenser does not make contact with the surface of the substrate. In some embodiments, the droplet dispenser is configured to motion with respect to at least three axes. In some embodiments, the droplet dispenser is configured to motion with respect to at least four axes. In some embodiments, the droplet dispenser dispenses in non-continuous volumes. In some embodiments, the droplet dispenser dispenses in continuous volumes. In some embodiments, the substrate further comprises a lubricant and/or a film. In some embodiments, the droplet dispenser does not make contact with the oil and/or film. In some embodiments, wherein the method further comprises providing a reagent reservoir adjacent to the substrate. In some embodiments, the reagent reservoir and the droplet dispenser are integrated into a single unit. In some embodiments, the reservoir and the droplet dispenser are configured to regulate temperature. In some embodiments, the reservoir or the droplet dispenser are configured to stir fluids. In some embodiments, the reservoir or the droplet dispenser are configured to agitate fluids. In some embodiments, the droplet comprises at least one biological sample, and wherein the droplet dispenser does not make contact with the biological sample. In some embodiments, the method further comprises: providing a sample droplet on an electrowetting substrate; suspending and mixing a bead in the sample droplet; introducing a magnet into the sample droplet, and moving the magnet in one or more axes while the sample droplet is held in place by the electrowetting substrate; and separating the bead from the sample droplet. In some embodiments, the droplet dispenser comprises a pipette. In some embodiments, the droplet dispenser comprises a pipette tip. In some embodiments, the droplet dispenser comprises a plurality of pipettes. In some embodiments, the droplet dispenser is connected with a tool changer. In some embodiments, the droplet dispenser is operatively connected to a motion gantry system. In some embodiments, the motion gantry system is a linear gantry. In some embodiments, the motion gantry system is a multi-axis dispensing system.

The present disclosure provides a method for droplet processing where the activity of an electrode is synchronized with a dispensing of said droplet. The method may comprise providing a substrate comprising a discrete location. The method may further comprise providing one or more electrodes disposed adjacent to the discrete location of substrate. The method may further comprise providing a droplet dispenser disposed over the substrate. The method may further comprise providing activating or deactivating an electrode of the one or more electrodes, which activating or deactivating is synchronized with dispensing the droplet to the discrete location. In some embodiments, the one or more electrodes is a plurality of electrodes. In some embodiments, the droplet dispenser comprises a droplet handling arm that moves towards or away from the substrate.

In some embodiments, an error margin is calculated based at least in part on a difference between an intended dispensing location and an actual dispensing location of the droplet. In some embodiments, the droplet is dispensed at the discrete location at an error margin of no more than about 20 millimeters (mm), no more than about 19 mm, no more than about 18 mm, no more than about 17 mm, no more than about 16 mm, no more than about 15 mm, no more than about 14 mm, no more than about 13 mm, no more than about 12 mm, no more than about 11 mm, no more than about 10 mm, no more than about 9 mm, no more than about 8 m no more than about 7 mm, no more than about 6 mm, no more than about 5 mm, no more than about 4 mm, no more than about 3 mm, no more than about 2 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, no more than about 0.1 mm, no more than about 0.05 mm, or less. In some embodiments, the droplet is dispensed at the discrete location at an error margin of no more than 20 millimeters (mm), In some embodiments, the droplet is dispensed at the discrete location comprising the error margin of no more than about 1 mm. In some embodiments, the droplet is dispensed at the discrete location comprising an error margin of no more than about 0.1 mm.

In some embodiments, the droplet dispenser is programmed to displace itself in an oscillating motion at an amplitude of at least about 0.05 mm to at least about 20 mm during dispensation. In some embodiments, the droplet dispenser is programmed to displace itself in an oscillating motion at an amplitude of at least about 0.05 mm, at least about 0.06 mm, at least about 0.07 mm, at least about 0.08 mm, at least about 0.09 mm, at least about 0.1 mm, at least about 0.2 mm, at least about 0.3 mm, at least about 0.4 mm, at least about 0.5 mm, at least about 0.6 mm, at least about 0.7 mm, at least about 0.8 mm, at least about 0.9 mm, at least about 1 mm, at least about 2 mm, at least about 3 mm, at least about 4 mm, at least about 5 mm, at least about 6 mm, at least about 7 mm, at least about 8 mm, at least about 9 mm, at least about 10 mm, at least about 11 mm, at least about 12 mm, at least about 13 mm, at least about 14 mm, at least about 15 mm, at least about 16 mm, at least about 17 mm, at least about 18 mm, at least about 19 mm, at least about 20 mm or more. In some embodiments, the droplet dispenser is programmed to displace itself in an oscillating motion at an amplitude of at least about 0.1 mm to at least about 5 mm during dispensation. In some embodiments, the droplet dispenser is programmed to displace itself in an oscillating motion at an amplitude of at least about 0.1 mm to at least about 1 mm during dispensation.

In some embodiments, the droplet dispenser is programmed to displace itself in an oscillating motion at a frequency of at least about 0.1 Hertz (Hz) to at least about 20 kilohertz (kHz) during dispensation. In some embodiments, the droplet dispenser is programmed to displace itself in an oscillating motion at a frequency of at least about 0.1 Hz, at least about 0.2 Hz, at least about 0.3 Hz, at least about 0.4 Hz, at least about 0.5 Hz, at least about 0.6 Hz, at least about 0.7 Hz, at least about 0.8 Hz, at least about 0.9 Hz, at least about 1 Hz, at least about 2 Hz, at least about 3 Hz, at least about 4 Hz, at least about 5 Hz, at least about 6 Hz, at least about 7 Hz, at least about 8 Hz, at least about 9 Hz, at least about 10 Hz, at least about 11 Hz, at least about 12 Hz, at least about 13 Hz, at least about 14 Hz, at least about 15 Hz, at least about 16 Hz, at least about 17 Hz, at least about 18 Hz, at least about 19 Hz, at least about 20 Hz, at least about 30 Hz, at least about 40 Hz, at least about 50 Hz, at least about 60 Hz, at least about 70 Hz, at least about 80 Hz, at least about 90 Hz, at least about 100 Hz, at least about 200 Hz, at least about 300 Hz, at least about 400 Hz, at least about 500 Hz, at least about 600 Hz, at least about 700 Hz, at least about 800 Hz, at least about 900 Hz, at least about 1000 Hz, or more. In some embodiments, the droplet dispenser is programmed to displace itself in an oscillating motion at a frequency of at least about 0.1 kHz, at least about 0.2 kHz, at least about 0.3 kHz, at least about 0.4 kHz, at least about 0.5 kHz, at least about 0.6 kHz, at least about 0.7 kHz, at least about 0.8 kHz, at least about 0.9 kHz, at least about 1 kHz, at least about 2 kHz, at least about 3 kHz, at least about 4 kHz, at least about 5 kHz, at least about 6 kHz, at least about 7 kHz, at least about 8 kHz, at least about 9 kHz, at least about 10 kHz, at least about 11 kHz, at least about 12 kHz, at least about 13 kHz, at least about 14 kHz, at least about 15 kHz, at least about 16 kHz, at least about 17 kHz, at least about 18 kHz, at least about 19 kHz, at least about 20 kHz, at least about 30 kHz, at least about 40 kHz, at least about 50 kHz, at least about 60 kHz, at least about 70 kHz, at least about 80 kHz, at least about 90 kHz, at least about 100 kHz, at least about 200 kHz, at least about 300 kHz, at least about 400 kHz, at least about 500 kHz, at least about 600 kHz, at least about 700 kHz, at least about 800 kHz, at least about 900 kHz, at least about 1000 kHz or more. In some embodiments, the droplet dispenser is programmed to displace itself in an oscillating motion at a frequency of at least about 0.1 MHZ, at least about 0.2 MHz, at least about 0.3 MHZ, at least about 0.4 MHZ, at least about 0.5 MHZ, at least about 0.6 MHz, at least about 0.7 MHz, at least about 0.8 MHz, at least about 0.9 MHZ, at least about 1 MHZ, at least about 2 MHZ, at least about 3 MHz, at least about 4 MHz, at least about 5 MHz, at least about 6 MHZ, at least about 7 MHz, at least about 8 MHz, at least about 9 MHZ, at least about 10 MHz, at least about 11 MHz, at least about 12 MHz, at least about 13 MHZ, at least about 14 MHZ, at least about 15 MHz, at least about 16 MHZ, at least about 17 MHz, at least about 18 MHZ, at least about 19 MHZ, at least about 20 MHZ, at least about 30 MHz, at least about 40 MHz, at least about 50 MHz, at least about 60 MHz, at least about 70 MHz, at least about 80 MHz, at least about 90 MHz, at least about 100 MHz, at least about 200 MHz, at least about 300 MHz, at least about 400 MHZ, at least about 500 MHz, at least about 600 MHZ, at least about 700 MHZ, at least about 800 MHZ, at least about 900 MHZ, at least about 1000 MHz or more. In some embodiments, the droplet dispenser is programmed to displace itself in an oscillating motion at a frequency of at least about 1 Hz to at least about 20 kilohertz (kHz) during dispensation. In some embodiments, the droplet dispenser is programmed to displace itself in an oscillating motion at a frequency of at least about 1 Hz and at least about 500 Hz during dispensation. In some embodiments, the droplet dispenser is programmed to displace itself in an oscillating motion at a frequency of at least about 1 Hz and 20 Hz during dispensation.

In some embodiments, the droplet is dispensed at a height of no more than about 100 centimeters to no more than about 0.01 millimeters (mm). In some embodiments, the droplet is dispensed at a height of no more than 100 centimeters (cm), no more than about 75 cm, no more than about 30 cm, no more than about 25 cm, no more than about 20 cm, no more than about 15 cm, no more than about 10 cm, no more than about 5 cm, no more than about 1 cm, no more than about 750 mm, no more than about 500 mm, no more than about 250 mm, no more than about 200 mm no more than about 150 mm, no more than about 100 mm, no more than about 75 mm, no more than about 50 mm, no more than about 25 mm, no more than about 20 mm, no more than about 10 mm, no more than about 9 mm, no more than about 8 m no more than about 7 mm, no more than about 6 mm, no more than about 5 mm, no more than about 4 mm, no more than about 3 mm, no more than about 2 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, no more than about 0.1 mm, no more than about 0.05 mm, no more than about 0.01 mm, or less. In some embodiments, the droplet is dispensed at a height of no more than 100 centimeters (cm). In some embodiments, droplet is dispensed at a height of no more than about 20 mm. In some embodiments, the droplet is dispensed at a height of no more than about 0.1 mm.

In some embodiments, the rate of manipulation (e.g., dispensation, aspiration, etc.) of the droplet on to the discrete location is no more than about 2,000 microliters per second (μL/s) to no more than about 0.01 μL/s. In some embodiments, the rate of manipulation (e.g., dispensation, aspiration, etc.) of the droplet on to the discrete location is no more than about 2,000 μL/s, no more than about 1,500 μL/s, no more than about 1,000 μL/s, no more than about 750 μL/s, no more than about 500 μL/s, no more than about 250 μL/s, no more than about 200 L/s, no more than about 150 μL/s, no more than about 100 μL/s, no more than about 75 μL/s, or no more than about 50 μL/s. not more than at most no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, no more than about 50 μL/s, or no more than about 25 μL/s, no more than about 15 μL/s, no more than about 10 μL/s, no more than about 5 μL/s, no more than about 1 μL/s, no more than about 0.75 μL/s, no more than about 0.5 L/s, no more than about 0.25 μL/s, no more than about 0.1 μL/s, no more than about 0.05 μL/s, or no more than about 0.01 μL/s. In some embodiments, the rate of manipulation (e.g., dispensation, aspiration, etc.) of the droplet on to the discrete location is no more than about 1000 μL/s. In some embodiments, the rate of manipulation (e.g., dispensation, aspiration, etc.) of the droplet on to the discrete location is no more than about 100 μL/s. In some embodiments, the rate of manipulation (e.g., dispensation, aspiration, etc.) of the droplet on to the discrete location is no more than about 0.5 μL/s. In some embodiments, the rate of manipulation (e.g., dispensation, aspiration, etc.) of the droplet on to the discrete location is no more than about 0.1 μL/s.

In some embodiments, one or more electrodes are activated during the manipulation. In some embodiments, one or more electrodes are activated before the manipulation. In some embodiments, the one or more electrodes are activated after the manipulation. In some embodiments, one or more electrodes are activated in a time dependent pattern by the controller. In some embodiments, one or more electrodes are activated in an alternating checkerboard like pattern by the controller. In some embodiments, one or more electrodes are activated in a square like pattern by the controller. In some embodiments, one or more electrodes are deactivated by the controller. In some embodiments, the droplet dispenser is in an open configuration. In some embodiments, the droplet comprises at least one biological sample. In some embodiments, the substrate further comprises a top plate and a bottom plate. In some embodiments, the top plate has at least one hole. In some embodiments, the droplet dispenser is robotic. In some embodiments, the droplet dispenser is automated. In some embodiments, the droplet dispenser makes contact with the surface of the substrate. In some embodiments, the droplet dispenser does not make contact with the surface of the substrate. In some embodiments, the droplet dispenser is configured to motion with respect to at least three axes. In some embodiments, the droplet dispenser is configured to motion with respect to at least four axes. In some embodiments, the droplet dispenser dispenses in non-continuous volumes. In some embodiments, the droplet dispenser dispenses in continuous volumes. In some embodiments, the substrate further comprises a lubricant and/or a film. In some embodiments, the droplet dispenser does not make contact with the oil and/or film. In some embodiments, wherein the method further comprises providing a reagent reservoir adjacent to the substrate. In some embodiments, the reagent reservoir and the droplet dispenser are integrated into a single unit. In some embodiments, the reservoir and the droplet dispenser are configured to regulate temperature. In some embodiments, the reservoir or the droplet dispenser are configured to stir fluids. In some embodiments, the reservoir or the droplet dispenser are configured to agitate fluids. In some embodiments, the droplet comprises at least one biological sample, and wherein the member does not make contact with the biological sample. In some embodiments, wherein the method further comprises: providing a sample droplet on an electrowetting substrate; suspending and mixing a bead in the sample droplet; introducing a magnet into the sample droplet, and moving the magnet in one or more axes while the sample droplet is held in place by the electrowetting substrate; and separating the bead from the sample droplet. In some embodiments, the droplet dispenser comprises a pipette. In some embodiments, the droplet dispenser comprises a pipette tip. In some embodiments, the droplet dispenser comprises a plurality of pipettes. In some embodiments, the droplet dispenser is connected with a tool changer. In some embodiments, the droplet dispenser is operatively connected to a motion gantry system. In some embodiments, the motion gantry system is a linear gantry. In some embodiments, the motion gantry system is a multi-axis dispensing system.

The present disclosure provides a method for droplet processing where the activity of an electrode is synchronized with an aspirating of said droplet. The method may comprise providing a substrate comprising a discrete location. The method may further comprise providing one or more electrodes disposed adjacent to the discrete location of substrate. The method may further comprise providing a droplet dispenser disposed over the substrate. The method may further comprise providing activating or deactivating an electrode of the one or more electrodes, which activating or deactivating is synchronized with removal of the at least the portion of the droplet from the discrete location. In some embodiments, the one or more electrodes is a plurality of electrodes. In some embodiments, the droplet dispenser comprises a droplet handling arm that moves towards or away from the substrate. In some embodiments, the droplet dispenser removes at least a portion of the droplet from the discrete location.

In some embodiments, the method reduces the offload dead volume remaining after a droplet has been aspirated. The offload dead volume may be calculated as a percentage of the droplet remaining after aspiration. In some embodiments, the offload dead volume is less than about 99%, less than about 95%, less than about 90%, less than about 80%, less than about 70%, less than about 60%, less than about 50%, less than about 40%, less than about 30%, less than about 20%, less than about 15%, less than about 10%, less than about 5%, less than about 1%, less than about 0.1%, less than about 0.01%, less than about 0.001%, or less. In some embodiments, the offload dead volume is less than 20%.

In some embodiments, the rate of manipulation (e.g., dispensation, aspiration, etc.) of the droplet on to the discrete location is no more than about 2,000 microliters per second (μL/s) to no more than about 0.01 μL/s. In some embodiments, the rate of manipulation (e.g., dispensation, aspiration, etc.) of the droplet on to the discrete location is no more than about 2,000 μL/s, no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, or no more than about 50 μL/s. not more than at most no more than about 1,500 μL/s, no more than about 1,000 L/s, no more than about 750 μL/s, no more than about 500 μL/s, no more than about 250 μL/s, no more than about 200 μL/s, no more than about 150 μL/s, no more than about 100 μL/s, no more than about 75 μL/s, no more than about 50 μL/s, or no more than about 25 μL/s, no more than about 15 μL/s, no more than about 10 μL/s, no more than about 5 μL/s, no more than about 1 μL/s, no more than about 0.75 μL/s, no more than about 0.5 L/s, no more than about 0.25 μL/s, no more than about 0.1 μL/s, no more than about 0.05 μL/s, or no more than about 0.01 μL/s. In some embodiments, the rate of manipulation (e.g., dispensation, aspiration, etc.) of the droplet on to the discrete location is no more than about 1000 μL/s. In some embodiments, the rate of manipulation (e.g., dispensation, aspiration, etc.) of the droplet on to the discrete location is no more than about 100 μL/s. In some embodiments, the rate of manipulation (e.g., dispensation, aspiration, etc.) of the droplet on to the discrete location is no more than about 0.5 μL/s. In some embodiments, the rate of manipulation (e.g., dispensation, aspiration, etc.) of the droplet on to the discrete location is no more than about 0.1 μL/s.

In some embodiments, the droplet volume may comprise a volume of at least 1 picoliter (pL), 10 pL, 100 pL, 1 nanoliter (nL), 10 nL, 100 nL, 1 μL, 10 μL, 100 μL, 1 milliliter (mL), 10 mL or more. In some embodiments, The droplet volume may comprise a volume of at most 10 mL, 1 mL, 100 μL, 10 μL, 1 μL, 100 nL, 10 nL, 1 nL, 100 pL, 10 pL, 1 pL, or less.

In some embodiments, one or more electrodes are activated during the manipulation. In some embodiments, one or more electrodes are activated before the manipulation. In some embodiments, the one or more electrodes are activated after the manipulation. In some embodiments, the one or more electrodes are activated in a time dependent pattern by the controller. In some embodiments, the one or more electrodes are activated in an alternating checkerboard like pattern by the controller. In some embodiments, the one or more electrodes are activated in a square like pattern by the controller. In some embodiments, the substrate further comprises a top plate and a bottom plate. In some embodiments, the top plate has at least one hole. In some embodiments, the droplet dispenser is robotic. In some embodiments, the droplet dispenser is automated. In some embodiments, the droplet dispenser makes contact with the surface of the substrate. In some embodiments, the droplet dispenser does not make contact with the surface of the substrate. In some embodiments, the droplet dispenser is configured to motion with respect to at least three axes. In some embodiments, the droplet dispenser is configured to motion with respect to at least four axes. In some embodiments, the droplet dispenser dispenses in non-continuous volumes. In some embodiments, the droplet dispenser dispenses in continuous volumes. In some embodiments, the substrate further comprises a lubricant and/or a film. In some embodiments, the droplet dispenser does not make contact with the oil and/or film. In some embodiments, the method further comprises providing a reagent reservoir adjacent to the substrate. In some embodiments, the reagent reservoir and the droplet dispenser are integrated into a single unit. In some embodiments, the reservoir and the droplet dispenser are configured to regulate temperature. In some embodiments, the reservoir or the droplet dispenser are configured to stir fluids. In some embodiments, the reservoir or the droplet dispenser are configured to agitate fluids. In some embodiments, the droplet comprises at least one biological sample, and wherein the droplet dispenser does not make contact with the biological sample. In some embodiments, the method further comprises: providing a sample droplet on an electrowetting substrate; suspending and mixing a bead in the sample droplet; introducing a magnet into the sample droplet, and moving the magnet in one or more axes while the sample droplet is held in place by the electrowetting substrate; and separating the bead from the sample droplet. In some embodiments, the droplet dispenser comprises a pipette. In some embodiments, the droplet dispenser comprises a pipette tip. In some embodiments, the droplet dispenser comprises a plurality of pipettes. In some embodiments, the droplet dispenser is connected with a tool changer. In some embodiments, the droplet dispenser is operatively connected to a motion gantry system. In some embodiments, the motion gantry system is a linear gantry. In some embodiments, the motion gantry system is a multi-axis dispensing system.

The present disclosure provides a method for synchronizing an activity of an electrode with a manipulation of a droplet. The method may result in a lower error margin. The method may comprise providing a substrate comprising a discrete location. The method may further comprise providing one or more electrodes disposed adjacent to the discrete location of substrate. The method may further comprise providing a droplet dispenser disposed over the substrate. The method may further comprise providing activating or deactivating an electrode of the one or more electrodes, which activating or deactivating is synchronized with manipulating the droplet, wherein the error margin, comprises the difference between the intended location for manipulation (e.g., dispensation, aspiration, etc.) of the droplet on the substrate and the actual location for manipulation of the droplet on the substrate, is no more than 20 millimeters (mm). In some embodiments, the one or more electrodes is a plurality of electrodes. In some embodiments, the droplet dispenser comprises a droplet handling arm that moves towards or away from the substrate. In some embodiments, the droplet dispenser is used to dispense the droplet at the location. In some embodiments, the droplet dispenser is used to remove at least a portion of the droplet from the discrete location. In some embodiments, the error margin is calculated based at least in part on a difference between an intended dispensing location and an actual dispensing location of the droplet. In some embodiments, the droplet is dispensed at the discrete location at an error margin of no more than about 20 millimeters (mm), no more than about 19 mm, no more than about 18 mm, no more than about 17 mm, no more than about 16 mm, no more than about 15 mm, no more than about 14 mm, no more than about 13 mm, no more than about 12 mm, no more than about 11 mm, no more than about 10 mm, no more than about 9 mm, no more than about 8 m no more than about 7 mm, no more than about 6 mm, no more than about 5 mm, no more than about 4 mm, no more than about 3 mm, no more than about 2 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, no more than about 0.1 mm, no more than about 0.05 mm, or less. In some embodiments, the droplet is dispensed at the discrete location at an error margin of no more than 20 millimeters (mm), In some embodiments, the droplet is dispensed at the discrete location comprising the error margin of no more than about 1 mm. In some embodiments, the droplet is dispensed at the discrete location comprising an error margin of no more than about 0.1 mm.

In some embodiments, the droplet dispenser is programmed to displace itself in an oscillating motion at an amplitude of at least about 0.05 mm to at least about 20 mm during dispensation. In some embodiments, the droplet dispenser is programmed to displace itself in an oscillating motion at an amplitude of at least about 0.05 mm, at least about 0.06 mm, at least about 0.07 mm, at least about 0.08 mm, at least about 0.09 mm, at least about 0.1 mm, at least about 0.2 mm, at least about 0.3 mm, at least about 0.4 mm, at least about 0.5 mm, at least about 0.6 mm, at least about 0.7 mm, at least about 0.8 mm, at least about 0.9 mm, at least about 1 mm, at least about 2 mm, at least about 3 mm, at least about 4 mm, at least about 5 mm, at least about 6 mm, at least about 7 mm, at least about 8 mm, at least about 9 mm, at least about 10 mm, at least about 11 mm, at least about 12 mm, at least about 13 mm, at least about 14 mm, at least about 15 mm, at least about 16 mm, at least about 17 mm, at least about 18 mm, at least about 19 mm, at least about 20 mm or more. In some embodiments, the droplet dispenser is programmed to displace itself in an oscillating motion at an amplitude of at least about 0.1 mm to at least about 5 mm during dispensation. In some embodiments, the droplet dispenser is programmed to displace itself in an oscillating motion at an amplitude of at least about 0.1 mm to at least about 1 mm during dispensation.

In some embodiments, the droplet dispenser is programmed to displace itself in an oscillating motion at a frequency of at least about 0.1 Hertz (Hz) to at least about 20 kilohertz (kHz) during dispensation. In some embodiments, the droplet dispenser is programmed to displace itself in an oscillating motion at a frequency of at least about 0.1 Hz, at least about 0.2 Hz, at least about 0.3 Hz, at least about 0.4 Hz, at least about 0.5 Hz, at least about 0.6 Hz, at least about 0.7 Hz, at least about 0.8 Hz, at least about 0.9 Hz, at least about 1 Hz, at least about 2 Hz, at least about 3 Hz, at least about 4 Hz, at least about 5 Hz, at least about 6 Hz, at least about 7 Hz, at least about 8 Hz, at least about 9 Hz, at least about 10 Hz, at least about 11 Hz, at least about 12 Hz, at least about 13 Hz, at least about 14 Hz, at least about 15 Hz, at least about 16 Hz, at least about 17 Hz, at least about 18 Hz, at least about 19 Hz, at least about 20 Hz, at least about 30 Hz, at least about 40 Hz, at least about 50 Hz, at least about 60 Hz, at least about 70 Hz, at least about 80 Hz, at least about 90 Hz, at least about 100 Hz, at least about 200 Hz, at least about 300 Hz, at least about 400 Hz, at least about 500 Hz, at least about 600 Hz, at least about 700 Hz, at least about 800 Hz, at least about 900 Hz, at least about 1000 Hz, or more. In some embodiments, the droplet dispenser is programmed to displace itself in an oscillating motion at a frequency of at least about 0.1 kHz, at least about 0.2 kHz, at least about 0.3 kHz, at least about 0.4 kHz, at least about 0.5 kHz, at least about 0.6 kHz, at least about 0.7 kHz, at least about 0.8 kHz, at least about 0.9 kHz, at least about 1 kHz, at least about 2 kHz, at least about 3 kHz, at least about 4 kHz, at least about 5 kHz, at least about 6 kHz, at least about 7 kHz, at least about 8 kHz, at least about 9 kHz, at least about 10 kHz, at least about 11 kHz, at least about 12 kHz, at least about 13 kHz, at least about 14 kHz, at least about 15 kHz, at least about 16 kHz, at least about 17 kHz, at least about 18 kHz, at least about 19 kHz, at least about 20 kHz, at least about 30 kHz, at least about 40 kHz, at least about 50 kHz, at least about 60 kHz, at least about 70 kHz, at least about 80 kHz, at least about 90 kHz, at least about 100 kHz, at least about 200 kHz, at least about 300 kHz, at least about 400 kHz, at least about 500 kHz, at least about 600 kHz, at least about 700 kHz, at least about 800 kHz, at least about 900 kHz, at least about 1000 kHz or more. In some embodiments, the droplet dispenser is programmed to displace itself in an oscillating motion at a frequency of at least about 0.1 MHZ, at least about 0.2 MHz, at least about 0.3 MHz, at least about 0.4 MHZ, at least about 0.5 MHZ, at least about 0.6 MHz, at least about 0.7 MHz, at least about 0.8 MHz, at least about 0.9 MHZ, at least about 1 MHZ, at least about 2 MHZ, at least about 3 MHz, at least about 4 MHZ, at least about 5 MHZ, at least about 6 MHZ, at least about 7 MHz, at least about 8 MHz, at least about 9 MHZ, at least about 10 MHz, at least about 11 MHz, at least about 12 MHz, at least about 13 MHz, at least about 14 MHZ, at least about 15 MHZ, at least about 16 MHz, at least about 17 MHZ, at least about 18 MHZ, at least about 19 MHz, at least about 20 MHz, at least about 30 MHz, at least about 40 MHz, at least about 50 MHz, at least about 60 MHz, at least about 70 MHz, at least about 80 MHZ, at least about 90 MHz, at least about 100 MHz, at least about 200 MHZ, at least about 300 MHz, at least about 400 MHz, at least about 500 MHz, at least about 600 MHZ, at least about 700 MHz, at least about 800 MHZ, at least about 900 MHZ, at least about 1000 MHz or more. In some embodiments, the droplet dispenser is programmed to displace itself in an oscillating motion at a frequency of at least about 1 Hz to at least about 20 kilohertz (kHz) during dispensation. In some embodiments, the droplet dispenser is programmed to displace itself in an oscillating motion at a frequency of at least about 1 Hz and at least about 500 Hz during dispensation. In some embodiments, the droplet dispenser is programmed to displace itself in an oscillating motion at a frequency of at least about 1 Hz and 20 Hz during dispensation.

In some embodiments, the droplet is dispensed at a height of no more than about 100 centimeters to no more than about 0.01 millimeters (mm). In some embodiments, the droplet is dispensed at a height of no more than 100 centimeters (cm), no more than about 75 cm, no more than about 30 cm, no more than about 25 cm, no more than about 20 cm, no more than about 15 cm, no more than about 10 cm, no more than about 5 cm, no more than about 1 cm, no more than about 750 mm, no more than about 500 mm, no more than about 250 mm, no more than about 200 m no more than about 150 mm, no more than about 100 mm, no more than about 75 mm, no more than about 50 mm, no more than about 25 mm, no more than about 20 mm, no more than about 10 mm, no more than about 9 mm, no more than about 8 m no more than about 7 mm, no more than about 6 mm, no more than about 5 mm, no more than about 4 mm, no more than about 3 mm, no more than about 2 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, no more than about 0.1 mm, no more than about 0.05 mm, no more than about 0.01 mm, or less. In some embodiments, the droplet is dispensed at a height of no more than 100 centimeters (cm). In some embodiments, droplet is dispensed at a height of no more than about 20 mm. In some embodiments, the droplet is dispensed at a height of no more than about 0.1 mm.

In some embodiments, the rate of manipulation (e.g., dispensation, aspiration, etc.) of the droplet on to the discrete location is no more than about 2,000 microliters per second (μL/s) to no more than about 0.01 μL/s. In some embodiments, the rate of manipulation (e.g., dispensation, aspiration, etc.) of the droplet on to the discrete location is no more than about 2,000 μL/s, no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, or no more than about 50 μL/s. not more than at most no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, no more than about 50 μL/s, or no more than about 25 μL/s, no more than about 15 μL/s, no more than about 10 μL/s, no more than about 5 μL/s, no more than about 1 μL/s, no more than about 0.75 μL/s, no more than about 0.5 μL/s, no more than about 0.25 μL/s, no more than about 0.1 μL/s, no more than about 0.05 μL/s, or no more than about 0.01 μL/s. In some embodiments, the rate of manipulation (e.g., dispensation, aspiration, etc.) of the droplet on to the discrete location is no more than about 1000 μL/s. In some embodiments, the rate of manipulation (e.g., dispensation, aspiration, etc.) of the droplet on to the discrete location is no more than about 100 μL/s. In some embodiments, the rate of manipulation (e.g., dispensation, aspiration, etc.) of the droplet on to the discrete location is no more than about 0.5 μL/s. In some embodiments, the rate of manipulation (e.g., dispensation, aspiration, etc.) of the droplet on to the discrete location is no more than about 0.1 μL/s.

In some embodiments, one or more electrodes are activated during the manipulation. In some embodiments, one or more electrodes are activated before the manipulation. In some embodiments, the one or more electrodes are activated after the manipulation. In some embodiments, one or more electrodes are activated in a time dependent pattern by the controller. In some embodiments, one or more electrodes are activated in an alternating checkerboard like pattern by the controller. In some embodiments, one or more electrodes are activated in a square like pattern by the controller. In some embodiments, one or more electrodes are deactivated by the controller. In some embodiments, wherein the droplet dispenser is in an open configuration. In some embodiments, wherein the droplet comprises at least one biological sample. In some embodiments, the manipulation is a dispensation of the droplet from the liquid handling arm. In some embodiments, the manipulation is an aspiration of the droplet from the liquid handling arm. In some embodiments, the substrate further comprises a top plate and a bottom plate. In some embodiments, the top plate has at least one hole. In some embodiments, the droplet dispenser is robotic. In some embodiments, the droplet dispenser is automated. In some embodiments, the droplet dispenser makes contact with the surface of the substrate. In some embodiments, the droplet dispenser does not make contact with the surface of the substrate. In some embodiments, the droplet dispenser is configured to motion with respect to at least three axes. In some embodiments, the droplet dispenser is configured to motion with respect to at least four axes. In some embodiments, the droplet dispenser dispenses in non-continuous volumes. In some embodiments, the droplet dispenser dispenses in continuous volumes. In some embodiments, the substrate further comprises a lubricant and/or a film. In some embodiments, the droplet dispenser does not make contact with the oil and/or film. In some embodiments, the method further comprises providing a reagent reservoir adjacent to the substrate. In some embodiments, the reagent reservoir and the droplet dispenser are integrated into a single unit. In some embodiments, the reservoir and the droplet dispenser are configured to regulate temperature. In some embodiments, the reservoir or the droplet dispenser are configured to stir fluids. In some embodiments, the reservoir or the droplet dispenser are configured to agitate fluids. In some embodiments, the droplet comprises at least one biological sample, and wherein the droplet dispenser does not make contact with the biological sample. In some embodiments, the method further comprises: providing a sample droplet on an electrowetting substrate; suspending and mixing a bead in the sample droplet; introducing a magnet into the sample droplet, and moving the magnet in one or more axes while the sample droplet is held in place by the electrowetting substrate; and separating the bead from the sample droplet. In some embodiments, the droplet dispenser comprises a pipette. In some embodiments, the droplet dispenser comprises a pipette tip. In some embodiments, the droplet dispenser comprises a plurality of pipettes. In some embodiments, the droplet dispenser is connected with a tool changer. In some embodiments, the droplet dispenser is operatively connected to a motion gantry system. In some embodiments, the motion gantry system is a linear gantry. In some embodiments, the motion gantry system is a multi-axis dispensing system.

The present disclosure provides a method for synchronizing an activity of an electrode with a dispensing of a droplet. The method may result in a lower error margin. The method may comprise providing a substrate comprising a discrete location. The method may further comprise providing one or more electrodes disposed adjacent to the discrete location of substrate. The method may further comprise providing a droplet dispenser disposed over the substrate. The method may further comprise providing activating or deactivating an electrode of the one or more electrodes, which activating or deactivating is synchronized with dispensing the droplet, wherein an error margin comprising the difference between an intended dispensing location and an actual dispensing location of the droplet on the substrate is no more than 20 millimeters (mm). In some embodiments, the one or more electrodes is a plurality of electrodes. In some embodiments, the droplet dispenser comprises a droplet handling arm that moves towards or away from the substrate. In some embodiments, the droplet dispenser dispenses the droplet. In some embodiments, the error margin is calculated based at least in part on a difference between an intended dispensing location and an actual dispensing location of the droplet. In some embodiments, the droplet is dispensed at the discrete location at an error margin of no more than about 20 millimeters (mm), no more than about 19 mm, no more than about 18 mm, no more than about 17 mm, no more than about 16 mm, no more than about 15 mm, no more than about 14 mm, no more than about 13 mm, no more than about 12 mm, no more than about 11 mm, no more than about 10 mm, no more than about 9 mm, no more than about 8 m no more than about 7 mm, no more than about 6 mm, no more than about 5 mm, no more than about 4 mm, no more than about 3 mm, no more than about 2 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, no more than about 0.1 mm, no more than about 0.05 mm, or less. In some embodiments, the droplet is dispensed at the discrete location at an error margin of no more than 20 millimeters (mm), In some embodiments, the droplet is dispensed at the discrete location comprising the error margin of no more than about 1 mm. In some embodiments, the droplet is dispensed at the discrete location comprising an error margin of no more than about 0.1 mm.

In some embodiments, the droplet dispenser is programmed to displace itself in an oscillating motion at an amplitude of at least about 0.05 mm to at least about 20 mm during dispensation. In some embodiments, the droplet dispenser is programmed to displace itself in an oscillating motion at an amplitude of at least about 0.05 mm, at least about 0.06 mm, at least about 0.07 mm, at least about 0.08 mm, at least about 0.09 mm, at least about 0.1 mm, at least about 0.2 mm, at least about 0.3 mm, at least about 0.4 mm, at least about 0.5 mm, at least about 0.6 mm, at least about 0.7 mm, at least about 0.8 mm, at least about 0.9 mm, at least about 1 mm, at least about 2 mm, at least about 3 mm, at least about 4 mm, at least about 5 mm, at least about 6 mm, at least about 7 mm, at least about 8 mm, at least about 9 mm, at least about 10 mm, at least about 11 mm, at least about 12 mm, at least about 13 mm, at least about 14 mm, at least about 15 mm, at least about 16 mm, at least about 17 mm, at least about 18 mm, at least about 19 mm, at least about 20 mm or more. In some embodiments, the droplet dispenser is programmed to displace itself in an oscillating motion at an amplitude of at least about 0.1 mm to at least about 5 mm during dispensation. In some embodiments, the droplet dispenser is programmed to displace itself in an oscillating motion at an amplitude of at least about 0.1 mm to at least about 1 mm during dispensation.

In some embodiments, the droplet dispenser is programmed to displace itself in an oscillating motion at a specific frequency. In some embodiments, the droplet dispenser is programmed to displace itself in an oscillating motion at a frequency of at least about 0.1 Hertz (Hz) to at least about 20 kilohertz (kHz) during dispensation. In some embodiments, the droplet dispenser is programmed to displace itself in an oscillating motion at a frequency of at least about 0.1 Hz, at least about 0.2 Hz, at least about 0.3 Hz, at least about 0.4 Hz, at least about 0.5 Hz, at least about 0.6 Hz, at least about 0.7 Hz, at least about 0.8 Hz, at least about 0.9 Hz, at least about 1 Hz, at least about 2 Hz, at least about 3 Hz, at least about 4 Hz, at least about 5 Hz, at least about 6 Hz, at least about 7 Hz, at least about 8 Hz, at least about 9 Hz, at least about 10 Hz, at least about 11 Hz, at least about 12 Hz, at least about 13 Hz, at least about 14 Hz, at least about 15 Hz, at least about 16 Hz, at least about 17 Hz, at least about 18 Hz, at least about 19 Hz, at least about 20 Hz, at least about 30 Hz, at least about 40 Hz, at least about 50 Hz, at least about 60 Hz, at least about 70 Hz, at least about 80 Hz, at least about 90 Hz, at least about 100 Hz, at least about 200 Hz, at least about 300 Hz, at least about 400 Hz, at least about 500 Hz, at least about 600 Hz, at least about 700 Hz, at least about 800 Hz, at least about 900 Hz, at least about 1000 Hz, or more. In some embodiments, the droplet dispenser is programmed to displace itself in an oscillating motion at a frequency of at least about 0.1 kHz, at least about 0.2 kHz, at least about 0.3 kHz, at least about 0.4 kHz, at least about 0.5 kHz, at least about 0.6 kHz, at least about 0.7 kHz, at least about 0.8 kHz, at least about 0.9 kHz, at least about 1 kHz, at least about 2 kHz, at least about 3 kHz, at least about 4 kHz, at least about 5 kHz, at least about 6 kHz, at least about 7 kHz, at least about 8 kHz, at least about 9 kHz, at least about 10 kHz, at least about 11 kHz, at least about 12 kHz, at least about 13 kHz, at least about 14 kHz, at least about 15 kHz, at least about 16 kHz, at least about 17 kHz, at least about 18 kHz, at least about 19 kHz, at least about 20 kHz, at least about 30 kHz, at least about 40 kHz, at least about 50 kHz, at least about 60 kHz, at least about 70 kHz, at least about 80 kHz, at least about 90 kHz, at least about 100 kHz, at least about 200 kHz, at least about 300 kHz, at least about 400 kHz, at least about 500 kHz, at least about 600 kHz, at least about 700 kHz, at least about 800 kHz, at least about 900 kHz, at least about 1000 kHz or more.

In some embodiments, the droplet dispenser is programmed to displace itself in an oscillating motion at a frequency of at least about 0.1 MHz, at least about 0.2 MHz, at least about 0.3 MHz, at least about 0.4 MHZ, at least about 0.5 MHZ, at least about 0.6 MHz, at least about 0.7 MHz, at least about 0.8 MHz, at least about 0.9 MHZ, at least about 1 MHZ, at least about 2 MHZ, at least about 3 MHZ, at least about 4 MHZ, at least about 5 MHZ, at least about 6 MHZ, at least about 7 MHz, at least about 8 MHZ, at least about 9 MHZ, at least about 10 MHz, at least about 11 MHz, at least about 12 MHz, at least about 13 MHZ, at least about 14 MHZ, at least about 15 MHz, at least about 16 MHz, at least about 17 MHz, at least about 18 MHZ, at least about 19 MHZ, at least about 20 MHz, at least about 30 MHz, at least about 40 MHz, at least about 50 MHz, at least about 60 MHz, at least about 70 MHz, at least about 80 MHz, at least about 90 MHz, at least about 100 MHZ, at least about 200 MHz, at least about 300 MHz, at least about 400 MHz, at least about 500 MHz, at least about 600 MHZ, at least about 700 MHZ, at least about 800 MHZ, at least about 900 MHZ, at least about 1000 MHz or more. In some embodiments, the droplet dispenser is programmed to displace itself in an oscillating motion at a frequency of at least about 1 Hz to at least about 20 kilohertz (kHz) during dispensation. In some embodiments, the droplet dispenser is programmed to displace itself in an oscillating motion at a frequency of at least about 1 Hz and at least about 500 Hz during dispensation. In some embodiments, the droplet dispenser is programmed to displace itself in an oscillating motion at a frequency of at least about 1 Hz and 20 Hz during dispensation.

In some embodiments, the droplet is dispensed at a height of no more than about 100 centimeters to no more than about 0.01 millimeters (mm). In some embodiments, the droplet is dispensed at a height of no more than 100 centimeters (cm), no more than about 75 cm, no more than about 30 cm, no more than about 25 cm, no more than about 20 cm, no more than about 15 cm, no more than about 10 cm, no more than about 5 cm, no more than about 1 cm, no more than about 750 mm, no more than about 500 mm, no more than about 250 mm, no more than about 200 m no more than about 150 mm, no more than about 100 mm, no more than about 75 mm, no more than about 50 mm, no more than about 25 mm, no more than about 20 mm, no more than about 10 mm, no more than about 9 mm, no more than about 8 m no more than about 7 mm, no more than about 6 mm, no more than about 5 mm, no more than about 4 mm, no more than about 3 mm, no more than about 2 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, no more than about 0.1 mm, no more than about 0.05 mm, no more than about 0.01 mm, or less. In some embodiments, the droplet is dispensed at a height of no more than 100 centimeters (cm). In some embodiments, droplet is dispensed at a height of no more than about 20 mm. In some embodiments, the droplet is dispensed at a height of no more than about 0.1 mm.

In some embodiments, the rate of manipulation (e.g., dispensation, aspiration, etc.) of the droplet on to the discrete location is no more than about 2,000 microliters per second (μL/s) to no more than about 0.01 μL/s. In some embodiments, the rate of manipulation (e.g., dispensation, aspiration, etc.) of the droplet on to the discrete location is no more than about 2,000 L/s, no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, or no more than about 50 μL/s. not more than at most no more than about 1,500 μL/s, no more than about 1,000 μL/s, no more than about 750 μL/s, no more than about 500 μL/s, no more than about 250 μL/s, no more than about 200 μL/s, no more than about 150 L/s, no more than about 100 μL/s, no more than about 75 μL/s, no more than about 50 μL/s, or no more than about 25 μL/s, no more than about 15 μL/s, no more than about 10 μL/s, no more than about 5 μL/s, no more than about 1 uL/s, no more than about 0.75 μL/s, no more than about 0.5 μL/s, no more than about 0.25 μL/s, no more than about 0.1 μL/s, no more than about 0.05 μL/s, or no more than about 0.01 μL/s. In some embodiments, the rate of manipulation (e.g., dispensation, aspiration, etc.) of the droplet on to the discrete location is no more than about 1000 μL/s. In some embodiments, the rate of manipulation (e.g., dispensation, aspiration, etc.) of the droplet on to the discrete location is no more than about 100 μL/s. In some embodiments, the rate of manipulation (e.g., dispensation, aspiration, etc.) of the droplet on to the discrete location is no more than about 0.5 μL/s. In some embodiments, the rate of manipulation (e.g., dispensation, aspiration, etc.) of the droplet on to the discrete location is no more than about 0.1 μL/s.

In some embodiments, one or more electrodes are activated during the manipulation. In some embodiments, one or more electrodes are activated before the manipulation. In some embodiments, the one or more electrodes are activated after the manipulation. In some embodiments, one or more electrodes are activated in a time dependent pattern by the controller. In some embodiments, one or more electrodes are activated in an alternating checkerboard like pattern by the controller. In some embodiments, one or more electrodes are activated in a square like pattern by the controller. In some embodiments, one or more electrodes are deactivated by the controller. In some embodiments, the droplet dispenser is in an open configuration. In some embodiments, the droplet comprises at least one biological sample. In some embodiments, the substrate further comprises a top plate and a bottom plate. In some embodiments, the top plate has at least one hole. In some embodiments, the droplet dispenser is robotic. In some embodiments, the droplet dispenser is automated. In some embodiments, the droplet dispenser makes contact with the surface of the substrate. In some embodiments, the droplet dispenser does not make contact with the surface of the substrate. In some embodiments, the droplet dispenser is configured to motion with respect to at least three axes. In some embodiments, the droplet dispenser is configured to motion with respect to at least four axes. In some embodiments, the droplet dispenser dispenses in non-continuous volumes. In some embodiments, the droplet dispenser dispenses in continuous volumes. In some embodiments, the substrate further comprises a lubricant and/or a film. In some embodiments, the droplet dispenser does not make contact with the oil and/or film. In some embodiments, the method further comprises providing a reagent reservoir adjacent to the substrate. In some embodiments, the reagent reservoir and the droplet dispenser are integrated into a single unit. In some embodiments, the reservoir and the droplet dispenser are configured to regulate temperature. In some embodiments, the reservoir or the droplet dispenser are configured to stir fluids. In some embodiments, the reservoir or the droplet dispenser are configured to agitate fluids. In some embodiments, the droplet comprises at least one biological sample, and wherein the droplet dispenser does not make contact with the biological sample. In some embodiments, the method further comprises: providing a sample droplet on an electrowetting substrate; suspending and mixing a bead in the sample droplet; introducing a magnet into the sample droplet, and moving the magnet in one or more axes while the sample droplet is held in place by the electrowetting substrate; and separating the bead from the sample droplet. In some embodiments, the droplet dispenser comprises a pipette. In some embodiments, the droplet dispenser comprises a pipette tip. In some embodiments, the droplet dispenser comprises a plurality of pipettes. In some embodiments, the droplet dispenser is connected with a tool changer. In some embodiments, the droplet dispenser is operatively connected to a motion gantry system. In some embodiments, the motion gantry system is a linear gantry. In some embodiments, the motion gantry system is a multi-axis dispensing system.

The present disclosure provides a method for synchronizing an activity of an electrode with an aspirating of a droplet. The method may result in a lower error margin. The method may comprise providing a substrate comprising a discrete location. The method may further comprise one or more electrodes disposed adjacent to the discrete location of substrate. The method may further comprise a droplet dispenser disposed over the substrate. The method may further comprise activating or deactivating an electrode of the one or more electrodes, which activating or deactivating is synchronized with removal of the at least the portion of the droplet from the discrete location, wherein an error margin comprising the difference between an intended location for the removal of the at least the portion of the droplet on the substrate and an actual location for the removal of at least a portion of the droplet on the substrate is no more than 20 millimeters (mm). In some embodiments, the one or more electrodes is a plurality of electrodes. In some embodiments, the droplet dispenser comprises a droplet handling arm that moves towards or away from the substrate. In some embodiments, the droplet dispenser removes at least a portion of the droplet from the discrete location.

The method may reduce an amount of offload dead volume after the droplet is aspirated. In some embodiments, the offload dead volume is calculated as the percentage of the original droplet remaining after aspiration. In some embodiments, the offload dead volume is less than about 99%, less than about 95%, less than about 90%, less than about 80%, less than about 70%, less than about 60%, less than about 50%, less than about 40%, less than about 30%, less than about 20%, less than about 15%, less than about 10%, less than about 5%, less than about 1%, less than about 0.1%, less than about 0.01%, less than about 0.001%, or less. In some embodiments, the offload dead volume is less than 20%.

In some embodiments, the rate of manipulation (e.g., dispensation, aspiration, etc.) of the droplet on to the discrete location is no more than about 2,000 microliters per second (μL/s) to no more than about 0.01 μL/s. In some embodiments, the rate of manipulation (e.g., dispensation, aspiration, etc.) of the droplet on to the discrete location is no more than about 2,000 μL/s, no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, or no more than about 50 μL/s. not more than at most no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, no more than about 50 μL/s, or no more than about 25 μL/s, no more than about 15 μL/s, no more than about 10 μL/s, no more than about 5 μL/s, no more than about 1 μL/s, no more than about 0.75 μL/s, no more than about 0.5 μL/s, no more than about 0.25 μL/s, no more than about 0.1 μL/s, no more than about 0.05 μL/s, or no more than about 0.01 μL/s. In some embodiments, the rate of manipulation (e.g., dispensation, aspiration, etc.) of the droplet on to the discrete location is no more than about 1000 μL/s. In some embodiments, the rate of manipulation (e.g., dispensation, aspiration, etc.) of the droplet on to the discrete location is no more than about 100 μL/s. In some embodiments, the rate of manipulation (e.g., dispensation, aspiration, etc.) of the droplet on to the discrete location is no more than about 0.5 μL/s. In some embodiments, the rate of manipulation (e.g., dispensation, aspiration, etc.) of the droplet on to the discrete location is no more than about 0.1 μL/s.

In some embodiments, one or more electrodes are activated during the manipulation. In some embodiments, one or more electrodes are activated before the manipulation. In some embodiments, the one or more electrodes are activated after the manipulation. In some embodiments, one or more electrodes are activated in a time dependent pattern by the controller. In some embodiments, one or more electrodes are activated in an alternating checkerboard like pattern by the controller. In some embodiments, one or more electrodes are activated in a square like pattern by the controller. In some embodiments, one or more electrodes are deactivated by the controller. In some embodiments, the droplet dispenser is in an open configuration. In some embodiments, the droplet comprises at least one biological sample, and wherein the member does not make contact with the biological sample. In some embodiments, the droplet has a volume that is between at least about 1 μL and at least about 10 milliliters (mL). In some embodiments, the droplet has a volume that is between at least about 1 μL and at least about 0.1 microliters (μL). In some embodiments, the the one or more electrodes are activated during the manipulation. In some embodiments, the the one or more electrodes are activated before the manipulation. In some embodiments, the the one or more electrodes are activated after the manipulation. In some embodiments, the one or more electrodes are activated in a time dependent pattern by the controller. In some embodiments, the one or more electrodes are activated in an alternating checkerboard like pattern by the controller. In some embodiments, the substrate further comprises a top plate and a bottom plate. In some embodiments, the top plate has at least one hole. In some embodiments, the droplet dispenser is robotic. In some embodiments, the droplet dispenser is automated. In some embodiments, the droplet dispenser makes contact with the surface of the substrate. In some embodiments, the droplet dispenser does not make contact with the surface of the substrate. In some embodiments, the droplet dispenser is configured to motion with respect to at least three axes. In some embodiments, the droplet dispenser is configured to motion with respect to at least four axes. In some embodiments, the droplet dispenser dispenses in non-continuous volumes. In some embodiments, the droplet dispenser dispenses in continuous volumes. In some embodiments, the substrate further comprises a lubricant and/or a film. In some embodiments, the droplet dispenser does not make contact with the oil and/or film. In some embodiments, the method further comprises providing a reagent reservoir adjacent to the substrate. In some embodiments, the reagent reservoir and the droplet dispenser are integrated into a single unit. In some embodiments, the reservoir and the droplet dispenser are configured to regulate temperature. In some embodiments, the reservoir or the droplet dispenser are configured to stir fluids. In some embodiments, the reservoir or the droplet dispenser are configured to agitate fluids. In some embodiments, the droplet comprises at least one biological sample, and wherein the droplet dispenser does not make contact with the biological sample. In some embodiments, the method further comprises: providing a sample droplet on an electrowetting substrate; suspending and mixing a bead in the sample droplet; introducing a magnet into the sample droplet, and moving the magnet in one or more axes while the sample droplet is held in place by the electrowetting substrate; and separating the bead from the sample droplet. In some embodiments, the droplet dispenser comprises a pipette. In some embodiments, the droplet dispenser comprises a pipette tip. In some embodiments, the droplet dispenser comprises a plurality of pipettes. In some embodiments, the droplet dispenser is connected with a tool changer. In some embodiments, the droplet dispenser is operatively connected to a motion gantry system. In some embodiments, the motion gantry system is a linear gantry. In some embodiments, the motion gantry system is a multi-axis dispensing system.

The present disclosure provides a system for droplet processing. The system may be configured to synchronize a droplet operation with a manipulation of the droplet. The system may result in an error margin of no more than 20 millimeters (mm). The system may comprise a droplet dispenser configured to be disposed over a substrate comprising a discrete location. The system may further comprise controller operatively coupled to the droplet dispenser, wherein the controller is programmed to: use the droplet dispenser to dispense the droplet to the discrete location or to remove at least a portion of the droplet from the discrete location; and during (i), activate or deactivate an electrode of one or more electrodes, wherein the electrode is disposed adjacent to the discrete location, and wherein activation or deactivation of the electrode is synchronized with the droplet being dispensed to the discrete location or at least a portion of the droplet being removed from the discrete location, wherein an error margin comprising the difference between an intended location for manipulation (e.g., dispensation, aspiration, etc.) of the droplet on the substrate and an actual location for manipulation of the droplet on the substrate is no more than 20 millimeters (mm). In some embodiments, the one or more electrodes is a plurality of electrodes. In some embodiments, the droplet dispenser comprises a droplet handling arm that moves towards or away from the substrate. In some embodiments, the droplet dispenser is used to dispense the droplet to the discrete location. In some embodiments, the droplet dispenser is used to remove at least a portion of the droplet from the discrete location. In some embodiments, the error margin is calculated based at least in part on a difference between an intended dispensing location and an actual dispensing location of the droplet. In some embodiments, the droplet is dispensed at the discrete location at an error margin of no more than about 20 millimeters (mm), no more than about 19 mm, no more than about 18 mm, no more than about 17 mm, no more than about 16 mm, no more than about 15 mm, no more than about 14 mm, no more than about 13 mm, no more than about 12 mm, no more than about 11 mm, no more than about 10 mm, no more than about 9 mm, no more than about 8 m no more than about 7 mm, no more than about 6 mm, no more than about 5 mm, no more than about 4 mm, no more than about 3 mm, no more than about 2 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, no more than about 0.1 mm, no more than about 0.05 mm, or less. In some embodiments, the droplet is dispensed at the discrete location at an error margin of no more than 20 millimeters (mm), In some embodiments, the droplet is dispensed at the discrete location comprising the error margin of no more than about 1 mm. In some embodiments, the droplet is dispensed at the discrete location comprising an error margin of no more than about 0.1 mm.

In some embodiments, the droplet dispenser is programmed to displace itself in an oscillating motion at an amplitude of at least about 0.05 mm to at least about 20 mm during dispensation. In some embodiments, the droplet dispenser is programmed to displace itself in an oscillating motion at an amplitude of at least about 0.05 mm, at least about 0.06 mm, at least about 0.07 mm, at least about 0.08 mm, at least about 0.09 mm, at least about 0.1 mm, at least about 0.2 mm, at least about 0.3 mm, at least about 0.4 mm, at least about 0.5 mm, at least about 0.6 mm, at least about 0.7 mm, at least about 0.8 mm, at least about 0.9 mm, at least about 1 mm, at least about 2 mm, at least about 3 mm, at least about 4 mm, at least about 5 mm, at least about 6 mm, at least about 7 mm, at least about 8 mm, at least about 9 mm, at least about 10 mm, at least about 11 mm, at least about 12 mm, at least about 13 mm, at least about 14 mm, at least about 15 mm, at least about 16 mm, at least about 17 mm, at least about 18 mm, at least about 19 mm, at least about 20 mm or more. In some embodiments, the droplet dispenser is programmed to displace itself in an oscillating motion at an amplitude of at least about 0.1 mm to at least about 5 mm during dispensation. In some embodiments, the droplet dispenser is programmed to displace itself in an oscillating motion at an amplitude of at least about 0.1 mm to at least about 1 mm during dispensation.

In some embodiments, the droplet dispenser is programmed to displace itself in an oscillating motion at a frequency of at least about 0.1 Hertz (Hz) to at least about 20 kilohertz (kHz) during dispensation. In some embodiments, the droplet dispenser is programmed to displace itself in an oscillating motion at a frequency of at least about 0.1 Hz, at least about 0.2 Hz, at least about 0.3 Hz, at least about 0.4 Hz, at least about 0.5 Hz, at least about 0.6 Hz, at least about 0.7 Hz, at least about 0.8 Hz, at least about 0.9 Hz, at least about 1 Hz, at least about 2 Hz, at least about 3 Hz, at least about 4 Hz, at least about 5 Hz, at least about 6 Hz, at least about 7 Hz, at least about 8 Hz, at least about 9 Hz, at least about 10 Hz, at least about 11 Hz, at least about 12 Hz, at least about 13 Hz, at least about 14 Hz, at least about 15 Hz, at least about 16 Hz, at least about 17 Hz, at least about 18 Hz, at least about 19 Hz, at least about 20 Hz, at least about 30 Hz, at least about 40 Hz, at least about 50 Hz, at least about 60 Hz, at least about 70 Hz, at least about 80 Hz, at least about 90 Hz, at least about 100 Hz, at least about 200 Hz, at least about 300 Hz, at least about 400 Hz, at least about 500 Hz, at least about 600 Hz, at least about 700 Hz, at least about 800 Hz, at least about 900 Hz, at least about 1000 Hz, or more. In some embodiments, the droplet dispenser is programmed to displace itself in an oscillating motion at a frequency of at least about 0.1 kHz, at least about 0.2 kHz, at least about 0.3 kHz, at least about 0.4 kHz, at least about 0.5 kHz, at least about 0.6 kHz, at least about 0.7 kHz, at least about 0.8 kHz, at least about 0.9 kHz, at least about 1 kHz, at least about 2 kHz, at least about 3 kHz, at least about 4 kHz, at least about 5 kHz, at least about 6 kHz, at least about 7 kHz, at least about 8 kHz, at least about 9 kHz, at least about 10 kHz, at least about 11 kHz, at least about 12 kHz, at least about 13 kHz, at least about 14 kHz, at least about 15 kHz, at least about 16 kHz, at least about 17 kHz, at least about 18 kHz, at least about 19 kHz, at least about 20 kHz, at least about 30 kHz, at least about 40 kHz, at least about 50 kHz, at least about 60 kHz, at least about 70 kHz, at least about 80 kHz, at least about 90 kHz, at least about 100 kHz, at least about 200 kHz, at least about 300 kHz, at least about 400 kHz, at least about 500 kHz, at least about 600 kHz, at least about 700 kHz, at least about 800 kHz, at least about 900 kHz, at least about 1000 kHz or more. In some embodiments, the droplet dispenser is programmed to displace itself in an oscillating motion at a frequency of at least about 0.1 MHZ, at least about 0.2 MHz, at least about 0.3 MHz, at least about 0.4 MHZ, at least about 0.5 MHz, at least about 0.6 MHZ, at least about 0.7 MHz, at least about 0.8 MHz, at least about 0.9 MHZ, at least about 1 MHZ, at least about 2 MHZ, at least about 3 MHz, at least about 4 MHZ, at least about 5 MHZ, at least about 6 MHZ, at least about 7 MHz, at least about 8 MHz, at least about 9 MHZ, at least about 10 MHz, at least about 11 MHZ, at least about 12 MHZ, at least about 13 MHZ, at least about 14 MHZ, at least about 15 MHZ, at least about 16 MHz, at least about 17 MHz, at least about 18 MHz, at least about 19 MHZ, at least about 20 MHz, at least about 30 MHz, at least about 40 MHZ, at least about 50 MHZ, at least about 60 MHz, at least about 70 MHz, at least about 80 MHz, at least about 90 MHz, at least about 100 MHz, at least about 200 MHZ, at least about 300 MHz, at least about 400 MHz, at least about 500 MHz, at least about 600 MHZ, at least about 700 MHZ, at least about 800 MHZ, at least about 900 MHZ, at least about 1000 MHz or more. In some embodiments, the droplet dispenser is programmed to displace itself in an oscillating motion at a frequency of at least about 1 Hz to at least about 20 kilohertz (kHz) during dispensation. In some embodiments, the droplet dispenser is programmed to displace itself in an oscillating motion at a frequency of at least about 1 Hz and at least about 500 Hz during dispensation. In some embodiments, the droplet dispenser is programmed to displace itself in an oscillating motion at a frequency of at least about 1 Hz and 20 Hz during dispensation.

In some embodiments, the droplet is dispensed at a height of no more than about 100 centimeters to no more than about 0.01 millimeters (mm). In some embodiments, the droplet is dispensed at a height of no more than 100 centimeters (cm), no more than about 75 cm, no more than about 30 cm, no more than about 25 cm, no more than about 20 cm, no more than about 15 cm, no more than about 10 cm, no more than about 5 cm, no more than about 1 cm, no more than about 750 mm, no more than about 500 mm, no more than about 250 mm, no more than about 200 m no more than about 150 mm, no more than about 100 mm, no more than about 75 mm, no more than about 50 mm, no more than about 25 mm, no more than about 20 mm, no more than about 10 mm, no more than about 9 mm, no more than about 8 m no more than about 7 mm, no more than about 6 mm, no more than about 5 mm, no more than about 4 mm, no more than about 3 mm, no more than about 2 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, no more than about 0.1 mm, no more than about 0.05 mm, no more than about 0.01 mm, or less. In some embodiments, the droplet is dispensed at a height of no more than 100 centimeters (cm). In some embodiments, droplet is dispensed at a height of no more than about 20 mm. In some embodiments, the droplet is dispensed at a height of no more than about 0.1 mm.

In some embodiments, the rate of manipulation (e.g., dispensation, aspiration, etc.) of the droplet on to the discrete location is no more than about 2,000 microliters per second (μL/s) to no more than about 0.01 μL/s. In some embodiments, the rate of manipulation (e.g., dispensation, aspiration, etc.) of the droplet on to the discrete location is no more than about 2,000 μL/s, no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, or no more than about 50 μL/s. not more than at most no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, no more than about 50 μL/s, or no more than about 25 μL/s, no more than about 15 μL/s, no more than about 10 μL/s, no more than about 5 μL/s, no more than about 1 μL/s, no more than about 0.75 μL/s, no more than about 0.5 μL/s, no more than about 0.25 μL/s, no more than about 0.1 μL/s, no more than about 0.05 μL/s, or no more than about 0.01 μL/s. In some embodiments, the rate of manipulation (e.g., dispensation, aspiration, etc.) of the droplet on to the discrete location is no more than about 1000 μL/s. In some embodiments, the rate of manipulation (e.g., dispensation, aspiration, etc.) of the droplet on to the discrete location is no more than about 100 μL/s. In some embodiments, the rate of manipulation (e.g., dispensation, aspiration, etc.) of the droplet on to the discrete location is no more than about 0.5 μL/s. In some embodiments, the rate of manipulation (e.g., dispensation, aspiration, etc.) of the droplet on to the discrete location is no more than about 0.1 μL/s.

In some embodiments, one or more electrodes are activated during the manipulation. In some embodiments, one or more electrodes are activated before the manipulation. In some embodiments, the one or more electrodes are activated after the manipulation. In some embodiments, one or more electrodes are activated in a time dependent pattern by the controller. In some embodiments, one or more electrodes are activated in an alternating checkerboard like pattern by the controller. In some embodiments, one or more electrodes are activated in a square like pattern by the controller. In some embodiments, one or more electrodes are deactivated by the controller. In some embodiments, wherein the droplet dispenser is in an open configuration. In some embodiments, wherein the droplet comprises at least one biological sample. In some embodiments, the manipulation is a dispensation of the droplet from the liquid handling arm. In some embodiments, the manipulation is an aspiration of the droplet from the liquid handling arm. In some embodiments, the substrate further comprises a top plate and a bottom plate. In some embodiments, the top plate has at least one hole. In some embodiments, the droplet dispenser is robotic. In some embodiments, the droplet dispenser is automated. In some embodiments, the droplet dispenser makes contact with the surface of the substrate. In some embodiments, the droplet dispenser does not make contact with the surface of the substrate. In some embodiments, the droplet dispenser is configured to motion with respect to at least three axes. In some embodiments, the droplet dispenser is configured to motion with respect to at least four axes. In some embodiments, the droplet dispenser dispenses in non-continuous volumes. In some embodiments, the droplet dispenser dispenses in continuous volumes. In some embodiments, the substrate further comprises a lubricant and/or a film. In some embodiments, the droplet dispenser does not make contact with the oil and/or film. In some embodiments, the method further comprises providing a reagent reservoir adjacent to the substrate. In some embodiments, the reagent reservoir and the droplet dispenser are integrated into a single unit. In some embodiments, the reservoir and the droplet dispenser are configured to regulate temperature. In some embodiments, the reservoir or the droplet dispenser are configured to stir fluids. In some embodiments, the reservoir or the droplet dispenser are configured to agitate fluids. In some embodiments, the droplet comprises at least one biological sample, and wherein the droplet dispenser does not make contact with the biological sample. In some embodiments, the method further comprises: providing a sample droplet on an electrowetting substrate; suspending and mixing a bead in the sample droplet; introducing a magnet into the sample droplet, and moving the magnet in one or more axes while the sample droplet is held in place by the electrowetting substrate; and separating the bead from the sample droplet. In some embodiments, the droplet dispenser comprises a pipette. In some embodiments, the droplet dispenser comprises a pipette tip. In some embodiments, the droplet dispenser comprises a plurality of pipettes. In some embodiments, the droplet dispenser is connected with a tool changer. In some embodiments, the droplet dispenser is operatively connected to a motion gantry system. In some embodiments, the motion gantry system is a linear gantry. In some embodiments, the motion gantry system is a multi-axis dispensing system.

### Pseudo-Contact

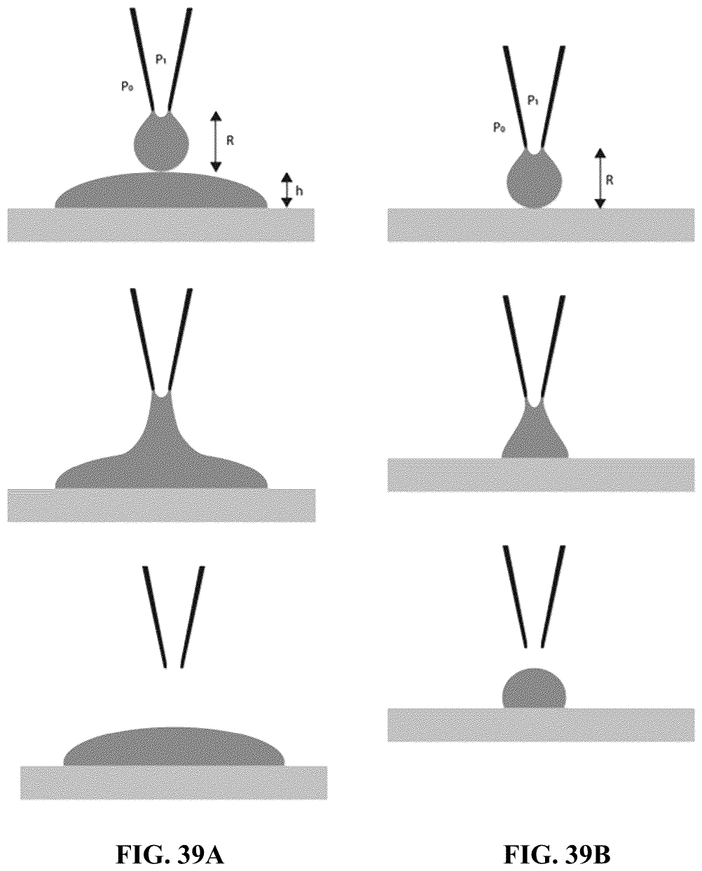

The present disclosure provides a method for contacting a droplet with a discrete location. In some embodiments, this method of distribution is demonstrated in FIGS. 39A and 39B. The method may comprise providing a substrate comprising a discrete location. The method may further comprise one or more electrodes disposed adjacent to the discrete location of substrate. The method may further comprise a droplet dispenser disposed over the substrate. The method may further comprise contacting the droplet with the discrete location without creating contact between the droplet dispenser and the discrete location. In some embodiments, the one or more electrodes is a plurality of electrodes. In some embodiments, the droplet dispenser comprises a droplet handling arm that moves towards or away from the substrate. In some embodiments, the discrete location is a second droplet on the substrate as demonstrated in FIG. 39A. In some embodiments, the method further comprises merging the droplet with the second droplet to form a merged droplet. In some embodiments, the method further comprises using vibration to mix the merged droplet. In some embodiments, the droplet or the second droplet comprise a plurality of artifacts. In some embodiments, the plurality of artifacts are responsive to a magnetic field. In some embodiments, a magnetic field adjacent to the substrate is applied to the merged droplet. In some embodiments, the magnetic field is supplied by a magnet. In some embodiments, the magnet is actuated to supply the magnetic field to the merged droplet. In some embodiments, the magnetic field is used to separate the plurality of artifacts from the merged droplet. In some embodiments, upon the contact between the droplet and the second droplet, a surface tension of the droplet and surface tension of the second droplet are disrupted. In some embodiments, the discrete location is a surface of the substrate as demonstrated in FIG. 39B. In some embodiments, the surface comprises a liquid layer. In some embodiments, the liquid layer comprises a lubricant or film. In some embodiments, upon the contact between the droplet and the surface, a surface tension of the droplet and surface tension on the surface are disrupted. In some embodiments, the method further comprises using gravitational forces to allow the droplet to overcome adhesion to the droplet dispenser. In some embodiments, the droplet comprises at least one biological sample, and wherein the droplet dispenser does not make contact with the biological sample.

In some embodiments, the rate of manipulation (e.g., dispensation, aspiration, etc.) of the droplet on to the discrete location is no more than about 2,000 microliters per second (μL/s) to no more than about 0.01 μL/s. In some embodiments, the rate of manipulation (e.g., dispensation, aspiration, etc.) of the droplet on to the discrete location is no more than about 2,000 μL/s, no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, or no more than about 50 μL/s. not more than at most no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, no more than about 50 μL/s, or no more than about 25 μL/s, no more than about 15 μL/s, no more than about 10 μL/s, no more than about 5 μL/s, no more than about 1 μL/s, no more than about 0.75 μL/s, no more than about 0.5 μL/s, no more than about 0.25 μL/s, no more than about 0.1 μL/s, no more than about 0.05 μL/s, or no more than about 0.01 μL/s. In some embodiments, the rate of manipulation (e.g., dispensation, aspiration, etc.) of the droplet on to the discrete location is no more than about 1000 μL/s. In some embodiments, the rate of manipulation (e.g., dispensation, aspiration, etc.) of the droplet on to the discrete location is no more than about 100 μL/s. In some embodiments, the rate of manipulation (e.g., dispensation, aspiration, etc.) of the droplet on to the discrete location is no more than about 0.5 μL/s. In some embodiments, the rate of manipulation (e.g., dispensation, aspiration, etc.) of the droplet on to the discrete location is no more than about 0.1 μL/s.

In some embodiments, one or more electrodes are activated during the manipulation. In some embodiments, one or more electrodes are activated before the manipulation. In some embodiments, the one or more electrodes are activated after the manipulation. In some embodiments, one or more electrodes are activated in a time dependent pattern by the controller. In some embodiments, one or more electrodes are activated in an alternating checkerboard like pattern by the controller. In some embodiments, one or more electrodes are activated in a square like pattern by the controller. In some embodiments, one or more electrodes are deactivated by the controller. In some embodiments, the droplet dispenser is in an open configuration. In some embodiments, the substrate further comprises a top plate and a bottom plate. In some embodiments, the top plate has at least one hole. In some embodiments, the droplet dispenser is robotic. In some embodiments, the droplet dispenser is automated. In some embodiments, the droplet dispenser does not make contact with the surface of the substrate. In some embodiments, the droplet dispenser is configured to motion with respect to at least three axes. In some embodiments, the droplet dispenser is configured to motion with respect to at least four axes. In some embodiments, the droplet dispenser dispenses in non-continuous volumes. In some embodiments, the droplet dispenser dispenses in continuous volumes. In some embodiments, the droplet dispenser does not make contact with the oil and/or film. In some embodiments, the method further comprises providing a reagent reservoir adjacent to the substrate. In some embodiments, the reagent reservoir and the droplet dispenser are integrated into a single unit. In some embodiments, the reservoir and the droplet dispenser are configured to regulate temperature. In some embodiments, the reservoir or the droplet dispenser are configured to stir fluids. In some embodiments, the reservoir or the droplet dispenser are configured to agitate fluids. In some embodiments, the droplet dispenser comprises a pipette. In some embodiments, the droplet dispenser comprises a pipette tip. In some embodiments, the droplet dispenser comprises a plurality of pipettes. In some embodiments, the droplet dispenser is connected with a tool changer. In some embodiments, the droplet dispenser is operatively connected to a motion gantry system. In some embodiments, the motion gantry system is a linear gantry. In some embodiments, the motion gantry system is a multi-axis dispensing system.

The present disclosure provides a method for contacting a droplet with a second droplet. The method may comprise providing a substrate comprising a second droplet one or more electrodes disposed adjacent to the discrete location of substrate. The method may further comprise providing a droplet dispenser disposed over the substrate; generating a first droplet from the droplet dispenser; contacting the first droplet with the second droplet without creating contact between the droplet dispenser and the second droplet. In some embodiments, the one or more electrodes is a plurality of electrodes. In some embodiments, the droplet dispenser comprises a droplet handling arm that moves towards or away from the substrate. In some embodiments, the method further comprises merging the droplet with the second droplet to form a merged droplet. In some embodiments, the method further comprises using vibration to mix the merged droplet. In some embodiments, the droplet or the second droplet comprise a plurality of artifacts. In some embodiments, the plurality of artifacts are responsive to a magnetic field. In some embodiments, a magnetic field adjacent to the substrate is applied to the merged droplet. In some embodiments, the magnetic field is supplied by a magnet. In some embodiments, the magnet is actuated to supply the magnetic field to the merged droplet. In some embodiments, the magnetic field is used to separate the plurality of artifacts from the merged droplet. In some embodiments, upon the contact between the droplet and the second droplet, a surface tension of the droplet and surface tension of the second droplet are disrupted. In some embodiments, the method further comprises using gravitational forces to allow the droplet to overcome adhesion to the liquid handling arm. In some embodiments, the droplet comprises at least one biological sample, and wherein the liquid handling arm does not make contact with the biological sample.

In some embodiments, the rate of manipulation (e.g., dispensation, aspiration, etc.) of the droplet on to the discrete location is no more than about 2,000 microliters per second (μL/s) to no more than about 0.01 μL/s. In some embodiments, the rate of manipulation (e.g., dispensation, aspiration, etc.) of the droplet on to the discrete location is no more than about 2,000 μL/s, no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, or no more than about 50 μL/s. not more than at most no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, no more than about 50 μL/s, or no more than about 25 μL/s, no more than about 15 μL/s, no more than about 10 μL/s, no more than about 5 μL/s, no more than about 1 μL/s, no more than about 0.75 μL/s, no more than about 0.5 μL/s, no more than about 0.25 μL/s, no more than about 0.1 μL/s, no more than about 0.05 μL/s, or no more than about 0.01 μL/s. In some embodiments, the rate of manipulation (e.g., dispensation, aspiration, etc.) of the droplet on to the discrete location is no more than about 1000 μL/s. In some embodiments, the rate of manipulation (e.g., dispensation, aspiration, etc.) of the droplet on to the discrete location is no more than about 100 μL/s. In some embodiments, the rate of manipulation (e.g., dispensation, aspiration, etc.) of the droplet on to the discrete location is no more than about 0.5 μL/s. In some embodiments, the rate of manipulation (e.g., dispensation, aspiration, etc.) of the droplet on to the discrete location is no more than about 0.1 μL/s.

In some embodiments, one or more electrodes are activated during the manipulation. In some embodiments, one or more electrodes are activated before the manipulation. In some embodiments, the one or more electrodes are activated after the manipulation. In some embodiments, one or more electrodes are activated in a time dependent pattern by the controller. In some embodiments, one or more electrodes are activated in an alternating checkerboard like pattern by the controller. In some embodiments, one or more electrodes are activated in a square like pattern by the controller. In some embodiments, one or more electrodes are deactivated by the controller. In some embodiments, the droplet dispenser is in an open configuration. In some embodiments, the substrate further comprises a top plate and a bottom plate. In some embodiments, the top plate has at least one hole. In some embodiments, the droplet dispenser is robotic. In some embodiments, the droplet dispenser is automated. In some embodiments, the droplet dispenser does not make contact with the surface of the substrate. In some embodiments, the droplet dispenser is configured to motion with respect to at least three axes. In some embodiments, the droplet dispenser is configured to motion with respect to at least four axes. In some embodiments, the droplet dispenser dispenses in non-continuous volumes. In some embodiments, the droplet dispenser dispenses in continuous volumes. In some embodiments, the droplet dispenser does not make contact with the oil and/or film. In some embodiments, the method further comprises providing a reagent reservoir adjacent to the substrate. In some embodiments, the reagent reservoir and the droplet dispenser are integrated into a single unit. In some embodiments, the reservoir and the droplet dispenser are configured to regulate temperature. In some embodiments, the reservoir or the droplet dispenser are configured to stir fluids. In some embodiments, the reservoir or the droplet dispenser are configured to agitate fluids. In some embodiments, the droplet dispenser comprises a pipette. In some embodiments, the droplet dispenser comprises a pipette tip. In some embodiments, the droplet dispenser comprises a plurality of pipettes. In some embodiments, the droplet dispenser is connected with a tool changer. In some embodiments, the droplet dispenser is operatively connected to a motion gantry system. In some embodiments, the motion gantry system is a linear gantry. In some embodiments, the motion gantry system is a multi-axis dispensing system.

The present disclosure provides a method for contacting a droplet with a discrete region on a surface of a substrate. The method may comprise providing a substrate comprising a surface comprising a discrete region. The method may further comprise one or more electrodes disposed adjacent to the discrete location of substrate. The method may further comprise a droplet dispenser disposed over the substrate; generating a first droplet from the droplet dispenser; contacting the first droplet with the discrete region of the surface of the substrate without creating contact between the droplet dispenser and the discrete region of the surface of the substrate. In some embodiments, the one or more electrodes is a plurality of electrodes. In some embodiments, the droplet dispenser comprises a droplet handling arm that moves towards or away from the substrate. In some embodiments, the surface comprises a liquid layer. In some embodiments, the liquid layer comprises a lubricant. In some embodiments, upon the contact between the droplet and the surface, a surface tension of the droplet and surface tension on the surface are disrupted. In some embodiments, the method further comprises using gravitational forces to allow the droplet to overcome adhesion to the liquid handling arm. In some embodiments, the droplet comprises at least one biological sample, and wherein the liquid handling arm does not make contact with the biological sample.

In some embodiments, the rate of manipulation (e.g., dispensation, aspiration, etc.) of the droplet on to the discrete location is no more than about 2,000 microliters per second (μL/s) to no more than about 0.01 μL/s. In some embodiments, the rate of manipulation (e.g., dispensation, aspiration, etc.) of the droplet on to the discrete location is no more than about 2,000 μL/s, no more than about 1,500 μL/s, no more than about 1,000 μL/s, no more than about 750 μL/s, no more than about 500 μL/s, no more than about 250 μL/s, no more than about 200 L/s, no more than about 150 μL/s, no more than about 100 μL/s, no more than about 75 μL/s, or no more than about 50 μL/s. not more than at most no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, no more than about 50 μL/s, or no more than about 25 μL/s, no more than about 15 μL/s, no more than about 10 μL/s, no more than about 5 μL/s, no more than about 1 μL/s, no more than about 0.75 μL/s, no more than about 0.5 L/s, no more than about 0.25 μL/s, no more than about 0.1 μL/s, no more than about 0.05 μL/s, or no more than about 0.01 μL/s. In some embodiments, the rate of manipulation (e.g., dispensation, aspiration, etc.) of the droplet on to the discrete location is no more than about 1000 μL/s. In some embodiments, the rate of manipulation (e.g., dispensation, aspiration, etc.) of the droplet on to the discrete location is no more than about 100 μL/s. In some embodiments, the rate of manipulation (e.g., dispensation, aspiration, etc.) of the droplet on to the discrete location is no more than about 0.5 μL/s. In some embodiments, the rate of manipulation (e.g., dispensation, aspiration, etc.) of the droplet on to the discrete location is no more than about 0.1 μL/s.

In some embodiments, one or more electrodes are activated during the manipulation. In some embodiments, one or more electrodes are activated before the manipulation. In some embodiments, the one or more electrodes are activated after the manipulation. In some embodiments, one or more electrodes are activated in a time dependent pattern by the controller. In some embodiments, one or more electrodes are activated in an alternating checkerboard like pattern by the controller. In some embodiments, one or more electrodes are activated in a square like pattern by the controller. In some embodiments, one or more electrodes are deactivated by the controller. In some embodiments, the droplet dispenser is in an open configuration. In some embodiments, the substrate further comprises a top plate and a bottom plate. In some embodiments, the top plate has at least one hole. In some embodiments, the droplet dispenser is robotic. In some embodiments, the droplet dispenser is automated. In some embodiments, the droplet dispenser does not make contact with the surface of the substrate. In some embodiments, the droplet dispenser is configured to motion with respect to at least three axes. In some embodiments, the droplet dispenser is configured to motion with respect to at least four axes. In some embodiments, the droplet dispenser dispenses in non-continuous volumes. In some embodiments, the droplet dispenser dispenses in continuous volumes. In some embodiments, the droplet dispenser does not make contact with the oil and/or film. In some embodiments, the method further comprises providing a reagent reservoir adjacent to the substrate. In some embodiments, the reagent reservoir and the droplet dispenser are integrated into a single unit. In some embodiments, the reservoir and the droplet dispenser are configured to regulate temperature. In some embodiments, the reservoir or the droplet dispenser are configured to stir fluids. In some embodiments, the reservoir or the droplet dispenser are configured to agitate fluids. In some embodiments, the droplet dispenser comprises a pipette. In some embodiments, the droplet dispenser comprises a pipette tip. In some embodiments, the droplet dispenser comprises a plurality of pipettes. In some embodiments, the droplet dispenser is connected with a tool changer. In some embodiments, the droplet dispenser is operatively connected to a motion gantry system. In some embodiments, the motion gantry system is a linear gantry. In some embodiments, the motion gantry system is a multi-axis dispensing system.

The present disclosure provides a system for droplet processing. The system may comprise: a droplet dispenser configured to be disposed over a substrate comprising a discrete location; and a controller operatively coupled to the droplet dispenser, wherein the controller is programmed to manipulate the droplet dispenser to contact the droplet with the discrete location of the surface of the substrate without creating contact between the droplet dispenser and the discrete region of the surface of the substrate. In some embodiments, the one or more electrodes is a plurality of electrodes. In some embodiments, the droplet dispenser comprises a pipette tip. In some embodiments, the droplet dispenser comprises a droplet handling arm that moves towards or away from the substrate. In some embodiments, the method further comprises merging the droplet with the second droplet to form a merged droplet. In some embodiments, the method further comprises using vibration to mix the merged droplet. In some embodiments, the droplet or the second droplet comprise a plurality of artifacts. In some embodiments, the plurality of artifacts are responsive to a magnetic field. In some embodiments, a magnetic field adjacent to the substrate is applied to the merged droplet. In some embodiments, the magnetic field is supplied by a magnet. In some embodiments, the magnet is actuated to supply the magnetic field to the merged droplet. In some embodiments, the magnetic field is used to separate the plurality of artifacts from the merged droplet. In some embodiments, upon the contact between the droplet and the second droplet, a surface tension of the droplet and surface tension of the second droplet are disrupted. In some embodiments, the method further comprises using gravitational forces to allow the droplet to overcome adhesion to the liquid handling arm. In some embodiments, the droplet comprises at least one biological sample, and wherein the liquid handling arm does not make contact with the biological sample.

In some embodiments, the rate of manipulation (e.g., dispensation, aspiration, etc.) of the droplet on to the discrete location is no more than about 2,000 microliters per second (μL/s) to no more than about 0.01 μL/s. In some embodiments, the rate of manipulation (e.g., dispensation, aspiration, etc.) of the droplet on to the discrete location is no more than about 2,000 μL/s, no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, or no more than about 50 L/s. not more than at most no more than about 1,500 μL/s, no more than about 1,000 μL/s, no more than about 750 μL/s, no more than about 500 μL/s, no more than about 250 μL/s, no more than about 200 μL/s, no more than about 150 μL/s, no more than about 100 μL/s, no more than about 75 μL/s, no more than about 50 μL/s, or no more than about 25 μL/s, no more than about 15 μL/s, no more than about 10 μL/s, no more than about 5 L/s, no more than about 1 μL/s, no more than about 0.75 μL/s, no more than about 0.5 μL/s, no more than about 0.25 μL/s, no more than about 0.1 μL/s, no more than about 0.05 μL/s, or no more than about 0.01 L/s. In some embodiments, the rate of manipulation (e.g., dispensation, aspiration, etc.) of the droplet on to the discrete location is no more than about 1000 μL/s. In some embodiments, the rate of manipulation (e.g., dispensation, aspiration, etc.) of the droplet on to the discrete location is no more than about 100 μL/s. In some embodiments, the rate of manipulation (e.g., dispensation, aspiration, etc.) of the droplet on to the discrete location is no more than about 0.5 μL/s. In some embodiments, the rate of manipulation (e.g., dispensation, aspiration, etc.) of the droplet on to the discrete location is no more than about 0.1 μL/s.

In some embodiments, one or more electrodes are activated during the manipulation. In some embodiments, one or more electrodes are activated before the manipulation. In some embodiments, the one or more electrodes are activated after the manipulation. In some embodiments, one or more electrodes are activated in a time dependent pattern by the controller. In some embodiments, one or more electrodes are activated in an alternating checkerboard like pattern by the controller. In some embodiments, one or more electrodes are activated in a square like pattern by the controller. In some embodiments, one or more electrodes are deactivated by the controller. In some embodiments, the droplet dispenser is in an open configuration. In some embodiments, the substrate further comprises a top plate and a bottom plate. In some embodiments, the top plate has at least one hole. In some embodiments, the droplet dispenser is robotic. In some embodiments, the droplet dispenser is automated. In some embodiments, the droplet dispenser does not make contact with the surface of the substrate. In some embodiments, the droplet dispenser is configured to motion with respect to at least three axes. In some embodiments, the droplet dispenser is configured to motion with respect to at least four axes. In some embodiments, the droplet dispenser dispenses in non-continuous volumes. In some embodiments, the droplet dispenser dispenses in continuous volumes. In some embodiments, the droplet dispenser does not make contact with the oil and/or film. In some embodiments, the method further comprises providing a reagent reservoir adjacent to the substrate. In some embodiments, the reagent reservoir and the droplet dispenser are integrated into a single unit. In some embodiments, the reservoir and the droplet dispenser are configured to regulate temperature. In some embodiments, the reservoir or the droplet dispenser are configured to stir fluids. In some embodiments, the reservoir or the droplet dispenser are configured to agitate fluids. In some embodiments, the droplet dispenser comprises a pipette. In some embodiments, the droplet dispenser comprises a pipette tip. In some embodiments, the droplet dispenser comprises a plurality of pipettes. In some embodiments, the droplet dispenser is connected with a tool changer. In some embodiments, the droplet dispenser is operatively connected to a motion gantry system. In some embodiments, the motion gantry system is a linear gantry. In some embodiments, the motion gantry system is a multi-axis dispensing system.

In the systems and methods described herein, the droplet may be dispensed at a discrete location with an error margin of no more than about 0.001 mm to about 40 mm. The droplet may be dispensed at a discrete location with an error margin of at most about 40 mm to about 20 mm, about 40 mm to about 15 mm, about 40 mm to about 10 mm, about 40 mm to about 5 mm, about 40 mm to about 4 mm, about 40 mm to about 3 mm, about 40 mm to about 2 mm, about 40 mm to about 1 mm, about 40 mm to about 0.1 mm, about 40 mm to about 0.01 mm, about 40 mm to about 0.001 mm, about 20 mm to about 15 mm, about 20 mm to about 10 mm, about 20 mm to about 5 mm, about 20 mm to about 4 mm, about 20 mm to about 3 mm, about 20 mm to about 2 mm, about 20 mm to about 1 mm, about 20 mm to about 0.1 mm, about 20 mm to about 0.01 mm, about 20 mm to about 0.001 mm, about 15 mm to about 10 mm, about 15 mm to about 5 mm, about 15 mm to about 4 mm, about 15 mm to about 3 mm, about 15 mm to about 2 mm, about 15 mm to about 1 mm, about 15 mm to about 0.1 mm, about 15 mm to about 0.01 mm, about 15 mm to about 0.001 mm, about 10 mm to about 5 mm, about 10 mm to about 4 mm, about 10 mm to about 3 mm, about 10 mm to about 2 mm, about 10 mm to about 1 mm, about 10 mm to about 0.1 mm, about 10 mm to about 0.01 mm, about 10 mm to about 0.001 mm, about 5 mm to about 4 mm, about 5 mm to about 3 mm, about 5 mm to about 2 mm, about 5 mm to about 1 mm, about 5 mm to about 0.1 mm, about 5 mm to about 0.01 mm, about 5 mm to about 0.001 mm, about 4 mm to about 3 mm, about 4 mm to about 2 mm, about 4 mm to about 1 mm, about 4 mm to about 0.1 mm, about 4 mm to about 0.01 mm, about 4 mm to about 0.001 mm, about 3 mm to about 2 mm, about 3 mm to about 1 mm, about 3 mm to about 0.1 mm, about 3 mm to about 0.01 mm, about 3 mm to about 0.001 mm, about 2 mm to about 1 mm, about 2 mm to about 0.1 mm, about 2 mm to about 0.01 mm, about 2 mm to about 0.001 mm, about 1 mm to about 0.1 mm, about 1 mm to about 0.01 mm, about 1 mm to about 0.001 mm, about 0.1 mm to about 0.01 mm, about 0.1 mm to about 0.001 mm, or about 0.01 mm to about 0.001 mm. The droplet may be dispensed at a discrete location with an error margin of at most about 40 mm, about 20 mm, about 15 mm, about 10 mm, about 5 mm, about 4 mm, about 3 mm, about 2 mm, about 1 mm, about 0.1 mm, about 0.01 mm, or about 0.001 mm.

In the systems and methods described herein, the droplet dispenser may be programmed to displace itself in an oscillating motion with an amplitude from at least about 0.01 mm to about 100 mm. The droplet dispenser may be programmed to displace itself in an oscillating motion with an amplitude from at least about 100 mm to about 75 mm, about 100 mm to about 50 mm, about 100 mm to about 25 mm, about 100 mm to about 10 mm, about 100 mm to about 5 mm, about 100 mm to about 4 mm, about 100 mm to about 3 mm, about 100 mm to about 2 mm, about 100 mm to about 1 mm, about 100 mm to about 0.1 mm, about 100 mm to about 0.01 mm, about 75 mm to about 50 mm, about 75 mm to about 25 mm, about 75 mm to about 10 mm, about 75 mm to about 5 mm, about 75 mm to about 4 mm, about 75 mm to about 3 mm, about 75 mm to about 2 mm, about 75 mm to about 1 mm, about 75 mm to about 0.1 mm, about 75 mm to about 0.01 mm, about 50 mm to about 25 mm, about 50 mm to about 10 mm, about 50 mm to about 5 mm, about 50 mm to about 4 mm, about 50 mm to about 3 mm, about 50 mm to about 2 mm, about 50 mm to about 1 mm, about 50 mm to about 0.1 mm, about 50 mm to about 0.01 mm, about 25 mm to about 10 mm, about 25 mm to about 5 mm, about 25 mm to about 4 mm, about 25 mm to about 3 mm, about 25 mm to about 2 mm, about 25 mm to about 1 mm, about 25 mm to about 0.1 mm, about 25 mm to about 0.01 mm, about 10 mm to about 5 mm, about 10 mm to about 4 mm, about 10 mm to about 3 mm, about 10 mm to about 2 mm, about 10 mm to about 1 mm, about 10 mm to about 0.1 mm, about 10 mm to about 0.01 mm, about 5 mm to about 4 mm, about 5 mm to about 3 mm, about 5 mm to about 2 mm, about 5 mm to about 1 mm, about 5 mm to about 0.1 mm, about 5 mm to about 0.01 mm, about 4 mm to about 3 mm, about 4 mm to about 2 mm, about 4 mm to about 1 mm, about 4 mm to about 0.1 mm, about 4 mm to about 0.01 mm, about 3 mm to about 2 mm, about 3 mm to about 1 mm, about 3 mm to about 0.1 mm, about 3 mm to about 0.01 mm, about 2 mm to about 1 mm, about 2 mm to about 0.1 mm, about 2 mm to about 0.01 mm, about 1 mm to about 0.1 mm, about 1 mm to about 0.01 mm, or about 0.1 mm to about 0.01 mm. The droplet dispenser may be programmed to displace itself in an oscillating motion with an amplitude from at least about 100 mm, about 75 mm, about 50 mm, about 25 mm, about 10 mm, about 5 mm, about 4 mm, about 3 mm, about 2 mm, about 1 mm, about 0.1 mm, or about 0.01 mm.

In the systems and methods described herein, the droplet dispenser may be programmed to displace itself in an oscillating motion with a frequency of from at least about 1 Hz to at least about 20 MHz. The droplet dispenser may displace itself in an oscillating motion with a frequency of at least about 1 Hz to at least about 20 Hz, at least about 1 Hz to at least about 100 Hz, at least about 1 Hz to at least about 500 Hz, at least about 1 Hz to at least about 1 kHz, at least about 1 Hz to at least about 2 kHz, at least about 1 Hz to at least about 20 kHz, at least about 1 Hz to at least about 100 kHz, at least about 1 Hz to at least about 500 kHz, at least about 1 Hz to at least about 1 MHz, at least about 1 Hz to at least about 10 MHz, at least about 1 Hz to at least about 20 MHz, at least about 20 Hz to at least about 100 Hz, at least about 20 Hz to at least about 500 Hz, at least about 20 Hz to at least about 1 kHz, at least about 20 Hz to at least about 2 kHz, at least about 20 Hz to at least about 20 kHz, at least about 20 Hz to at least about 100 kHz, at least about 20 Hz to at least about 500 kHz, at least about 20 Hz to at least about 1 MHZ, at least about 20 Hz to at least about 10 MHz, at least about 20 Hz to at least about 20 MHz, at least about 100 Hz to at least about 500 Hz, at least about 100 Hz to at least about 1 kHz, at least about 100 Hz to at least about 2 kHz, at least about 100 Hz to at least about 20 kHz, at least about 100 Hz to at least about 100 kHz, at least about 100 Hz to at least about 500 kHz, at least about 100 Hz to at least about 1 MHZ, at least about 100 Hz to at least about 10 MHz, at least about 100 Hz to at least about 20 MHz, at least about 500 Hz to at least about 1 kHz, at least about 500 Hz to at least about 2 kHz, at least about 500 Hz to at least about 20 kHz, at least about 500 Hz to at least about 100 kHz, at least about 500 Hz to at least about 500 kHz, at least about 500 Hz to at least about 1 MHZ, at least about 500 Hz to at least about 10 MHz, at least about 500 Hz to at least about 20 MHz, at least about 1 kHz to at least about 2 kHz, at least about 1 kHz to at least about 20 kHz, at least about 1 kHz to at least about 100 kHz, at least about 1 kHz to at least about 500 kHz, at least about 1 kHz to at least about 1 MHZ, at least about 1 kHz to at least about 10 MHz, at least about 1 kHz to at least about 20 MHz, at least about 2 kHz to at least about 20 kHz, at least about 2 kHz to at least about 100 kHz, at least about 2 kHz to at least about 500 kHz, at least about 2 kHz to at least about 1 MHz, at least about 2 kHz to at least about 10 MHz, at least about 2 kHz to at least about 20 MHz, at least about 20,000 Hz kHz at least about 100 kHz, at least about 20 kHz to at least about 500 kHz, at least about 20 kHz to at least about 1 MHZ, at least about 20 kHz to at least about 10 MHz, at least about 20 kHz to at least about 20 MHz, at least about 100 kHz to at least about 500 kHz, at least about 100 kHz to at least about 1 MHz, at least about 100 kHz to at least about 10 MHz, at least about 100 kHz to at least about 20 MHz, at least about 500 kHz to at least about 1 MHZ, at least about 500 kHz to at least about 10 MHz, at least about 500 kHz to at least about 20 MHZ, at least about 1 MHz to at least about 10 MHZ, at least about 1 MHz to at least about 20 MHz, or at least about 10 MHz to at least about 20 MHz. The droplet dispenser may displace itself in an oscillating motion with a frequency of at least about 1 Hz, 10 Hz, 20 Hz, 100 Hz, 500 Hz, 1 kHz, 10 kHz, 20 kHz, 100 kHz, 500 kHz, 1 MHz, 5 MHz, 10 MHZ, 20 MHz, or more.

In the systems and methods described herein, the dispensing of the droplet may occur from at least about at a height of no more than about 100 centimeters (cm) to no more than about 0.01 millimeters (mm) above the surface of the substrate. In some embodiments, the droplet is dispensed at a height of no more than 100 cm, no more than about 75 cm, no more than about 30 cm, no more than about 25 cm, no more than about 20 cm, no more than about 15 cm, no more than about 10 cm, no more than about 5 cm, no more than about 1 cm, no more than about 750 mm, no more than about 500 mm, no more than about 250 mm, no more than about 200 m no more than about 150 mm, no more than about 100 mm, no more than about 75 mm, no more than about 50 mm, no more than about 25 mm, no more than about 20 mm, no more than about 10 mm, no more than about 9 mm, no more than about 8 m no more than about 7 mm, no more than about 6 mm, no more than about 5 mm, no more than about 4 mm, no more than about 3 mm, no more than about 2 mm, no more than about 1 mm, no more than about 0.9 mm, no more than about 0.8 mm, no more than about 0.7 mm, no more than about 0.6 mm, no more than about 0.5 mm, no more than about 0.4 mm, no more than about 0.3 mm, no more than about 0.2 mm, no more than about 0.1 mm, no more than about 0.05 mm, no more than about 0.01 mm, or less above the surface of the substrate.

The present disclosure provides methods for distribution of one or more droplets. A droplet may be dispensed onto a substrate using any of the methods of distribution as disclosed herein. noncontact distribution. In noncontact distribution, a droplet may be dispensed from a device, e.g., a droplet dispenser, onto a substrate without touching a surface of the device to the substrate. One or more droplets may be distributed in this manner. One or more reagents may be distributed using this distribution method for various experiments, such as high molecular weight (HMW) extraction, amplification, and sequencing. The amplification may comprise, for example, polymerase chain reaction (PCAR), reverse transcriptase (RT) PCR, quantitative and/or Real-Time (rt) PCR, bridge amplification, and/or rolling circle amplification (RCA). Examples of rolling circle amplification, but are not limited to, protocols of circularizing nucleic acid as described in U.S. Pat. Nos. 9,290,800; 11,067,562; U.S. Publication Number US20190360997; PacBio SMRT Sequencing (see https://www.pacb.com/smrt-science/smrt-sequencing/); Wenger, Aaron M., et al. “Accurate circular consensus long-read sequencing improves variant detection and assembly of a human genome.” Nature biotechnology 37.10 (2019): 1155-1162; Illumina's CirSeq (see https://www.illumina.com/science/sequencing-method-explorer/kits-and-arrays/cirseq.html); Acevedo, A., Andino R., “Library preparation for highly accurate population sequencing of RNA viruses.” Nat Protoc. 2014 July; 9 (7): 1760-9); Hunt, M., Silva, N.D., Otto, T. D. et al. “Circlator: automated circularization of genome assemblies using long sequencing reads.” Genome Biol 16, 294 (2015); and Wilson, Brandon D et al. “High-Fidelity Nanopore Sequencing of Ultra-Short DNA Targets.” Analytical chemistry vol. 91, 10 (2019): 6783-6789, all of which are incorporated herein by reference in their entirety). The sequencing may be, for example, next generation sequencing (NGS). The NGS may comprise, for example, circular consensus sequencing (CCS), sequencing by synthesis (SBS), nanopore sequencing, or other sequencing approaches. Examples of circular consensus sequencing are provided in Wenger, Aaron M., et al. “Accurate circular consensus long-read sequencing improves variant detection and assembly of a human genome.” Nature biotechnology 37.10 (2019): 1155-1162; Illumina's CirSeq (see https://www.illumina.com/science/sequencing-method-explorer/kits-and-arrays/cirseq.html); Acevedo, A., Andino R., “Library preparation for highly accurate population sequencing of RNA viruses.” Nat Protoc. 2014 July; 9 (7): 1760-9); Hunt, M., Silva, N. D., Otto, T. D. et al. “Circlator: automated circularization of genome assemblies using long sequencing reads.” Genome Biol 16, 294 (2015); and Wilson, Brandon D et al. “High-Fidelity Nanopore Sequencing of Ultra-Short DNA Targets.” Analytical chemistry vol. 91, 10 (2019): 6783-6789; U.S. Pat. Nos. 7,906,284; 10,563,255; and WO2009120374, all of which are incorporated herein by reference in their entirety. Examples of SBS include, but are not limited to Illumina, Inc.'s Cluster Generation technology (see “Technology Spotlight: Illumina Sequencing Technology,” which is incorporated herein by reference in its entirety.) In an aspect, the one or more reagent droplets contains at least one reagent for any of the methods of HMW extraction, amplification, or sequencing described herein. The reagent may be used for, e.g., PacBio library preparation. Methods of distribution as described herein may yield a high success rate for dispensation of droplets. The success rate may be defined as the accuracy of the dispensation of the droplet to a location. The location may be, for a example, a discrete location on a substrate or another droplet.

The method of distribution may be noncontact distribution. In noncontact distribution, a droplet may be dispensed from a device, e.g., a droplet dispenser, onto a substrate without touching a surface of the device to the substrate. One or more droplets may be distributed in this manner. Noncontact distribution may be used for any experiment known to the skilled artisan. For example, noncontact distribution may be used to distribute reagents for methods of amplification, HMW extraction, or sequencing. Noncontact distribution may yield a high success rate for dispensation of one or more droplets. Noncontact distribution may yield a success rate of at least about 60%, at least about 65%, at least about 70%, at least about 75%, at least about 80%, at least about 85%, at least about 90%, at least about 95%, or about 100%.

The method of distribution may be pseudo-contact distribution. In pseudo-contact distribution, a droplet may be dispensed from a device, e.g., a droplet dispenser, onto a discrete region such that the device does not touch the discrete region, but the dispensed droplet does make contact with the discrete region. The discrete region may be, e.g., a surface of the substrate, a region of the surface of the substrate, or a second droplet on the surface of the substrate. One or more droplets may be distributed in this manner. Pseudo-contact distribution may be used for any experiment known to the skilled artisan. For example, pseudo-contact distribution may be used to distribute reagents for methods of amplification, HMW extraction, or sequencing. Pseudo-contact distribution may yield a high success rate for dispensation of one or more droplets. Pseudo-contact distribution may yield a success rate of at least about 60%, at least about 65%, at least about 70%, at least about 75%, at least about 80%, at least about 85%, at least about 90%, at least about 95%, or about 100%. In some embodiments, pseudo-contact distribution may be effective for distribution of smaller volumes of droplets, e.g., at most about 10 microliters.

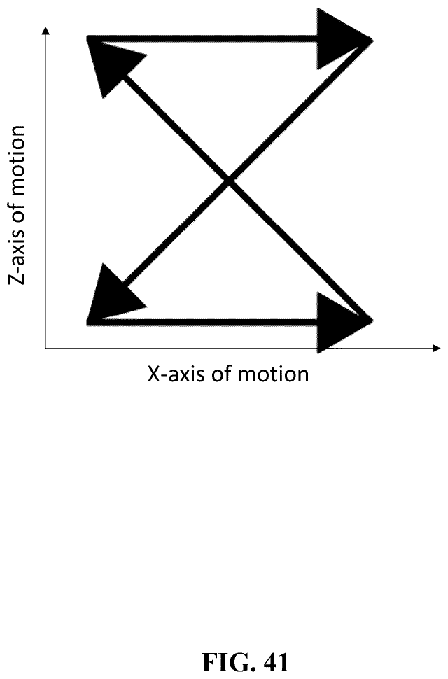

The method of distribution may be shaking a device, e.g., a droplet dispenser, that dispenses one or more droplets. One or more droplets may be distributed in this manner. Shaking distribution may be used for any experiment known to the skilled artisan. For example, shaking distribution may be used to distribute reagents for methods of amplification, HMW extraction, or sequencing. Shaking distribution may yield a high success rate for dispensation of one or more droplets. Shaking distribution may yield a success rate of at least about 60%, at least about 65%, at least about 70%, at least about 75%, at least about 80%, at least about 85%, at least about 90%, at least about 95%, or about 100%. In an exemplary mechanism, a shaking distribution may be in an eight-shaped pattern: a device for dispensing droplets, e.g., a droplet dispenser, may be manipulated to move with respect to the Z-axis or an X-axis with respect to a plane parallel to a surface of said substrate to form a “figure eight” shape. An example of such a pattern is provided in FIG. 41. In this pattern, the droplet dispenser may move at an amplitude with respect to a Z-axis and at an amplitude with respect to an Z-axis. The amplitude with respect to the Z-axis may be at least about 0.05 millimeters (mm), at least about 0.1 mm, at least about 0.15 mm, at least about 0.2 mm, at least about 0.25 mm, at least about 0.3 mm, at least about 0.35 mm, at least about 0.4 mm, at least about 0.45 mm, at least about 0.5 mm, at least about 0.6 mm, at least about 0.7 mm, at least about 0.8 mm, at least about 0.9 mm, at least about 1 mm or more. The amplitude with respect to the Z-axis may be about 0.2 mm. In this pattern, the droplet dispenser may move at an amplitude with respect to the X-axis. The amplitude with respect to the X-axis may be at least about 0.05 millimeters (mm), at least about 0.1 mm, at least about 0.15 mm, at least about 0.2 mm, at least about 0.25 mm, at least about 0.3 mm, at least about 0.35 mm, at least about 0.4 mm, at least about 0.45 mm, at least about 0.5 mm, at least about 0.6 mm, at least about 0.7 mm, at least about 0.8 mm, at least about 0.9 mm, at least about 1 mm or more. The amplitude with respect to the x-axis may be about 0.2 mm. The droplet dispenser may move with respect to both the Z-axis or an X-axis with respect to a plane parallel to a surface of said substrate.

A combination of two or more of noncontact distribution, shaking, and pseudo-contact distribution may be used. A combination of two or more of noncontact distribution, shaking, and pseudo-contact distribution may field a success rate of at least about 60%, at least about 65%, at least about 70%, at least about 75%, at least about 80%, at least about 85%, at least about 90%, at least about 95%, or about 100%.

### Tile Transformation

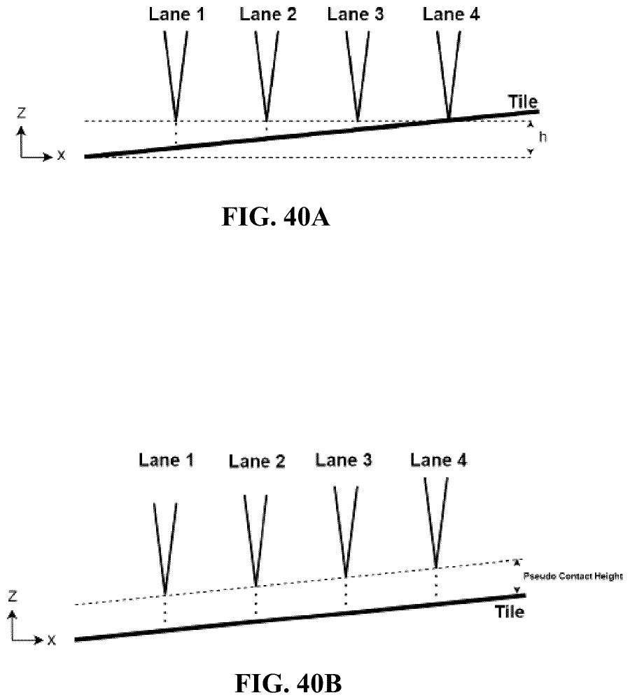

When implementing pseudo-contact distribution there may arise mechanical difficulties associated with using a pipette gantry which may be on a plane that is slightly misaligned to a plane of a substrate. The substrate may comprise one or more tiles. FIG. 40A demonstrates an exemplary outcome wherein a system fails to correct for the misalignment of the substrate to the pipette gantry. When a system fails to properly calculates a pseudo-contact height for a tile to which a droplet is to be dispensed, the resulting dispensation may be inconsistent in the individual lanes. In some lanes of the substrate, a pipette tip of the droplet dispenser may fail to make pseudo-contact, while in other lanes, the pipette tip may make actual contact with the substrate. FIG. 40B represents results after a proper transformation is applied to the position and height of the tiles with respect to the pipette gantry. With proper transformation pseudo-contact heights may be consistent across entire tiles, thereby leading to proper droplet distribution in every lane.

In order to successfully implement a pseudo-contact system in an automated workflow environment the controller may need to make adjustments to the angles of the gantry in order to facilitate pseudo-contact. In some embodiments, this may be accomplished using a coordinate transform from the frame of the tile to the pipette gantry to ensure that a pseudo-contact dispense may be performed at a consistent height above its target electrode. This step may be required where tile axes are misaligned with those of the gantry, as this misalignment causes the height of the electrode to be variable based on its location on the tile. Therefore, if a translation alone is calculated using the equation: GdTϵIR3, wherein the location of an electrode, e in the frame of the tile, T, is represented by T: T PeϵIR3 to obtain the tile in the frame of the gantry, G, followed by a pseudo-contact offset along the Z-axis of the gantry, h, the height of the pipette tip above the tile may not be consistent across all electrode locations. This poses risk for the pipette tip to collide with the tile or move to a height too high above it. This phenomenon is demonstrated in FIG. 40a.

In some embodiments, the controller instead may uses the transformation equation of _{G}T_{T}=[^{GR}^{_{T}}₀ ^{Gd}^{_{T}}₁]ϵSE(3) is used to adjust the frame of the tile on the substrate to that of the gantry wherein, the variables are the same as those in the transformation. The electrode position in the gantry frame become represented by the equation. The transformation may be applied to obtain the electrode position in the gantry frame, ^{T}PₑϵR3, as follows: _{G}Pₑ=^{G}R_{T}^{T}Pₑ+^{G}dᵣ. The pseudo-contact height can then be added to the transformed electrode position, properly adjusting for the differing angles of the two planes. FIG. 40B exhibits how the pipette tip will move to a consistent height above the tile for a pseudo-contact dispense after the transformation is applied.

### Magnets

Systems and methods as disclosed herein may comprise a droplet on a surface, wherein the surface is configured to support the droplet. The droplet may comprise an artifact. The artifact may be at least one bead formed of a material configured to couple to a magnetic field. A magnet may be configured to supply a magnetic field. An actuator may be operatively coupled to the magnet, and the actuator may be configured to subject the magnetic field to translation along a plane parallel to the surface. A may be controller operatively coupled to the actuator. The controller may direct the actuator to subject the magnetic field to translation along the plane, such that while the magnetic field translates along the plane, the droplet undergoes motion along the surface. The actuator can be a switch. The actuator can comprise motor coupled to the magnet, wherein the motor is configured to translate the magnet along a direction parallel to the surface. In some embodiments, the system further comprises an electrode configured to supply an electric field to the surface, wherein the electric field and the magnetic field are sufficient to subject the droplet to the motion. In some embodiments, the actuator is configured to motion the magnet to translate along at least two axes parallel to the plane. In some embodiments, the magnetic comprises a permanent magnet. In some embodiments, the magnet comprises at least one electromagnet. In some embodiments, the actuator comprises a pivot, wherein the pivot is coupled to the surface. In some embodiments, the surface comprises a dielectric disposed over one or more electrodes. In some embodiments, the one or more magnets are disposed below the surface. In some embodiments, the surface comprises a liquid layer. In some embodiments, the liquid layer comprises a liquid comprising an affinity for the surface.

Systems and methods as disclosed herein may comprise a liquid layer adjacent to a dielectric layer and a plurality of electrodes. The present disclosure provides a system for inducing motion in a droplet, comprising: (a) a surface configured to support the droplet comprising at least one bead formed of a material configured to couple to a magnetic field; (b) an actuator coupled a magnet, wherein the magnet is configured to supply the magnetic field, and wherein the actuator is configured to subject the magnetic field to translation along a plane parallel to the surface; and (c) a controller operatively coupled to the actuator, wherein the controller is configured to direct the actuator to subject the magnetic field to translation along the plane, such that while the magnetic field translates along the plane, the droplet undergoes motion along the surface. In some embodiments, the actuator is a switch. In some embodiments, the actuator comprises a motor coupled to the magnet, wherein the motor is configured to translate the magnet along a direction parallel to the surface. In some embodiments, the system further comprises an electrode configured to supply an electric field to the surface, wherein the electric field and the magnetic field are sufficient to subject the droplet to the motion. In some embodiments, the actuator is configured to motion the magnet to translate along at least two axes parallel to the plane. In some embodiments, the magnetic comprises a permanent magnet. In some embodiments, the magnet comprises at least one electromagnet. In some embodiments, the actuator comprises a pivot, wherein the pivot is coupled to the surface. In some embodiments, the surface comprises a dielectric disposed over one or more electrodes. In some embodiments, the one or more magnets are disposed below the surface. In some embodiments, the surface comprises a liquid layer. In some embodiments, the liquid layer comprises a liquid comprising an affinity for the surface. The system may include a magnetic bead-based separation unit for DNA size selection, DNA purification, protein purification, plasmid extraction and any other biological workflow that uses magnetic beads. The device may perform a number of simultaneous magnetic bead-based operations—from one to a million on a single chip.

### Vibration

Liquid droplets can be mixed in a variety of methods. The present disclosure provides methods by which vibration of a digital microfluidic surface can be used to assist in the mixing of liquids on the surface of the digital microfluidic device. The vibration may produce small-scale fluidic motion within a droplet on the surface of the digital microfluidic device. The motion may encourage diffusion and rapidly speed up the mixing process. The result is efficient capture of the DNA onto the magnetic microparticles and ultimately to a higher yield DNA extraction. In some embodiments, an electrowetting array comprising an open surface is provided.

Vibration based mixing is synergistic with electrowetting based mixing. While vibration mixing is effective at dispersing particles within portions of a liquid droplet, it is often less effective at macro-scale mixing across the entire droplet, especially for droplets with low contact angle with the surface. Electrowetting-based droplet mixing helps address this problem and with both vibration and electrowetting acting together, mixing of a wide variety of droplets of various compositions can be accomplished rapidly and effectively.

A common problem with digital microfluidics platforms is achieving robust mixing with all varieties of reagents and droplets. Highly viscous liquid droplets, for example, can be extremely difficult to mix effectively using a purely electrowetting based motion. These kinds of viscous droplets are important in a wide range of applications including DNA extraction from highly concentrated sample material where DNA needs to be efficiently bound to magnetic beads. Using purely electrowetting based motion to mix in these applications results in very poor mixing and therefore very poor DNA extraction from the sample droplet.

Implementation of devices, systems, and methods by which vibration and/or application of acoustic forces to the digital microfluidic surface can be used to assist in the mixing of liquids on the surface is described herein. The vibration, when tuned to the appropriate frequency and amplitude, produces small-scale fluidic motion within the droplet that encourages diffusion and rapidly speeds up the mixing process.

Vibration also contributes to enhanced mobility of droplets. This is especially true for droplets that contain particulates. Without vibration, large particles can tend to settle at the interface between the droplet and the substrate. When these particles are present at the droplet's contact line they can act to pin the droplet in place, restricting its mobility. The introduction of vibration can help keep particles from settling at the contact line and, in doing so, greatly improves the reliability of electrowetting mobility of particulate-carrying droplets.

Vibration also contributes to controlled immobility of droplets. The present disclosure provides systems and methods for immobilizing droplets. The method may comprise providing a droplet on an electrowetting array comprising a plurality of electrodes. A subset of the plurality of electrodes may comprise one or more adjacent electrodes forming a field on the surface comprising a discrete location. The one or more adjacent electrodes may be activated or deactivated in a pattern to immobilize the droplet. The pattern may be a cross shape. The horizontal and vertical elements of the electrode may be alternatively activated. The diameter of the discrete location may be at least about 50 micrometers (μm) to at least about 10 millimeters (mm). The diameter of the discrete location may at least about 50 μm, 60 μm, 70 μm, 80 μm, 90 μm, 100 μm, 200 μm, 300 μm, 400 μm, 500 μm, 600 μm, 700 μm, 800 μm, 900 μm, or more. The diameter of the discrete location may be at least about 1, 2, 3, 4, 5, 6, 7, 8, 9, 10, or more mm.

The vibration frequency and amplitude may need to be tuned to the droplet and the system dynamics. The resonant dynamics of the droplet depends on a number of factors including the volume, surface tension, and viscosity of the droplet. Droplets with higher contact angles tend to exhibit a greater response to the vibration while droplets that spread more readily on the surface (and have a lower contact angle) require greater amplitude to achieve comparable mixing. In order to achieve sufficient mixing of droplets using vibration the entire digital microfluidics device or parts of it can be displaced anywhere from a few micrometers to few millimeters. A displacement between 0.1 millimeters (mm) and 10 mm is a good range for this purpose. In the vibration assisted mixing schemes described above typical frequencies of vibrations may range from 1 Hertz (Hz) to 1 gigahertz (gHz). In the vibration assisted mixing schemes described above typical frequencies of vibrations may range from 1 Hertz (Hz) to 20 kilohertz (kHz).

Beyond vibration, in some embodiments, other methods to mix difficult-to-mix droplets may be used. If assistance is needed with resuspending magnetic beads, an alternating magnetic field may be used to resuspend and mix magnetic beads within a droplet. This may be accomplished with the use of rotating permanent magnets or with electromagnetic coils oriented in multiple axes around the droplet. Using the electrode grid itself, it is possible to mix the droplet by exciting a resonance using an alternating current circuit that oscillates the voltage on electrodes beneath the droplet. This actuation may benefit from having a low impedance path to the droplet itself in order to increase the magnitude of the response.

The present disclosure provides methods of electrowetting-based droplet mixing. In some embodiments, electrowetting-based droplet mixing comprises both vibration and electrowetting. In some embodiments, vibration and electrowetting act together and mix a wide variety of droplets. In some embodiments, vibration and electrowetting of various compositions may be accomplished rapidly and effectively. The frequency for electrowetting-based droplet mixing may be modulated. The amplitude for electrowetting-based droplet mixing may be modulated.

The vibration of the digital microfluidic surface may be accomplished through a number of approaches. In one embodiment, the surface itself may be used as a spring element whereby one end of the surface is fixed while the other is attached to an electro-mechanical actuator. In some embodiments, the electro-mechanical actuator is an oscillating mechanism or cantilever. In an exemplary embodiment, a gradient may be produced in the vibration energy across the length of the surface of a substrate. Droplets positioned closer to the vibrating edge of the cantilever will experience much greater amplitude than those closer to the fixed end. For example, electromagnetic actuators, voice coil actuators, piezoelectric actuators, ultrasonic transducers, rotating eccentric masses, motor driven linkage, and brushed/brushless/stepper motors with oscillating linkage mechanisms may be used.

In another embodiment, the whole surface may be translated vertically. This may be accomplished with an electro-mechanical actuator comprising various flexible elements (e.g. a linear flexure) or with traditional bearings. A uniform vibration amplitude may be produced across the entire surface (assuming a sufficiently rigid substrate is used). In some embodiments, one or more springs and/or other shock absorbers can be positioned beneath the surfaces described herein to facilitate vibration application to the surface via whole surface vertical translation.

The vibration mechanisms of constraining the motion of the surface described herein may be actuated through a number of different methods including electromagnetic actuators, piezoelectric actuators, ultrasonic transducers, rotating eccentric masses, as well as brushed/brushless/stepper motors with oscillating linkage mechanisms.

Electromagnetic voice coil actuators can be actuated at a wide range of frequencies and amplitudes and these can be controlled independently. Additionally, a variety of waveforms can be used to excite the actuator to achieve different effects. A sine wave can be used, for example, to produce quiet oscillation while a square wave may be used to excite the surface much more aggressively.

An exemplary system may include a dynamic system that may be modified or augmented through the use of external elements such as passive springs, dampers, or masses. These elements can be used, for example, to shift the resonant frequency of the system to one that is aligned with a resonant frequency of the droplets on the surface. This can be done passively or actively (with actuated spring elements). In some embodiments a disposable widget may be attached to the system between the surface and the system to modify the system for greater stability and reliable performance. This widget may be a sponge clip and may facilitate the vibration of the surface within the system.

In some embodiments the system may be leveled by the user through the use of a digital leveling interface. This digital leveling may increase the functionality of the vibrational mixing and decrease the occurrence of vibrational induced droplet splitting. This leveling interface may instruct the user on how to properly level the system and may ensure that it has been properly leveled through a leveling module configured to detect an angle of the surface.

In some embodiments, a voice coil actuator may be used to generate vibration. The voice coil actuator may comprise a permanent magnetic field assembly and a coil assembly. The voice coil actuator may be actuated at a wide range of frequencies and amplitudes. The voice coil actuator may be excited via a variety of waveforms. A sine wave can be used, for example, to produce quiet oscillation while a square wave may be used to excite the surface much more aggressively.

In some embodiments, a motor driven linkage may be used to generate vibration. A conventional brushless, brushed, or stepper motor may be used to turn a shaft. The shaft may be connected to a rigid-body or flexural linkage, which when turned, results in oscillatory motion of the output. The motor driven linkage may be augmented with, for example, passive spring, mass, and damping elements, to improve efficiency and allow for larger amplitude oscillations with less input power. For example, spring elements may be placed between the output of the linkage and the oscillating substrate. This embodiment is much less dependent on the system dynamics of the surface and motion constraint mechanisms but, as a result, may require more power input in order to achieve equivalent vibration output to a well-tuned dynamic system.

In some embodiments, a rotating eccentric mass may be used to generate vibration. The rotating eccentric mass may be off-center from the point of rotation. A motor may be mounted to an oscillating substrate (either directly or through coupling springs). The motor may spin an offset mass to create an oscillating acceleration. The operation of the rotating eccentric mass may cause an uneven centripetal force, which may in turn cause the motor to move backwards and forwards. The acceleration amplitude and frequency may be directly linked.

While the resonant frequency of the system may be excited at or close to the resonant peak in order to achieve best efficiency between input and output power. It may also be advantageous in some embodiments to excite the system far from the resonant frequency. This may be beneficial, for example, if it is desirable to excite the droplet with a roughly equivalent amplitude across a wide range of frequencies. This particular case can be readily achieved by tuning the system's natural frequency to be low relative to the desired frequency range and results in a near constant acceleration amplitude across a broad frequency range.

In another embodiment, a closed loop control can be utilized for fine control of amplitude independently from frequency. This may be accomplished, for example, with the use of an accelerometer mounted to the vibrating platform. A microcontroller may communicate with the sensor and calculate the acceleration amplitude in real time. Given some desired acceleration amplitude, the microcontroller can adjust the amplifier gain and modulate the drive waveform of the vibration actuator in order to precisely control the vibration amplitude.

### Properties of Arrays

Described herein are arrays and substrates configured to facilitate EWOD to induce droplet actuation. The array may comprise a plurality of elements which may comprise: a plurality of heaters, a plurality of coolers, a plurality of magnetic field generators, a plurality of electroporation units, a plurality of light sources, a plurality of radiation sources, a plurality of nucleic acids sequencers, a plurality of biological protein channels, a plurality of solid state nanopores, a plurality of protein sequencers, a plurality of acoustic transducers, a plurality of microelectromechanical system (MEMS) transducers, a plurality of capillary tubes as liquid dispensers, a plurality of holes for dispensing or transferring liquids using gravity, a plurality of electrodes in a hole to dispense or transfer liquids using electric field, a plurality of holes for optical inspection, a plurality of holes for liquids to interact through membranes, or any combination thereof. The plurality of elements may comprise less than or equal to about 100, 90, 80, 70, 60, 50, 40, 30, 20, 10, 5, 4, 3, 2 or less of each element. The plurality of elements may comprise greater than or equal to about 2, 3, 4, 5, 6, 7, 8, 9, 10, 20, 30, 40, 50, 60, 70, 80, 90, 100 or more of each element.

The heater may have a maximum temperature less than or equal to about 150° C., 125° C., 100° C., 75° C., 50° C., 25° C., or less. The heater may be thermoelectric, resistive, or heated by a heat transfer medium (e.g., a recirculated hot water loop). The cooler may have a minimum temperature greater than or equal to about −50° C., −25° C., −10° C., −5° C., 0° C., 10° C., or more. The cooler may be thermoelectric, evaporative, or cooled by a heat transfer medium (e.g., a water chiller). The magnetic field generator may be for magnetic bead based operations or for other operations requiring magnetic field. The magnetic field generator may be electromagnets.

The electroporation unit may be two or more electrodes on either side of the droplet.

The light source may be broadband, monochromatic, or a combination thereof. The light source may be an incandescent source, a light emitting diode (LED), a laser, or a combination thereof. The light source may emit polarized light, collimated light, or a combination thereof. The plurality of radiation sources may emit ultraviolet light (light of a wavelength from 10 nm to 400 nm), x-rays, gamma rays, alpha particles, beta particles, or a combination thereof. The radiation source may be collimated.

### Electrowetting-Based Mixing

The present disclosure provides systems and methods for electrowetting-based mixing of droplet. Typically, mechanical agitation, i.e., mixing without using electrowetting, may be used to mix one or more droplets. The mechanical agitation of droplets and puddles by, e.g., vibration or movement of a magnetic field may be capable of assisting with mixing of the droplets and puddles. Electrowetting may be employed in mixing droplets and puddles that are difficult to mix. This also includes resuspension of particles, such as magnetic beads, within the drop without the use of any mechanical agitation. This may be done by either exciting a resonant mode of the drop or by exciting a faraday wave within the puddle.

### Patterns

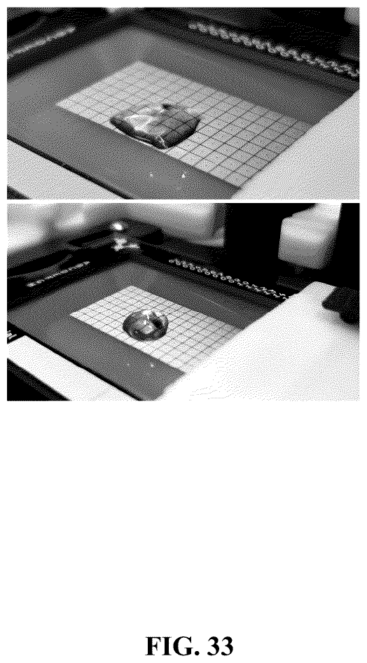

Electrowetting-based agitation and mixing may be accomplished by applying a temporally- and/or spatially-patterned activation of electrodes in the electrode array. The temporal pattern of the electrode activation may include a single frequency of activation or multiple frequencies overlaid. The frequency that results in maximum agitation and mixing is dependent upon the fluid properties of the droplet, especially surface tension or viscosity. Droplets with low surface tension or high viscosity tend to respond more vigorously to lower frequency (<15 Hz) stimulation, while drops with higher surface tension and low viscosity respond more vigorously at higher frequencies (>15 Hz). Droplets of greater size may response to lower frequencies while droplets of smaller size may respond to higher frequencies. At certain size ranges, for droplets of, e.g., water, frequencies in the range of 40 to 55 Hz may be most effective at producing a strong mixing response in the drop. At certain size ranges, for droplets of, e.g., 70% ethanol, frequencies in the range of 2 to 15 Hz may produce the strongest response (FIG. 33).

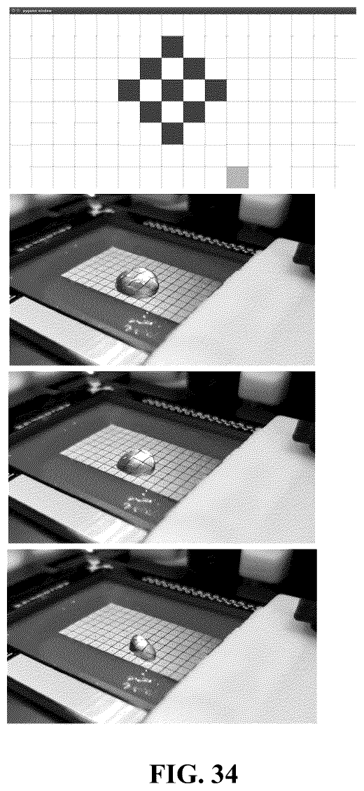

The electrode activation can also be spatially patterned in order to get a stronger mixing and agitation response. The spatial pattern of the active electrodes is important and depends on the size of the drop being agitated. In general, the size of the active electrode may scale with the diameter of the drop. To be able to effectively mix and agitate a range of different drop sizes with a single electrode activation pattern, a chessboard pattern may be used. This pattern is relatively agnostic to drop size because it has a uniform number of activated and deactivated electrodes throughout the electrowetting array, thereby maximizing the perimeter between inactive and active electrodes, and allowing the droplet to spread easily no matter where it is positioned (FIG. 34).

### Localization

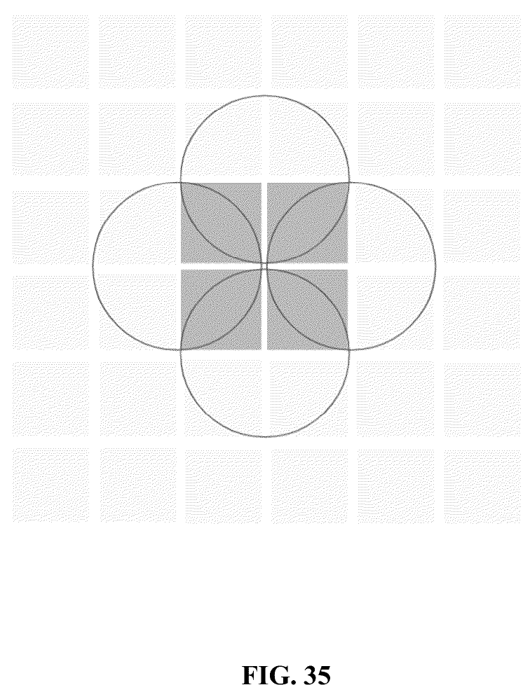

Spatial electrode activation patterns can also be used to improve the localization of droplets on the EWOD grid. When driving the active electrodes with high frequency (>100 Hz) alternating electric field, drops are attracted to the boundary between inactive and active electrodes. This is because the droplets are driven towards being 50% on activated and deactivated electrodes and may spread to increase their surface area in approaching this goal. For simple contiguous electrode patterns this can result in droplets not having a well determined location. For example, with a 2×2 electrode grid active, a droplet will localize itself anywhere along the perimeter of the 2×2 grid (FIG. 35).

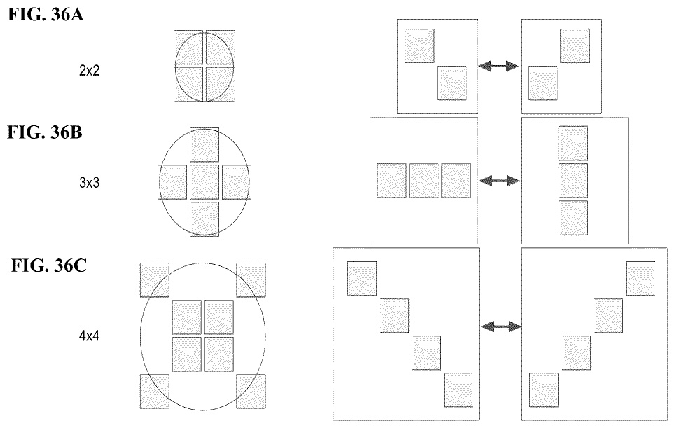

An alternative is to use a spatial electrode pattern to better determine the localization of the droplet with respect to the active electrodes. One such embodiment of this involves a cross shape with alternating activation of the vertical and horizontal element. Other embodiments may involve diagonal crosses (FIG. 36).

Localization methods may also be used to immobilize droplets. The method may comprise providing a droplet on an electrowetting array comprising a plurality of electrodes. A subset of the plurality of electrodes may comprise one or more adjacent electrodes forming a field on the surface comprising a discrete location. The one or more adjacent electrodes may be activated or deactivated in a pattern to immobilize the droplet. The pattern may be a cross shape. The horizontal and vertical elements of the electrode may be alternatively activated. The diameter of the discrete location may be at least about 50 micrometers (μm) to at least about 10 millimeters (mm). The diameter of the discrete location may at least about 50 μm, 60 μm, 70 μm, 80 μm, 90 μm, 100 μm, 200 μm, 300 μm, 400 μm, 500 μm, 600 μm, 700 μm, 800 μm, 900 μm, or more. The diameter of the discrete location may be at least about 1, 2, 3, 4, 5, 6, 7, 8, 9, 10, or more mm.

### Computer Systems

Various processes described herein may be implemented by appropriately programmed general purpose computers, special purpose computers, and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more 10 scripts, or in other forms. The processing may be performed on one or more microprocessors, central processing units (CPUs), computing devices, microcontrollers, digital signal processors, or like devices or any combination thereof. Programs that implement the processing and the data operated on, may be stored and transmitted using a variety of media. In some cases, hardwired circuitry or custom hardware may be used in place of, or in combination with, some or all 15 of the software instructions that can implement the processes. Algorithms other than those described may be used.

Programs and data may be stored in various media appropriate to the purpose, or a combination of heterogenous media that may be read and/or written by a computer, a processor or a like device. The media may include non-volatile media, volatile media, optical or magnetic 20 media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including 25 the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination thereof). Each of the devices may themselves comprise computers or other computing devices, such as those based on the Intel® Pentium® or Centrino™ processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices

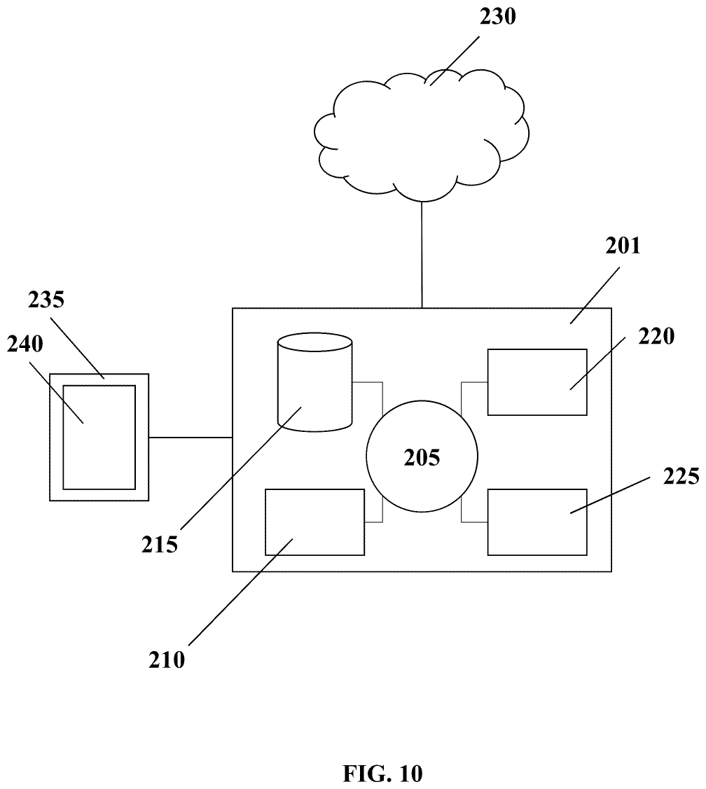

The present disclosure provides computer systems that are programmed to implement methods of the disclosure. FIG. 10 Shows a computer system 1001 that is programmed or otherwise configured to manipulate a droplet, or a plurality thereof, on a system described herein. The computer system 1001 can regulate various aspects of sample manipulation of the present disclosure, such as, for example, droplet size, droplet volume, droplet position, droplet speed, droplet wetting, droplet temperature, droplet pH, beads in droplets, number of cells in droplets, droplet color, concentration of chemical material, concentration of biological substance, or any combination thereof. The computer system 1101 can be an electronic device of a user or a computer system that is remotely located with respect to the electronic device. The electronic device can be a mobile electronic device.

The computer system 1001 includes a central processing unit (CPU, also “processor” and “computer processor” herein) 1005, which can be a single core or multi core processor, or a plurality of processors for parallel processing. The computer system 1001 also includes memory or memory location 1010 (e.g., random-access memory, read-only memory, flash memory), electronic storage unit 1015 (e.g., hard disk), communication interface 1020 (e.g., network adapter) for communicating with one or more other systems, and peripheral devices 1025, such as cache, other memory, data storage, electronic display adapters, or any combination thereof. The memory 1010, storage unit 1015, interface 1020 and peripheral devices 1025 are in communication with the CPU 1005 through a communication bus (solid lines), such as a motherboard. The storage unit 1015 can be a data storage unit (or data repository) for storing data. The computer system 1001 can be operatively coupled to a computer network (“network”) 1030 with the aid of the communication interface 1020. The network 1030 can be the Internet, an internet, extranet, or any combination thereof, or an intranet, extranet, or any combination thereof that is in communication with the Internet. The network 1030 in some cases is a telecommunication, data network, or any combination thereof. The network 1030 can include one or more computer servers, which can enable distributed computing, such as cloud computing. The network 1030, in some cases with the aid of the computer system 1001, can implement a peer-to-peer network, which may enable devices coupled to the computer system 1001 to behave as a client or a server.

The CPU 1005 can execute a sequence of machine-readable instructions, which can be embodied in a program or software. The instructions may be stored in a memory location, such as the memory 1010. The instructions can be directed to the CPU 1005, which can subsequently program or otherwise configure the CPU 1005 to implement methods of the present disclosure. Examples of operations performed by the CPU 1005 can include fetch, decode, execute, and writeback.

The CPU 1005 can be part of a circuit, such as an integrated circuit. One or more other components of the system 1101 can be included in the circuit. In some cases, the circuit is an application specific integrated circuit (ASIC).

The storage unit 1015 can store files, such as drivers, libraries and saved programs. The storage unit 1015 can store user data, e.g., user preferences and user programs. The computer system 1001 in some cases can include one or more additional data storage units that are external to the computer system 1001, such as located on a remote server that is in communication with the computer system 1001 through an intranet or the Internet.

The computer system 1001 can communicate with one or more remote computer systems through the network 1030. For instance, the computer system 1001 can communicate with a remote computer system of a user (e.g., mobile electronic device). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 1001 via the network 1030.

Methods as described herein can be implemented by way of machine (e.g., computer processor) executable code stored on an electronic storage location of the computer system 1001, such as, for example, on the memory 1010 or electronic storage unit 1015. The machine executable or machine readable code can be provided in the form of software. During use, the code can be executed by the processor 1005. In some cases, the code can be retrieved from the storage unit 1015 and stored on the memory 1010 for ready access by the processor 1005. In some situations, the electronic storage unit 1015 can be precluded, and machine-executable instructions are stored on memory 1010.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1001, can be embodied in programming. Various aspects of the technology may be thought of as “products” or “articles of manufacture” typically in the form of machine (or processor) executable code, associated data, or any combination thereof that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code, data, or any combination thereof. Many of these forms of computer readable media may be involved in carrying one or more sequences of one or more instructions to a processor for execution.

The computer system 1001 can include or be in communication with an electronic display 1035 that comprises a user interface (UI) 1040 for providing, for example, information related to droplet manipulation, sample manipulation, or a combination thereof. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1105. The algorithm can, for example, provide additional liquid to a droplet, replace evaporated solvent of a droplet, map out a path for a droplet, or any combination thereof.

Video, input, and control of the system may be accessed through a web-based software application. User inputs through software may include, for example, droplet motion, droplet sizes, and images of the array, and user inputs may be recorded and stored in a cloud-based computing system. Stored user inputs may be accessed and retrieved in subsets or in entirety to inform machine-learning based algorithms. Droplet movement patterns may be recorded and analyzed for use in training navigation algorithms. Trained algorithms may be used for automation of droplet movement. Spatial fluid properties may be recorded and analyzed for use in training protocol optimization and generation algorithms. Trained algorithms may be used for optimizing biological and droplet movement protocols or in the generation of new biological and droplet movement protocols. Biological quality control techniques (e.g., amplification-based quantification methods, fluorescence-based, absorbance-based quantification, surface plasmon resonance methods, and capillary-electrophoretic methods to analyze nucleic acid fragment size) may be used to analyze the effectiveness of the workflows performed on the array. The data from these techniques may then be used as an input into machine learning algorithms to improve output. The process may be automated so that the system can iteratively improve the output.

### Definitions

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “droplet”, as used herein, generally refers to a discrete or finite volume of a fluid (e.g., a liquid). A droplet may be generated by one phase separated from another phase by an interface. The droplet may be a first phase phase-separated from another phase. The droplet me include a single phase or multiple phases (e.g., an aqueous phase containing a polymer). The droplet may be a liquid phase disposed adjacent to a surface and in contact with a separate phase (e.g., gas phase, such as air).

The term “biological sample,” as used herein, generally refers to a biological material. Such biological material may display bioactivity or be bioactive. Such biological material may be, or may include, a deoxyribonucleic acid (DNA) molecule, a ribonucleic acid (RNA) molecule, a polypeptide (e.g., protein), or any combination thereof. A biological sample (or sample) may be a tissue sample, such as a biopsy, core biopsy, needle aspirate, or fine needle aspirate. The sample may be a fluid sample, such as a blood sample, urine sample, stool sample, or saliva sample. The sample may be a skin sample. The sample may be a cheek swab. The sample may be a plasma or serum sample. The sample may be a plant derived sample, water sample or soil sample. The sample may be extraterrestrial. The extraterrestrial sample may contain biological material. The sample may be a cell-free (or cell free) sample. A cell-free sample may include extracellular polynucleotides. Extracellular polynucleotides may be isolated from a bodily sample that may be selected from a group consisting of blood, plasma, serum, urine, saliva, mucosal excretions, sputum, stool and tears. The sample may include a eukaryotic cell or a plurality thereof. The sample may include a prokaryotic cell or a plurality thereof. The sample may include a virus. The sample may include a compound derived from an organism. The sample may be from a plant. The sample may be from an animal. The sample may be from an animal suspected of having or carrying a disease. The sample may be from a mammal.

The term “% glycerol,” as used herein, generally refers to the viscosity of a solution as compared to a glycerol in water solution wherein the amount of glycerol in water (by volume) is determined by the value of the percentage. For example, a solution described herein with a viscosity of about “30% glycerol” expresses that the viscosity of the solution is the equivalent of a glycerol in water solution comprising about 30% glycerol.

The term “subject,” as used herein, generally refers to an animal, such as a mammal (e.g., human) or avian (e.g., bird), or other organism, such as a plant. The subject can be a vertebrate, a mammal, a rodent (e.g., a mouse), a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, an individual that needs therapy or suspected of needing therapy, or any combination thereof. A subject can be a patient.

The term “error margin” as used herein generally refers to a difference between an intended manipulation (e.g., aspiration or dispensation) location of a droplet and an actual manipulation location of the droplet.

The term “offload dead volume” as used herein generally refers to a percentage of a droplet remaining after the droplet has been aspirated (e.g., by a droplet dispenser.)

### EXAMPLES

### Example 1: Next-Generation Sequencing Library Preparation Platform

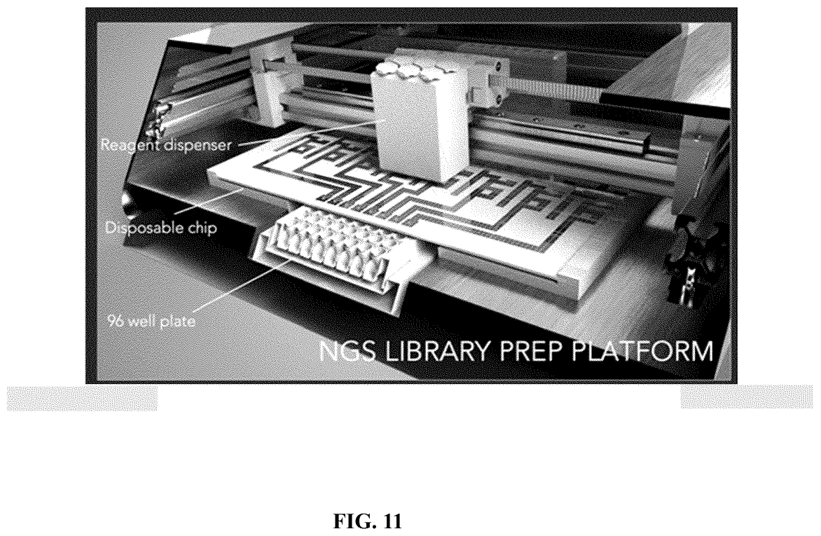

FIG. 11 represents an example of a next-generation sequencing library preparation platform described herein. The system is capable of processing biological samples, and comprises: a reagent dispenser, a plurality of 96 well plates, and a disposable chip. The reagent dispenser processes, for example, various biological samples (e.g., proteins, peptides, nucleic acids, polymers, monomers, cells, tissues, etc.), chemical reagents, solvents, liquids, gasses, solids, or any combination thereof. The disposable plate provides a surface for sample manipulation that is done directly on the surface, in an open environment, using, for example, acoustic waves, vibrations, air pressure, light field, magnetic field, gravitational field, centrifugal force, hydrodynamic forces, electrophoretic forces, dielectrowetting force, capillary forces, or any combination thereof. The samples are moved on the disposable chip to an assay, such as, for example, a 96 well plate, where attributes of a sample are measured. Reactions are done either directly on the surface or in the assay. Reagents are combined in the reagent dispenser, on the surface of the system, in the assay, or any combination thereof. Measurements of the biological sample, or plurality thereof, are performed in the reagent dispenser, on the surface of the system, in the assay, or any combination thereof. The system is pre-programmed, controlled in real time by a user, or any combination thereof. The system provides a way to manipulate biological samples for next generation sequencing library preparation with minimal sample manipulation.

### Example 2: Electrowetting Array Comprising a Lubricating Fluid Disposed on the Surface of the Array

A smooth dielectric film (textureless) with lubricating oil film together providing a low friction surface can be used for efficient manipulation of droplets using electrowetting or other digital microfluidic or droplet manipulation approaches. In prior disclosures (US20190262829A1), the lubricating oil film is formed on a textured surface. However, an alternate approach that does not require a porous dielectric film to hold the lubricating oil but instead relies on chemical affinity between the surface of the film and the lubricating oil is proposed herein.

Similarly to the devices and systems described herein wherein the droplet motions across a liquid surface disposed on a textured surface, in the case of a textureless surface, the droplet is again above the surface of a lubricating film. The lubricating film comprises a lubricating liquid immiscible with the droplet. The lubricant film is thermodynamically stable such that it preferentially wets the surface of the dielectric and droplets sit on top of the lubricant film. Achieving this stability is important and is governed by the affinity of the lubricant liquid to the surface of the dielectric. For fluorinated surfaces of dielectric, it may be advantageous to use fluorinated lubricant liquids. The similar chemical structure leads to a greater affinity and therefore the lubricant is more likely to wet the surface in a stable way. On the other hand, when using dielectrics with hydrocarbon-based surfaces, or siliconized surfaces, (such as silicones and untreated polymer plastics), it may be advantageous to use a hydrocarbon based lubricant liquid (such as silicone oil).

The lubricating film can include, but is not limited to:

Silicone oils: polydimethylsiloxanes, polymethyl hydrogen siloxane/hydrogen silicone oil, amino silicone oil, phenyl methyl silicone oil, Dipheny silicone oil, vinyl silicone oil, hydroxy silicone oil, cyclosiloxanes, polyalkylene oxide silicones.

Fluorinated oils: perfluoropolyether (PFPE), perfluoroalkanes, fluorinated ionic fluid, fluorinated silicone oils, perfluoroalkylether, perfluoro tri-n-butylamine (FC-40), hydrofluoroether (HFE) liquids.

Other lubricants: ionic liquids, mineral oils, ferrofluids, polyphenyl ether, vegetable oil, esters of saturated fatty and dibasic acids, grease, fatty acids, triglycerides, polyalphaolefin, polyglycol hydrocarbons, other Non-hydrocarbon synthetic oils.

Lubricant liquid may contain other functional additives, including surfactants, electrolytes, rheology modifier, wax, graphite, graphene, molybdenum disulfide, PTFE particles.

### Example 3: Electrowetting Array Comprising a Filler Fluid Below the Dielectric

The devices and systems described herein generally include a dielectric layer disposed on a layer of co-planar (or nearly co-planar) electrodes. Described herein, are further embodiments wherein the devices and systems include a filler fluid disposed below the dielectric layer.

The filler fluid below the film serves to keep the dielectric film in close contact with the underlying PCB substrate and electrode grid through surface tension. When a dielectric film is applied to the surface of an electrode array, a layer of oil fills the air gap between the film and the electrodes and the air gap between the electrodes. So, while filling the air gap between the electrodes and the film, the oil layer keeps the film adhered to the surface via surface tension. Further, filling the airgap between any two neighboring electrodes the oil acts as a high dielectric breakdown material and prevents air from breaking down.

Air typically has a breakdown voltage of about 1 kilovolt per millimeter. So while reducing the gap between two neighboring electrodes is beneficial to allow for smooth transition of droplets, if the gap between two electrodes is reduced at some point, then it will start conducting and rendering the electrowetting device non-functional. By adding a lubricant to fill the gap between two electrodes, the gap between the electrodes will be reduced and high voltages can be utilized for reliable droplet motion.

A layer of oil below the dielectric film also has the benefit of smoothening the surface of the film. It allows for the dielectric film to easily stretch and unstretch on a lubricated layer. This easy stretching-unstretching allows for the film settle with no wrinkles in the film. Wrinkles in the film can prevent droplets from being mobile and/or provide further hinderances to droplet motion.

Finally, having a layer of oil below the dielectric film provides a way to easily attach and detach the film from an electrode array. The filler oil layer here acts as a semi-permanent adhesive and keeps the dielectric layer on the electrode array when the device is in use. However, a user can easily remove the dielectric layer from the surface since it is not permanently fixed to the surface of the electrode array. The alternative to not using oil may mean that the dielectric film/layer is permanently attached to the electrode array or the user may need more complex instrumentation to pull the film down to the surface evenly across the entire surface. In these embodiments, the use of the filler fluid on the electrode array can enable devices and systems with removable “cartridges” wherein the cartridges can include the surface which supports the droplet.

### Example 4: Enzymatic DNA Synthesis

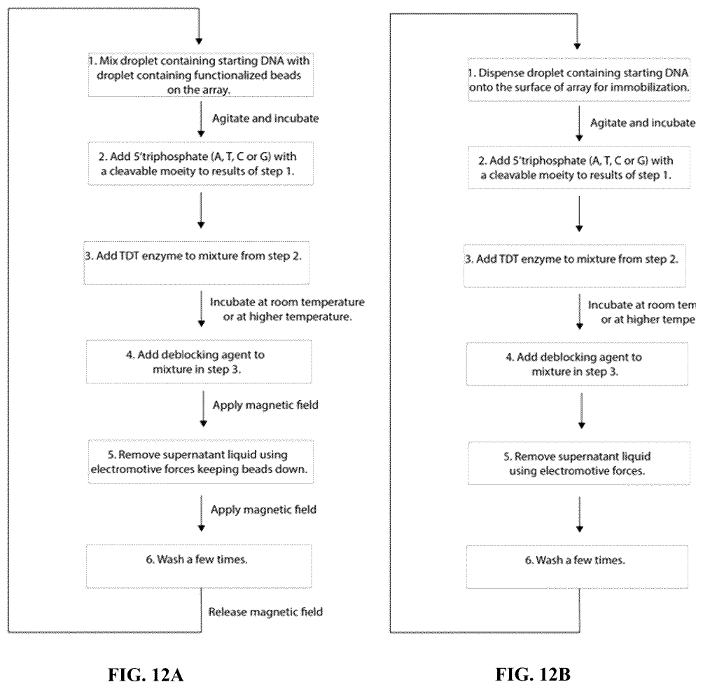

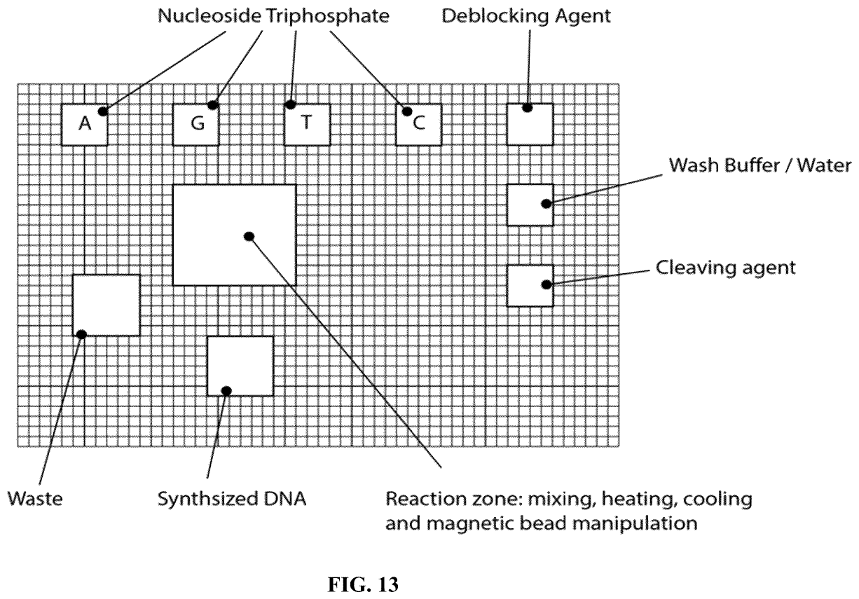

A method to synthesize polynucleotides (e.g., DNA) using an enzyme catalyzed process in an aqueous medium on arrays described herein was performed. Terminal Deoxynucleotidyl Transferase (TDT) is a template independent polymerase that catalyzes the formation of phosphodiester bonds between the 3′ and 5′ end of DNA. FIG. 12A and FIG. 12B show example workflows to afford the synthesis of DNA. FIG. 13 shows a schematic diagram for a single reaction site that performs step by step addition of nucleotides to synthesize a long molecule of DNA.

Aspects of the present disclosure provide that a reagent comprises of an enzyme that mediates synthesis or polymerization. In some embodiments, the first reagent, second reagent, third reagent, or any combination thereof comprises an enzyme that mediates synthesis or polymerization. In some embodiments, the enzyme is from the group consisting of Polynucleotide Phosphorylase (PNPase), Terminal Denucleotidyl Transferas (TdT), DNA polymerase Beta, DNA polymerase lambda, DNA polymerase mu and other enzymes from X family of DNA polymerases.

A droplet containing a starting DNA material with an unprotected 3′-hydroxyl group is mixed with a droplet containing functionalized magnetic beads. After a brief period of agitation, the DNA molecules are bound to the magnetic beads. Alternatively, a droplet containing starting DNA material is dispensed onto a location of the array that is functionalized to immobilize the DNA to a solid support. A droplet containing a nucleoside 5′-triphosphate with a cleavable/removable moiety is mixed with the droplet containing immobilized starting DNA. TDT enzyme, which catalyzes the 5′ to 3′ phosphodiester linkage between the unprotected 3′-hydroxyl end of the starting DNA and the 5′-phosphate end of the nucleoside triphosphate, in a droplet is then merged and mixed with the droplet containing immobilized DNA. The reaction is incubated for at room temperature or higher temperature for 5-30 minutes.

A droplet containing a deblocking agent is then mixed with the subsequent reaction mixture, producing the nucleotide with a free 3′-hydroxyl. In the case of using magnetic beads for immobilization, a magnetic field is then applied to pull the beads down to the surface of the array and the excess liquid is removed. The beads are then washed multiple times (e.g., 2-4) by flowing a washing buffer over the beads. The washed liquid is then discarded to the waste area of the array. Additional nucleotides are added to the DNA by repeating the method described above. During each addition of a nucleoside triphosphate, a controller instructs the array to dispense one of the nucleoside triphosphates from respective reservoirs. After multiple iterations, a polynucleotide of known sequence is produced, staying immobilized either to the beads or on the functional surface of the array. The final DNA product is cleaved and released from the surface (e.g., the beads or the surface of the array) by bringing a droplet containing a cleaving agent. The final product is then suspended in a droplet and recovered from the array.

Errors in DNA synthesis can be corrected with mismatch binding and mismatch cleaving proteins. A mismatch binding protein (e.g., MutS) is bound to a magnetic bead and mixed with a droplet containing assembled DNA comprising at least one error (e.g., identified as distortion in the double helix). For example, DNA molecules comprising an error are bound to the magnetic beads and the DNA without errors are not attached to the beads. The beads are then moved to another area of the array using a magnetic field, removing the DNA comprising at least one error. The excess liquid containing DNA with no errors is separated from the beads using electromotive force (e.g., EWOD).

Alternately, errors are corrected using mismatch cleaving enzymes, such as, for example, T4 endonuclease VII or T7 endonuclease I. A droplet comprising a cleaving enzyme is mixed with a droplet containing assembled DNA. The mismatch cleaving enzymes target the regions at or near the errors. The error-free fragments are then retrieved using magnetic bead-based separation. Alternately, exonucleases are used to remove additional errors on fragments left over by the mismatch cleaving enzymes. These trimmed fragments are assembled correctly using PCR assembly in a droplet.

The assembled and error corrected DNA is amplified using PCR in a droplet. The final product from PCR is then prepared into libraries for sequencing on the array using methods described herein. The libraries are sequenced using any of the sequencing techniques described herein for final sequence verification of the synthesized DNA.

The protocols described herein were performed using the platform using a 10 base initiator DNA. Two reactions were performed to synthesize the addition of 5 and 10 thymine bases to the base DNA. The results were analyzed using denaturing polyacrylamide gel electrophoresis on an Azure 600 with blue light illumination. The DNA was conjugated to fluorescein dye for visualization. The synthesis was confirmed by Agarose gel assay.

The protocol described herein has also been used to prepare function DNA primers for use in PCR amplification. A forward and reverse primer were synthesized at a 200 pmole scale and required manual post synthesis processing. Functionality of the primers was assayed by performing a 40 cycle PCR protocol and having the results analyzed using 2% Agarose gel (e-gel EX). The results, confirmed by gel assays, suggest that the primers synthesized using the systems and methods described herein have comparable functionality as IDT DNA primers based on the endpoint PCR analysis.

### Example 5: Extraction of High Molecular Weight (HMW) Nucleic Acid

Cells from various sources (e.g., mammalian, bacterial, plants) are lysed directly on the array by merging a droplet containing cells with another droplet containing lysis agent (e.g., detergent or enzymatic). This mixture is heated and mixed (e.g., separately or simultaneously) on the EWOD array to promote lysis of cells and, if applicable, lysis of the nucleus. Enzymatic digestion of proteins, RNA, or a combination thereof are performed to improve the purity of the sample. While cells are lysed, the progress of lysis reaction and lysis efficiency is monitored via DNA-specific fluorescent stains. DNA is purified directly on the array by solid phase (e.g., bead-based capture or by precipitation (e.g. salt and ethanol or phenol-chloroform extraction)). Recovered DNA is manipulated and transferred to different locations of the array by EWOD with minimal shearing. DNA purity, critical for high quality long-read sequencing, is improved by increasing the number of washing cycles performed on the array. Small DNA fragments are removed using silica-nanostructured magnetic disks. The yield of recovered DNA is increased by performing additional successive elution in buffers.

After DNA extraction, samples are analyzed by Pulse Field Gel Electrophoresis (PFGE), quantifying size distribution for each sample relative to one another and analyzing commercially available ladders (BioRad) and ImageJ (NIH) profile analysis tools. For smaller inputs, (e.g., cell input) recovery/size distribution is measured by Femto Pulse (Agilent) and qPCR for lower input amounts. Genomic intactness is assessed by additional complementary methods, e.g. the BioNano Genomics Saphyr System, allowing rapid and cost-effective prototyping at a macro scale as well as independent comparability of data using the Saphyr System.

The passivation of the EWOD surface is determined by testing DNA deposition and retention in the presence of solution- and surface-deposited PEG200 or BlockAid (Invitrogen) passivated devices. Measurements are obtained i) by staining the surfaces after use with Hoechst 33342, ii) calculating surface retention of a commercial preparation of Lambda DNA (New England Biolabs, linearized 48.5 Kb), and/or iii) measuring % loss by qPCR of sample pre- and post-manipulation and input quantities from 109 to 102 copies of DNA.

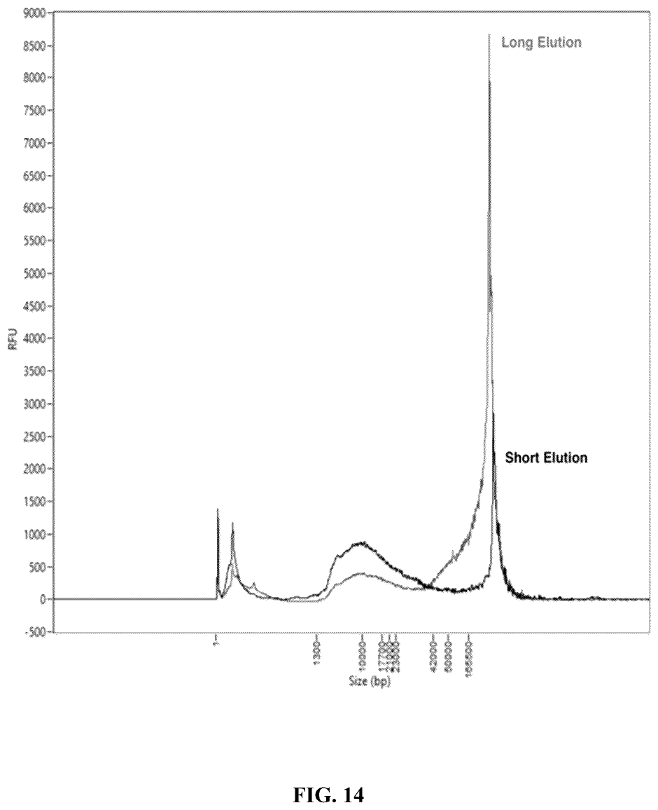

Mammalian cell lysis, RNA, and protein digestion followed by HMW DNA isolation was performed on the EWOD array. The distribution of the high molecular weight DNA fragments are seen in FIG. 14 with DNA fragments larger than 165,000 bp being isolated from the sample. The longer duration of elution recovers more DNA (e.g., indicated by the taller peak) and is a way to obtain higher DNA yield.

These techniques were utilized to prepare DNA libraries for sequencing as described in the following examples.

### Example 6: Next-Generation Sequencing (NGS) Library Preparation

224 nanograms (ng) of purified genomic DNA was used as starting material and Genome In A Bottle NA12878 was used as the DNA source. Final libraries were amplified by two cycles of PCR, which was performed on a thermal cycler in a separate post-PCR area. A control library was performed off-chip manually for data comparison. Libraries were quantified by Qubit and fragment size distribution was assessed by BioAnalyzer. Libraries were normalized accordingly and sequenced on a NextSeq500 (e.g., shallow sequencing with initial mid-output run at 2×75 cycles and 2×8 cycles for the indexes followed by additional coverage generation with a high-output 2×150 cycles run). Sequencing data was demultiplexed using Illumina's bcl2fastq v2.20 without adapter trimming. Bioinformatics analysis was performed using well-established algorithms (e.g., FASTQC, BWA-MEM, SAMtools, Picard and GATK).

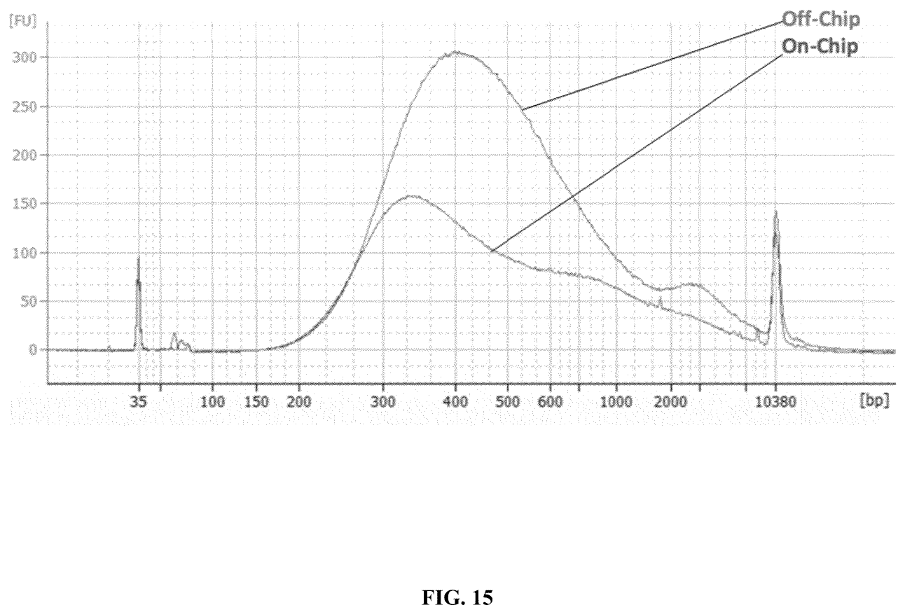

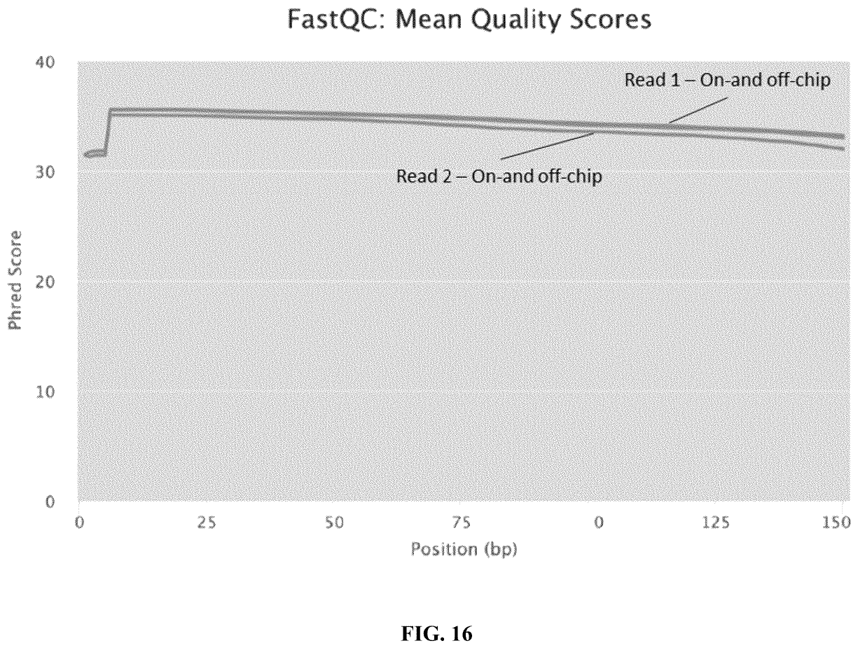

The library prepared on chip generated enough material for sequencing (Table 1). The off-chip control generated ˜2.3× more DNA material than the on-chip experiment; however, the average fragment size was higher than described previously for both on-chip and off-chip libraries (Table 1 & FIG. 15). All sequencing and mapping QC data demonstrated that high quality sequencing libraries were generated (Table 1), with Q30>90% (FIG. 16), % PF reads >90%, using systems and methods described herein.

TABLE 1

| | Target | | Manual - |
|---|---|---|---|
| Metrics | Value | On Chip | Off Chip |
| DNA Yield | 125-625 ng | 294.32 | 712.4 |
| Average | 250 bp | 450 | 467 |
| Fragment | | | |
| Size | | | |
| Number | — | 158693266 | 106693500 |
| of Reads | | | |
| Q30 | >75% | 93.35% | |
| PF Reads | >80% | 92.90% | |
| % Duplicates | — | 9.35% | 8% |
| % PF reads | >0.9 | 0.994232 | 0.993074 |
| aligned | | | |
| (hg19) | | | |
| Median | — | 9 | 7 |
| Coverage | | | |
| HET SNP | >0.8 | 0.836866 | .875379 |
| Sensitivity | | | |

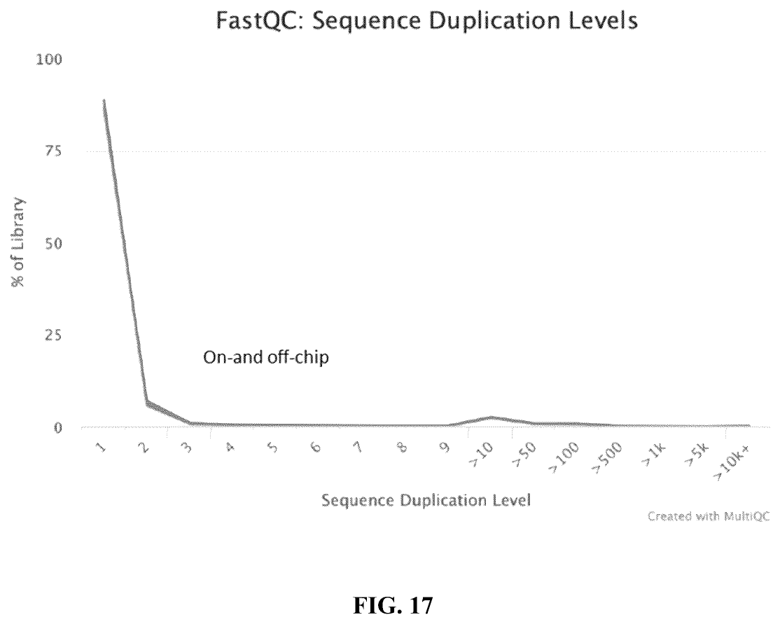

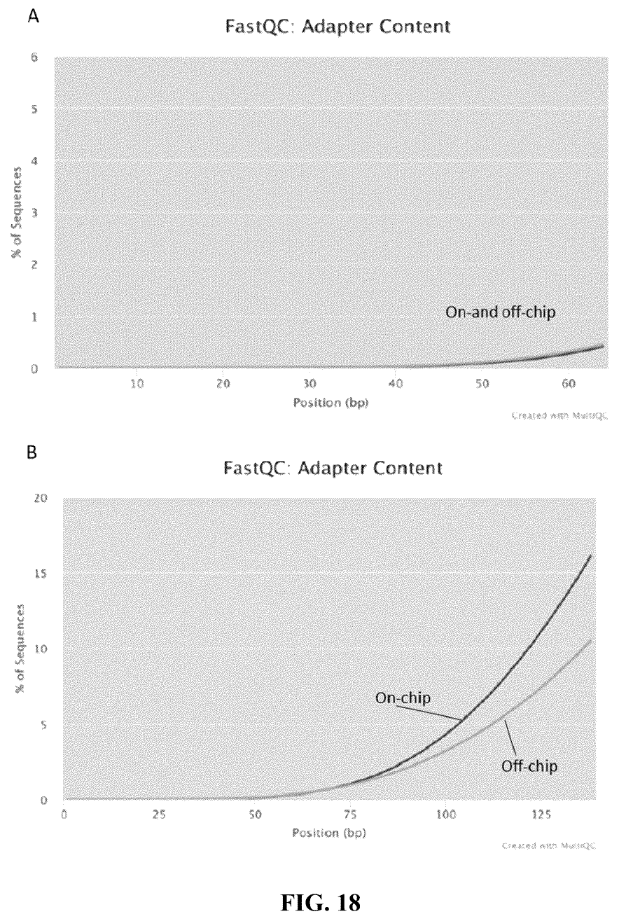

The level of duplicates for both on and off-chip libraries was low (FIG. 17) and <10% overall (Table 1). The low level of duplicated reads was also reflected in the limited content in adapters. Initial shallow sequencing (2×75) indicated <1% adapter contamination (FIG. 18A) while up to 15% and 10% adapters for on-chip and off-chip libraries, respectively, were detected when increasing sequencing depth and read length to 2×150 (FIG. 18B). The difference between on and off-chip can be due to the higher number of reads generated for the on-chip library compared to off-chip control.

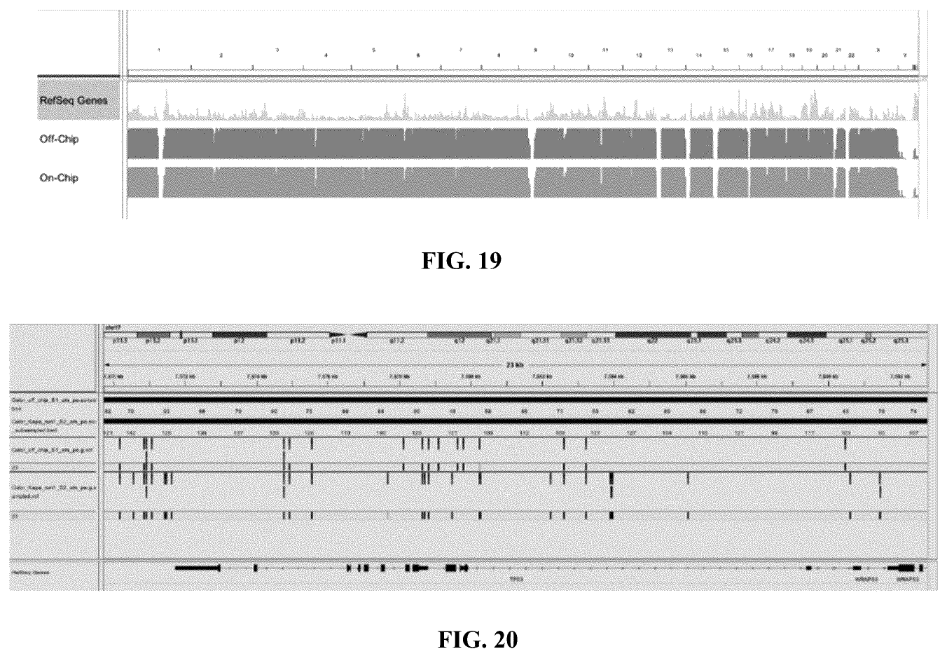

Mapping rate of passed-filter reads was high (>99%) and coverage across the genome was comparable between both libraries (FIG. 19), at a median coverage of 9X and 7X for the on-chip and off-chip libraries, respectively. Variants and the ability to call single nucleotide polymorphisms (SNPs) was determined. The heterozygous (HET) single nucleotide polymorphism (SNP) sensitivity was comparable at similar coverage between on- and off-chip (Table 1). This was confirmed by looking specifically at SNPs on the TP53 locus where identical genotypic variants were detected for both libraries in intergenic regions (FIG. 20).

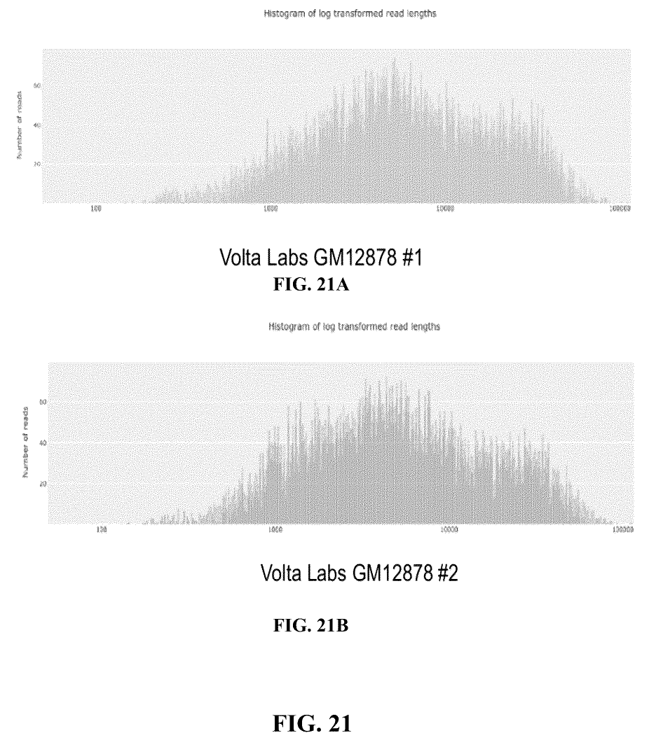

The LSK-110 ligated-based library preparation was performed on the platform to generate a library for analysis on the Oxford Nanopore MinION. Kit consumables were prepared and loaded onto the platform along with the Film Consumable for the platform itself. 1 μL of HMW gDNA derived from GM12878 cells were then loaded onto the platform. The systems automated preparation protocol was loaded and launched. At the end of the automated protocol the library was attached to beads and was manually eluted using a 37 C° incubation for 10 minutes followed by a magnetic rack. 12 μL of the supernatant containing the prepared library were transferred to an Oxford Nanopore system for analysis. The results from the experiment are displayed in Table 2 and histograms showing the read lengths for two different experimental runs are shown in FIGS. 21A and 21B.

TABLE 2

| Feature | Volta Labs | Volta Labs |
|---|---|---|
| General summary | GM12878 #1 | GM12878 #2 |
| Active channels | 480.0 | 510.0 |
| Mean read length | 10,917.9 | 10,066.3 |
| Mean read quality | 12.7 | 12.5 |
| Median read length | 5,544.0 | 4,793.0 |
| Median read quality | 13.5 | 13.2 |
| Number of reads | 1,361,151.0 | 1,546,672.0 |
| Read length N50 | 23,628.0 | 23,263.0 |
| STDEV read length | 12,862.8 | 12,655.0 |
| Total basses | 14,860,952,865.0 | 15,569,239,873.0 |

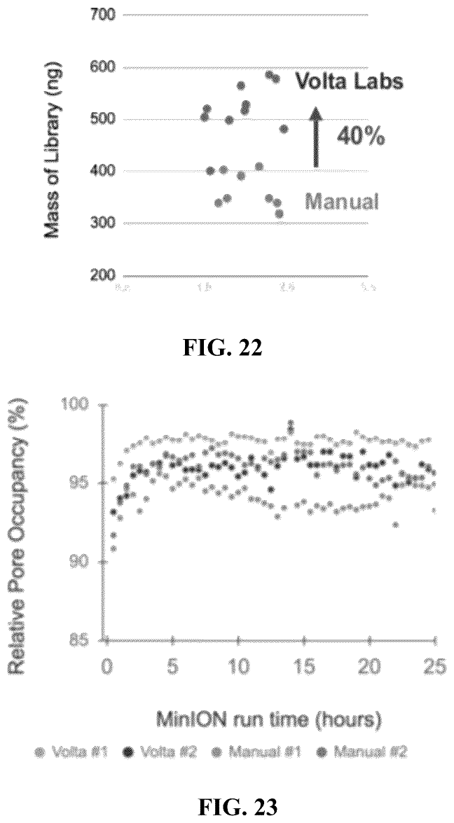

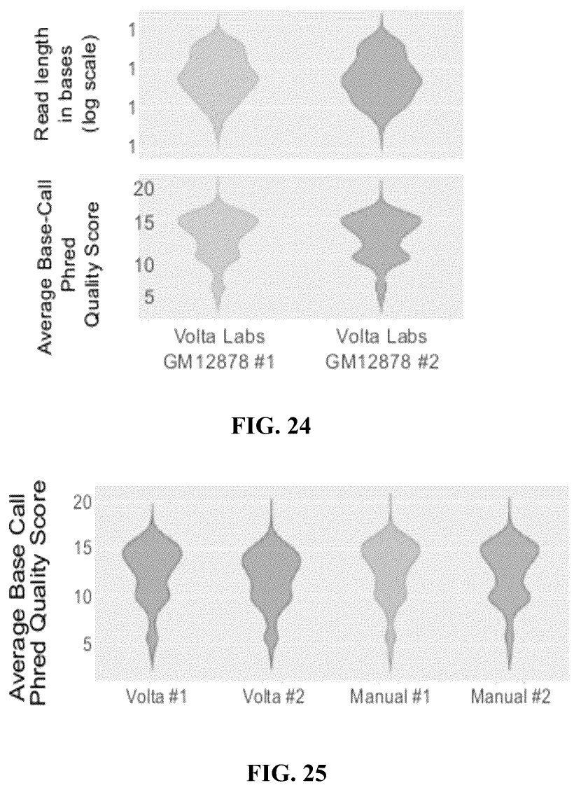

The preparation on the platform resulted in a library that contained a 40% higher yield when compared to manual preparation as seen in the results in FIG. 22. The library also showed a high level of compatibility with the MinION sequencing chemistry through high relative pore occupancy percentage when compared to manually prepared samples as shown in FIG. 23. The base call quality scores were also highly similar to those derived from manually prepared libraries as seen in FIG. 24. The sequencing data also demonstrated that the gDNA from the platform resulted in N50 of 23 kb as shown in FIG. 25.

### Example 7: Workflow Sample Preparation for DNA Samples for Sequencing on an Array

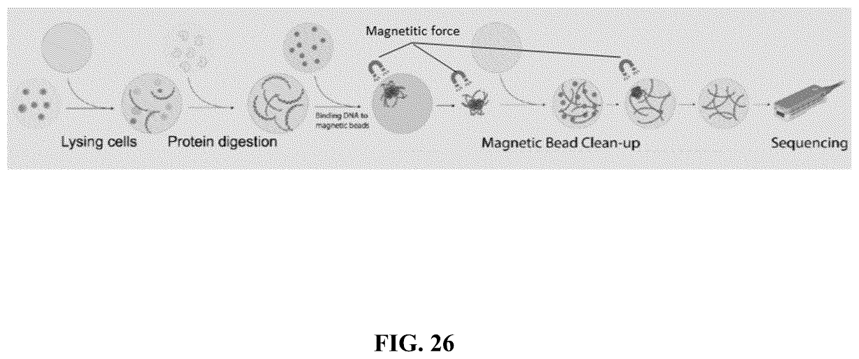

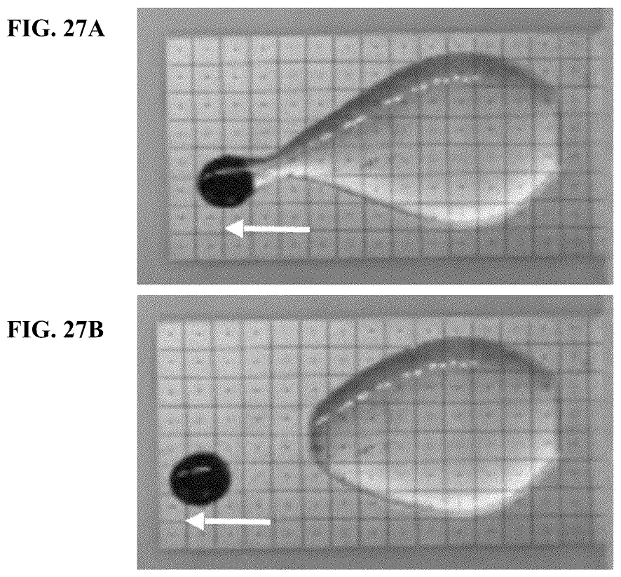

An example of a workflow for NGS on an array described herein is shown in FIG. 26. Cells in a droplet on an array are lysed on the array by introducing another droplet comprising chemical or enzymatic cellular lysis reagents. The proteins contained in the droplet are degraded by introducing degradation enzymes contained in another droplet of the array, and magnetic particles specific for DNA molecules are introduced to the droplet containing the DNA molecules. The magnetic beads are attached to the surface of the array or the magnetic beads are suspended in a droplet. The DNA molecules are separated and isolated from the cellular debris and degraded proteins using magnetic fields of the array (e.g., the movable magnets as described herein). The isolated DNA, attached to magnetic particles suspended in solution, is separated from the droplet by translating the movable magnet across a plane parallel to the surface of the substrate as depicted in FIGS. 27A-B. The isolated, DNA-coated beads undergo a magnetic bead washing process. The DNA is introduced to a DNA sequencer on, adjacent to, or separate from the array. The DNA is sequenced.

### Example 8: High-Molecular Weight DNA Extraction with Vibration Assisted Mixing

### Aims

In this experiment the intended goal is to extract long and clean DNA from biological samples such as blood, mammalian cells and cultured microbes. Typically, the aim is to isolate DNA of length greater than 50 kb (50 kilobases) and isolate enough nucleic acid material for downstream applications such as DNA sequencing and optical mapping.

The workflow starts with lysing the cells in biological samples (e.g. cells, blood). The lysis is carried out on an electrowetting array by merging two droplets-one containing the cells that need to be lysed and the other containing the lysis reagents. The lysed cells release everything from within including long pieces of DNA, proteins and other cell debri (collectively called “cell lysate”). This mixture of cell lysate is generally quite viscous. Viscous fluids do not move in response to electrowetting forces or experience severely impaired movement (e.g. more energy is needed to induce motion).

A typical method to isolate nucleic acid molecules (e.g. DNA, RNA) from this type of cell lysate mixture is by using magnetically responsive functionalized substrates (e.g. beads, discs) that have the affinity to bind to nucleic acid molecules. So even if magnetic beads are added to the mixture containing the cell lysate, due to the viscosity of the cell lysate and its non-responsiveness to electrowetting, it is difficult to mix the substrate(s) with the lysate. The substrate(s) will remain stationary within the fluid and not sufficiently bind to the nucleic acid molecules. And most often, it may be difficult to proceed to next steps in the workflow to complete the isolation of nucleic acid molecules. This is because it may be difficult to remove the excess fluid from the mixture-which is essential to separate everything from the nucleic acid molecules that are bound to the substrate(s). Even if the excess fluid was separated, the amount of nucleic acid molecules bound to the substrate(s) is typically very low. As a result, most of the nucleic acid molecules are lost and % isolated from the sample of interest is very low.

Introducing vibration/acoustic forces into this system allows for mixing viscous cell lysate with magnetic substrates (e.g. DNA with beads). This encourages most of the DNA in the lysate to bind to the beads. Once the DNA is bound to the beads, the excess fluid then becomes less viscous. The excess, less viscous fluid can then be easily separated from the beads using more standard electrowetting as described herein.

In addition to enabling efficient DNA binding onto the beads from the cell lysate, vibration assisted mixing allows for highly efficient elution of DNA from the beads (removal of DNA from beads). This typically happens when the beads with DNA are suspended in the solution in which the DNA is released. In this case, efficiency is measured by how quickly the DNA is eluted and how much of the DNA bound to the beads is eluted.

### Methods

DNA was extracted from 750,000 human cells (GM12878) on an electrowetting array with vibration assisted mixing and without. These cells are estimated to contain about 4500 ng of total genomic DNA. The results of the respective assays are exemplified in Table 3. With vibration assisted mixing, the total DNA recovered is about 2830 ng or about 63%. Whereas without vibration, the total DNA recovered is 480 ng or just about 11%. Vibration assisted mixing allows for much higher binding of DNA and isolation in comparison to if only electrowetting was relied on for mixing.

TABLE 3

| | |
|---|---|
| | DNA Yield |
| DNA Yield with | with vibration |
| no vibration | assisted mixing |

| | | | | |
|---|---|---|---|---|
| DNA Concentration | 4.8 | ng/μL | 28.3 | ng/μL |
| (nanograms of DNA | | | | |
| per microliter) | | | | |
| Total DNA Extracted | 480 | ng | 2830 | ng |
| (in nanograms) | | | | |
| in 100 μL | | | | |

| | | |
|---|---|---|
| % DNA isolated | 11% | 63% |
| from sample | | |

### Example 9: DNA Clean Up Using Magnetically Responsive Beads with Vibration Assisted Mixing

In applications where nucleic acid molecules (DNA or RNA) are the molecules of interest (e.g. as next-generation DNA sequencing (NGS), protein sequencing, quantitative PCR (qPCR), droplet digital PCR (ddPCR) and other molecular biology applications to immobilize DNA, RNA, proteins and other bio-molecules), the functionalized substrates can be used for: binding to a molecule of known size, binding to a molecule of known type and generally for isolation and cleanups from other contaminants. A typical usage of the beads and in particular for cleaning up nucleic acids from contaminants looks as shown in the diagram below.

When this cleanup workflow is performed on an electrowetting device, this is all done in droplets as follows:

First, a droplet consisting of the nucleic acid(s) of interest is merged with another droplet consisting of the functionalized substrates. During this step, the nucleic acid selectively binds to the beads and leaves all the contaminants in the solution.

Then, the substrates are then pulled down to the surface of the electrowetting array by applying a strong local magnetic field. Once the substrates are pelletized, the liquid consisting of contaminants is pulled away from the substrates using electrowetting forces. Additionally, the substrate pellet on the surface of the electrowetting array can be washed with a washing liquid such as ethanol one or more times.

Finally, the substrates are suspended by adding a droplet of water, or other elution buffer, with the magnetic field lowered. The nucleic acids bound to the beads then gets released into the solution under aqueous condition.

In the above three step process, the quality of mixing has a direct impact on the quantity of nucleic acids that are recovered at the end of the workflow. In particular, during step the first step of nucleic acid immobilization, it is important that the substrates in the liquid are mixed well to bind to most of the nucleic acid in the solution. Similarly, the amount of nucleic acid eluted in the last step is directly proportional to the quality of mixing.

On an electrowetting device (e.g. the devices described herein), mixing using electrowetting motion alone may not be good enough to achieve sufficient binding in the mixing step described immediately above and sufficient elution as described above. This results in unbound nucleic acids lost during the clean-up process. Whereas with vibration assisted mixing on an electrowetting device, the quantity of nucleic acid binding to the substrates is high. Similarly, with vibration assisted mixing, nucleic acids eluting from the substrates results in most of the nucleic acids eluted. As a result, with vibration assisted mixing, most of the DNA is recovered.

### Methods

To demonstrate this, a cleanup reaction of DNA with contaminants using SPRI (Solid Phase Reversible Immobilization) magnetic beads was carried out.

For this workflow, about 2900 ng of DNA was used as input and clean-up using three steps shown above was implemented. The workflow was carried without vibration assisted mixing and with vibration assisted mixing. Both reactions were carried out for about 5 minutes. As shown in Table 4 below, with vibration assisted mixing DNA cleanup, 2444 ng of DNA was recovered. Whereas when there is no vibration, only about 931 ng of DNA was recovered. Vibration assisted mixing recovers 2.5 times higher amount of DNA from the same input material in a cleanup process performed on an electrowetting device.

TABLE 4

| | | DNA recovered |
|---|---|---|
| | DNA recovered with | with vibration |
| | no vibration | assisted mixing |
| Mass of DNA recovered | 930.6 ng | 2444 ng |
| (in nanograms) | | |
| % Yield as a function | 32% | 84% |
| of input DNA | | |

### Vibration Assisted Mixing Generally

In general, vibration assisted mixing aides in achieving high quality results that are relevant biologically and chemically, that is difficult to achieve with pure electrowetting based mixing alone. The examples above illustrate improvements in
1. % recovery of certain molecules;
2. faster processing of samples; and
3. high efficiency in isolating DNA from challenging samples such as cell lysates.

Generally, vibration assisted mixing can improve the performance of several other biological processes. Some additional process that may benefit from this include any and all enzymatic and bead based reactions in next-generation sequencing, protein sequencing, PCR, nucleic acid restriction, nucleic acid digestion, nucleic acid amplification, gene editing, molecular cloning, biopolymer synthesis, biopolymer assembly, DNA repair, RNA repair, DNA ligation, DNA error detection and DNA replication. In particular, in these reactions, vibration assisted mixing provides the benefit of:
1. speeding up these processes and hence reducing the time for completion of reaction;
2. helps utilize these enzymes efficiently;
3. help reduce the usage of the input samples; and
4. carryout reactions with minimal errors.

Furthermore, this technique can be expanded to general biological and chemical processing with liquids containing nucleic acids, proteins, salts, surfactants, beads, cells, metabolites, organic molecules and inorganic molecules.

### Example 10: Extraction of High Molecular Weight (HMW) Genomic DNA (gDNA) from GM12878 Cells and Whole Human Blood

Cells from various sources (e.g., mammalian, bacterial, plants) are lysed directly on the array by merging a droplet containing cells with another droplet containing lysis agent (e.g., detergent or enzymatic). This mixture is heated and mixed (e.g., separately or simultaneously) on the EWOD array to promote lysis of cells and, if applicable, lysis of the nucleus. Enzymatic digestion of proteins, RNA, or a combination thereof are performed to improve the purity of the sample. While cells are lysed, the progress of lysis reaction and lysis efficiency is monitored via DNA-specific fluorescent stains. DNA is purified directly on the array by solid phase (e.g., bead-based capture or by precipitation (e.g. salt and ethanol or phenol-chloroform extraction)). Recovered DNA is manipulated and transferred to different locations of the array by EWOD with minimal shearing. DNA purity, critical for high quality long-read sequencing, is improved by increasing the number of washing cycles performed on the array. Small DNA fragments are removed using silica-nanostructured magnetic disks. The yield of recovered DNA is increased by performing additional successive elution in buffers.

After DNA extraction, samples are analyzed by Pulse Field Gel Electrophoresis (PFGE), quantifying size distribution for each sample relative to one another and analyzing commercially available ladders (BioRad) and ImageJ (NIH) profile analysis tools. For smaller inputs, (e.g., cell input) recovery/size distribution is measured by Femto Pulse (Agilent) and qPCR for lower input amounts. Genomic intactness is assessed by additional complementary methods, e.g. the BioNano Genomics Saphyr System, allowing rapid and cost-effective prototyping at a macro scale as well as independent comparability of data using the Saphyr System.

The passivation of the EWOD surface is determined by testing DNA deposition and retention in the presence of solution- and surface-deposited PEG200 or BlockAid (Invitrogen) passivated devices. Measurements are obtained i) by staining the surfaces after use with Hoechst 33342, ii) calculating surface retention of a commercial preparation of Lambda DNA (New England Biolabs, linearized 48.5 Kb), and/or iii) measuring % loss by qPCR of sample pre- and post-manipulation and input quantities from 109 to 102 copies of DNA.

Mammalian cell lysis, RNA, and protein digestion followed by HMW DNA isolation was performed on the EWOD array. The distribution of the high molecular weight DNA fragments are seen in FIG. 14 with DNA fragments larger than 165,000 bp being isolated from the sample. The longer duration of elution recovers more DNA (e.g., indicated by the taller peak) and is a way to obtain higher DNA yield.

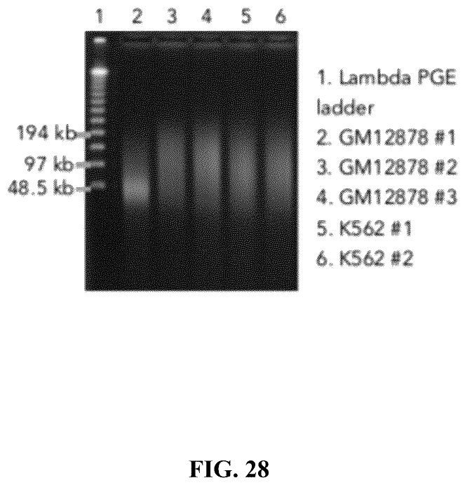

Automated extraction procedures referenced herein were performed on the EWOD array in order to derive isolated HMW DNA from GM12878 cells. The platform performed automated DNA binding, bead pelleting, washing and cleanup and finally elution without requiring manual interactions with the sample. More than 5 μg of DNA were extracted in under an hour and were of a high purity with lengths exceeding 100 kb as demonstrated in the results in FIG. 28 and in Table 5.

TABLE 5

| | GM12878 |
|---|---|
| Yield (μg) | 6.4 ± 0.9 |
| A260/A280 | 1.84 ± 0.02 |
| A260/A280 | 1.93 ± 0.09 |

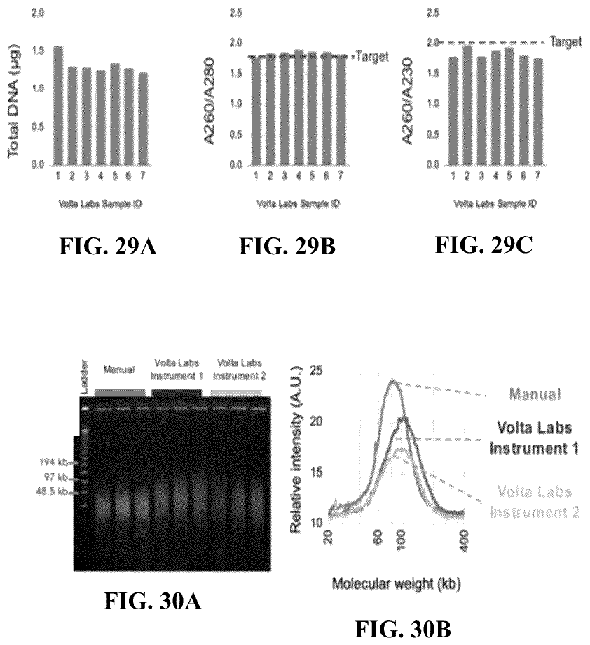

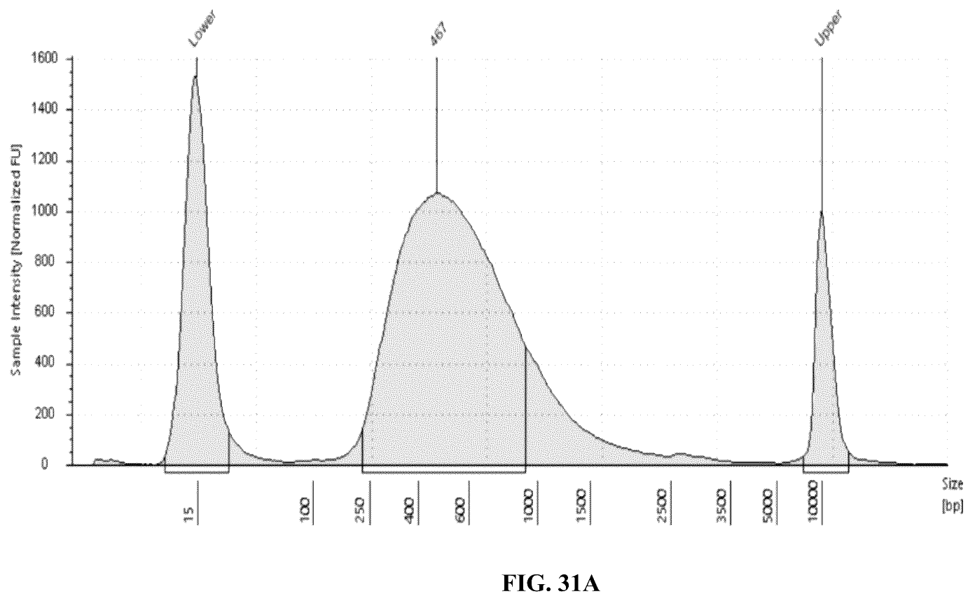

The same system was also used to extract HMW gDNA from whole human blood samples. An average of approx. 1.2 μg of DNA were derived per 100 μL of whole blood per lane in under an hour as seen in FIGS. 29A-C. Multiple lanes of extraction were run simultaneously resulting in rapid high yield isolation of gDNA. PFGE gel analysis was performed to assess the extracted fragment length compared to a manually performed extraction. The results in FIGS. 30A-B demonstrate that the extraction performed on the platform had similar or greater average gDNA fragment lengths.

Assay using similar techniques have been performed successfully on multiple mammalian cell lines including GM06852, GM09237, GM20241, GM07537, and K562.

### Example 11: Whole Genome Sequencing on Cellular Nucleic Acids

Genomic intactness is demonstrated by long read sequencing through an Oxford Nanopore device. DNA can be extracted using protocols described herein alongside Qiagen HMW kit and Loman protocols. Libraries are prepared according to an optimized protocol for keeping strands in >1 Mb lengths. The repeatability of the extractions is evaluated by sequencing a minimum of 3 each of Qiagen and Loman libraries and 7 Flexomics libraries to ensure robustness of evaluation of size performance. Regular input and low input (e.g., 1000 cells) libraries are assessed. At low input, ˜24 subsets are barcoded of 1000 cells each to provide enough material for downstream sequencing (˜150 ng theoretical).

Cell HMW DNA input is titrated down, for example, i) by supplementation with carrier DNA, e.g. Lambda DNA, to ensure balanced library preparation or ii) dilution of an absolute number of cells and scaling of library preparation and analysis reagents for subsequent reactions. Lambda DNA is biotinylated (e.g. with Pierce 3′ biotinylation kit, Thermo Fisher) to allow depletion to concentrate on-target library prior to sequencing. Performance of the ONT transposase library preparation is assessed on-device, e.g., without moving the sample to a separate tube.

Preparation of samples for whole genome sequencing across a variety of platforms has been demonstrated. Using the HMW gDNA extracted from GM12878 and whole human blood using the extraction protocols described herein, libraries were prepared for the Illumina NovaSeq 6000. The sequencing data was then compared to gDNA derived from manual extractions. The results in Table 6 and Table 7 demonstrate that the sample derived from the automated platform are of similar quality as to the samples prepared manually.

TABLE 6

| Sequencing | GM12878 gDNA | GM12878 gDNA |
|---|---|---|
| Metrics | (Manual) | (Volta Labs) |
| Total Reads | 1.545 | 1.106 |
| (in billions) | | |
| % Aligned | 94.6 | 95 |
| Mappable Mean | 74.8x | 53.7x |
| Coverage | | |
| % Genome | 97.3 | 97.1 |
| Covered ≥ 10x | | |
| % Genome | 96.7 | 96.3 |
| Covered ≥ 20x | | |
| % Genome | 96.1 | 94.8 |
| Covered ≥ 30x | | |
| Median Insert Size | 281 bp | 322 bp |
| % Bases Q ≥ 30 | 89.95 | 89.39 |
| (Illumina_{cut-off} = 85%) | | |

TABLE 7

| | Whole | Whole |
|---|---|---|
| Sequencing | Blood gDNA | Blood gDNA |
| Metrics | (Manual) | (Volta Labs) |
| Total Reads | 1.009 | 1.671 |
| (in billions) | | |
| % Aligned | 94.7 | 94.2 |
| Mappable Mean | 48.9x | 80.5x |
| Coverage | | |
| % Genome | 97.5 | 97.9 |
| Covered ≥ 10x | | |
| % Genome | 95 | 97.3 |
| Covered ≥ 20x | | |
| % Genome | 88.9 | 95.8 |
| Covered ≥ 30x | | |
| Median Insert Size | 265 bp | 275 bp |
| % Bases Q ≥ 30 | 90.80 | 90.13 |
| (Illumina_{cut-off} = 85%) | | |

These preparations and assays were also repeated using the same inputs and protocols to demonstrate that the library preparations were both consistent and reliable. The results in Table 8 show that the libraries prepared on the EWOD platform for the Illumina sequencer reliably produced high quality scores across gDNA sources.

TABLE 8

| | | | Whole | Whole |
|---|---|---|---|---|
| Sequencing | GM12878 | GM12878 | Blood | Blood |
| Metrics | gDNA #1 | gDNA #2 | gDNA #1 | gDNA #2 |
| Total Reads | 0.718 | 0.510 | 0.883 | 1.075 |
| (in billions) | | | | |
| % Aligned | 95.1 | 95.5 | 94.6 | 94.7 |
| Mappable Mean | 34.9 | 24.9 | 40.3 | 52.1 |
| Coverage | | | | |
| % Genome | 96.6 | 95.8 | 97.3 | 97.6 |
| Covered ≥ 10x | | | | |
| % Genome | 92.7 | 70.6 | 93.1 | 95.7 |
| Covered ≥ 20x | | | | |
| % Genome | 61.6 | 17.2 | 79.9 | 90.9 |
| Covered ≥ 30x | | | | |
| % Bases Q≥ 30 | 90.2 | 90.5 | 90.3 | 89.9 |
| (Illumina_{cut-off} = 85%) | | | | |

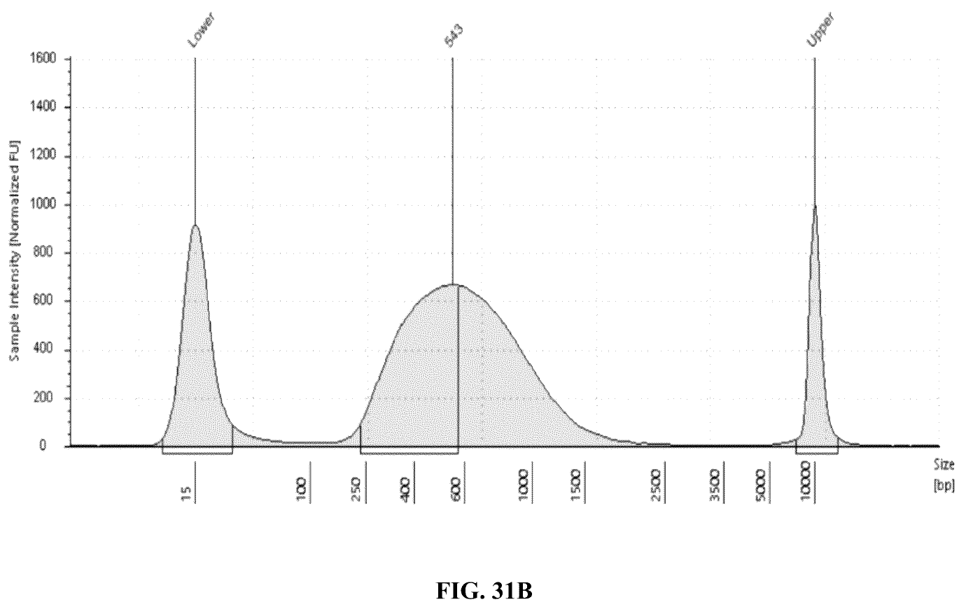

The library preparation procedure was repeated for the Illumina sequencing system to demonstrate the consistency of the streamlined, single droplet reaction automated workflow. Using an Agilent TapeStation the size of the inserts and library fragments were analyzed and the results are displayed in Table 9. The distribution of the library fragment size for one GM12878 and one whole blood sample are displayed in FIGS. 31A and 31B, respectively.

TABLE 9

| | | Insert Size | Library Size |
|---|---|---|---|
| Sample | gDNA | Desired target size: | Desired target size: |
| Number | Source | 300-450 bp | 400-600 bp |
| 1 | GM12878 | 366 | 543 |
| 2 | GM12878 | 382 | 531 |
| 3 | GM12878 | 369 | 532 |
| 4 | Whole Blood | 234 | 467 |
| 5 | Whole Blood | 342 | 511 |
| 6 | Whole Blood | 224 | 451 |

The functionality of the fragments produced in these workflows was also analyzed to ensure functionality using qPCR-based library quantification. The data from these experiments are displayed in Table 10.

TABLE 10

| Sample | gDNA | qPCR-based | Qubit-based |
|---|---|---|---|
| Number | Source | concentration (nM) | concentration (nM) |
| 1 | GM12878 | 25.2 | 58 |
| 2 | GM12878 | 28.7 | 58.9 |
| 3 | Whole Blood | 17.5 | 33.1 |
| 4 | Whole Blood | 27.4 | 34.1 |

Libraries were similarly prepared for the PacBio Sequel II sequencer from gDNA extracted from a SMRTcell of the GM07537 cell line using the automatic platform. Preparation of the library for sequencing on the PacBio equipment was accomplished using the PacBio SMRTbell v3.0 kit. A fresh 80% ethanol in nuclease free water solution and a 35% AMPure PB Bead solution in elution buffer were prepared. These two solutions along with nuclease free water were placed into the Dispenser Deck. The rest of the reagents had the volume required calculated based on the amount required per sample and were pipetted onto the reagent cartridge in the volumes listed in Table 11.

TABLE 11

| | Volume per |
|---|---|
| Reagent | sample (μL) |
| Repair Buffer | 8 |
| End Repair Mix | 4 |
| DNA Repair Mix | 2 |
| SMRTbell Adapter | 4 |
| Ligation Mix | 30 |
| Ligation Enhancer | 1 |
| Nuclease Buffer | 5 |
| Nuclease Mix | 5 |
| SMRTbell Cleanup Beads | 95 |
| Elution Buffer | 60 |

A consumable was then loaded into the platform by pressing the “Load Consumable” button on the user interface. When prompted by the system a Film Consumable was loaded. 46 μL of HMW gDNA was then pipetted using wide-bore tips onto the platform. The mass of HWM gDNA was between 300 ng and 5 μg and were between 15k and 18k base pairs in length. The A260/280 was 1.8 and the A260/230 was between 2.0 and 2.2.

After the platform was entirely prepared, the proper library preparation protocol was loaded by the user. Once engaged the instrument performed the entire automated workflow without intervention by the users. Once the protocol was finished running, a wide-bore pipette tip was used to aspirate 1.5 μL of the supernatant containing the purified library and dispensed into a 1.5 ml LoBind tube. 1 μL of the library was then dilute with 9 μL of elution buffer and analyzed using a Qubit and FemtoPulse to determine the quality of the purified library. Upon confirmation that the sample has successfully passed the quality control check, it was then used to sequence the gDNA using he PacBio sequencing equipment. These methods were conducted in droplet form on an array using methods as described in the present disclosure.

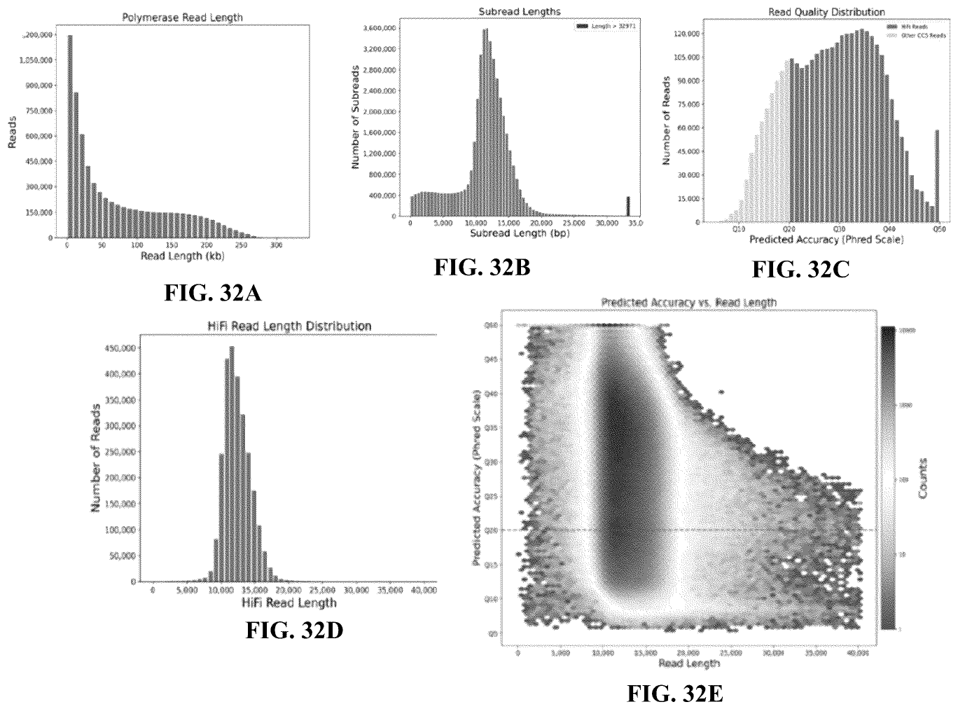

The results from the experiment are displayed in FIG. 32A-E. The raw sequence output resulted in 512 Gb of data which is above the average output of approx. 300-400 Gb experienced by the lab performing the assay. Circular consensus sequencing was performed on the sample as well and resulted in 32.5 Gb of HiFi compared to the expected average of 16-20 Gb of HiFi data. There results demonstrate 10× coverage of the genome of the single SMRTcell confirming both the high quality extraction in terms of intactness and purity as well as high compatibility with the PacBio sequencing chemistry.

### Example 12: Next Gen. Library Preparation Using the QIAseq FX DNA Kit

Preparation of the library for sequencing on the QIAseq equipment was accomplished using the QIAseq FX DNA library kit. A fresh 80% ethanol in nuclease free water solution was prepared. It, along with nuclease free water and AMPure XP beads were placed into the Dispenser Deck. The rest of the reagents had the volume required calculated based on the amount required per sample and were pipetted onto the reagent cartridge in the volumes listed in Table 12.

TABLE 12

| | Volume per |
|---|---|
| Reagent | sample (μL) |
| FX Buffer, 10x | 5 |
| Nuclease-free water | 70 |
| FX Enzyme Mix | 10 |
| DNA ligase | 10 |
| Ligation Buffer, 5x | 20 |
| Buffer EB | 140 |
| Barcodes | 5 |

A consumable was then loaded into the platform by pressing the “Load Consumable” button on the user interface. When prompted by the system, a Film Consumable was loaded. 35 μL of HMW gDNA was then pipetted using 200 μL tips onto the platform. The mass of HWM gDNA was between 100 ng and 1 μg and A260/280 was 1.8 and A260/230 was between 2.0 and 2.2.

After the platform was entirely prepared, the proper library preparation protocol was loaded by the user and the desired fragmentation time was selected. Once engaged the instrument performed the entire automated workflow without intervention by the users. Once the protocol was finished running, a pipette tip was used to aspirate 30 μL of the supernatant containing the purified library and dispensed into a 1.5 ml LoBind tube. 1 μL of the library was then analyzed using a Qubit to determine the quality of the purified library. Upon confirmation that the sample has successfully passed the quality control check, it was then used to sequence the gDNA using he PacBio sequencing equipment. These methods were conducted in droplet form on an array using methods as described in the present disclosure.

### Example 13: Sample Offloading Using Automatic Liquid Handling Systems

The ability of an automated microfluidic system to offload samples or other fluids from the analysis array will enable greater functionality for the system. Automating the removal of liquids from the array will increase the available analytical methodologies and increase the value of the device to users. This system may be able to reliable remove the majority of the desired fluid, either for further analysis or disposal. It may enable complex multistage analysis to be conducted on the platform and increase the reliability and robustness of such analyses. It may also prevent contamination of samples and the device or prevent biofouling of the electrowetting channels.

To prepare a new automated procedure, a new programing branch was created from the standard automation programing. A new Boolean parameter was added to the dispense step of the protocol function. This new parameter when set to “true” may cause the protocol to carry out an offload function. This function caused the pipettor to move above the specified tile, specified within the dispense protocol, move to the set contact height, and aspirate the specified volume. After aspiration, the pipettor dispensed the aspirated liquid into the labware tubes for the chosen reagent.

The program was set to create a 3×3 square shape on tile D7 using the electrodes in communication with the surface of the array. 40 μL of water was then dispensed into each the four lanes created on the D7 tile. These four lanes of 40 μL of water were then individually aspirated and offloaded from the surface of the array. The contact height of the pipette was set to 124.3 mm above the array surface during the procedure.

The experimental protocol resulted in the successful offloading of at least some of the water from the surface of the array. However, issues related to the positional accuracy of the aspiration were detected. This was due to the positional variability of the droplets' actual location as compared to the droplets' position at dispensation. This was attributed mainly to positional inconsistency related to the dispensation of the liquid and was most commonly observed in the fourth lane of the D7 tile. When the droplet was too far from the calculated location the tip may aspirate air instead of the droplet. In addition, the pipette was unable to aspirate the entire volume of the droplet, leaving behind a small volume of water even after the offload procedure. This volume, called the “offload dead volume,” was a small volume that may remain on the array after the protocol had been complete and may remain as one drop.

### Example 14: Increasing the Efficiency of the Sample Offloading Through Optimizing Positional Dispensation Precision

The main issues encountered during the first tests of the automatic offloading system was the difficulty encountered when the droplets may not be in the predicted location during the attempt to offload. When the aspirating tip was too far from the droplet due to this positional inaccuracy air may be aspirated instead of the desired droplet. Therefore, by increasing the accuracy of dispensation location for the droplets, the ability of the system to offload the droplets through an automated protocol may increase as well. In addition, increased accuracy for droplet dispensation locations may also assist with the implementation of other protocols. The increase precision may assist with greater control and regulations of the droplets during other operations on the array. This may increase the precision of the electrowetting array, it may prevent or reduce contamination and biofouling of the array and may allow for greater ability to conduct multiple reactions in parallel simultaneously.

The program was set to create a 3×3 checkerboard like alternating pattern on tile D7 using the electrodes in communication with the surface of the array. 40 μL of water was then dispensed into each of the four lanes created on the D7 tile. Between each disposition of droplets into their lanes on the D7 tile, the dispenser was programed to move to the D4 tile before moving back for the next dispensation step. These four lanes of 40 μL of water were then individually aspirated and offloaded from the surface of the array. The contact height of the pipette was set to 124.3 mm above the array surface. The aspiration speed of the offloading step was also slowed down as compared to previously performed experiments.

These changes to the protocols resulted in an increase in the amount that was successfully aspirated from each droplet. The modified protocol decreased the dispositional positional discrepancy. Thus, the issue of the aspirating tip failing to make contact with the droplet due to positional inaccuracy was eliminated entirely. However, the contact height may have been too high to aspirate the entirety of the droplet, as there remained an offload dead volume. The character of this offload dead volume was also altered from the previous experiments. Instead of remaining in a single droplet, it was dispersed into several independent outposts of remaining liquid. This may have been due to the checkerboard pattern of the electrowetting array, leading to increased internal on-off charged edges that the offload dead volume may have stuck to.

### Example 15: Using Water with Pluronic and Adjusted Aspirator Height to Increase Offload Efficiency

Pluronics, also known as poloxamers, are a class of synthetic block copolymers. They are unique materials composed of triblock PEO-PPO-PEO copolymers of poly(ethylene oxide) (PEO) and poly(propylene oxide) (PPO). The Pluronic PEO block is hydrophilic and water soluble while the PPO block is hydrophobic and water insoluble. In an aqueous environment, these block copolymers self-assemble into micelles with a hydrophobic PPO center core and a hydrophilic PEO outer shell that interfaces with water. They can be usefully integrated into electrowetting array workflows to prevent the biofouling of work surfaces, preventing malfunction and contamination. This will likely allow instruments to require less upkeep and maintenance while also maintaining a high-level analytical performance. It is necessary to understand how the addition of such an additive will affect the physics of a droplet when undergoing automated dispensation and aspiration on the array. This addition likely lowers the contact angle of the dispensed droplets and it also will more closely mimic the geometry of samples containing actual DNA.

The program was set to create a 3×3 checkerboard like alternating pattern on tile D7 using the electrodes in communication with the surface of the array. 40 μL of water with Pluronics was then dispensed into each of the four lanes created on the D7 tile. Between each disposition of droplets into their lanes on the D7 tile, the dispenser was programed to move to the D4 tile before moving back for the next dispensation step. These four lanes of 40 μL of water with Pluronics were then individually aspirated and offloaded from the surface of the array. The aspiration speed was the same as used in the experiment 2. The contact height of the pipettor was set to 124.3 mm above the array surface for the first trial. This was then decreased to 123.8 mm for a second run to assess the effect of lowered contract heigh on the dead weight volume of aspiration.

The addition of the Pluronics alone created similar results to those observed under the same conditions without the Pluronics. However, with the lowered contact angle from the Pluronic containing droplet, the lowered contact height of the pipette tip allowed for greater aspirational efficiency, decreasing the dead volume. However, this did not completely remove the offload dead volume from the array. The offload dead volume was again also split between several electrodes instead of concentrated in a single drop.

### Example 16: Offloading with Manual Controls and Variable Contact and Electrode Array Patterns

Fine tuning of the isolated individual actions of the system requires that each operation be tested while removing or isolating as many other variables as possible to optimize each variable. The offloading step has two major variable that are implicated only during the actual aspiration and may be isolated and tested individually for their effect on offloading efficiency in order to minimize dead weight volume. The first tested was the contact height of the pipette tip, which has been shown to have an effect as has the efficiency of the aspiration.

In order to test different contact heights, the following procedure was used. A 3×3 alternating checkerboard pattern was created using the electrodes on tile D7. 50 μL of water with Pluronics were manually pipetted onto lane three on tile D7. The aspiration pipette tip was then moved above lane three on tile D7. A command to aspirate 50 μL was entered. The pipette was then withdrawn from the tile and the dead weight volume was assessed.

The lowest acceptable contact height was found to be 122.7 mm. This height was the minimum allowable height for the pipette tip that the instrument can afford for the offloading procedure and represents the optimal height for the offloading of water containing Pluronics.

With the optimal height determined, the second major variable during the offloading state was the status of the electrowetting forces. These forces may counteract the adhesive forces between the liquid and the pipette tip. By adjusting the patterns after the tip was in place, the most efficiency pattern for decreasing the dead weight volume left after the offloading procedure may be determined.

The previous methodology was repeated, with the contact height set to 122.7 mm. However, between the moving the pipette to tile D7 and the command to aspirate the fluid, the electrowetting pattern was altered. 3 different patterns were tested: 3×3 checkerboard, off, and 4×4 square on.

Under these three conditions, it was predicted that turning the array off may yield the best results. Here, there may be no forces to counter the adhesive forces that attract the liquid to the pipette tip. This may make it more likely that the liquid may be centered around the pipette tip when aspirated. In practice, this may be challenging to implement as each lane may need to be discharged piecemeal as the pipettor arrived. The switch to the full 4×4 pattern was thus also included as a more feasible alternative, since this may anchor the drop in place in the time before the tip arrives while reducing the chance that a small leftover volume may separate from the aspirated portion.

The results for the experiment are shown in Table 13. These tests indicate that while the checkerboard is useful for reducing drop position variability across lanes, it is less optimal to have on during the offloading step compared to a large solid shape or a lack of EWOD.

TABLE 13

| Electrowetting condition | | |
|---|---|---|
| during aspiration | Dead Volume | |
| 3 × 3 Checkerboard On | 5.1 | μL |
| 4 × 4 Square On | <1 | μL |
| Off | <1 | μL |

### Example 17: Using Anchoring Beads for Greater Positional Accuracy

The foregoing examples of this application show that both high precision in where the droplets are dispensed and anchoring the droplets to that position during offloading have a significant effect on the offloading efficiency. While using the electrowetting pattern has been used to address both of these factors, this may not always be an option during the more complex automated processes. Therefore, an alternative that may help address both factors as well is the use of beads to anchor the droplets both during disposition and aspiration.

Experiments will be conducted to test the effect of using beads to decrease the positional inaccuracy of the disposition. This will use the same methodology as the testing for other disposition and aspiration related variables. These experiments will then be repeated to demonstrate the effect of using the beads to anchor the droplet during aspiration, demonstrating that the bead will enable greater aspirational. It is likely that the addition of beads will show similar increases in offload efficiency as the modified electrowetting patterns.

### Example 18: Testing the Viability of Various Methods of Dispersal in an Exemplar Workflow

The method of distribution used to perform automated procedures are required to be highly accurate and repeatable. Any variation in the distribution pattern may cause failure in the sample preparation or assay and a useful instrument cannot regularly have a failure to properly perform the given workflows. These variations may result from uncertainty in the locational distribution or failure to distribute the proper volume. Noncontact, shake, and pseudo-contact are three possible distribution methods that provide certain advantages, depending on the given methodology, and may be better suited to different stages of the protocol. In order to ensure that the proper method of distribution was selected for each step, a reliability study was performed.

Twelve individual steps taken from the PacBio library preparation protocol were performed on the instrument using the standard base method of contactless droplet distribution. These steps were distribution of 14 μL End Repair Master Mix and 4 μL of the Barcode Adapter. The rate of successful performance of each step was recorded, and if the rate of successful performance was less than 100%, then the step was repeated with a vibrational component added to the distribution step. The success rate was again recorded, and any step that had less than a 100% success rate was then tested a third time using a pseudo-contact method for distribution.

The result of the testing was that every one of the twelve steps that were tested were able to reach a 100% success rate using one of the three possible distribution methods. Generally noncontact was successful with the majority of steps. However it struggled with lower volume distributions. Adding shaking was able to improve the success rate for four of the remaining six steps to the desired rate of 100%. The remaining two steps then had to be tested using pseudo-contact to achieve 100%. Using pseudo-contact with both of these steps achieved 100% success rate for both. The results are displayed in Table 14 below. The results demonstrate that for smaller volumes, especially those below 10 microliters, pseudo-contact may be required for reliable distribution.

TABLE 14
Success Rates of Distribution Methods

| | Volume | Noncontact | Shake | Pseudo-Contact |
|---|---|---|---|---|
| Reagent | (μL) | (%) | (%) | (%) |
| End Repair MM | 14 | 60* | 70* | 100** |
| Ligation MM | 31 | 100** | † | † |
| Nuclease MM | 10 | 100** | † | † |
| Barcode Adapter | 4 | 15* | 25* | 100** |
| Water | 8 | 90* | 100** | † |
| | 10 | 100** | † | † |
| | 14 | 100** | † | † |
| | 30 | 80* | 100** | † |
| | 40 | 80* | 100** | † |
| 80% Ethanol | 40 | 100** | † | † |
| Elution Buffer | 50 | 100** | † | † |
| | 20 | 90* | 100** | † |
| Elution Buffer P | 45 | 100** | † | † |
| SMRBell Beads | 95 | 100** | † | † |
| Ampure Beads | 50 | 100** | † | † |
| Diluted Ampure | 151 | 100** | † | † |
| Beads | | | | |
| Lubricant | 30 | 100** | † | † |

*Unacceptable Success Rate
**Successful attempt
† Not attempted

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method for droplet processing, the method comprising:
(a) providing (i) a substrate comprising a discrete location, (ii) one or more electrodes disposed adjacent to said discrete location of said substrate, and (iii) a droplet dispenser disposed over said substrate; and
(b) activating or deactivating an electrode of said one or more electrodes, which activating or deactivating is synchronized with dispensing a droplet to said discrete location or removal of at least a portion of said droplet from said discrete location by said droplet dispenser.

2. (canceled)

3. The method of claim 1, wherein said droplet dispenser comprises a droplet handling arm that moves towards or away from said substrate.

4. The method of claim 1, wherein said droplet dispenser is used to dispense said droplet to said discrete location.

5. The method of claim 1, wherein said droplet dispenser is used to remove at least a portion of said droplet from said discrete location.

6. The method of claim 1, wherein said droplet is dispensed at said discrete location at an error margin of no more than 20 millimeters (mm), which error margin is calculated based at least in part on a difference between an intended dispensing location and an actual dispensing location of said droplet.

7. (canceled)

8. (canceled)

9. (canceled)

10. The method of claim 1, wherein said droplet dispenser is programmed to displace itself in an oscillating motion at an amplitude from about 0.1 mm to about 20 mm during dispensation or at a frequency of about 1 Hertz (Hz) to about 20 mega Hz during dispensation.

11. (canceled)

12. (canceled)

13. (canceled)

14. (canceled)

15. (canceled)

16. (canceled)

17. (canceled)

18. (canceled)

19. The method of claim 1, wherein said droplet dispenser is in an open configuration.

20. The method of claim 1, wherein said droplet comprises a biological sample.

21. (canceled)

22. (canceled)

23. The method of claim 1, wherein said substrate further comprises a top plate and a bottom plate, wherein said top plate comprises one or more inlets configured to receive a droplet from said droplet dispenser.

24. The method of claim 23, wherein said top plate has at least one hole.

25. (canceled)

26. The method of claim 1, wherein said droplet dispenser is automated.

27. (canceled)

28. The method of claim 1, wherein said droplet dispenser does not make contact with a surface of said substrate.

29. The method of claim 1, wherein said droplet dispenser is configured to move with respect to at least three axes.

30. (canceled)

31. (canceled)

32. (canceled)

33. The method of claim 1, wherein said droplet dispenser comprising said droplet shakes with respect to a plane parallel to a surface of said substrate during said dispensing said droplet to said location or shakes in a “Figure Eight” pattern.

34. (canceled)

35. The method of claim 1, further comprising providing a reagent reservoir adjacent to said substrate, wherein said reagent reservoir comprises one or more reagents configured to be received by said droplet dispenser.

36. The method of claim 35, wherein said reagent reservoir or said droplet dispenser are integrated into a single unit.

37. The method of claim 35, wherein said reservoir and/or said droplet dispenser are configured to regulate temperature, stir, or agitate fluids.

38. (canceled)

39. The method of claim 1, wherein said droplet comprises at least one biological sample, and wherein said droplet dispenser does not make contact with said biological sample.

40. The method of claim 1, further comprising:
(a) providing a sample droplet on an electrowetting substrate;
(b) suspending and mixing beads in said sample droplet;
(c) introducing a magnet into said sample droplet, and moving said magnet in one or more axes while said sample droplet is held in place by said electrowetting substrate; and
(d) separating said bead from said sample droplet.

41.-179. (canceled)
